(19) United States
(12) Patent Application Publication
(10) Pub. No.: US 2024/0273411 A1
(43) Pub. Date: Aug. 15, 2024

(54) ARTIFICIAL INTELLIGENCE REGULATORY MECHANISMS

(71) Applicant: Intel Corporation, Santa Clara, CA (US)

(72) Inventors: Markus Dominik MUECK, Unterhaching (DE); John M. ROMAN, Beaverton, OR (US); Amit ELAZARI BAR ON, Pacifica, CA (US)

(21) Appl. No.: 18/566,483

(22) PCT Filed: Aug. 5, 2022
(86) PCT No.: PCT/US2022/039597

§ 371 Date: Dec. 1, 2023

Related U.S. Application Data
(60) Provisional application No. 63/230,320, filed on Aug. 6, 2021.
(60) Provisional application No. 63/286,215, filed on Dec. 6, 2021.

(51) Int. Cl. G06N 20/00; H04L 9/32

(52) U.S. Cl. CPC G06N 20/00; H04L 9/3247

(57) ABSTRACT

The present disclosure is related to mechanisms for enforcing compliance with artificial intelligence (AI) and machine learning (ML) regulatory frameworks. The AI regulatory enforcement mechanisms are capable of testing AI systems for quality, accuracy, and robustness, as well as for compliance with AI regulatory requirements. AI regulatory enforcement mechanisms provide restrictions and safeguards by controlling actions of AI systems and/or other components to prevent erroneous or biased AI system predictions from being used, and potentially causing harm to individuals or objects. The AI regulatory enforcement mechanisms ensure that AI systems function in ways that are secure, trustworthy, and ethical.

### RELATED APPLICATIONS

The present disclosure claims priority to U.S. Provisional App. No. 63/230,320 filed on Aug. 6, 2021 (“['320]”) and U.S. Provisional App. No. 63/286,215 filed on Dec. 6, 2021 (“['215]”), the contents of each of which are hereby incorporated by reference in their entireties and for all purposes.

### TECHNICAL FIELD

The present disclosure is generally related to data processing, service management, resource allocation and management, network communication, communication system implementations, and edge computing, and in particular, to artificial intelligence (AI) and machine learning (ML) regulatory mechanisms.

### BACKGROUND

Artificial Intelligence (AI) is a fast evolving family of technologies that can bring a wide array of economic and societal benefits across the entire spectrum of industries and social activities. By improving prediction, optimizing operations and resource allocation, and personalizing service delivery, the use of artificial intelligence can support socially and environmentally beneficial outcomes. Such action is especially needed in high-impact sectors, including climate change, environment and health, the public sector, finance, mobility, home affairs and agriculture. However, the same elements and techniques that power the socio-economic benefits of AI can also bring about new risks or negative consequences for individuals or the society.

The European Commission (EC) is the executive branch of the European Union (EU), which is responsible for proposing legislation and enforcing EU laws. The EC is currently in the process of finalizing the regulations laying down harmonized rules on artificial intelligence referred to as the “Artificial Intelligence Act”. The AI Act is a proposed EU law that assigns applications of AI to three risk categories including applications and systems that create an unacceptable risk (e.g., government-run social scoring) are banned, high-risk applications (e.g., CV-scanning tools that ranks job applicants) are subject to specific legal requirements, and applications not explicitly banned or listed as high-risk are largely left unregulated (see e.g., Proposal for a REGULATION OF THE EUROPEAN PARLIAMENT AND OF THE COUNCIL LAYING DOWN HARMONISED RULES ON ARTIFICIAL INTELLIGENCE (ARTIFICIAL INTELLIGENCE ACT) AND AMENDING CERTAIN UNION LEGISLATIVE ACTS, European Commission, Brussels, COM(2021) 206 final, 2021/0106 (COD) {SEC(2021) 167 final}-{SWD(2021) 84 final}-{SWD(2021) 85 final} (21 Apr. 2021) (“[AIA]”), the contents of which is hereby incorporated by reference in its entirety). As a next step, the European Standards Organizations (ESOs) will receive a standardization request with specific instructions to define technical and testable requirements in Harmonised Standards (HS). The European Telecommunications Standards Institute (ETSI), the European Committee for Standardization (French: Comité Européen de Normalisation (CEN)), and European Committee for Electrotechnical Standardization (French: Comité Européen de Normalisation Électrotechnique (CENELEC)) will be tasked to develop such HS.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 depicts an example procedure for requesting high-risk AI (HRAI) authorization codes.

FIGS. 2 and 8 show example data packets.

FIGS. 3, 4, and 5 depict procedures for verifying of HRAI systems.

FIG. 6 depicts a procedure for creation and consumption of data packets for HRAI systems.

FIG. 7 depicts an example registration procedure for registering HRAI systems.

FIG. 9 depicts example components of a AI system independent of external components.

FIG. 10 depicts an example process for accessing a HRAI systems.

FIG. 11 depicts an example process for using training data for AI systems.

FIG. 12 depicts an example process for processing information on technical documentation for AI systems.

FIG. 13 depicts an example process for management of access to recorded data of AI systems.

FIG. 14 depicts an example procedure for record keeping of data related to a user and user activity.

FIG. 15 depicts an example procedure for comparison of AI input data to reference data.

FIG. 16 depicts an example procedure for requesting information related to transparency and other.

FIG. 17 depicts an example procedure for update of information related to transparency and other.

FIG. 18 depicts an example procedure for human oversight.

FIG. 19 depicts an example procedure for usage of redundant versions of the AI system/equipment/functionality.

FIG. 20 depicts an example procedure for access to data required from data required from providers of HRAI system(s) and/or non-HRAI system(s).

FIG. 21 depicts an example procedure for management of access to quality management system information.

FIG. 22 depicts an example procedure for processing information on technical documentation for AI systems.

FIG. 23 depicts an example AI system monitoring, evaluation, and reporting (AIMER) arrangement.

FIG. 24 depicts an example AI risk management system function.

FIG. 25 depicts an example data verification component.

FIG. 26 depict aspects of an example entity for AI output self-verification.

FIG. 27 shows an example accuracy verification process.

FIG. 28 shows an example robustness verification process.

FIG. 29 depicts an example AI system verification based on a hash calculation related to AI system state.

FIG. 30 depicts an example AI system quality manager.

FIG. 31 depicts an example vehicle network environment implementing the various AI system regulatory aspects discussed herein.

FIG. 32 illustrates an example network connectivity for non-terrestrial and terrestrial settings.

FIG. 33 illustrates an example edge computing environment.

FIG. 34 illustrates an example software distribution platform.

FIG. 35 depict example components of various compute nodes, which may be used in edge computing system(s).

FIG. 36 depicts an example neural network (NN).

FIG. 37 depicts an example reinforcement learning architecture.

### DETAILED DESCRIPTION

### 1. Artificial Intelligence Regulation-Related Aspects

Artificial intelligence (AI) is a fast evolving family of technologies that can contribute to a wide array of economic and societal benefits across the entire spectrum of industries and social activities. By improving prediction, optimizing operations and resource allocation, and personalizing digital solutions available for individuals and organizations, the use of artificial intelligence can provide key competitive advantages to companies and support socially and environmentally beneficial outcomes, for example in healthcare, farming, education and training, infrastructure management, energy, transport and logistics, public services, security, justice, resource and energy efficiency, and climate change mitigation and adaptation.

The European Commission (EC) is currently in the process of finalizing the AI Regulation (see e.g., [AIA]). As a next step, the European Standards Organizations (ESOs) will receive a standardization request with specific instructions to define technical and testable requirements in Harmonized Standards (HS). ETSI, CEN and CENELEC will be tasked to develop such HS.

The present disclosure provides solutions for the basic requirements of the [AIA], which can be implemented in any AI related equipment. The present disclosure provides solutions for: marking of components suitable for HRAI systems, Marking and usage of (training) data for high-risk and non-HRAI systems, Automated registration obligations as referred to in Article 51 of the regulation. Management and detection of errors, faults or inconsistencies that may occur within the system or the environment in which the system operates, in particular due to their interaction with natural persons or other systems, and automated recording of events (‘logs’) while the HRAI systems is operating.

Currently, there is very little regulation of AI systems. In particular, there is currently no differentiation between HRAI systems and non-HRAI systems, and little to no restrictions or regulations on the operation of AI systems. The [AIA] will specify restrictions or regulations on the operation of AI systems and differentiate between HRAI systems and non-HRAI systems. Currently existing AI systems, including those used for commercial purposes, have no such solutions implemented. Some existing AI systems do have self-imposed restrictions put in place, but these self-imposed restrictions are not aligned to the [AIA].

The present disclosure provides mechanisms for marking components suitable for HRAI systems/categories identified by the [AIA]. The present disclosure provides mechanisms for marking and usage of (training) data for HRAI systems and non-HRAI systems and categories identified by the [AIA]. The present disclosure provides mechanisms for automated registration obligations as referred to in Article 51 of the [AIA] including registering an AI system to the EU database as identified by the [AIA]. The present disclosure provides mechanisms for managing and detecting errors, faults, and/or inconsistencies that may occur within the system or the environment in which the system operates, in particular due to their interaction with natural persons or other systems including management of identified errors, faults or inconsistencies as identified by the [AIA]. The present disclosure provides mechanisms for automated recording of events (‘logs’) while the HRAI systems is operating including management of recording of events including the management of access to the related data (e.g., differentiating between access to abstracted data and full datasets). With the mechanisms discussed herein, a manufacturer will be compliant to the [AIA], and will be able to place AI systems and related equipment onto the European single market. Additionally, because the [AIA] addresses the various risks and benefits associated with AI, the various examples discussed herein allow AI systems to be developed in a secure, trustworthy, and ethical manner in ways that consume less time and computing resources than existing AI development techniques. The various examples discussed herein improve the functioning of the AI systems themselves and/or computing devices/systems that use or operate such AI systems by reducing the amount of time and/or computing resources needed to ensure compliance with the [AIA].

### 1.1. AI Regulatory Framework

Article 1 of the [AIA] states the high level framework/requirements for AI systems, which is shown by Table 1.1-1.

TABLE 1.1-1
Article 1
Subject matter

| This Regulation lays down: | |
|---|---|
| (a) | harmonised rules for the placing on the market, the putting |
| | into service and the use of artificial intelligence systems |
| | (‘AI systems') in the Union; |
| (a) | prohibitions of certain artificial intelligence practices; |
| (b) | specific requirements for high-risk AI systems and |
| | obligations for operators of such systems; |
| (c) | harmonised transparency rules for AI systems intended to |
| | interact with natural persons, emotion recognition systems |
| | and biometric categorisation systems, and AI systems used |
| | to generate or manipulate image, audio or video content; |
| (d) | rules on market monitoring and surveillance. |

The regulation further differentiates between “high-risk AI systems” and “non-high-risk AI systems”. High-Risk AI (HRAI) systems are AI systems likely to pose high risks to fundamental rights and safety, according to Article 6 of the [AIA], which is shown by Table 1.1-2 and Table 1.1-3.

TABLE 1.1-2
Article 6
Classification rules for high-risk AI systems

| 1. | Irrespective of whether an AI system is placed on the market | |
|---|---|---|
| | or put into service independently from the products referred to | |
| | in points (a) and (b), that AI system shall be considered high- | |
| | risk where both of the followin gconditions are fulfilled: | |
| | (a) | the AI system is intended to be used as a safety component |
| | | of a product, or is itself a product, covered by the Union |
| | | harmonisation legislation listed in Annex II; |
| | (b) | the product whose safety component is the AI system, or the |
| | | AI system itself as a product, is required to undergo a third- |
| | | party conformity assessment with a view to the placing on the |
| | | market or putting into service of that product pursuant to the |
| | | Union harmonisation legislation listed in Annex II. |

| | |
|---|---|
| 2. | In addition to the high-risk AI systems referred to in paragraph |
| | 1, AI systems referred to in Annex III shall also be considered |
| | high-risk. |

TABLE 1.1-3
ANNEX III
HIGH-RISK AI SYSTEMS REFERRED TO IN ARTICLE 6(2)

High-risk AI systems pursuant to Article 6(2) are the AI systems listed in any of
the following areas:

| 1. | Biometric identification and categorisation of natural persons: | |
|---|---|---|
| | (a) | AI systems intended to be used for the ‘real-time’ and ‘post’ remote biometric |
| | | identification of natural persons; |
| 2. | Management and operation of critical infrastructure: | |
| | (a) | AI systems intended to be used as safety components in the management and |
| | | operation of road traffic and the supply of water, gas, heating and |
| | | electricity. |
| 3. | Education and vocational training: | |
| | (a) | AI systems intended to be used for the purpose of determining access or |
| | | assigning natural persons to educational and vocational training institutions; |
| | (b) | AI systems intended to be used for the purpose of assessing students in |
| | | educational and vocational training institutions and for assessing |
| | | participants in tests commonly required for admission to educational |
| | | institutions. |
| 4. | Employment, workers management and access to self-employment: | |
| | (a) | AI systems intended to be used for recruitment or selection of natural persons, |
| | | notably for advertising vacancies, screening or filtering applications, |
| | | evaluating candidates in the course of interviews or tests; |
| | (b) | AI intended to be used for making decisions on promotion and termination of |
| | | work-related contractual relationships, for task allocation and for monitoring |
| | | and evaluating performance and behavior of persons in such relationships. |
| 5. | Access to and enjoyment of essential private services and public services and | |
| | benefits: | |
| | (a) | AI systems intended to be used by public authorities or on behalf of public |
| | | authorities to evaluate the eligibility of natural persons for public |
| | | assistance benefits and services, as well as to grant, reduce, revoke, or |
| | | reclaim such benefits and services; |
| | (b) | AI systems intended to be used to evaluate the creditworthiness of natural |
| | | persons or establish their credit score, with the exception of AI systems put |
| | | into service by small scale providers for their own use; |
| | (c) | AI systems intended to be used to dispatch, or to establish priority in the |
| | | dispatching of emergency first response services, including by firefighters |
| | | and medical aid. |
| 6. | Law enforcement: | |
| | (a) | AI systems intended to be used by law enforcement authorities for making |
| | | individual risk assessments of natural persons in order to assess the risk of |
| | | a natural person for offending or reoffending or the risk for potential victims |
| | | of criminal offences; |
| | (b) | AI systems intended to be used by law enforcement authorities as polygraphs |
| | | and similar tools or to detect the emotional state of a natural person; |
| | (c) | AI systems intended to be used by law enforcement authorities to detect deep |
| | | fakes as referred to in article 52(3); |
| | (d) | AI systems intended to be used by law enforcement authorities for evaluation |
| | | of the reliability of evidence in the course of investigation or prosecution |
| | | of criminal offences; |
| | (e) | AI systems intended to be used by law enforcement authorities for predicting |
| | | the occurrence or reoccurrence of an actual or potential criminal offence |
| | | based on profiling of natural persons as referred to in Article 3(4) of |
| | | Directive (EU) 2016/680 or assessing personality traits and characteristics |
| | | or past criminal behaviour of natural persons or groups; |
| | (f) | AI systems intended to be used by law enforcement authorities for profiling |
| | | of natural persons as referred to in Article 3(4) of Directive (EU) 2016/680 |
| | | in the course of detection, investigation or prosecution of criminal offences; |
| | (g) | AI systems intended to be used for crime analytics regarding natural persons, |
| | | allowing law enforcement authorities to search complex related and unrelated |
| | | large data sets available in different data sources or in different data |
| | | formats in order to identify unknown patterns or discover hidden relationships |
| | | in the data. |
| 7. | Migration, asylum and border control management: | |
| | (a) | AI systems intended to be used by competent public authorities as polygraphs |
| | | and similar tools or to detect the emotional state of a natural person; |
| | (b) | AI systems intended to be used by competent public authorities to assess a |
| | | risk, including a security risk, a risk of irregular immigration, or a health |
| | | risk, posed by a natural person who intends to enter or has entered into the |
| | | territory of a Member State; |
| | (c) | AI systems intended to be used by competent public authorities for the |
| | | verification of the authenticity of travel documents and supporting |
| | | documentation of natural persons and detect non-authentic documents by |
| | | checking their security features; |
| | (d) | AI systems intended to assist competent public authorities for the examination |
| | | of applications for asylum, visa and residence permits and associated |
| | | complaints with regard to the eligibility of the natural persons applying for |
| | | a status. |
| 8. | Administration of justice and democratic processes: | |
| | (a) | AI systems intended to assist a judicial authority in researching and |
| | | interpreting facts and the law and in applying the law to a concrete set of |
| | | facts. |

Non-High-Risk AI (non-HRAI) systems are AI systems for which only very limited transparency obligations are imposed, for example, in terms of the provision of information to flag the use of an AI system when interacting with humans. Products need to meet “essential requirements” (e.g., high quality data, documentation and traceability, transparency, human oversight, accuracy and robustness) to be further detailed by ESOs in HS.

### 1.2. Marking of Components Suitable for High-Risk AI Systems

As alluded to previously, software (SW) and hardware (HW) components can be marked to indicate whether they are an HRAI system or application, an HRAI component or otherwise part of an HRAI system. These markings are referred to herein as “HRAI application authorization codes” or the like, and are used to indicate to other components the high-risk nature of a system or application.

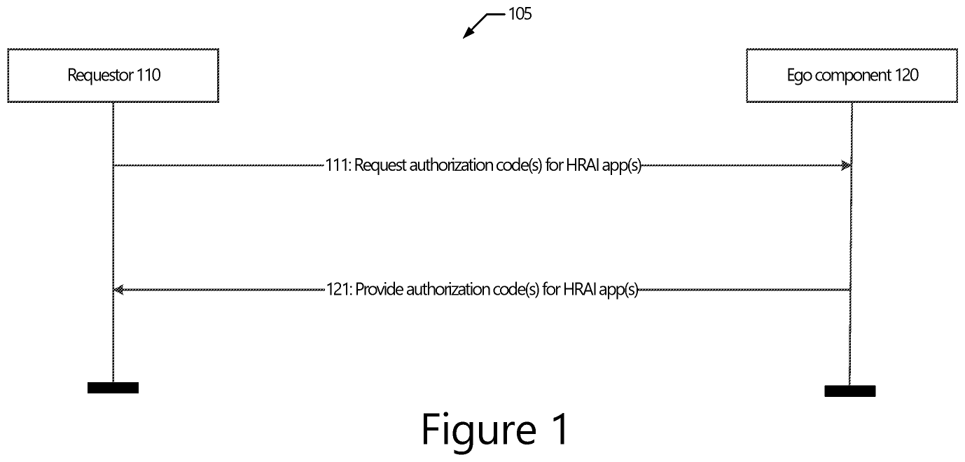

FIG. 1 shows a procedure 100 for requesting HRAI authorization codes. In procedure 100, a requestor 110 at operation 101 sends a request for HRAI authorization code(s) to a considered (ego) component 120. In some examples, the requestor 110 is a HW and/or SW element such as a compute node, a component within a compute node, a SW package or module, an AI/ML model, a user, a data processor, a service, and/or any other device, system, or entity, such as any of those discussed herein. At operation 102, the ego component 120 provides the requested HRAI authorization code(s) to the requestor 110. As examples, the ego component 120 is an AI system component, a HW component, and/or a SW element such as a compute node, a component within a compute node, a SW package or module, an AI/ML model, a user, a data processor, a service, and/or any other device, system, or entity, such as any of those discussed herein. Additionally or alternatively, the ego component 120 can include one or more, such as, for example, one or more processing elements (e.g., CPUs, GPUs, XPUs, FPGAs, multiply-and-accumulate units (MAC), probabilistic bit devices (p-bits), and/or other processing elements such as any of those discussed herein; see e.g., discussion of processor circuitry 3552 and/or acceleration circuitry 3564 of FIG. 35 infra), one or more memory devices (see e.g., discussion of memory circuitry 3554 of FIG. 35 infra), one or more storage devices (e.g., hard disc drives, solid-state drives, and/or the like; see e.g., discussion of storage circuitry 3558 of FIG. 35 infra), one or more communication modules (e.g., RLAN and/or WiFi station circuitry, cellular communication circuitry, and/or the like) and/or related RF components (see e.g., discussion of communication circuitry 3566 of FIG. 35 infra), and/or user interface elements (e.g., physical buttons, light emitting elements, touch interface(s), display elements to show results provided by the AI system, and/or the like; see e.g., discussion of input circuitry 3586 and output circuitry 3584 of FIG. 35 infra). Additionally or alternatively, the ego component 120 could include one or more quantum computing elements and/or quantum circuits. For purposes of the present disclosure a “component” may refer to a SW component, an HW component, and/or a component including both SW and HW elements including any of the elements/entities discussed herein or combinations thereof.

A component can include a field or data element that indicates whether the component may be used for HRAI systems and non-HRAI systems, or can only be used for non-HRAI systems. In some implementations, SW/HW components authorized to use HRAI systems are considered to be authorized to use non-HRAI systems since the requirements and/or protective measures for using non-HRAI systems are considerably lower than the requirements and/or protective measures for using HRAI systems. For purposes of the present disclosure an “HRAI system” may refer to a HW-based HRAI system, a SW-based system or application, and/or an HRAI system that includes both SW and HW elements including any of the elements/entities discussed herein or combinations thereof. Additionally, the term “HRAI system” may be used interchangeably with the term “HRAI application” even though these terms may refer to different concepts.

Furthermore, components authorized to use (or be used by) an HRAI system apply one or more of the following additional indications: (1) an indication that the component is authorized for usage for all HRAI systems; and/or (2) an indication that the component is authorized for one or more of the HRAI system categories shown by Table 1.2-1.

TABLE 1.2-1
Authorization codes for specific HRAI systems

| HRAI System Category | | | AI Authorization Code |
|---|---|---|---|
| 1. | Biometric identification and categorisation of natural persons: | | 0000 |
| | (a) | AI systems intended to be used for the ‘real-time’ and ‘post’ remote | Additionally or alternatively: code |
| | | biometric identification of natural persons; | “1000” if “0000” is used to indicate |
| | | | that no HRAI system/application is |
| | | | supported. |
| 2. | Management and operation of critical infrastructure: | | 0001 |
| | (a) | AI systems intended to be used as safety components in the | |
| | | management and operation of road traffic and the supply of water, | |
| | | gas, heating and electricity. | |
| AND/OR | | | |
| 2. | Critical infrastructure and protection of environment: | | |
| | (a) | AI systems intended to be used as safety components in the | |
| | | management and operation of road traffic and the supply of water, | |
| | | gas, heating and electricity. | |

| | |
|---|---|
| (aa) | AI systems intended to be used to control or as safety |
| | components of digital infrastructure; |

| | (b) | AI systems intended to be used to control emissions and pollution. | |
|---|---|---|---|
| 3. | Education and vocational training: | | 0010 |
| | (a) | AI systems intended to be used for the purpose of determining | Additionally or alternatively: |
| | | access or assigning natural persons to educational and vocational | 0010 − 01 if (a) is supported, |
| | | training institutions; | 0010 − 10 if (b) is supported, and |
| | (b) | AI systems intended to be used for: | 0010 − 11 if both (a) and (b) are |

| | | |
|---|---|---|
| (ba) | the purpose of assessing students in educational and | supported. |
| | vocational training institutions and for assessing participants in | |
| | tests commonly required for admission to educational | |
| | institutions, and/or | |
| (bb) | the purpose of assessing natural persons with the view to | |
| | evaluating learning outcomes or steering the learning process | |
| | in educational and vocational training institutions or | |
| | programmes at all levels. | |

| 4. | Employment, workers management and access to self-employment: | | 0011 |
|---|---|---|---|
| | (a) | AI systems intended to be used for recruitment or selection of | Additionally or alternatively: |
| | | natural persons, notably for advertising vacancies, screening or | 0011 − 01 if (a) is supported, |
| | | filtering applications, evaluating candidates, for example, in the | 0011 − 10 if (b) is supported, and |
| | | course of interviews or tests; | 0011 − 11 if both (a) and (b) are |
| | (b) | AI intended to be used for making decisions on promotion and | supported. |
| | | termination of work-related contractual relationships, for task | |
| | | allocation based on individual behavior or personal traits or | |
| | | characteristics and for monitoring and evaluating performance and | |
| | | behavior of persons in such relationships. | |
| 5. | Access to and enjoyment of essential or non-essential private services | | 0100 |
| | and public services and benefits: | | Additionally or alternatively: |
| | (a) | AI systems intended to be used by public authorities or on behalf of | 0100 − 001 if (a) is supported, |
| | | public authorities to evaluate the eligibility of natural persons for | 0100 − 010 if (b) is supported, |
| | | public assistance benefits and services, as well as to grant, reduce, | 0100 − 100 if (c) is supported; |
| | | revoke, or reclaim such benefits and services; | combinations of support of (a), (b), |
| | (b) | AI systems intended to be used to evaluate the creditworthiness of | and (c) are indicated by addition of |
| | | natural persons or establish their credit score, with the exception of | the respective last 3 digits (e.g., |
| | | AI systems put into service by small scale providers for their own | 0100 − [001 + 010 + 100] = 0100 − 111 if |
| | | use; | all (a), (b) and (c) are supported). |
| | (c) | AI systems intended to be used to dispatch, or to establish priority in | |
| | | the dispatching of emergency first response services, including by | |
| | | firefighters and medical aid; | |
| | (d) | AI systems intended to be used for insurance premium setting, | |
| | | underwritings and claims assessments. | |
| 6. | Law enforcement: | | 0101 |
| | (a) | AI systems intended to be used by law enforcement authorities or | Additionally or alternatively: |
| | | on their behalf for making individual risk assessments of natural | 0101-0000001 if (a) is supported, |
| | | persons in order to assess the risk of a natural person for offending | 0101-0000010 if (b) is supported, |
| | | or reoffending or the risk for a natural person to become a potential | 0101-0000100 if (c) is supported, |
| | | victim of criminal offences; | 0101-0001000 if (d) is supported, |
| | (b) | AI systems intended to be used by law enforcement authorities or | 0101-0010000 if (e) is supported, |
| | | on their behalf as polygraphs and similar tools or to detect the | 0101-0100000 if (f) is supported, |
| | | emotional state of a natural person; | 0101-1000000 if (g) is supported; |
| | (c) | AI systems intended to be used by law enforcement authorities or | combinations of support of (a), (b) |
| | | on their behalf and/or for law enforcement purposes to detect deep | and (c), (d), (e), (f), (g) are |
| | | fakes as referred to in article 52(3); | indicated by addition of the |
| | (d) | AI systems intended to be used by law enforcement authorities or | respective last 7 digits (e.g., 0101 − |
| | | on their behalf for evaluation of the reliability of evidence in the | [0000001 + 0000010 + |
| | | course of investigation or prosecution of criminal offences; | 0000100] = 0101 − 0000111 if (a), |
| | (e) | AI systems intended to be used by law enforcement authorities or | (b) and (c) are supported). |
| | | on their behalf for predicting the occurrence or reoccurrence of an | |
| | | actual or potential criminal offence based on profiling of natural | |
| | | persons as referred to in Article 3(4) of Directive (EU) 2016/680 or | |
| | | assessing personality traits and characteristics or past criminal | |
| | | behaviour of natural persons or groups; | |
| | (f) | AI systems intended to be used by law enforcement authorities for | |
| | | profiling of natural persons as referred to in Article 3(4) of Directive | |
| | | (EU) 2016/680 in the course of detection, investigation or | |
| | | prosecution of criminal offences; | |
| | (g) | AI systems intended to be used for crime analytics regarding natural | |
| | | persons, allowing law enforcement authorities to search complex | |
| | | related and unrelated large data sets available in different data | |
| | | sources or in different data formats in order to identify unknown | |
| | | patterns or discover hidden relationships in the data. | |
| 7. | Migration, asylum and border control management: | | 0110 |
| | (a) | AI systems intended to be used by competent public authorities or | Additionally or alternatively: |
| | | on their behalf as polygraphs and similar tools or to detect the | 0110-0001 if (a) is supported, |
| | | emotional state of a natural person; | 0110-0010 if (b) is supported, |
| | (b) | AI systems intended to be used by competent public authorities or | 0110-0100 if (c) is supported, |
| | | on their behalf to assess a risk, including a security risk, a risk of | 0110-1000 if (d) is supported,; |
| | | irregular immigration, or a health risk, posed by a natural person | combinations of support of (a), (b) |
| | | who intends to enter or has entered into the territory of a Member | and (c), (d) are indicated by |
| | | State; | addition of the respective last 4 |
| | (c) | AI systems intended to be used by competent public authorities or | digits (e.g., 0110 − [0001 + 0010 + |
| | | on their behalf for the verification of the authenticity of travel | 0100] = 0110 − 0111 if (a), (b) and |
| | | documents and supporting documentation of natural persons and | (c) are supported). |
| | | detect non-authentic documents by checking their security features; | |
| | (d) | AI systems intended to assist or otherwise used by competent | |
| | | public authorities or on their behalf for the examination of | |
| | | applications for asylum, visa and residence permits and associated | |
| | | complaints with regard to the eligibility of the natural persons | |
| | | applying for a status. | |
| 8. | Administration of justice and democratic processes: | | 0111 |
| | (a) | AI systems intended to assist or otherwise used by a judicial | |
| | | authority or on their behalf in researching and interpreting facts and | |
| | | the law and in applying the law to a concrete set of facts. | |

| For future usage and/or reserved | 1000, 1001, 1010, 1011, 1100, |
|---|---|
| | 1101, 1110, 1111 |

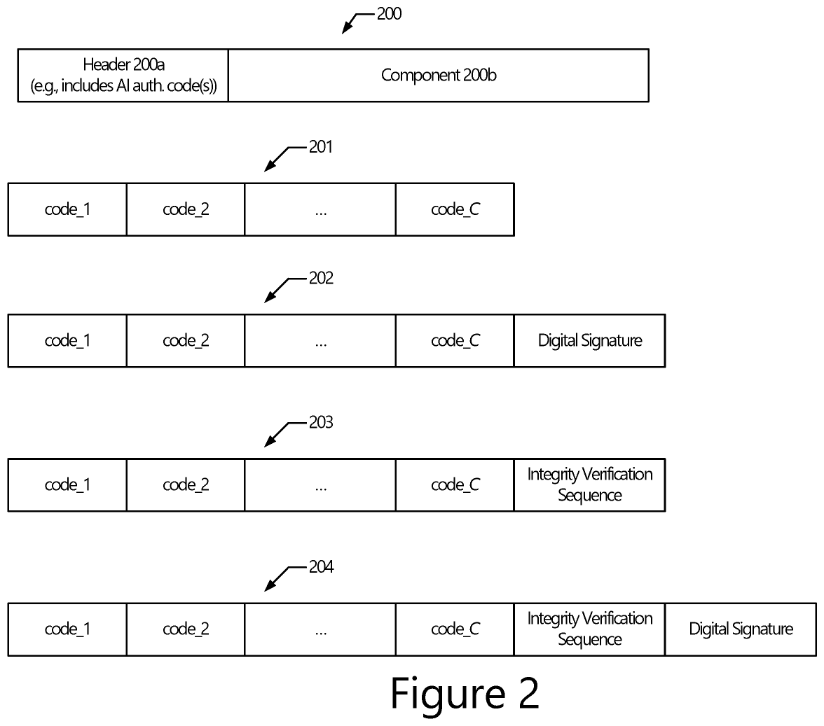

The codes included in Table 1.2-1 are example AI authorization codes, and other permutations of the AI authorization code allocation may be applied (e.g., instead of applying the code “0001” to item 2 of the High Risk AI applications, code “0001” may be applied to some other HRAI system/application category listed in Table 1.2-1). Other codes (e.g., binary and/or non-binary codes) may be used as the AI authorization codes. Furthermore, the codes may be combined with certain security mechanisms. For example, a code may be combined with a digital signature indicating that the code allocation and/or provisioning was authorized by an entity that has the power to do so (e.g., the original manufacturer of the equipment). Additionally or alternatively, a code may be combined with a hash or other sequence that is used to verify the integrity of the code, for example, to verify that the original code is available and no (potentially malicious) modification of the AI authorization code, or the data packet(s) in which it was carried, was performed. Examples of data packet formats that can be used to deliver the codes to convey are shown by FIG. 2.

Additionally or alternatively, the AI authorization codes can include a cryptographically protected authorization statement, a cryptographic signature, a digital signature, a cryptographically protected list of components that are authorized to be used/operated by a specified users or organizations, a cryptographically protected list of applications that are authorized to be used/operated by a specified users or organizations, and/or the like. These implementations can include using any suitable cryptographic mechanisms such as any of those discussed herein.

In some examples, the AI authorization codes may additionally or alternatively be referred to as “AI provisioning codes”, “AI machine codes”, “AI modeling codes”, “AI access codes”, “dataset authorization codes”, “AI authentication codes”, “AI permissions”, “AI markings”, “AI authorization mechanisms”, “AI tokens”, “AI access tokens”, “AI keys”, “AI signatures”, “AI certificates”, “certificate” (or any of the aforementioned terms) for usage of the AI system and/or (sub-)components of the AI system”, “certificate for usage of an AI system and/or (sub-) components of the AI system”, “certificate for usage of an AI system and/or (sub-)components of the AI system for X specific application” where X is an HRAI category such as those specified in Table 1.1-3, and/or the like. In some implementations, the AI provisioning codes assigned to, or otherwise associated with an AI system can be provided and/or assigned to a user of the AI system. In some examples, the AI provisioning codes can be assigned to a user who is a specialist who has conducted related training and has demonstrated to be capable of operating the AI system or (sub-) components of the AI system as according to the legal requirements such as those specified by the [AIA]. Additionally or alternatively, the AI provisioning codes can be assigned for usage at specified or assigned geographic locations or regions, specified or assigned jurisdictions, during a specified or assigned periods of time, for specified or assigned organizations, for specified or assigned computing systems devices, or platforms, and/or according to other specified or assigned classifications or categories.

There may be multiple “AI provisioning codes” provided for different (sub-)components of the AI System, for different users/operators/organizations/etc. Those “AI provisioning codes” can be combined as appropriate in order to activate all (sub-)components of the AI system corresponding to the available codes.

FIG. 2 shows various example data packet formats for conveying or otherwise communicating HRAI authorization codes. The HRAI categories of Table 1.2-1 are based on the HRAI systems listed in Article 6(2) and Annex III of the [AIA], and the encoding of the corresponding categories are used to indicate the HRAI categories of individual HW/SW components and/or systems. FIG. 2 shows an example data packet 200, which can be used to convey the AI authorization code for usage of a component for HRAI systems/applications in general and/or a subset of HRAI systems/applications. In this example, the AI authorization code is included in the header section 200a of the data packet 200, and the HW/SW component is indicated in a data section 200b of the data packet 200. The components use the same codes as indicated by Table 1.2-1.

Additionally or alternatively, a code may be allocated to a group of HRAI applications/systems. In a first option, the packet 201 includes 1 through C codes (where C is a number) applicable to the concerned equipment (e.g., a first code (code_1), a second code (code_2), . . . , a C-th code (code_C)). In a second option, the packet 202 includes the 1 through C codes (in a same or similar manner as packet 201) and a digital signature authorizing the 1-C codes. In a third option, the packet 203 includes the 1 through C codes (in a same or similar manner as packet 201) and an integrity verification sequence such as a hash or some other suitable sequence used to verify the integrity of the code sequences 1-C. In a fourth option, the packet 204 includes the 1 through C codes (in a same or similar manner as packet 201), an integrity verification sequence such as a hash or some other suitable sequence used to verify the integrity of the code sequences 1-C (in a same or similar manner as packet 203), and a digital signature authorizing the 1-C codes (in a same or similar manner as packet 202).

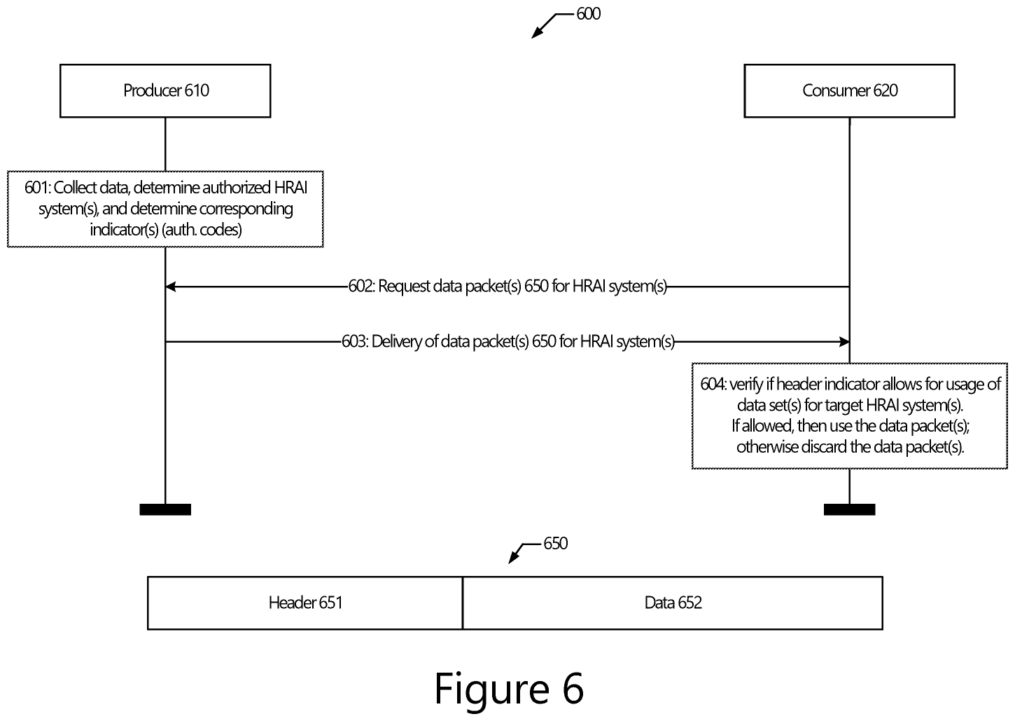

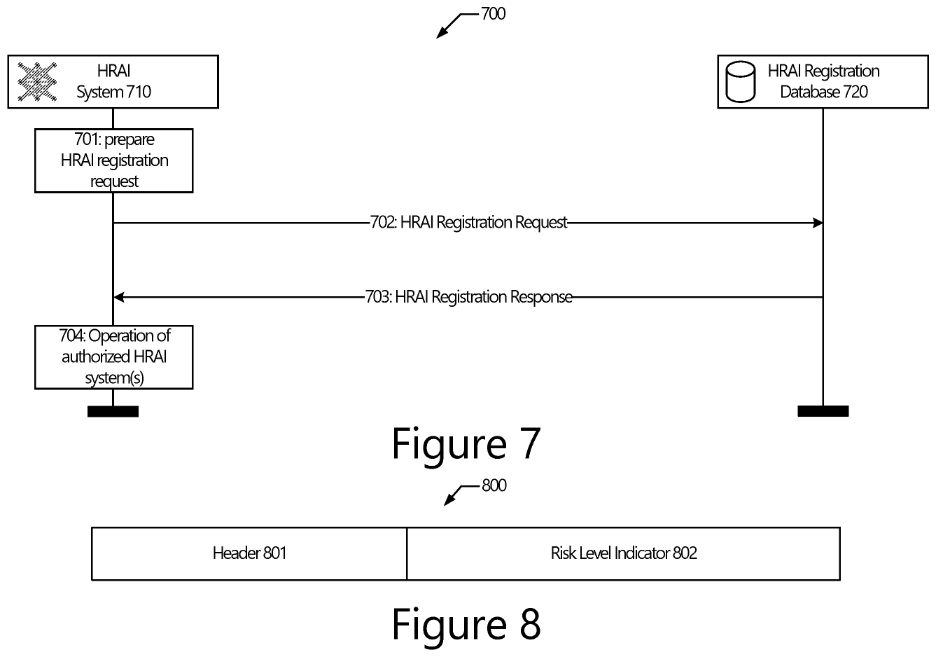

In the examples of FIG. 2, any number of codes may be included (e.g., a single code, two codes, three codes, etc.) taken from the list in Table 1.2-1 indicating the suitability of the concerned equipment or components to be used for the HRAI applications/systems corresponding to the respective codes. Additionally or alternatively, a data field (DF) or data element (DE) may be added to the packets 201-204 in FIG. 2, which includes information on the overall packet structure (e.g., number of codes included, information on whether a single signature or multiple signatures are included, whether a single hash or multiple hashes are included, etc.) Indeed, there may be a single signature and/or single hash for each of the codes. Additionally or alternatively, there may be signatures and/or hashes for a group of AI authorization codes and/or all AI authorization codes 1-C in the packet. Additionally or alternatively, the packets 201-204 may be included in the header portion of a suitable data packet (e.g., the header section 200a of data packet 200 of FIG. 2, the header section 651 of data packet 650 of FIG. 6, and/or the header section 751 of data packet 750 of FIG. 7) or the data section of the data packet (e.g., the data section 200b of data packet 200 of FIG. 1, the data section 652 of data packet 650 of FIG. 6, and/or the data section 752 of data packet 750 of FIG. 7). The DFs/DEs in the packets of FIG. 2 may be rearranged in any suitable order. Also, they may be hard-coded in the target equipment and/or updated as needed (e.g., through firmware updates) and/or dynamically modified depending on the specific usage conditions (e.g., type of client, type of usage environment (e.g., airport, private usage, usage in a professional environment such as for industrial automation, etc.)

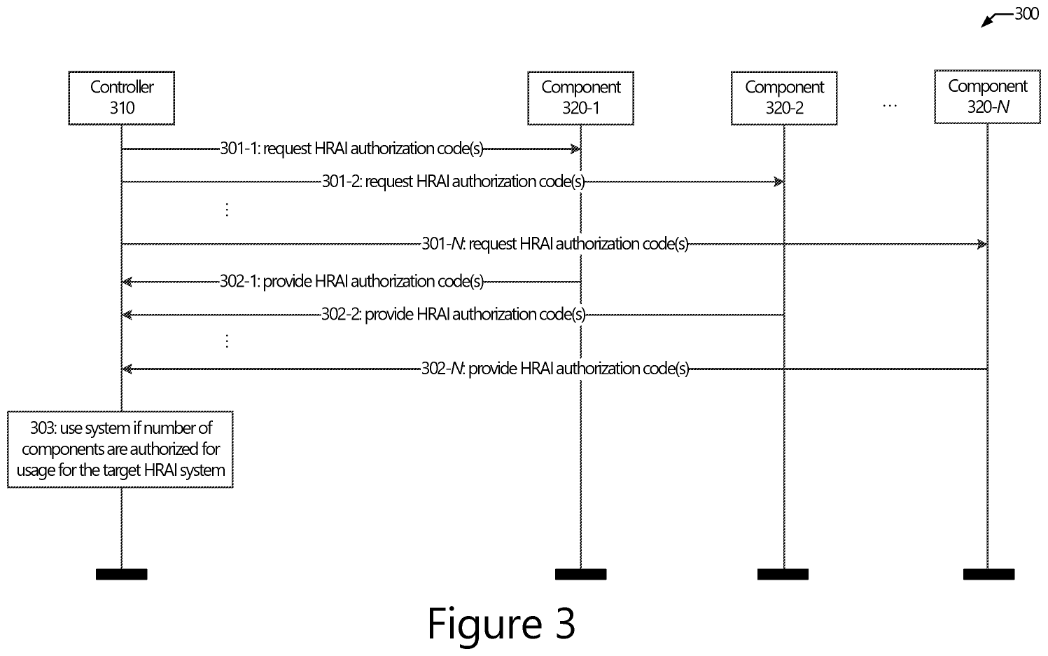

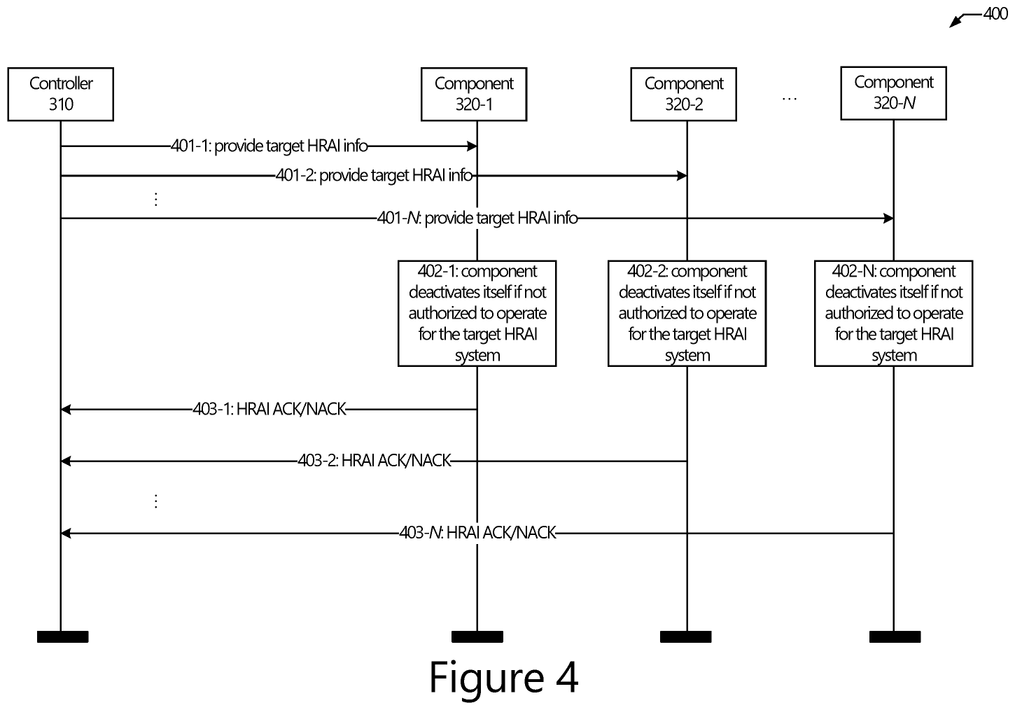

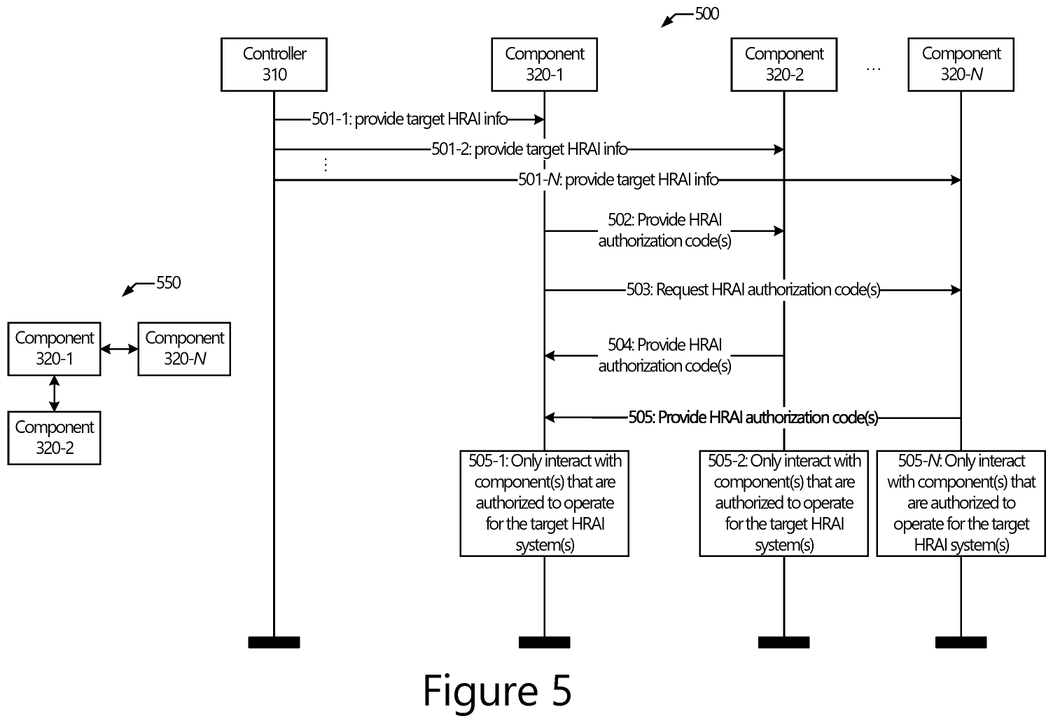

When HW/SW components are assembled into a system, the system and/or individual components are verified as being authorized for usage for or by an HRAI system. For this verification, centralized and distributed systems are provided. Examples of the centralized approach is shown by FIGS. 3 and 4, and an example of the distributed approach is shown by FIG. 5.

FIG. 3 shows a procedure 300 for verification of HRAI authorization a set of components. In this example, the set of components includes components 320-1 to 320-N (where N is a number), and may be collectively referred to as “components 320” or “component 320”. Here, a controller 310 sends respective requests 301-1, 301-2, . . . 301-N to corresponding components 320 to provide its HRAI authorization codes to the central controller 310. Each component 320 may be the same or similar to component 120 of FIG. 1. Individual components 320 provide respective responses 302-1, 302-2, . . . 302-N to the controller 310 including their respective HRAI authorization codes. At operation 303, the controller 310 uses the target (HR)AI system only if some or all of the components 320 are authorized to operate (or be operated by) the controller 310, then the system (including the set of components 320) is authorized for usage. In some implementations, all components 320 are required to be authorized in order for the target (HR)AI system to be used or operated, while in other implementations, a predetermined number of components 320 (or threshold number of components 320) are required to be authorized in order for the target (HR)AI system to be used for or operated. Additionally or alternatively, the controller 310 may build or otherwise determine a higher-level AI authorization code from a combination of the AI authorization codes of each components 320, and this higher-level AI authorization code may be used to determine whether the target (HR)AI system is authorized for a particular application, use case, domain, task, and/or objective. Any suitable function, algorithm, or set of operations can be used to fuse, merge, or otherwise combine the individual authorization codes to calculate or determine the higher-level AI authorization code. As examples, the individual authorization codes can be combined or otherwise used to obtain the higher-level AI authorization code using one or more of a set of binary mathematical operations, a set of bitwise operations, a cryptographic mechanism (e.g., a hash function or the like), concatenating or combining the individual authorization codes together according a predefined or configured policy or ruleset, and/or other operations/mechanisms.

In one example, authorization of the operation of an AI system and/or individual components of an AI system can be take place as follows: In the initial state, the AI system/components are not authorized to be operated and deactivated or in an inactive/deactivated state. An appropriate AI provisioning code is provided to a system (e.g., controller 310) and/or other compute node/device such as any of those discussed herein), which can be applicable to a specific trained specialist user; a group of users; some or all agents, employees, or other individuals authorized by a subscriber or service provider that has access to the AI system/components; and/or all users/individual in possession of the AI provisioning code. The AI system/components validate, verify, and/or authenticate the AI provisioning codes provided by individual users, groups, and/or other operators of the AI system/components. In some implementations, the authorization of usage for the AI system/components may be given for any application, service, platform, enterprise, and/or other entity (including authorization for specified HRAI applications and other applications); for a specific application, service, platform, enterprise, or other entity; and/or for a group of applications, services, platforms, enterprises, and/or other entities. After the AI codes are validated, verified, and/or authenticated, the AI system/components are then activated according to the provided AI provisioning codes. When activated, the AI system/components are usable by the authorized users according to permissions, rules, policies, and/or other parameters associated with the AI provisioning codes. If appropriate, the AI provisioning codes can be set to expire after a predefined or configurable period of time, which causes the AI system/components to be interrupted, terminated, paused, stopped, and/or put into stand-by, and then renewed AI provisioning codes can be obtained and provided to the AI system/components to (re)active the AI system/components.

FIG. 4 shows a procedure 400 for components 320 to de-activate themselves if not authorized to operate target HRAI system(s). In procedure 400, the central controller 310 is informs the components 320 about the target HRAI system(s) by sending, at operations 401-1 to 401-N, target HRAI information to each of the components 320. At operations 402-1 to 402-N, individual components 320 determine whether they are authorized to operate the target HRAI system(s) and deactivate themselves if/when they are not authorized to operate for the target HRAI system(s). At operations 403-1 to 403-N individual components 320 send respective acknowledgement messages (ACK) or non-acknowledgement messages (NACK) to the controller 310. An ACK is used to indicate that the corresponding component 320 is authorized to use (or be used by) the target HRAI system(s), and the NACK is used to indicate that the corresponding component 320 is not authorized to use (or be used by) the target HRAI system(s). In other implementation, operations 403-1 to 403-N are omitted, and procedure 400 ends after operations 402-1 to 402-N.

FIG. 5 shows an example procedure 500 of a distributed approach wherein individual components 320 verify whether their peer components 320 are authorized to operate target HRAI system(s), and also shows an example system/relationship 550 between the components 320 in the example of FIG. 5. In the distributed procedure 500, each component 320 interacts with other components 320 it is directly or indirectly connected to (e.g., for data exchange, processing, and/or the like) as indicated by the example system/relationship 550 between the components 320, and requests the respective HRAI authorization codes from the other components 320. First, the controller 310 informs the components 320 about target HRAI system(s) by sending, at operations 501-1 to 501-N, target HRAI information to each of the components 320 in a same or similar manner as operations 401-1 to 401-N. In this example, the information on the target HRAI system(s) is provided by the controller 310 to all of the components 320 (e.g., at operations 501-1 to 501-N). In other implementations, the HRAI information is provided to a set of components 320 (e.g., one or more components 320), and the components 320 in the set of components 320 feed the HRAI information to other components 320 that they are connected to. In this way, the information is propagated component-by-component through the system.

At operation 502, the component 320-1 provides its HRAI authorization code(s) for the target HRAI system(s) to the component 320-2. At operation 503, the component 320-1 requests the HRAI authorization code(s) of component 320-2 for the target HRAI system(s), and at operation 504 receives the component's 320-2 HRAI authorization code(s) for the target HRAI system(s) from the component 320-2. Additionally, at operation 505 the component 320-N provides its HRAI authorization code(s) for the target HRAI system(s) to the component 320-1. At operations 506-1 to 506-N, individual components 320 determine whether they are authorized to operate the target HRAI system(s) and/or whether they are authorized to interact with other components 320, and only interact with the authorized components 320. In some implementations, the components 320 that do not have the authorization code(s) for the target HRAI system(s) are taken out of future operation.

### 1.3. Marking and Using (Training and Inference) Data for HRAI and Non-HRAI Systems

This section considers the creation of datasets and the usage of datasets for HRAI systems/applications. The creator of a dataset (e.g., a sensor, data producer, etc.) assigns an indicator to each new dataset that is intended to be used in the context of HRAI systems/applications. These dataset may be used as, for example, as training data, validation data, testing data, input data, and/or inference data.

The assigned indicator authorizes the usage of the dataset for any type of HRAI systems/applications as defined by Table 1.2-1 or ii) authorizes the usage of the dataset for a sub-set of the HRAI systems as defined by Table 1.2-1 by indicating the relevant authorization codes as defined by Table 1.2-1. The choice of the correct indicator may be determined by the operator of the AI system, the manufacturer of the AI system, and/or by the creator of data (dataset) itself by considering context information of an AI system (e.g., location, type of data, collection processes, collection devices. AI/ML domain. AI/ML tasks. AI/Ml objectives. HW and/or SW platforms, and/or other like information/data). An example data packet 650 including the indicator (e.g., in header 651) and the data itself (e.g., in data section 652) is shown by FIG. 6. The data section 652 can include a relevant dataset or data that is part of a dataset to be used for one or more AI systems.

FIG. 6 shows an example procedure 600 for creation and consumption of data packets for HRAI system(s). Procedure 600 is performed between a producer 610 and a consumer 620. The producer 610 is the creator and/or source of data and/or data packets, or otherwise provides one or more services. As examples, the producer 610 can be or include one or more sensors (e.g., generating and providing sensor data), a network access node (NAN), a network function (NF), server, cloud computing service, an edge compute node or edge network, a user/client device, a robot or drone, a component 320, an application, and/or any other data source. The consumer 620) is an entity that uses a dataset as training data to train the HRAI systems/applications, as validation data to validate the HRAI systems/applications, as testing data to test the HRAI systems/applications, and/or as input data and/or inference data to be produced by the HRAI systems/applications to produce inferences/predictions or otherwise generate outputs. As examples, the consumer 620 can be or include an inference engine, an AI agent, a predictor, an NN, one or more NN layers, a non-Real Time (RT) RAN Intelligent Controller (RIC) such as those discussed in [O-RAN], a near-RT RIC such as those discussed in [O-RAN], and/or any other system, device, or component such as any of those discussed herein, including the examples of the producer 610.

Procedure 600 begins with operation 601, where the producer 610) collects data from one or more data sources, determines or identifies authorized HRAI system(s), if any, and determines corresponding indicators (e.g., HRAI authorization codes) of the determined/identified authorized HRAI system(s). At operation 602, the consumer 620) requests data packet(s) 650 for dataset(s) for target HRAI system(s). At operation 603, the producer 610 delivers the data packet(s) 650 for the target HRAI system(s) to the consumer 620. At operation 601 and/or 603, the producer 610 adds the indicators (e.g., HRAI authorization codes) in the header 651, and includes the data or datasets in the data section 652. At operation 604, the consumer 620 verifies if the indicator (e.g., included in header 651) allows for usage of the dataset (e.g., included in or indicated by the data section 652) for target HRAI system(s). If allowed, then the consumer 620 uses the data packet(s); otherwise, the consumer 620 discards the data packet(s).

In some implementations, the consumer 620 first verifies whether the dataset is authorized to be used for any type of HRAI system(s) as defined by Table 1.2-1 and/or is authorized to be used for a subset of the HRAI system(s) as defined by Table 1.2-1 using the relevant authorization codes as defined by Table 1.2-1 (e.g., included in header 651). If the indicator of the dataset authorizes the usage of the data (e.g., included in or indicated by the data section 652) for the target HRAI system, then the data packet will actually be used. Otherwise, the data packet(s) 650 will be discarded.

### 1.4. Automated Registration Obligations as Referred to in Article 51 of the Regulation

[AIA] Articles 51 and 61, and Annex VIII, shown by Table 1.4-1, Table 1.4-2, and Table 1.4-3, are concerned with registration aspects.

TABLE 1.4-1
Article 51
Registration

Before placing on the market or putting into service a high-risk
AI system referred to in Article 6(2), the provider or, where
applicable, the authorised representative shall register that
system in the EU database referred to in Article 60.

TABLE 1.4-2
Article 60
EU database for stand-alone high-risk AI systems

| | |
|---|---|
| 1. | The Commission shall, in collaboration with the Member States, |
| | set up and maintaina EU database containing information referred |
| | to in paragraph 2 concerning high-risk AI systems referred to in |
| | Article 6(2) which are registered in accordance with Article 51. |
| 2. | The data listed in Annex VIII shall be entered into the EU database |
| | by the providers. The Commission shall provide them with technical |
| | and administrative support. |
| 3. | Information contained in the EU database shall be accessible to the |
| | public. |
| 4. | The EU database shall contain personal data only insofar as |
| | necessary for collecting and processing information in accordance |
| | with this Regulation. That information shall include the names and |
| | contact details of natural persons who are responsible for registering |
| | the system and have the legal authority to represent the provider. |
| 5. | The Commission shall be the controller of the EU database. It shall |
| | also ensure to providers adequate technical and administrative |
| | support. |

TABLE 1.4-3
ANNEX VIII
INFORMATION TO BE SUBMITTED UPON THE REGISTRATION OF
HIGH-RISK AI SYSTEMS IN ACCORDANCE WITH ARTICLE 51

The following information shall be provided and thereafter kept up to date with
regard to high-risk AI systems to be registered in accordance with Article 51.

| | |
|---|---|
| 1. | Name, address and contact details of the provider; |
| 2. | Where submission of information is carried out by another person on behalf of the |
| | provider, the name, address and contact details of that person; |
| 3. | Name, address and contact details of the authorised representative, where |
| | applicable; |
| 4. | AI system trade name and any additional unambiguous reference allowing |
| | identification and traceability of the AI system; |
| 5. | Description of the intended purpose of the AI system; |
| | 6.Status of the AI system (on the market, or in service; no longer placed on the |
| | market/in service, recalled); |
| 7. | Type, number and expiry date of the certificate issued by the notified body and |
| | the name or identification number of that notified body, when applicable; |
| 8. | A scanned copy of the certificate referred to in point 7, when applicable; |
| 9. | Member States in which the AI system is or has been placed on the market, put into |
| | service or made available in the Union; |
| 10. | A copy of the EU declaration of conformity referred to in Article 48; |
| 11. | Electronic instructions for use; this information shall not be provided for high- |
| | risk AI systems in the areas of law enforcement and migration, asylum and border |
| | control management referred to in Annex III, points 1, 6 and 7. |
| 12. | URL for additional information (optional). |

Following the rule set cited in Table 1.4-1, Table 1.4-2, and Table 1.4-3, an example procedure shown by FIG. 7 can be performed prior to the operation of a HRAI system.

FIG. 7 depicts an example procedure 700 for registration of HRAI system(s) (e.g., HRAI system 710) to/with an HRAI registration database (DB) 720. In various implementations, the HRAI registration DB 720 acts as the “EU database” mentioned in [AIA] Articles 51 and 61, and Annex VIII (see e.g., Table 1.4-1, Table 1.4-2, and Table 1.4-3 supra). Procedure 700 begins with operation 701 where the HRAI system 710 (or any equipment and/or component of an HRAI system such as, for example, ego component 120 and/or a component 320) prepares a registration request for registering with the HRAI registration DB 720. In operation 701, data packet(s) for the registration request can be prepared according to Annex VIII shown by Table 1.4-3 and can include some or all of the information of Table 1.4-4.

TABLE 1.4-4

| Data Item/Element | Description |
|---|---|
| 0 | an identifier and/or a request to the HRAI registration DB 720 to provide an identifier of the |
| | considered HRAI system |
| 1 | name, address and contact details of the provider |
| 2 | where submission of information is carried out by another person on behalf of the provider, |
| | the name, address and contact details of that person |
| 3 | name, address and contact details of the authorised representative, where applicable |
| 4 | AI system trade name and any additional unambiguous reference allowing identification |
| | and traceability of the AI system |
| 5 | description of the intended purpose of the AI system |
| 6 | status of the AI system (on the market, or in service; no longer placed on the market/in |
| | service, recalled) |
| 7 | type, number and expiry date of the certificate issued by the notified body and the name or |
| | identification number of that notified body, when applicable |
| 8 | a scanned copy of the certificate referred to in data item/element (7), when applicable |
| 9 | member states or jurisdictions in which the AI system is or has been placed on the market, |
| | put into service, or otherwise made available |
| 10 | a copy of the EU declaration of conformity referred to in Article 48 |
| 11 | electronic instructions for use; this information shall not be provided for HRAI systems in |
| | the areas of law enforcement and migration, asylum and border control management |
| | referred to in Annex III, in data items/elements 1, 6, and 7 |
| 12 | URL and/or other reference for additional information |

In data item/element (5) of Table 1.4-4, the description of the intended purpose of the AI system can include, for example, an indication that the AI system is approved to operate any (all) high-risk applications, systems, and/or services, or a list of approved high-risk applications, systems, and/or services using, for example, the authorization codes of Table 1.2-1. In some implementations, the registration request can include a request for HRAI authorization code(s) (see e.g., Table 1.2-1) that will allow other HRAI system(s) and/or other systems, applications, and/or services to use the or otherwise integrate with the ego HRAI system 710. Additionally or alternatively, the registration request can include a request for HRAI authorization code(s) (see e.g., Table 1.2-1) that will allow the ego HRAI system 710 to operate or otherwise integrate with other HRAI system(s) and/or other systems, applications, and/or services. At operation 702, the HRAI system 710 sends the data packet(s) constructed in operation 701 to the HRAI registration DB 720 including the request for registration.

At operation 703, the HRAI registration DB 720 sends a registration response to the HRAI system 710 to authorize/decline operation of the HRAI system 710. In some implementations, the registration response is used to provision identifier(s) and/or authorization codes (see e.g., Table 1.2-1) to be used by the ego HRAI system 710, if it was requested by the concerned HRAI system. Additionally or alternatively, the registration response can include an ACK/NACK or other indicator to indicate that the HRAI system 710 is authorized (or not authorized) to be use one or more other HRAI systems (or be operated by one or more indicated systems, applications, and/or services). In some implementations, the ACK/NACK may be given for individual HRAI system(s), for example, where some of the indicated HRAI system(s) (e.g., HRAIs indicated by Table 1.2-1) may be authorized (ACK) and other HRAI system(s) may not be authorized (NACK).

At operation 704, in case that an ACK is received from the HRAI registration DB 720 at operation 703 for specific HRAI system(s) (or other systems, applications, and/or services), the HRAI system 710 can start operating those HRAI system(s) (or other systems, applications, and/or services) for which an authorization (e.g., ACK) was received. In some implementations, the HRAI system 710 does not operate the HRAI system(s) (or other systems, applications, and/or services) for which no ACK was received.

1.5. Management and Detection of Errors, Faults, and/or Inconsistencies that May Occur within the System or the Environment in which the System Operates, in Particular Due to their Interaction with Natural Persons or Other Systems

Mechanisms are provided to detect and manage errors, faults, and/or inconsistencies that may occur within the system and/or the environment in which the system operates, in particular due to their interaction with natural persons and/or other systems. These management and detection mechanisms are based on events (e.g., unexpected events or the like) that are linked to specific “event codes”, where each event code corresponds to a level of “severeness” of an event.

In various implementations, one or more event codes correspond to low-risk or minor-risk events. For event codes that correspond to low-risk or minor-risk events, the system provides information to the AI system operator/administrator, but the system may continue operating.

Additionally or alternatively, one or more event codes correspond to medium-risk events. For event codes that correspond to medium-risk events, the AI system operator/administrator is alerted and requested to explicitly authorize the continuation of the operation. A medium-risk event may be an event where some leakage of user related data could have occurred, an event where some risk of erroneous/false assessment is provided by the AI system, and/or the like. In these examples, the AI system can continue operating if the AI system operator/administrator authorizes the ongoing operation. Otherwise, the AI system will pause/stop its operations. The pausing/stopping of the operation is either executed immediately after the detection of the medium-risk event or after a predetermined or configurable time period (e.g., a number seconds, minutes, hours, and/or the like) during which the AI system operator/administrator is able to assess the risk and to decide whether it is appropriate to pause/stop the operations of the AI system or whether the operation can continue despite of the medium-risk event. Additionally or alternatively, the AI system is paused/stopped automatically only if a predefined or configured number of medium-risk events are observed. If such a number of medium-risk events are observed, then the AI system can only continue operating if the AI system operator/administrator authorizes the ongoing operation. Otherwise, the AI system will pause/stop its operations. This may be combined with the option to delay the pausing/stopping for a given time period to allow the AI System operator to assess the situation and to decide whether pausing/stopping the AI system is appropriate.

Additionally or alternatively, one or more event codes correspond to high-risk events. For event codes that correspond to high-risk events. AI System is automatically stopped. In order to have it continue its operation, the AI System operator/administrator must be specifically authorize the continuation of the operation of the AI system. High-risk events can include, for example, a leakage or data breach of personal data, sensitive data, and/or confidential data, a substantial risk of erroneous and/or false assessment being provided by the AI system implying possibly serious consequences for the involved users, and/or the like.

Example components of an AI system (e.g., ego component 120, components 320, and/or the like) include processing elements (e.g., CPUs, GPUs, XPUs, FPGAs, multiply-and-accumulate units (MAC), probabilistic bit devices (p-bits), and/or other processing elements such as any of those discussed herein; see e.g., discussion of processor circuitry 3552 and/or acceleration circuitry 3564 of FIG. 35 infra), memory devices (see e.g., discussion of memory circuitry 3554 of FIG. 35 infra), storage devices (e.g., hard disc drives, solid-state drives, and/or the like; see e.g., discussion of storage circuitry 3558 of FIG. 35 infra), communication modules (e.g., RLAN and/or WiFi station circuitry, cellular communication circuitry, and/or the like) and/or related RF components (see e.g., discussion of communication circuitry 3566 of FIG. 35 infra), and/or user interface elements (e.g., physical buttons, light emitting elements, touch interface(s), display elements to show results provided by the AI system, and/or the like; see e.g., discussion of input circuitry 3586 and output circuitry 3584 of FIG. 35 infra). Additionally or alternatively, the AI system could include one or more quantum computing elements and/or quantum circuits.

In various implementations, the various components (e.g., ego component 120, components 320, and/or the like) need to be authorized for usage in a target AI system. In some implementations, the authorization is provided individually and/or separately for each component. Additionally or alternatively, the authorization is provided for the set of components that can be combined to form the target AI system and/or for subsets of components making up a target AI system. In any of the aforementioned implementations, the authorization is performed as explained previously and using the HRAI authorization codes discussed previously (see e.g., Table 1.2-1 supra).

### 1.6. Automated Recording of Events (‘Logs’) During HRAI System Operation

In some implementations, events are classified based on the categorization discussed previously in section 1.5, including low-risk/minor-risk events, medium-risk events, and high-risk events. Additionally or alternatively, a new category “no risk” event may be added. Additionally or alternatively, a differentiation on a finer level is possible (e.g., “risk-level 0”, “risk-level 1”, “risk-level 2”, . . . “risk-level X” where X is a number). In various implementations, each event is recorded in a data packet 800 shown by FIG. 8.

FIG. 8 depicts an example data packet 800 for recording AI system-related events. In this example, the data packet 800 includes a header 801 and a risk level indicator 802 (also referred to as “HRAI indicator 802” or the like). The header 801 includes information such as AI system identity (ID), operated HRAI service/category (e.g., as defined in Table 1.2-1), date/time, and/or any other circumstantial information. The header 801 can include respective data elements and/or data fields for each of the aforementioned types of information. The risk level indicator 802 provides an indication of the risk level of the event, and includes, for example, no risk, low-risk events, minor-risk events, medium-risk events, high-risk events, and/or similar. Various codes (e.g., numerical values, characters, and/or the like) can be used to indicate respective event risk levels.

Any additional or alternative data related to the event may be added to the data packet 800 (e.g., error logs, screenshots, inputs/outputs on interfaces, logs on actions by the AI system operator/administrator and/or user, error and/or failure indicators/reasons, and/or other like information). Access to the recording information can be granted to authorized personnel such as, for example, an AI system administrator or the like.

### 2. Aspects Related to AI Regulation, Articles 9 to 18

### 2.1. AI System Entities and Components

According to the [AIA], an artificial intelligence (AI) system refers to software and/or a machine-based system that is developed with one or more of AI/machine learning (ML) techniques and approaches list in Annex I of the [AIA], and can, for a given set of human-defined objectives, generate outputs such as content, predictions, inferences, recommendations, and/or decisions influencing the environments with which they interact. The AI/ML techniques and approaches include ML approaches such as supervised, unsupervised, and reinforcement learning, using a wide variety of methods including deep learning; logic-based and knowledge-based approaches, including knowledge representation, inductive (logic) programming, knowledge bases, inference and deductive engines, (symbolic) reasoning and expert systems; and statistical approaches, Bayesian estimation, search and optimization methods. Other AI/ML techniques/approaches may be included, such as those discussed herein.

The entities in an AI system are based on the definition of HRAI systems in [AIA] Article 6 and Annex III, which are shown by Table 1.1-2 and Table 1.1-3 supra. The [AIA] provides specific rules for AI systems that create a high risk to the health and safety or fundamental rights of natural persons. In line with a risk-based approach, those HRAI systems are permitted on the European market subject to compliance with certain mandatory requirements and an ex-ante conformity assessment. The classification of an AI system as an HRAI system is based on the intended purpose of the AI system, in line with existing product safety legislation. Therefore, the classification as high-risk does not only depend on the function performed by the AI system, but also on the specific purpose and modalities for which that system is used. In embodiments, AI systems can include closed AI systems and AI systems interacting with external (independent) entities/components.

### 2.2. Closed AI Systems

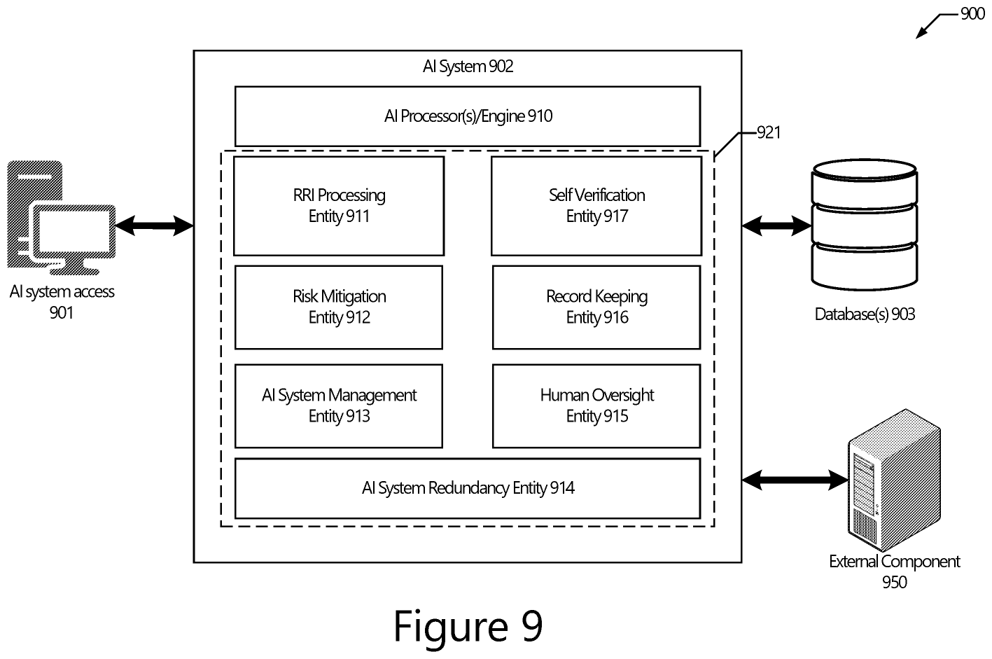

FIG. 9) depicts an example AI system architecture 900 including components of an AI system 902, which may be a close AI system or an open AI system. A closed AI system 902 is an AI system having no dependency on external and/or 3rd party components (e.g., external component 950). An open AI system 902 is one in which external and/or 3rd party components (e.g., external component 950) are at least partially relied upon by the AI system 902. Entities such as the one or more databases (DB) 903 are considered to be under control of the AI system 902 and/or the owner or operator of the AI system 902, and are not considered to be external/3rd party components, at least for purposes of the present disclosure. The usage of the AI system 902 can be applied to any of the HRAI systems defined in [AIA]. Annex III (see e.g., Table 1.1-3).

The AI system architecture 900 includes AI system access 901, which is used by a user to access the AI system 902 to use AI services, to perform human oversight (verify correct operation of the system, and the like), and the like. The AI system access 901 allows the AI system 902 to obtain input data from an authorized user. In some examples, a user can be authorized or authenticated using known techniques such as by using, for example, knowledge factors (e.g., the user knows and provides login credentials, full or partial password or passphrase, personal identification number (PIN), challenge-response or knowledge-based questions, and/or the like), ownership factors (e.g., the user has possession of HW and/or SW security tokens, credential documents such as an ID card, and/or the like), inherence factors (e.g., using the user's biometric data or biometric identifiers, signature, and/or the like), some or all of which may be used with existing single-factor or multi-factor authentication techniques. Examples of the authentication and/or authorization techniques include using API keys, basic access authentication (“Basic Auth”), Open Authorization (OAuth), hash-based message authentication codes (HMAC), Kerberos protocol, OpenID, WebID, and/or other authentication and/or authorization techniques. Additionally or alternatively, an authorized user can be assigned or otherwise associated with varying levels of permissions or authorizations to use specific types or categories of AI systems where, for example, the user may be permitted to use and/or approve usage of an AI system 902 assigned to a specific HRAI category such as those as shown by Table 1.2-1. For example, a user can have authorizations or permissions to use and/or approve usage of AI systems with HRAI categories 3-5 in Table 1.2-1, but not permitted to use or approve AI systems with HRAI categories 1-2 and 6-8 as shown by Table 1.2-1. In some implementations, the user authorizations/permission may be the same or similar to the authorization levels in Table 2.4-1 (supra). The AI system access 901 may include the use of various APIs, firmware, drivers, software glue, and/or any other communication means for conveying data between the various entities shown by FIG. 9. For purposes of the present disclosure. “input data” is data provided to or directly acquired by an AI system (e.g., AI system 902) on the basis of which the AI system 902 produces an output. In the example of FIG. 9, the AI system access 901 is depicted as a computing system (e.g., a desktop compute or workstation), however, the AI system access 901 can be or include any other type of computing device or system such as any of those discussed herein. For purposes of the present disclosure, the AI system access 901 can also be referred to as a “user” or “authorized user”, and a “user” can refer to any natural or legal person, public authority, agency, a compute node/device, a system, robot or drone, a service, an SW agent, an AI agent, a HW component, a module/component/function of an AI system 902, a remote system or device, and/or other body, element, or entity using and/or interacting with an AI system 902 in any way.

The DB 903 includes any suitable data storage means, which stores, for example, training data, testing data, validation data, user activity logs. AI system behavior logs, etc. For purposes of the present disclosure, “training data” is data used for training an AI system through fitting its learnable parameters, including the weights of a neural network. For purposes of the present disclosure, “testing data” is data used for providing an independent evaluation of the trained and validated AI system in order to confirm the expected performance of that system before its placing on the market or putting into service. For purposes of the present disclosure, “validation data” is data used for providing an evaluation of the trained AI system and for tuning its non-learnable parameters and its learning process, among other things, in order to prevent overfitting; whereas the validation dataset can be a separate dataset or part of the training dataset, either as a fixed or variable split.

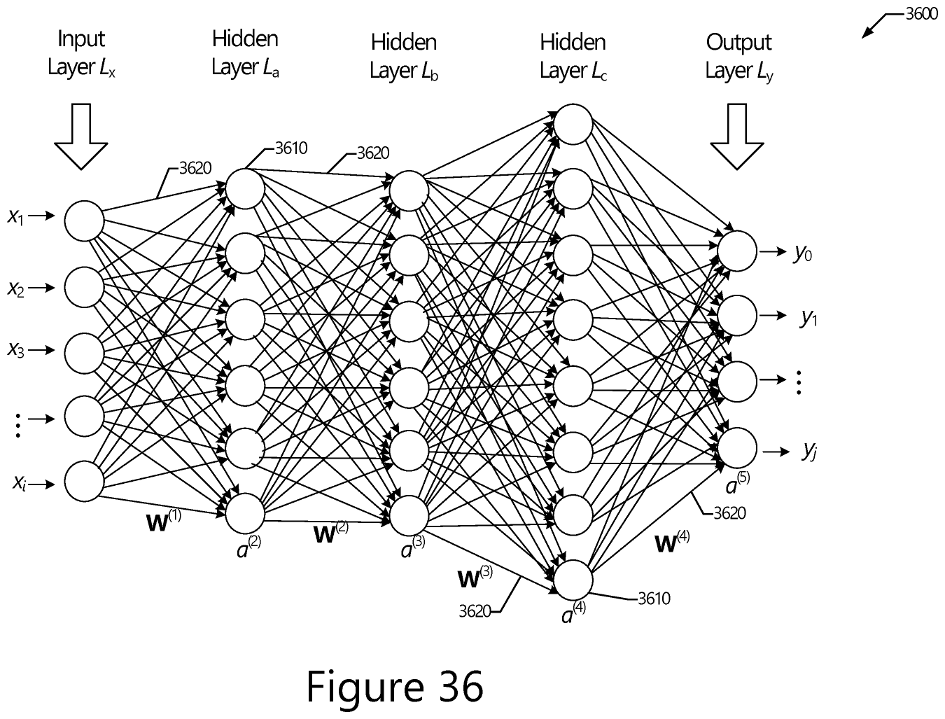

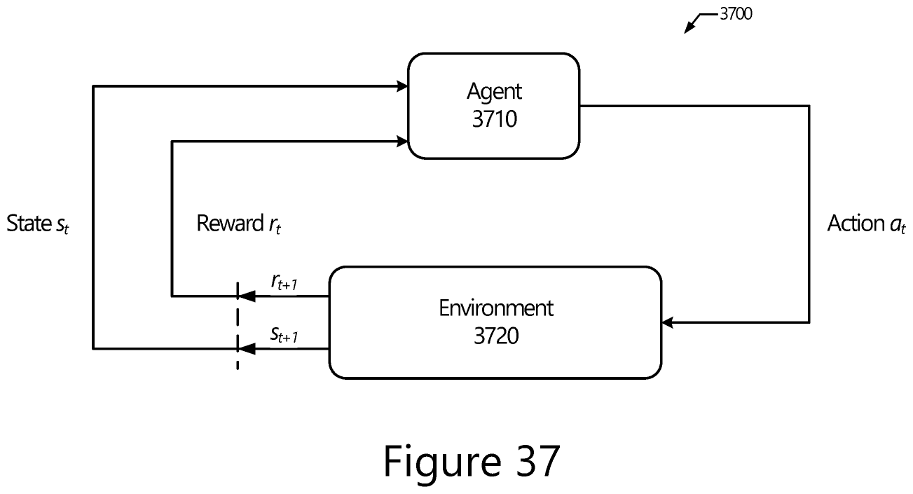

The AI system 902 includes an AI processor or engine 910 (sometimes referred to as the “entity for AI processing” or the like), which includes or implements one or more AI/ML techniques/approaches. The AI processor 910 can be the core of the AI system 902, and in some implementations (e.g., for supervised learning) is trained using a training dataset and optionally some additional data that is being acquired while the AI system 902 is being operated. Such an AI system 902 can rely on various AI/ML techniques/approaches including, for example, regression, classification, clustering, dimensionality reduction, ensemble methods, neural network (NN) (see e.g., FIG. 36), deep learning, transfer learning, reinforcement learning (RL) (see e.g., FIG. 37), natural language processing, word embeddings, topic classification, and/or any other AI/ML technique/approach such as those discussed herein. In some examples, the AI processor 910 is, or includes, an inference engine, a recommendation engine, an RL agent, an NN engine, a neural co-processor, an HW accelerator, an special-purpose processor designed to operate one or more AI/ML models, a general-purpose processor, and/or combinations thereof. Additionally or alternatively, the AI processor 910 can operate an AI agent; an ML model such as an NN (see e.g., FIG. 36), and RL model (see e.g., FIG. 37), and/or any of those discussed herein; an AI/Ml pipeline; an ensemble of AI/ML models; and/or any combinations thereof. For purposes of the present disclosure, the term “AI system” (with or without a reference label) as used herein may refer to the AI engine 910, the AI system 902 as a whole, the AI system architecture 900 as a whole, equipment used to perform one or more AI functions (e.g., hardware accelerators, processor circuitry, and the like) of an AI system 902, the AI engine 910, and/or the AI system architecture 900; one or more components or functions/functionalities of an AI system 902. AI engine 910, and/or AI system architecture 900; or any combination thereof. Additionally, the AI system 902 includes a set of self-assessment elements 921 including a risk-related information (RRI) processing entity 911, a risk mitigation entity 912, an AI system management entity 913, an AI system redundancy entity 914, a human oversight entity 915, a record keeping entity 916, and a self-verification entity 917.

The RRI processing entity 911 (also referred to as “RRI 911”) presents RRI to authorized user(s) for identifying the correct operation of the AI system 902. The RRI 911 takes the results of other entities, such as the self-verification entity 917 and processes identified RRI and unexpected behavior information such that it can be presented in a concise way to a user (e.g., by illustrating statistics on the decision making, including outlining unexpected biases of the statistics, and/or the like). In case of an issue, the user can use the provided information to take action (e.g., to terminate the AI system operation through the human oversight entity 915).

The risk mitigation entity 912 offers trade-offs to the user to choose from (e.g., functionality/risk trade-off such as, for example, offer less (more) functionalities implying less (more) risks, and/or the like). The risk mitigation entity 912 proposes a trade-off between risk and functionality to the user. For example, the risk mitigation entity 912 may propose that the AI system is periodically retrained using observed information obtained during operation. The upside is that this may improve the quality of the AI decision making. The risk is that the new data may introduce biases or other undesired characteristics. The authorized user will need to decide whether or not corresponding risks are being taken to achieve the expected improvements. Additionally or alternatively, a suitable AI/ML technique/approach can be used to determine whether or not corresponding risks are being taken to achieve the expected improvements.

AI system management entity 913 orchestrates AI system internal processes. For example, when a user requests information on AI system behavior or similar, the information is recovered from DB 903, processed and presented to the user, etc. The AI system management entity 913 will orchestrate the interaction between the different building blocks of the AI system 902. For example, when one of the entities of an AI system is dysfunctional or operates in an unexpected way, then the AI system management entity 913 detects this behavior using information provided by the self-verification entity 917, and triggers the replacement of concerned components/entities by redundant replacement components/entities through the AI system redundancy entity 914.

The AI system redundancy entity 914 replaces redundant entities if failures or errors occur. In case that critical entities of AI System 902 (or AI processor 910) stop operating or operate erroneously, they are replaced by redundant (replacement) entities. The AI system redundancy entity 914 oversees redundant replacement options for entities, components, and/or elements of the AI system 902 (or AI processor 910). When some malfunctioning entity/component/element is identified, using information provided by the self-verification entity 917, the AI system redundancy entity 914 is used to configure a corresponding replacement entity/component/element. After the replacement, the correct operation of the AI system 902 is verified by the self-verification entity 917. If the replacement is successfully verified, then the operation of the AI system 902 may continue.

The human oversight entity 915 identifies information that may be relevant for authorized users to intervene (e.g., stop or pause the operation of the AI system 902) because biases are observed or similar. The human oversight entity 915 allows the authorized user to take action in case that the AI system 902 operates in an unexpected or undesired way (e.g., in case that the decision making processes indicate harmful biases). The user may then take several actions, including termination of the AI system operation, enforce a retraining of the system 902, choose a different risk trade-off through the risk mitigation entity 912, and/or the like.

The self-verification entity 917 verifies the operation of the AI system 902 against criteria set out in the [AIA], including identification of eventual biases, verification of training data, and/or the like. The self-verification entity 917 to verify the correct operation of the newly trained system 902. In some implementations, the self-verification entity 917 uses a predefined test dataset, which is different from the dataset used for training, as input data to the AI system 902 in order to verify the correct operation. Only if the correct operation is verified, the AI system 902 is allowed for full usage for its intended purpose. In the opposite case (e.g., in case that biases and/or any unexpected behavior are detected), the operation of the AI system 902 is interrupted until the issues are resolved. Such a verification step is periodically repeated in case of retraining of the AI system 902 with new data, including the use of backpropagation techniques.

The record keeping entity 916 logs or otherwise track user activity, the behavior of the AI system 902, information on re-training of the AI system 902, and the like. When the system 902 is finally used for its intended purpose (after all successful verification steps), the record keeping entity 916 logs all user interactions (e.g., commands given by the authorized user, tracking/identifying input datasets, etc.), records or tracks the behavior of the AI system 902, and stores relevant information in the DB 903.

### 2.3. Open AI Systems

Still referring to AI system 900 of FIG. 9, which includes interactions with external components/entities 950 under 3rd party control. An “AI system interacting with external (independent) entities/components” is an AI system that obtains training data from external entities under control of 3rd parties (e.g., a party independent of the developer or owner of the AI system 902). The AI system architecture 900 includes the AI system access 901, the AI system 902 (including its components/entities) and the DB 903, which are the same as discussed previously with respect to (w.r.t.) FIG. 9. The AI system architecture 900 also includes the external component 950.

In this example, the AI system 902 interacts with external (independent) entities/components 950 operated by 3rd parties. The external component 950 may involve management and operation of critical infrastructure such as AI systems intended to be used as safety components in the management and operation of road traffic and the supply of water, gas, heating and electricity (see [AIA], Annex III, para 2(a)).

In one example external component 950 is a vehicle (e.g., autonomous or semi-autonomous vehicle, drone, or robot) under control of a 3rd party providing sensor information and similar to the AI System 902.

For road traffic management, the AI system 902 may be implemented in a road side unit (RSU) or edge compute node co-located with one or more RSUs. The RSU interacts through a wireless link (e.g., cellular V2X (C-V2X) link) with nearby vehicles. Those vehicles provide information (e.g., sensor data, inference/predictions, mapping data, etc.) to the AI system 902 via the AI system access 901. This external information will be used by the AI system 902 for its internal decision making and possibly for the improvement of its AI/ML models.

In this example of an RSU interacting with nearby vehicles, the processing discussed previously remains valid. Additionally, in case that the information provided by the external entity/component is considered fully trustable and equal to internal information, no further steps need to be taken. It is expected, however, that external information (under 3rd party control) cannot be fully trusted and additional steps for control and supervision need to be taken. The self-verification entity 917 takes additional steps for verification, (e.g., after retraining based on the external data) wherein the operation of the AI system 902, 910 is systematically verified by applying reference datasets as inputs (input data) and the outputs are then verified for correct operation of the AI system (e.g., eventual biases are identified, and the like).

### 2.4. AI System and AI System Components for AI Regulations

Technical solutions to address the regulatory requirements of [AIA] Articles 9 to 18 are outlined in the following sections. In addition to the technical solutions outlined infra, a hierarchy of authorization and authentication can be used. For example, the authorization and/or authentication hierarchy can be defined for different types of users attempting to access AI systems of varying levels of risk, and can implemented as “authorization levels” such as those shown by Table 2.4-1.

TABLE 2.4-1

| Authorization | |
|---|---|
| Level | Description of Authorization |
| 1 | users that have no access to AI systems (e.g., |
| | unauthorized users, children under a certain age, |
| | and the like) |
| 2 | users that have access to some or all Non-High-Risk |
| | AI systems only and excluding access to High Risk |
| | AI systems |
| 3 | users that have access to a subset of High-Risk |
| | AI systems as defined in [AIA], Annex III |
| 4 | users that have access to all available AI systems |
| | including those defined in [AIA], Annex III |

Different labeling or authorization level assignments may be used than those shown by Table 2.4-1. The data elements shown by Table 2.4-1 may be divided or combined in any way, and/or additional or alternative data elements (e.g., authorization levels) may be used. Additionally or alternatively, some or all of the data elements in Table 2.4-1 can be arranged in any order identical to or different from the order shown by Table 2.4-1. Furthermore, the authorization levels in Table 2.4-1 can be managed through any suitable (e.g., existing and/or state-of-the art) authorization and authentication mechanisms including those that use AI/ML techniques and/or approaches such as those discussed herein.

### 2.5. Risk Management Aspects

Article 9 of the [AIA] discusses aspects of risk management systems, and is reproduced in Table 2.5-1.

TABLE 2.5-1
Article 9
Risk management system

| 1. | A risk management system shall be established, implemented, documented and | |
|---|---|---|
| | maintained in relation to high-risk AI systems. | |
| 2. | The risk management system shall consist of a continuous iterative process run | |
| | throughout the entire lifecycle of a high-risk AI system, requiring regular | |
| | systematic updating. It shall comprise the following steps: | |
| | (a) | identification and analysis of the known and foreseeable risks associated |
| | | with each high-risk AI system; |
| | (b) | estimation and evaluation of the risks that may emerge when the high-risk AI |
| | | system is used in accordance with its intended purpose and under conditions |
| | | of reasonably foreseeable misuse; |
| | (c) | evaluation of other possibly arising risks based on the analysis of data |
| | | gathered from the post-market monitoring system referred to in Article 61; |
| | (d) | adoption of suitable risk management measures in accordance with the |
| | | provisions of the following paragraphs. |

| | |
|---|---|
| 3. | The risk management measures referred to in paragraph 2, point (d) shall give due |
| | consideration to the effects and possible interactions resulting from the combined |
| | application of the requirements set out in this Chapter 2. They shall take into |
| | account the generally acknowledged state of the art, including as reflected in |
| | relevant harmonised standards or common specifications. |
| 4. | The risk management measures referred to in paragraph 2, point (d) shall be such |
| | that any residual risk associated with each hazard as well as the overall residual |
| | risk of the high-risk AI systems is judged acceptable, provided that the high- |
| | risk AI system is used in accordance with its intended purpose or under conditions |
| | of reasonably foreseeable misuse. Those residual risks shall be communicated to |
| | the user. |

In identifying the most appropriate risk management measures, the following shall be
ensured:

| | |
|---|---|
| (a) | elimination or reduction of risks as far as possible through adequate design |
| | and development; |
| (b) | where appropriate, implementation of adequate mitigation and control measures |
| | in relation to risks that cannot be eliminated; |
| (c) | provision of adequate information pursuant to Article 13, in particular as |
| | regards the risks referred to in paragraph 2, point (b) of this Article, |
| | and, where appropriate, training to users. |

| | |
|---|---|
| | In eliminating or reducing risks related to the use of the high-risk AI system, |
| | due consideration shall be given to the technical knowledge, experience, |
| | education, training to be expected by the user and the environment in which the |
| | system is intended to be used. |
| 5. | High-risk AI systems shall be tested for the purposes of identifying the most |
| | appropriate risk management measures. Testing shall ensure that high-risk AI |
| | systems perform consistently for their intended purpose and they are in compliance |
| | with the requirements set out in this Chapter. |
| 6. | Testing procedures shall be suitable to achieve the intended purpose of the AI |
| | system and do not need to go beyond what is necessary to achieve that purpose. |
| 7. | The testing of the high-risk AI systems shall be performed, as appropriate, at |
| | any point in time throughout the development process, and, in any event, prior |
| | to the placing on the market or the putting into service. Testing shall be made |
| | against preliminarily defined metrics and probabilistic thresholds that are |
| | appropriate to the intended purpose of the high-risk AI system. |
| 8. | When implementing the risk management system described in paragraphs 1 to 7, |
| | specific consideration shall be given to whether the high-risk AI system is likely |
| | to be accessed by or have an impact on children. |
| 9. | For credit institutions regulated by Directive 2013/36/EU, the aspects described |
| | in paragraphs 1 to 8 shall be part of the risk management procedures established |
| | by those institutions pursuant to Article 74 of that Directive. |

In order to satisfy the requirements of Article 9, the following technical solutions are introduced. For each of the supported High Risk AI functionalities of a product, a DB 903 (either within the device or external to the device) shall be introduced which gather information on: Information on known and foreseeable risks associated with each high-risk system and/or each supported HRAI functionality (as defined in annex III of [AIA]), and/or Information on applied risk mitigation solutions, and/or Information on residual risk (if any) which is remaining despite risk mitigation solutions, and/or Information on past and/or future testing of HRAI systems and related impact on user (e.g., reduced availability of the AI service, etc.) and/or Information whether the HRAI system is likely to be/allowed to be accessed by or have an impact on children and/or Information of the validity of the upper information (e.g., a date until when the information is valid), information on when the upper information was gathered (e.g., date, time, location, by whom, etc.) and/or a reference to the (testing) processes used to derive the upper information.

The information may be stored in the IEs/containers shown by Table 2.5-2. An entirety or a subset of the data elements in Table 2.5-2 can be arranged in any order identical to or different from the order shown by Table 2.5-2. Furthermore, the data elements shown by Table 2.5-2 may be divided or combined in any way, and/or additional or alternative data elements may be used. Additionally or alternatively, for each of the IEs/containers shown by Table 2.5-2, an authorization level (see e.g., Table 2.4-1) may be defined depending on the use case or implementation.

TABLE 2.5-2

| ID | Info Acquisition IE | Validity Deadline IE | Type of information |
|---|---|---|---|
| 1 | Timestamp, | Timestamp, | Information on known and foreseeable risks associated with |
| | location, and/or | location, and/or | each high-risk system and/or each supported high-risk AI |
| | related info. | related info. | functionality (as defined in annex III of [AIA]), and/or |
| 2 | Timestamp, | Timestamp, | Information on applied risk mitigation solutions, and/or |
| | location, and/or | location, and/or | |
| | related info. | related info. | |
| 3 | Timestamp, | Timestamp, | Information on residual risk (if any) which is remaining |
| | location, and/or | location, and/or | despite risk mitigation solutions, and/or |
| | related info. | related info. | |
| 4 | Timestamp, | Timestamp, | Information on past and/or future testing of high-risk AI |
| | location, and/or | location, and/or | systems and related impact on user (e.g., reduced availability |
| | related info. | related info. | of the AI service, etc.) and/or |
| 5 | Timestamp, | Timestamp, | Information whether the high-risk AI system is likely to be/ |
| | location, and/or | location, and/or | allowed to be accessed by or have an impact on children |
| | related info. | related info. | and/or |
| 6 | Timestamp, | Timestamp, | Information of the validity of the upper information (e.g., a |
| | location, and/or | location, and/or | date until when the information is valid), information on when |
| | related info. | related info. | the upper information was gathered (e.g., date, time, location, |
| | | | by whom, etc.) and/or a reference to the (testing) processes |
| | | | used to derive the upper information. |

In Table 2.5-2, the Info Acquisition Information Element (IE)/container contains a timestamp, location data, and/or related information/data of when the described information/data was acquired, and the Validity Deadline IE contains a timestamp, location data, and/or related information/data of when and where the Information is valid. The “timestamp” mentioned in Table 2.5-2 refers to a time of day, a date, or time and date of the collected information, and “info” is an abbreviation of “information”. The timestamp may be in any suitable timestamp format. Additionally or alternatively, the timestamp in Validity Deadline IE can include an amount of time that the data will be valid such as a number of seconds, minutes, hours, days, weeks, months, years, and so forth. Additionally or alternatively, the location in Validity Deadline IE can be a geofence or other boundary in which the data will remain valid, such that when the AI system or the user exits the geofence or other boundary (e.g., as indicated by a network address, GNSS data, service area, and/or the like) the described information is no longer valid. Additionally or alternatively, the geofence or other boundary may indicate excluded regions or jurisdictions, such that when the AI system or the user enters the geofence or other boundary (e.g., as indicated by a network address, GNSS data, and/or the like) the described information is no longer valid. The related information may include some indication or indicator indicating the type of validity information included in the Validity Deadline IE (e.g., whether the timestamp is a time and/or date or amount of time, whether the location is an entry/exit geofence or boundary, etc.). Additionally or alternatively, for each of the IEs/containers in Table 2.5-2, a required authorization level (see e.g., Table 2.4-1) may be defined and used with the Article 9) mechanisms discussed herein.

The “location” data element in Table 2.5-2 may be useful when different countries have different processes/conditions for deriving requested information, require specific authorized personnel to perform the information acquisition, etc. The “Related Information” may include any further information of relevance to the acquisition of related information, e.g., Name/ID/contact details of the person(s) who is/are acquiring the requested information, further information on geographic validity of the acquired information, details on how the required information was acquired (e.g., which tools/processes were used, etc.) and/or certificates or similar of the provided information. Depending on local/specific needs, only part of the information may be stored/used as indicated above and/or additional IEs and/or data containers may be added.

The data element in Table 2.5-2 are stored in a DB 903 characterizing either a given AI system as a whole and/or specific functionalities/features offered by a given AI system, in particular related to the systems and inherent functionalities listed in Annex III of [AIA].

Also, for a given HRAI system and/or inherent functionality of a high risk AI system, there may be more than one risk mitigation solution, all of which have different tradeoffs for the user. Typically, those risk mitigation solutions that lead to a lower risk also restrict the functionalities available to the user. The process of FIG. 3 is performed before making a HRAI system and/or HRAI functionality available to a user.

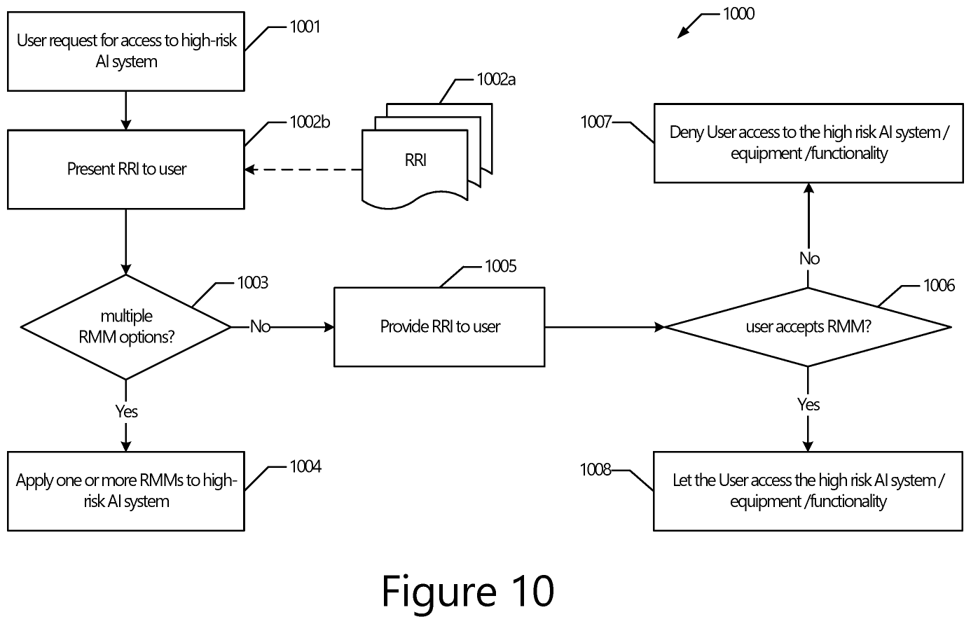

FIG. 10 shows a process 1000 for accessing an HRAI system according to various embodiments. At operation 1001, a user is requesting access to a HRAI system. At operation 1002a, risk-related information (RRI) is provided to the system (e.g., AI system 900 discussed previously). At operation 1002b, the risk related information is presented to the user. This may take place prior to the user using the HRAI feature. The various IEs/containers of the RRI 1002a may include any combination of one or more of:
i) Information on known and foreseeable risks associated with each high-risk system and/or each supported HRAI functionality (see e.g., [AIA], annex III).
ii) Information on applied risk mitigation methods (RMM).
iii) Information on residual risk (if any) which is remaining despite RMM.
iv) Information on past and/or future testing of HRAI systems and related impact on user (e.g., reduced availability of the AI service, etc.).
v) Information whether the HRAI system is likely to be/allowed to be accessed by or have an impact on children.
vi) Information of the validity of the upper information (e.g., a date until when the information is valid), information on when the upper information was gathered (e.g., date, time, location, by whom, etc.) and/or a reference to the (testing) processes used to derive the upper information.

At operation 1003, the system determines whether multiple RMM options are available for the HRAI system (e.g., depending on the context of the AI system, user device, and/or the like). If there are multiple options for RMM, at operation 1004, the system applies the user selected RMM to the AI system. In some embodiments, operation 1004 may include the system providing one or more RMM methods to the user (e.g., as a list in a graphical user interface), obtains a selection from the user, and applies the user selected RMM to the AI system. Additionally or alternatively, operation 1004 may include the system pre-selecting at least one RMM, and providing relevant RRI 1002a (e.g., RRI 1002a of the pre-selected RMM) at to the user. The system may apply the pre-selected RMM before or after providing the relevant information 1002a to the user. Additionally or alternatively, operation 1004 may include the system providing information on all (or a pre-selected subset of) available RMMs to the user, and letting the user select one out of the multiple available RMMs.

If at operation 1003 there are not multiple RMM options, at operation 1005, the system provides RRI 1002a to the user that is relevant to the (single) available RMM. If at operation 1005 there is an RMM applied, the system provides RRI for the applied RMM to the user (e.g., in the GUI, etc.).

At operation 1006, the system determines whether the user accepts the proposed RMM (or no RMM). This may be achieved via explicit approval by the user (e.g., clicking or tapping on a “accept” GUI button or the like, suitable voice command, or the like). If the user does not accept the proposed RMM, at operation 1007, the system denies user access to the high risk AI system. If the user does accept the proposed RMM, at operation 1008, the system permits the user access the high risk AI system.

Additionally or alternatively, different levels of access can be introduced to HRAI system(s) and/or HRAI system(s) depending on the type of user. For example, a first level may include users that have no access to AI systems (e.g., kids under a certain age, etc.), a second level may include users that have access to (all or a subset of) Non-HRAI systems only (excluding access to HRAI systems), a third level may include users that have access to a sub-set of the HRAI systems as defined in Annex III of [AIA], a fourth level may include users that have access to all of the (available) AI systems as defined in Annex III of [AIA]. The access rights of the user can be managed through state-of-the art authorization and authentication mechanisms including those that use AI/ML techniques and/or approaches such as those discussed herein.

### 2.6. Data and Data Governance Aspects

Article 10 of the [AIA] discusses aspects of data and data governance, and is reproduced in Table 2.6-1.

TABLE 2.6-1
Article 10
Data and data governance

| 1. | High-risk AI systems which make use of techniques involving the training of models | |
|---|---|---|
| | with data shall be developed on the basis of training, validation and testing | |
| | data sets that meet the quality criteria referred to in paragraphs 2 to 5. | |
| 2. | Training, validation and testing data sets shall be subject to appropriate data | |
| | governance and management practices. Those practices shall concern in particular, | |
| | (a) | the relevant design choices; |
| | (b) | data collection; |
| | (c) | relevant data preparation processing operations, such as annotation, |
| | | labelling, cleaning, enrichment and aggregation; |
| | (d) | the formulation of relevant assumptions, notably with respect to the |
| | | information that the data are supposed to measure and represent; |
| | (e) | a prior assessment of the availability, quantity and suitability of the data |
| | | sets that are needed; |
| | (f) | examination in view of possible biases; |
| | (g) | the identification of any possible data gaps or shortcomings, and how those |
| | | gaps and shortcomings can be addressed. |

| | |
|---|---|
| 3. | Training, validation and testing data sets shall be relevant, representative, |
| | free of errors and complete. They shall have the appropriate statistical |
| | properties, including, where applicable, as regards the persons or groups of |
| | persons on which the high-risk AI system is intended to be used. These |
| | characteristics of the data sets may be met at the level of individual data sets |
| | or a combination thereof. |
| 4. | Training, validation and testing data sets shall take into account, to the extent |
| | required by the intended purpose, the characteristics or elements that are |
| | particular to the specific geographical, behavioural or functional setting within |
| | which the high-risk AI system is intended to be used. |
| 5. | To the extent that it is strictly necessary for the purposes of ensuring bias |
| | monitoring, detection and correction in relation to the high-risk AI systems, the |
| | providers of such systems may process special categories of personal data referred |
| | to in Article 9(1) of Regulation (EU) 2016/679, Article 10 of Directive (EU) |
| | 2016/680 and Article 10(1) of Regulation (EU) 2018/1725, subject to appropriate |
| | safeguards for the fundamental rights and freedoms of natural persons, including |
| | technical limitations on the re-use and use of state-of-the-art security and |
| | privacy-preserving measures, such as pseudonymisation, or encryption where |
| | anonymisation may significantly affect the purpose pursued. |
| 6. | Appropriate data governance and management practices shall apply for the |
| | development of high-risk AI systems other than those which make use of techniques |
| | involving the training of models in order to ensure that those high-risk AI |
| | systems comply with paragraph 2. |

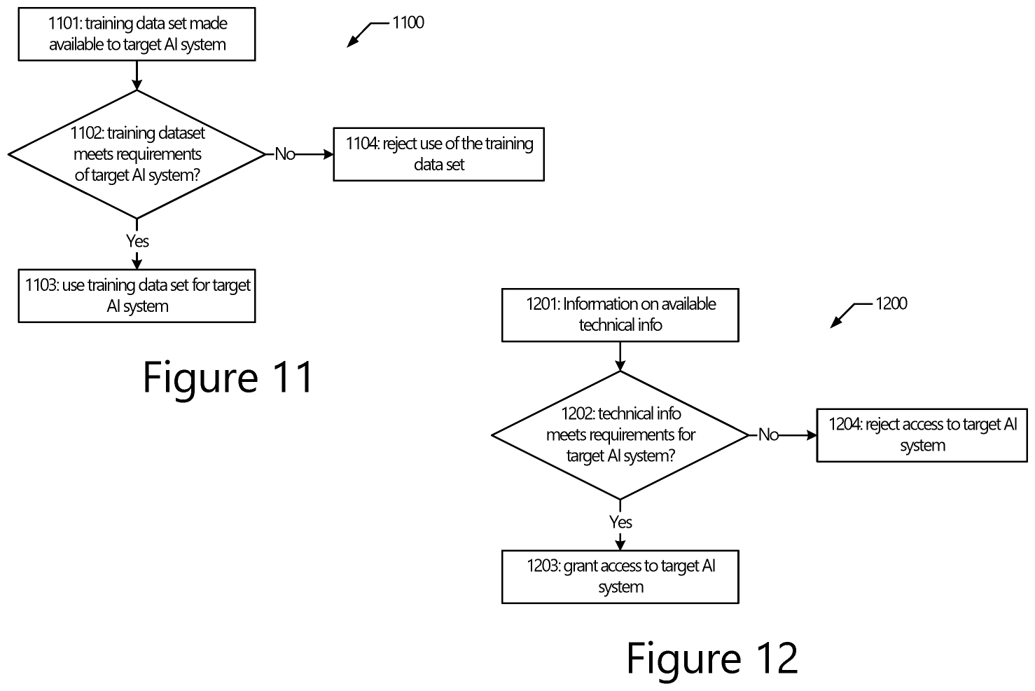

Data to be used in HRAI systems and/or non-HRAI systems can be complemented by additional information. Data and/or datasets used for training, validation, and testing are complemented by the some or all of the information in Table 2.6-2. An entirety or a subset of the data elements in Table 2.6-2 can be arranged in any order identical to or different from the order shown by Table 2.6-2. Furthermore, the data elements shown by Table 2.6-2 may be divided or combined in any way, and/or additional or alternative data elements may be used. Additionally or alternatively, for each of the IEs/containers shown by Table 2.6-2, an authorization level (see e.g., Table 2.4-1) may be defined depending on the use case or implementation. The process shown by FIG. 11 may be performed in order to process training data.

TABLE 2.6-2

| ID | Type of Information | |
|---|---|---|
| 1 | Statement that data is relevant, representative, free of errors and complete. If appropriate, the | |
| | statement is complemented by | |
| | Date/Time when the statement was made, and/or | |
| | Validity of Data to be used for training (i.e., is there any time/date until when the data may be used for | |
| | training, this may vary for specific applications (e.g., training data for Non-High-Risk systems may have | |
| | a longer validity period than training data for High-Risk systems), specific locations (e.g., depending on | |
| | local laws and other requirements), etc.) | |
| | Location where the data was verified to meet those requirements, and/or | |
| | Responsible person/authority who confirmed that those requirements are met, and/or | |
| | Information on processes/methods applied to determine that those requirements are met, and/or | |
| | Any Certifications or similar available for a given set of data (e.g., a training set is officially approved by | |
| | a government agency and a related certificate is given) | |
| | Access conditions to training data, e.g., it may openly accessible (to all), restricted to authorized expert | |
| | users, etc. | |
| 2 | Information for which applications the available data may be used, including: | |
| | ● | Data that can be used for training of (a specific set of or all) Non-High-Risk AI systems, |
| | ● | Data that can be used for training of (a specific set of or all) High-Risk AI systems as defined in Annex |
| | | III of [AIA], |
| | ● | Data can be used (or is excluded from usage) for specific applications, e.g., certain consumer |
| | | applications (e.g., computer games), vehicular applications, industrial applications (e.g., industrial IoT, |
| | | etc.), mission critical applications, law enforcement applications, etc. |
| 3 | Information on the source of the training data, including: | |
| | ● | Information whether the training data consists of a collection of sub-sets of training data; if yes, further |
| | | detail on the respective sub-sets of training data is given (e.g., reference to detailed characterization |
| | | of a specific sub-set, information on the source, any/all of the information provided in IDs 1 and/or 2 |
| | | above, etc.). |
| | ● | Information of specific circumstances of the acquisition of the training data, e.g., weather conditions |
| | | (rain/sunlight/etc.), time of day (sunlight/night/sunset/sunrise, etc.), location characteristics (e.g., |
| | | countryside, city, etc.), etc. |
| | ● | Information on (known) biases. |

FIG. 11 shows an example process 1100 for using training data for an AI system. Process 1100 begins at operation 1101 where a training dataset is made available to a target AI system. In this example, the target AI system may be a high risk AI system or a non-high risk AI system. At operation 1102, the system determines whether the training dataset meets the requirements for the target AI system. If the training dataset does meet the requirements for the target AI system, at operation 1103, the system uses the available dataset for training of the target AI system. If the training dataset does not meet the requirements for the target AI system, at operation 1104, the system rejects the training dataset as it cannot be used for training the AI system (ML model, etc.). After operation 1103 or 1104, process 1100 may end or repeat as necessary.

### 2.7. Technical Documentation Aspects

Article 11 of the [AIA] is related to technical documentation, and is reproduced in Table 2.7-1.

TABLE 2.7-1
Article 11
Technical documentation

| | |
|---|---|
| 1. | The technical documentation of a high-risk AI system shall be drawn up before |
| | that system is placed on the market or put into service and shall be kept up-to |
| | date. |
| | The technical documentation shall be drawn up in such a way to demonstrate that |
| | the high-risk AI system complies with the requirements set out in this Chapter |
| | and provide national competent authorities and notified bodies with all the |
| | necessary information to assess the compliance of the AI system with those |
| | requirements. It shall contain, at a minimum, the elements set out in Annex IV. |
| 2. | Where a high-risk AI system related to a product, to which the legal acts listed |
| | in Annex II, section A apply, is placed on the market or put into service one |
| | single technical documentation shall be drawn up containing all the information |
| | set out in Annex IV as well as the information required under those legal acts. |
| 3. | The Commission is empowered to adopt delegated acts in accordance with Article 73 |
| | to amend Annex IV where necessary to ensure that, in the light of technical |
| | progress, the technical documentation provides all the necessary information to |
| | assess the compliance of the system with the requirements set out in this Chapter. |

For each HRAI system and/or non-HRAI system, various data/information is provided characterizing available technical information. This information is made available in the IEs and/or container(s) shown by Table 2.7-2. An entirety or a subset of the data elements/IEs/containers in Table 2.7-2 can be arranged in any order identical to or different from the order shown by Table 2.7-2. Furthermore, the data elements shown by Table 2.7-2 may be divided or combined in any way, and/or additional or alternative data elements may be used. Additionally, for each of the IEs/containers shown by Table 2.7-2, an authorization level (see e.g., Table 2.4-1) may be defined depending on the use case or implementation. The process shown by FIG. 12 can be performed in order to process information on technical documentation.

TABLE 2.7-2

| ID | Type of Information |
|---|---|
| 1 | A characterization of available technical documentation is provided including |
| | i) Date/Time when the technical documentation was created, and/or |
| | ii) Validity of Data of technical documentation, and/or |
| | iii) Location where the technical documentation was created, and/or |
| | iv) Responsible person/authority who has approved the technical documents, and/or |
| | v) Information on processes/methods applied to determine that requirements for technical documents |
| | are met, and/or |
| | vi) Any Certifications or similar available for a technical documentation, and/or |
| | vii) Access conditions to technical documentation, e.g., it may openly accessible (to all), restricted to |
| | authorized expert users, etc. |
| 2 | Information for which applications the technical documentation may be used, including |
| | i) Technical documentation can be used for Non-High-Risk AI systems, |
| | ii) Technical documentation can be used for High-Risk AI systems as defined in Annex III of [AIA], |
| | iii) Technical documentation can be used (or is excluded from usage) for specific applications, e.g., |
| | certain consumer applications (e.g., computer games), vehicular applications, industrial applications |
| | (e.g., industrial IoT, etc.), mission critical applications, law enforcement applications, etc. |
| 3 | Information on technical documentation, including |
| | i) Information on (known) biases. |

FIG. 12 shows an example process 1200 for processing information on technical documentation for AI systems according to various embodiments. Process 1200 begins at operation 1201 where technical information (info) regarding a target AI system is made available to the system (e.g., AI system 900 discussed previously) and/or the target AI system itself. In this example, the target AI system may be a high risk AI system or a non-high risk AI system. At operation 1202, the system (e.g., AI system 900 discussed previously) determines whether the technical info meets the requirements for the target AI system. If the technical info does meet the requirements for the target AI system, at operation 1203, the system grants access to the target AI system (e.g., the provided technical info is sufficient). If the technical info does not meet the requirements for the target AI system, at operation 1204, the system rejects the access to the AI system (e.g., the technical info is not sufficient). After operation 1203 or 1204, process 1200 may end or repeat as necessary.

### 2.8. Record Keeping Aspects

Article 12 of the [AIA] discusses record keeping aspects, and is reproduced by Table 2.8-1.

TABLE 2.8-1
Article 12
Record-keeping

| 1. | High-risk AI systems shall be designed and developed with capabilities enabling | |
|---|---|---|
| | the automatic recording of events (‘logs') while the high-risk AI systems is | |
| | operating. Those logging capabilities shall conform to recognised standards or | |
| | common specifications. | |
| 2. | The logging capabilities shall ensure a level of traceability of the AI system's | |
| | functioning throughout its lifecycle that is appropriate to the intended purpose | |
| | of the system. | |
| 3. | In particular, logging capabilities shall enable the monitoring of the operation | |
| | of the high-risk AI system with respect to the occurrence of situations that may | |
| | result in the AI system presenting a risk within the meaning of Article 65(1) or | |
| | lead to a substantial modification, and facilitate the post-market monitoring | |
| | referred to in Article 61. | |
| 4. | For high-risk AI systems referred to in paragraph 1, point (a) of Annex III, the | |
| | logging capabilities shall provide, at a minimum: | |
| | (a) | recording of the period of each use of the system (start date and time and |
| | | end date and time of each use) ; |
| | (b) | the reference database against which input data has been checked by the |
| | | system; |
| | (c) | the input data for which the search has led to a match; |
| | (d) | the identification of the natural persons involved in the verification of |
| | | the results, as referred to in Article 14 (5). |

In some implementations, each time a user logs into a HRAI system and/or HRAI system (e.g., via AI system access 901), the data elements/IEs/containers shown by Table 2.8-2 is created and buffered for record keeping and/or later analysis. The buffering of the data elements/IEs/containers can occur in the subject HRAI system and/or HRAI system itself (e.g., on some persistent memory, hard disc, solid state drive, trusted memory area/location, TEE 3590 of FIG. 35, and/or the like) and/or on external memory (e.g., a secured remote DB, and/or the like).

An entirety or a subset of the data elements in Table 2.8-2 can be arranged in any order identical to or different from the order shown by Table 2.8-2. Furthermore, the data elements shown by Table 2.8-2 may be divided or combined in any way, and/or additional or alternative data elements may be used. Additionally or alternatively, for each of the IEs/containers shown by Table 2.8-2, an authorization level (see e.g., Table 2.4-1) may be defined depending on the use case or implementation.

TABLE 2.8-2

| ID | Type of Information |
|---|---|
| 1 | Start of the usage of the High-Risk and/or Non-High Risk AI system: |
| | i) Time |
| | ii) Date |
| | iii) Location |
| | iv) User name/ID/reference |
| | v) Login equipment ID |
| 2 | End of the usage the High-Risk and/or Non-High Risk AI system: |
| | i) Time |
| | ii) Date |
| | iii) Location |
| 3 | In case of an occurrence of situation(s) that may result in the AI system presenting a risk within the |
| | meaning of Article 65(1) of [AIA] or lead to a substantial modification |
| | i) Flag in case that a risk situation or a situation leading to a substantial modification had occurred. |
| | ii) Any further information on the specific identified risk or the specific identified substantial |
| | modification (e.g., which data sets are affected, under which high-risk and/or non-high-risk Al |
| | applications, which were the configuration parameters chosen by the User, etc.) |

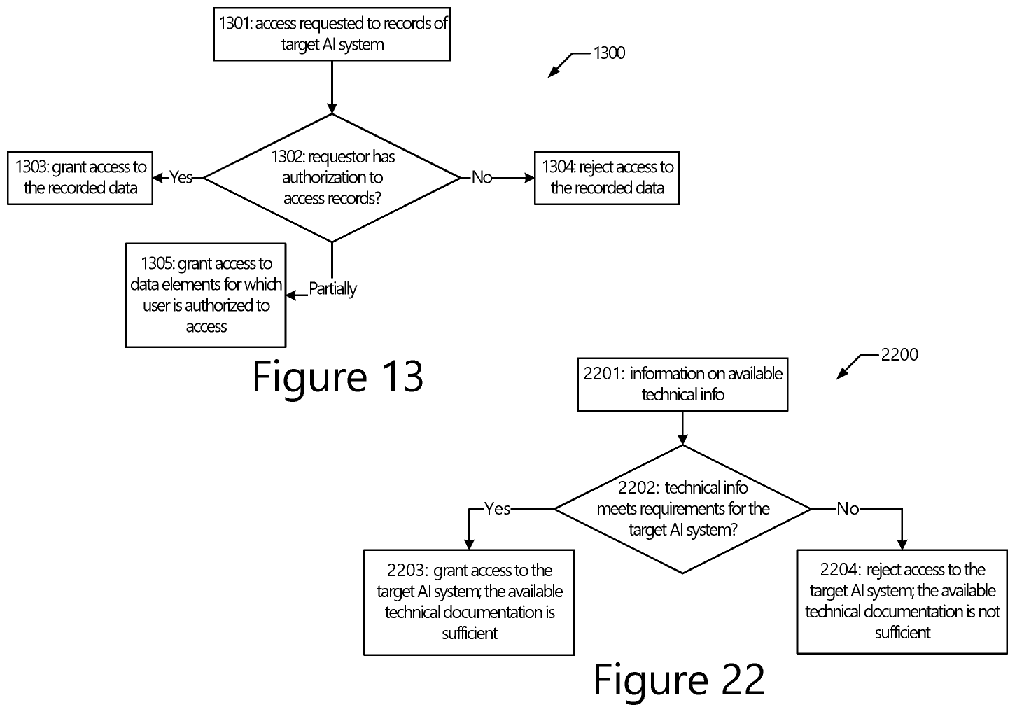

In case that any testing of the AI system is being performed, the data elements/IEs/containers shown by Table 2.4-x2 are stored. The buffering of the data elements/IEs/containers can occur in the subject HRAI system and/or non-HRAI system itself (e.g., on some persistent memory, hard disc, solid state drive, trusted memory, etc.) and/or on external memory (e.g., on a secured remote DB, etc.). Furthermore, the data elements shown by Table 2.4-x2 may be divided or combined in any way, and/or additional or alternative data elements may be used. Additionally or alternatively, for each of the IEs/containers shown by Table 2.4-x2, an authorization level (see e.g., Table 2.4-1) may be defined depending on the use case or implementation. The access to such recorded datasets is governed through an authentication and authorization based process as shown by FIG. 13.

TABLE 2.4-x2

| ID | Type of Information |
|---|---|
| 1 | Information on the reference database (DB) against which input data has been checked by the system: |
| | i) Information on the reference DB (e.g., reference DB identifier (ID), network address of the |
| | reference DB, pointer or reference to the reference DB, etc.). |
| | ii) Information on input data (e.g., input data DB ID, input data DB network address, pointer or |
| | reference to a related input data DB, etc.). |
| | iii) Information on the results of the comparison of input/output data (e.g., were any abnormalities |
| | observed, were any biases identified, were any unexpected output vectors created, has any risk |
| | been detected, etc.). |
| | iv) Details on the check: time and date of the check, entity that performed the check (e.g., user ID, |
| | network address, reference, etc.), location of the check, ID of equipment on which the check was |
| | performed, etc. |
| 2 | Information on the input data for which the search has led to a match: |
| | i) Information on input data (e.g., ID, network address, reference/pointer to a related input data DB, |
| | etc.). |
| | ii) Information on the match that occurred (e.g., type of match (e.g., identification of a number of |
| | animals or objects on a photo picture, etc.), were any abnormalities observed, were any biases |
| | identified, were any unexpected output vectors created, has any risk been detected, etc.). |
| | iii) Details on the check: time and date of the check, who has performed the check (e.g., ID, network |
| | address, reference/pointer, etc.), location of the check, equipment on which the check was |
| | performed (e.g., ID, network address, reference/pointer, etc.), etc. |

FIG. 13 shows an example process 1300 for management of access to recorded data of AI systems according to various embodiments. Process 1300 begins at operation 1301 where access is requested to records of a one or more AI systems (e.g., via AI system access 901 of FIG. 9), which may be HRAI systems and/or a non-HRAI systems (e.g., AI system 902). At operation 1302, the system (e.g., AI system 900 discussed previously) determines whether the requestor (e.g., a user as discussed previously w.r.t. FIG. 9) has authorization to the requested (recorded) data. If the requestor does have adequate authorization, at operation 1303, the system grants access to the requested (recorded) data. If the requestor does not have adequate authorization, at operation 1304, the system rejects the requested (recorded) data. If the requestor has partial authorization (e.g., authorization for some but not all of the requested data), at operation 1305, the system grants access to records/data to which the requestor has adequate authorization. After operations 1303, 1304, or 1305, process 1300 may end or repeat as necessary.

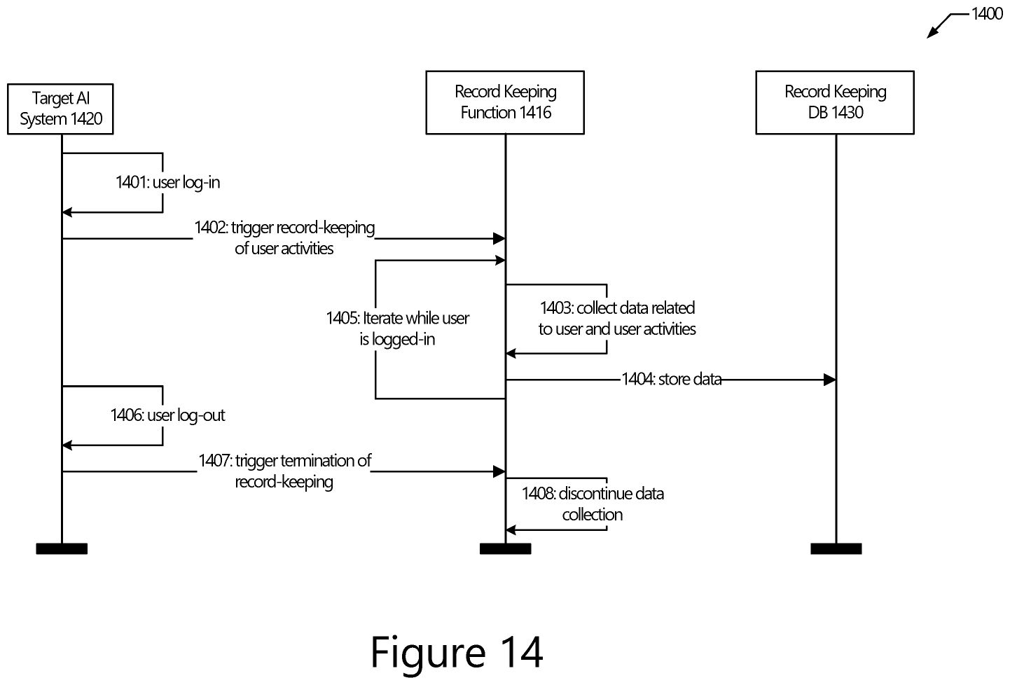

A procedure within a target AI system is shown by FIG. 14, which introduces an AI system management function (e.g., the record keeping function 1416 in FIG. 14) that coordinates relevant processes including record-keeping processes/functions.

FIG. 14 shows a procedure 1400 for record keeping of data related to a user and user activity (using the data containers specified previously). Procedure begins at operation 1401 where a user is logs in to a target AI system 1420 (e.g., using AI system access 901 of FIG. 9). The target AI system 1420 may be the same or similar to the target AI system 902 of FIG. 9, and/or can include one or more components that are the same or similar as components 120 and/or 320 of FIGS. 1 and 3. At operation 1402, the user log-in triggers record-keeping of user activities by the record keeping function 1416. The record keeping function 1416 may be the same or similar to the record keeping entity 916 of FIG. 9. At operation 1403, the record keeping function 1416 collects data related to the user and/or user activities (e.g., which search data has led to which results, and/or the like). At operation 1404, the record keeping function 1416 sends the collected user/user activity data to the record keeping database (DB) 1430 for storage. The record keeping DB 1430 may be the same or similar to DB 903 of FIG. 9. The data may be stored on a periodic basis, asynchronously (e.g., as data is collected), in batches, and/or using any other suitable technique(s). At operation 1405, the data collection process iterates while the user is logged-in to the target AI system 1420. At operation 1406, the user logs out of the AI system 1420. At operation 1407, the user logging out of the system 1420 triggers termination of record-keeping at the record keeping function 1416. At operation 1408, the record keeping function 1416 discontinues acquisition of data related to the specific user and user activity.

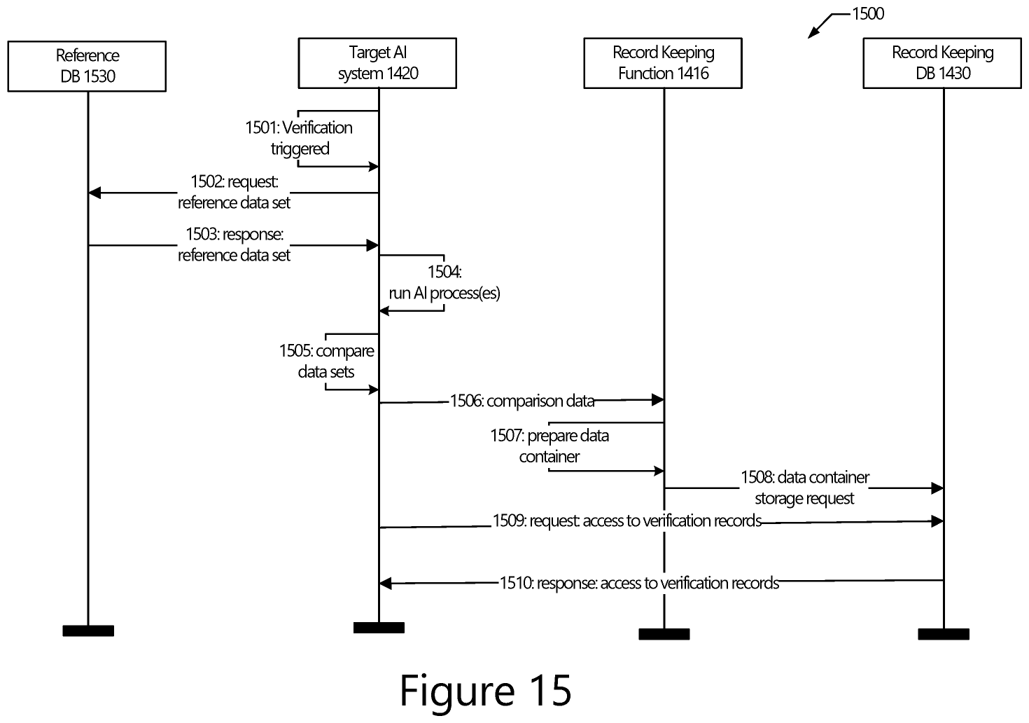

Additionally, tests may be conducted to verify and document (e.g., through record keeping) the correct operation of the AI system 1420 such as the procedure shown by FIG. 15.

FIG. 15 shows an example procedure 1500 for comparison of AI input data to reference data. Procedure 1500 begins at operation 1501 where a target AI system 1420 triggers verification of itself. Additionally or alternatively, the trigger may come from an external or remote entity (e.g., from user, administrator, IoT device, etc.). At operation 1502, the target AI system 1420 requests a reference dataset from a reference DB 1530, and at operation 1503, the reference DB 1530 responds with the requested reference dataset. The reference DB 1530 may be the same or similar to DB 903 of FIG. 9, and/or may be stored on a same or different data storage devices as the record keeping DB 1430. At operation 1504, the target AI system 1420 runs AI processes (e.g., inference, prediction, etc.) with two datasets including the reference dataset from the reference database 1530, and a new dataset (e.g., provided by the user or accessed from some other element/entity). At operation 1505, the target AI system 1420 compares AI processing results (e.g., inference/prediction results) based on the two datasets, and at operation 1506, the target AI system 1420 provides comparison to record-keeping function 1420. At operation 1507, the record-keeping function 1420 prepares a data container comprising the relevant comparison results, any flagging of issues, etc. At operation 1508, the record-keeping function 1420 sends the data container storage request to the record-keeping DB 1430. At operation 1509, the target AI system 1420 sends a request to access records related to verification of comparison results. At operation 1420, the record keeping DB 930 provides data related to verification of comparison results to the target AI system 1420.

### 2.9. Transparency and Information Provisioning Aspects

Article 13 of the [AIA] discusses aspects related to transparency and provision of information to users, and is reproduced in Table 2.9-1.

TABLE 2.9-1
Article 13
Transparency and provision of information to users

| 1. | High-risk AI systems shall be designed and developed in such a way to ensure that | |
|---|---|---|
| | their operation is sufficiently transparent to enable users to interpret the | |
| | system's output and use it appropriately. An appropriate type and degree of | |
| | transparency shall be ensured, with a view to achieving compliance with the | |
| | relevant obligations of the user and of the provider set out in Chapter 3 of this | |
| | Title. | |
| 2. | High-risk AI systems shall be accompanied by instructions for use in an appropriate | |
| | digital format or otherwise that include concise, complete, correct and clear | |
| | information that is relevant, accessible and comprehensible to users. | |
| 3. | The information referred to in paragraph 2 shall specify: | |
| | (a) | the identity and the contact details of the provider and, where applicable, |
| | | of its authorised representative; |
| | (b) | the characteristics, capabilities and limitations of performance of the high- |
| | | risk AI system, including: |

| | |
|---|---|
| (i) | its intended purpose; |
| (ii) | the level of accuracy, robustness and cybersecurity referred to in Article |
| | 15 against which the high-risk AI system has been tested and validated |
| | and which can be expected, and any known and foreseeable circumstances |
| | that may have an impact on that expected level of accuracy, robustness |
| | and cybersecurity; |
| (iii) | any known or foreseeable circumstance, related to the use of the high- |
| | risk AI system in accordance with its intended purpose or under conditions |
| | of reasonably foreseeable misuse, which may lead to risks to the health |
| | and safety or fundamental rights; |
| (iv) | its performance as regards the persons or groups of persons on which the |
| | system is intended to be used; |
| (v) | when appropriate, specifications for the input data, or any other relevant |
| | information in terms of the training, validation and testing data sets |
| | used, taking into account the intended purpose of the AI system. |

| | |
|---|---|
| (c) | the changes to the high-risk AI system and its performance which have been |
| | pre-determined by the provider at the moment of the initial conformity |
| | assessment, if any; |
| (d) | the human oversight measures referred to in Article 14, including the |
| | technical measures put in place to facilitate the interpretation of the |
| | outputs of AI systems by the users; |
| (e) | the expected lifetime of the high-risk AI system and any necessary maintenance |
| | and care measures to ensure the proper functioning of that AI system, |
| | including as regards software updates. |

For purposes of the [AIA], a “provider” is a natural or legal person, public authority, agency, or other body that develops an AI system or that has an AI system developed with a view to placing it on the market or putting it into service under its own name or trademark, whether for payment or free of charge. For purposes of the present disclosure, a “provider” further includes any user (as defined previously), compute node, system, and/or service that develops an AI system or that has an AI system developed, including other AI systems that develop or otherwise incorporate or utilize an AI system for any purpose. Additionally, a “provider” could include a “small-scale provider”, which is a micro or small enterprise within the meaning of Commission Recommendation of 6 May 2003 concerning the definition of micro, small and medium-sized enterprises, Official Journal of the European Union, L124, pp. 36-41 (20 May 2003) (“[2003/361/EC]”) and/or other suitable regulation or standard.

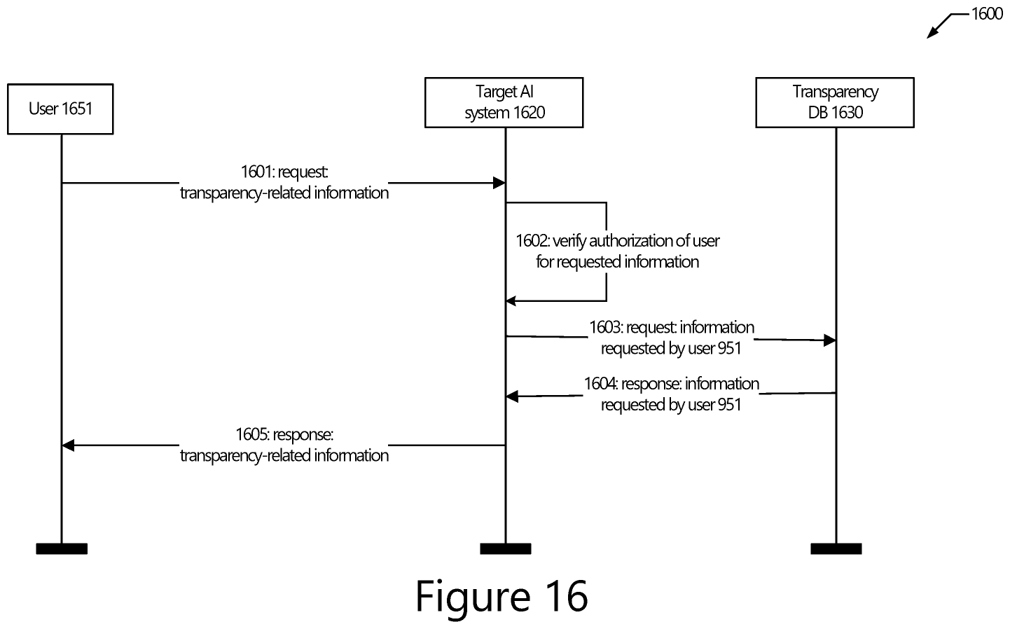

The data elements/IEs/containers containing the data in Table 2.9-2 is/are accessible to authorized personnel for purposes of Article 13. An entirety or a subset of the data elements/IEs/containers in Table 2.9-2 can be arranged in any order identical to or different from the order shown by Table 2.9-2. Furthermore, the data elements shown by Table 2.9-2 may be divided or combined in any way, and/or additional or alternative data elements may be used. Additionally, in Table 2.9-2, the Authorization Level IE indicates the required authorization level needed to access the described information, and the “required authorization level” may be the same or similar to those discussed previously w.r.t. Table 2.4-1, which may be defined depending on the use case or implementation. Furthermore, the “relevant metadata” may include, for example, a source of the data (ID, network address, etc.), timestamp when was the data created, validity limits (e.g., timestamp or amount of time until the data is valid), geographic restrictions, and/or any other metadata. The data elements/IEs/containers in Table 2.9-2 may be used in the procedure shown by FIG. 16.

TABLE 2.9-2

| ID | Authorization Level | Related Metadata | Type of Information |
|---|---|---|---|
| 1 | Required | Relevant metadata | Identity (ID), network address, and/or contact details of the |
| | authorization level | | provider and/or authorized representative (where applicable). |
| 2 | Required | Relevant metadata | Characteristics, capabilities, and limitations of performance of |
| | authorization level | | the high-risk AI system, including: (i) its intended purpose. |
| 3 | Required | Relevant metadata | Characteristics, capabilities, and limitations of performance of |
| | authorization level | | the high-risk AI system, including: (ii) the level of accuracy, |
| | | | robustness and cybersecurity referred to in Article 15 against |
| | | | which the high-risk AI system has been tested and validated |
| | | | and which can be expected, and any known and foreseeable |
| | | | circumstances that may have an impact on that expected |
| | | | level of accuracy, robustness and cybersecurity. |
| 4 | Required | Relevant metadata | Characteristics, capabilities, and limitations of performance of |
| | authorization level | | the high-risk AI system, including: (iii) any known or |
| | | | foreseeable circumstance, related to the use of the high-risk |
| | | | AI system in accordance with its intended purpose or under |
| | | | conditions of reasonably foreseeable misuse, which may lead |
| | | | to risks to the health and safety or fundamental rights. |
| 5 | Required | Relevant metadata | Characteristics, capabilities, and limitations of performance of |
| | authorization level | | the high-risk AI system, including: (iv) its performance as |
| | | | regards the persons or groups of persons on which the |
| | | | system is intended to be used. |
| 6 | Required | Relevant metadata | Characteristics, capabilities, and limitations of performance of |
| | authorization level | | the high-risk AI system, including: (v) when appropriate, |
| | | | specifications for the input data, or any other relevant |
| | | | information in terms of the training, validation and testing |
| | | | data sets used, taking into account the intended purpose of |
| | | | the AI system. |
| 7 | Required | Relevant metadata | Changes to the high-risk AI system and its performance |
| | authorization level | | which have been pre-determined by the provider at the |
| | | | moment of the initial conformity assessment, if any. |
| 8 | Required | Relevant metadata | Human oversight measures referred to in Article 14, including |
| | authorization level | | the technical measures put in place to facilitate the |
| | | | interpretation of the outputs of AI systems by the users. |
| 9 | Required | Relevant metadata | Expected lifetime of the high-risk AI system and any |
| | authorization level | | necessary maintenance and care measures to ensure the |
| | | | proper functioning of that AI system, including as regards |
| | | | software updates |

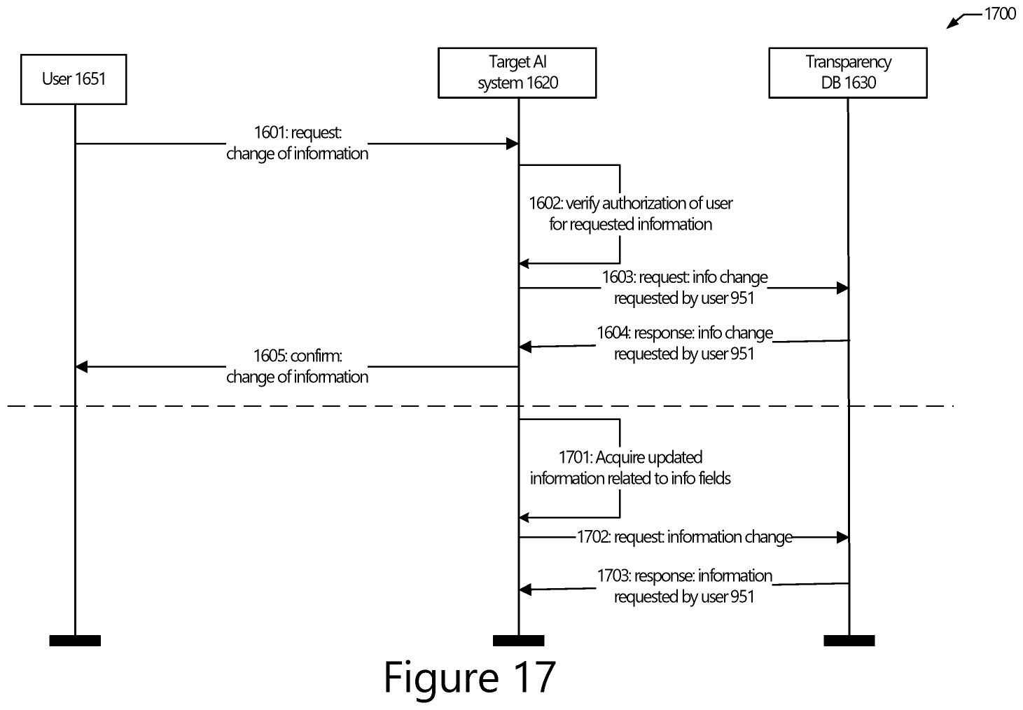

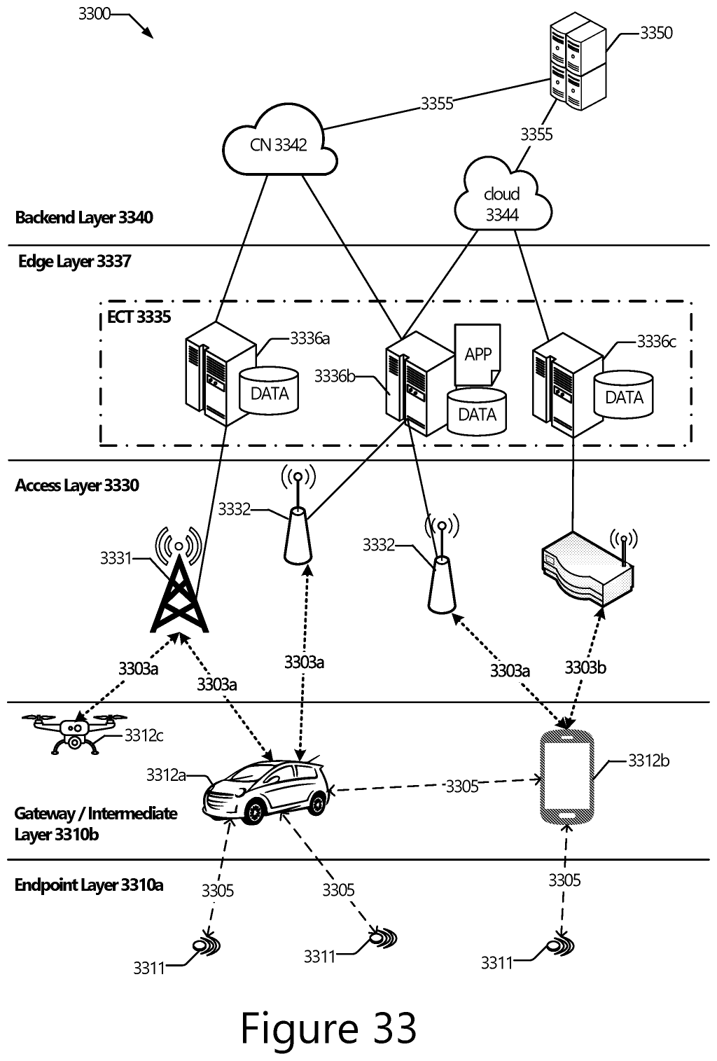

FIG. 16 shows an example procedure 1600 for requesting information related to transparency and other according to various embodiments. Procedure 1600 begins at operation 1601 where a user 1651 sends a request for information (transparency related or other) to the target AI system 1620. The target AI system 1620 may be the same or similar as the target AI system 1420, and the user 1651 may be the same or similar as the user discussed previously, the AI system access 901 of FIG. 9, the UEs 3310 of FIG. 33, and/or any other compute node/device discussed herein. At operation 1602, the target AI system 1620 verifies the authorization of the user related to the requested information elements. At operation 1603, the target AI system 1620 sends a request for information required/requested by the user 1651 (e.g., if user 1651 is authorized to access) to the transparency DB 1630. The transparency DB 1630 may be the same or similar as the DB 903 of FIG. 9. At operation 1604, the target AI system 1620 obtains/accesses/reads the information from the transparency DB 1630. At operation 1605, the target AI system 1620 provides the information to the user 1651. After operation 1605, the procedure 1600 may end or repeat as necessary. Additionally or alternatively, the information as defined by Table 2.9-2 may be modified by authorized personnel (or by information derived by the AI system) using the process of FIG. 17.

FIG. 17 shows an example procedure 1700 to update information related to transparency aspects and other aspects. Procedure 1700 begins by performing operations 1601 to 1605, which may be the same or similar to the operations discussed previously w.r.t. FIG. 16. At some point later at operation 1701, the target AI system 1620 acquires updated information related to information fields (related to transparency and/or other). At operation 1702, the target AI system 1620 sends a request for the information change for which updated information is available (if required, verification by authorized personnel is sought for first). At operation 1703, the transparency DB 1630 confirms the information change. After operation 1703, procedure 1700 may end or repeat as necessary.

### 2.10. Human Oversight Aspects

Article 14 of the [AIA] human oversight aspects, and is reproduced in Table 2.10-1.

TABLE 2.10-1
Article 14
Human oversight

| 1. | High-risk AI systems shall be designed and developed in such a way, including | |
|---|---|---|
| | with appropriate human-machine interface tools, that they can be effectively | |
| | overseen by natural persons during the period in which the AI system is in use. | |
| 2. | Human oversight shall aim at preventing or minimising the risks to health, safety | |
| | or fundamental rights that may emerge when a high-risk AI system is used in | |
| | accordance with its intended purpose or under conditions of reasonably foreseeable | |
| | misuse, in particular when such risks persist notwithstanding the application of | |
| | other requirements set out in this Chapter. | |
| 3. | Human oversight shall be ensured through either one or all of the following | |
| | measures: | |
| | (a) | identified and built, when technically feasible, into the high-risk AI system |
| | | by the provider before it is placed on the market or put into service; |
| | (b) | identified by the provider before placing the high-risk AI system on the |
| | | market or putting it into service and that are appropriate to be implemented |
| | | by the user. |
| 4. | The measures referred to in paragraph 3 shall enable the individuals to whom human | |
| | oversight is assigned to do the following, as appropriate to the circumstances: | |
| | (a) | fully understand the capacities and limitations of the high-risk AI system |
| | | and be able to duly monitor its operation, so that signs of anomalies, |
| | | dysfunctions and unexpected performance can be detected and addressed as |
| | | soon as possible; |
| | (b) | remain aware of the possible tendency of automatically relying or over- |
| | | relying on the output produced by a high-risk AI system (‘automation bias'), |
| | | in particular for high-risk AI systems used to provide information or |
| | | recommendations for decisions to be taken by natural persons; |
| | (c) | be able to correctly interpret the high-risk AI system's output, taking into |
| | | account in particular the characteristics of the system and the |
| | | interpretation tools and methods available; |
| | (d) | be able to decide, in any particular situation, not to use the high-risk AI |
| | | system or otherwise disregard, override or reverse the output of the high- |
| | | risk AI system; |
| | (e) | be able to intervene on the operation of the high-risk AI system or interrupt |
| | | the system through a “stop” button or a similar procedure. |

| | |
|---|---|
| 5. | For high-risk AI systems referred to in point 1(a) of Annex III, the measures |
| | referred to in paragraph 3 shall be such as to ensure that, in addition, no action |
| | or decision is taken by the user on the basis of the identification resulting |
| | from the system unless this has been verified and confirmed by at least two |
| | natural persons. |

In some implementations, data elements/IEs/containers containing the data in Table 2.10-2 is accessible to authorized personnel. An entirety or a subset of the data elements/IEs/containers in Table 2.10-2 can be arranged in any order identical to or different from the order shown by Table 2.10-2. Furthermore, the data elements shown by Table 2.10-2 may be divided or combined in any way, and/or additional or alternative data elements may be used. Additionally, in Table 2.10-2, the “required authorization level” may be the same or similar to those discussed previously w.r.t. Table 2.4-1, which may be defined depending on the use case or implementation. Furthermore, the “relevant metadata” may include, for example, a source of the data (ID, network address, etc.), timestamp when was the data created, validity limits (e.g., timestamp or amount of time until the data is valid), geographic restrictions, and/or any other metadata.

TABLE 2.10-2

| ID | Authorization Level | Related Metadata | Type of Information |
|---|---|---|---|
| 1 | Required | Relevant metadata | Capacities of the high-risk AI system |
| | authorization level | | |
| 2 | Required | Relevant metadata | Limitations of the high-risk AI system |
| | authorization level | | |
| 3 | Required | Relevant metadata | Information on capabilities to allow an authorized user to duly |
| | authorization level | | monitor operation of the high-risk AI system, so that signs of |
| | | | anomalies, dysfunctions, and unexpected performance can |
| | | | be detected and addressed as soon as possible. |

The information in Table 2.10-2 is made available to authorized users upon request (e.g., via AI system access 901 in FIG. 9). To meet the requirements of Article 14 [AIA], Section 4, the human oversight entity 915 and/or functionality (either as part of the AI system 902 or external to the AI system 902) provides the following features.

The human oversight entity 915 provides the requested information in Table 2.10-2 to authorized users upon request or automatically (e.g., through periodic updates of information made accessible to the authorized user). This process allows authorized users tasked with human oversight to understand the capacities and limitations of the HRAI system (e.g., AI system 902) and be able to monitor its operation, so that signs of anomalies, dysfunctions, and unexpected performance can be detected and addressed as soon as possible.

The human oversight entity 915 collects information related to the possible tendency of automatically relying or over-reliance on the output produced by a HRAI system (e.g., ‘automation bias’), in particular for HRAI systems used to provide information or recommendations for decisions to be taken by natural persons. Such information is made available to the authorized user tasked with human oversight. The process for identifying the automatic reliance (or over-reliance) on the output produced by a HRAI system (‘automation bias’) may be as follows: As the AI system (e.g., AI system 902) evolves, a set of reference input data is periodically fed to the inputs of the AI system (e.g., via AI system access 901). Then, the outputs are compared to previously obtained outputs with identical inputs to the AI system. Deviations in the generated outputs are analyzed and any (over-)reliance on the output produced by a HRAI system (‘automation bias’) is documented and made available to the authorized user tasked with human oversight. Additionally or alternatively, other forms of bias may be detected by the human oversight entity 915 such as any of the forms of bias discussed herein.

The human oversight entity 915 processes internal characteristics, data, information, and observations of the AI system (e.g., AI system 902) such that the authorized user tasked with human oversight is able to correctly interpret the HRAI system's output, taking into account the characteristics of the AI system and the interpretation tools and methods available.

The human oversight entity 915 processes internal characteristics, data, information, and observations of the AI system (e.g., AI system 902) such that the authorized user tasked with human oversight is able to decide, in any particular situation, not to use the HRAI system or otherwise disregard, override, or reverse the output of the HRAI system.

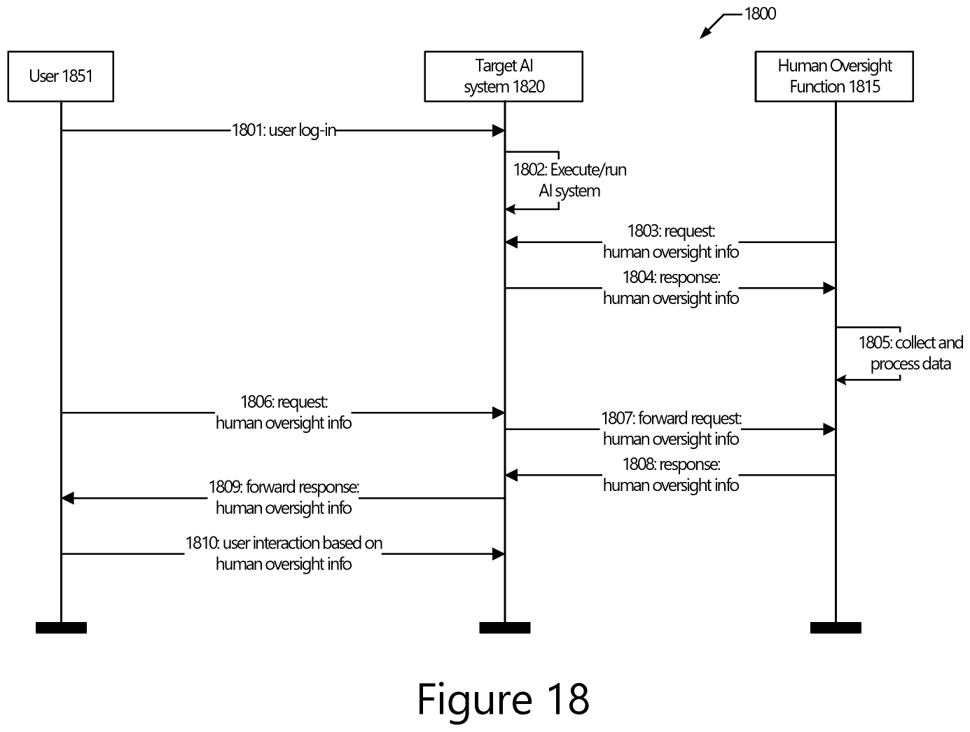

The human oversight entity 915 processes internal characteristics, data, information, and observations of the AI system (e.g., AI system 902) such that the authorized user tasked with human oversight is able to decide, in any particular situation, when to intervene on the operation of the HRAI system or interrupt the system through a “stop” button, termination or pause process, and/or a similar procedure. In these implementations. HRAI systems and/or non-HRAI systems (e.g., AI system 902) are have a “stop” button, termination or pause process, and/or a similar procedure such that the operation can be interrupted at all times. The stop button may be implemented as a physical input device (e.g., input circuitry 3586 of FIG. 35) and/or as a software based mechanism (e.g., a GUI element/object or the like). In some implementations, multiple stop buttons may be included, where a first stop button (e.g., GUI element) is a primary stop button and a second stop button (physical button(s) or switch) acts as a backup or redundancy in case first stop button malfunctions or otherwise fails to stop the AI system. This stop button may be accessible to any user or only authorized users. The stop button may be restricted (e.g., where only authorized users have access to the stop button), for example, by requiring a user to enter/input a digital certificate, a personal identification number (PIN), password, or code (e.g., one or multiple digits) to authorize usage of the stop button, using a physical key to unlock the stop button, or a combination of both and/or any other suitable means. An example of the operation of the human oversight entity 915 is shown by FIG. 18.

FIG. 18 shows an example human oversight procedure 1800. Procedure 1800 begins at operation 1801 where a user 1851 logs-in to a target AI system 1820. The target AI system 1820 may be the same or similar as the AI system 902 of FIG. 9 target AI system 1420 and/or 1620, and the user 1851 may be the same or similar as the user 1651, the AI system access 901 of FIG. 9, the UEs 3310 of FIG. 33, and/or any other compute node/device discussed herein. At operation 1802, the AI system 1820 operates (e.g., executes/runs the AI engine 910 and/or the like), which may be based on user inputs and/or commands. At operation 1803, the human oversight function 1815 requests human oversight information from the target AI system 1820, and at operation 1804, the target AI system 1820 provides the requested human oversight information to the human oversight function 1815. The human oversight information may include, for example, internal characteristics, data, information, and/or observations produced or obtained by the AI system 1820. The human oversight function 1815 may be the same or similar as the human oversight function 915 of FIG. 9.

At operation 1805, the human oversight function 1815 collects and processes data such that the authorized user tasked with human oversight is able to decide, in any particular situation, when to intervene on the operation of the HRAI system 1820 and/or interrupt the system. At operation 1806, the user 1851 request information relevant for human oversight (human oversight info), and at operation 1807, the target AI system 1820 forwards the request to the human oversight function 1815. At operation 1808 the human oversight function 1815 provides the human oversight info to the target AI system 1820, and at operation 1809 the target AI system 1820 provides the human oversight info to user 1851. At operation 1820, the user 1851 may act upon Information, for example, by interrupting the AI system 1820 using a stop button or the like. After operation 1820, procedure 1800 may end or repeat as necessary.

### 2.11. Accuracy, Robustness, and Cybersecurity Aspects

Article 15 of the [AIA] discusses aspects related to accuracy, robustness and cybersecurity, and is reproduced in Table 2.11-1.

TABLE 2.11-1
Article 15
Accuracy, robustness and cybersecurity

| | |
|---|---|
| 1. | High-risk AI systems shall be designed and developed in such a way that they |
| | achieve, in the light of their intended purpose, an appropriate level of accuracy, |
| | robustness and cybersecurity, and perform consistently in those respects |
| | throughout their lifecycle. |
| 2. | The levels of accuracy and the relevant accuracy metrics of high-risk AI systems |
| | shall be declared in the accompanying instructions of use. |
| 3. | High-risk AI systems shall be resilient as regards errors, faults or |
| | inconsistencies that may occur within the system or the environment in which the |
| | system operates, in particular due to their interaction with natural persons or |
| | other systems. |
| | The robustness of high-risk AI systems may be achieved through technical |
| | redundancy solutions, which may include backup or fail-safe plans. |
| | High-risk AI systems that continue to learn after being placed on the market or |
| | put into service shall be developed in such a way to ensure that possibly biased |
| | outputs due to outputs used as an input for future operations (‘feedback loops') |
| | are duly addressed with appropriate mitigation measures. |
| 4. | High-risk AI systems shall be resilient as regards attempts by unauthorised third |
| | parties to alter their use or performance by exploiting the system |
| | vulnerabilities. |
| | The technical solutions aimed at ensuring the cybersecurity of high-risk AI |
| | systems shall be appropriate to the relevant circumstances and the risks. |
| | The technical solutions to address AI specific vulnerabilities shall include, |
| | where appropriate, measures to prevent and control for attacks trying to |
| | manipulate the training dataset (‘data poisoning’), inputs designed to cause the |
| | model to make a mistake (‘adversarial examples'), or model flaws. |

HRAI systems and/or non-HRAI systems (e.g., AI system 902) should include technical redundancy solutions, which may include backup or fail-safe plans and/or detection and/or mitigation of biased outputs, in particular for self-learning systems. Also, access control is performed such that only authorized users are able to access to the system and are able to use the system and possibly perform harmful actions, including to manipulate the training dataset (‘data poisoning’), inputs designed to cause the model to make a mistake (adversarial examples), or model flaws.

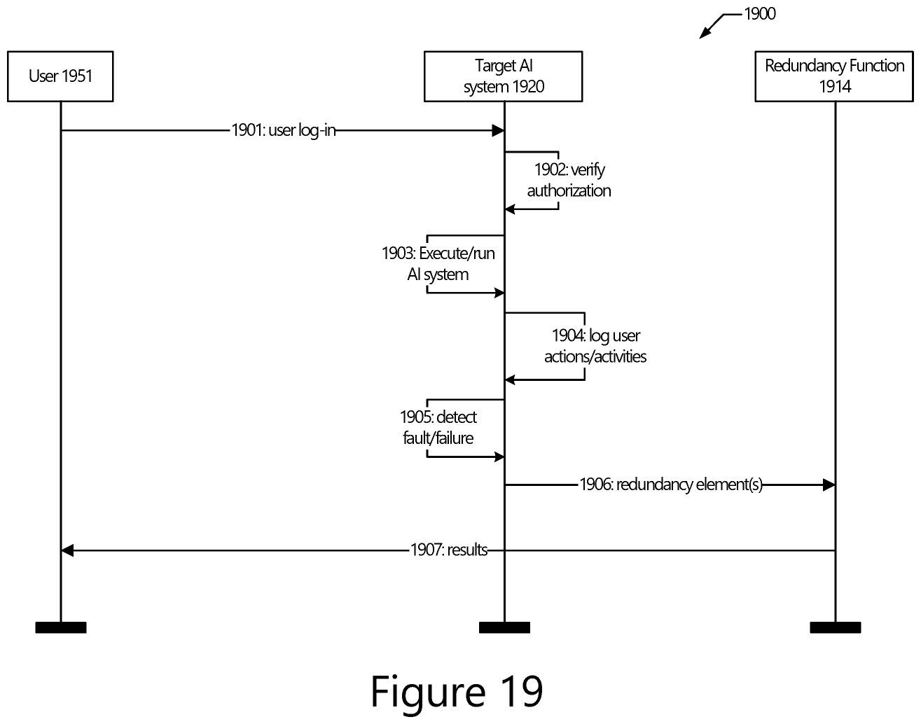

FIG. 19 shows an example procedure 1900 for usage of redundant versions of an AI system 1920 and/or its components/functions. Procedure 1900 begins at operation 1901 where a user 1951 logs-in to a target AI system 1920. The target AI system 1920 may be the same or similar as the target AI system 1420, 1620, and/or 1820, and the user 1951 may be the same or similar as the user 1851 and/or 1651, the AI system access 901 of FIG. 9, the UEs 3310 of FIG. 33, and/or any other compute node/device discussed herein. At operation 1902, the AI system 1920 verifies and/or validates the authorization level of the user 1951 (see e.g., Table 2.4-1). At operation 1903, the AI system 1920 operates (e.g., executes/runs the AI engine 910) and/or the like), which may be based on user inputs and/or commands. At operation 1904, the AI system 1920 logs all user actions, activities, and/or interactions with the AI system 1920 and/or other related/relevant systems (see e.g., FIG. 14). At operation 1905, the AI system 1920 detects a fault, failure, or malfunction of the AI system 1920 and/or some component or function of the AI system 1920 (including any of the functions/entities discussed previously w.r.t. FIG. 9). At operation 1906, redundancy elements are provided to the redundancy function 1914. The redundancy function 1914 may be the same or similar as the AI system redundancy entity 914 of FIG. 9. The redundancy elements intermediate states, data (e.g., training and/or testing datasets), AI system components, system images, and/or other like relevant elements related to the malfunctioning element of the AI system 1920. In one example, the redundancy elements include a redundant version of the AI system 1920 (or component/function thereof), which is used to continue the operation, where all related components(s) and/or data are transferred to the redundancy function 1914 (or recovered from a data storage (e.g., DB 903) where intermediate states, data, and/or system images are buffered or otherwise backed-up). At operation 1907, the redundancy function 1914 provides results to authorized users 1951. The results may include an indication of the detected fault, failure, and/or malfunction; an indication of the redundancy elements; results of recovery operations; and/or any other relevant information/data.

Furthermore, the data elements/IEs/containers containing the data in Table 2.11-2 is/are accessible to authorized personnel (e.g., as part of the redundancy elements of operation 1906, as results in operation 1907, or in response to some other request). An entirety or a subset of the data elements/IEs/containers in Table 2.11-2 can be arranged in any order identical to or different from the order shown by Table 2.11-2. Furthermore, the data elements shown by Table 2.11-2 may be divided or combined in any way, and/or additional or alternative data elements may be used. Additionally, in Table 2.11-2, the Authorization Level IE indicates the required authorization level needed to access the described information, and the “required authorization level” may be the same or similar to those discussed previously w.r.t. Table 2.4-1, which may be defined depending on the use case or implementation. Furthermore, the “relevant metadata” may include, for example, a source of the data (ID, network address, etc.), timestamp when was the data created, validity limits (e.g., timestamp or amount of time until the data is valid), geographic restrictions, and/or any other metadata.

TABLE 2.11-2

| ID | Authorization Level | Related Metadata | Type of Information |
|---|---|---|---|
| 1 | Required | Relevant metadata | Information on High-risk AI systems, detailing on how they |
| | authorization level | | are designed and developed in such a way that they achieve, |
| | | | in the light of their intended purpose, an appropriate level of |
| | | | accuracy, robustness and cybersecurity, and perform |
| | | | consistently in those respects throughout their lifecycle. |
| 2 | Required | Relevant metadata | Information on the levels of accuracy and the relevant |
| | authorization level | | accuracy metrics of high-risk AI systems. |
| 3 | Required | Relevant metadata | Information on High-risk AI systems, detailing how they are |
| | authorization level | | made resilient as regards errors, faults or inconsistencies that |
| | | | may occur within the system or the environment in which the |
| | | | system operates, in particular due to their interaction with |
| | | | natural persons or other systems. The robustness of high-risk |
| | | | AI systems may be achieved through technical redundancy |
| | | | solutions, which may include backup or fail-safe plans. |
| | | | Related details are provided. |
| 4 | Required | Relevant metadata | Information on High-risk AI systems, detailing how they are |
| | authorization level | | made resilient as regards attempts by unauthorised third |
| | | | parties to alter their use or performance by exploiting the |
| | | | system vulnerabilities. The technical solutions aimed at |
| | | | ensuring the cybersecurity of high-risk AI systems shall be |
| | | | appropriate to the relevant circumstances and the risks |

### 2.12. Obligations of Providers of High-Risk AI Systems Aspects

Article 16 of the [AIA] discusses obligations of providers of HRAI systems, and is reproduced in Table 2.12-1.

TABLE 2.12-1
Article 16
Obligations of providers of high-risk AI systems

Providers of high-risk AI systems shall:

| | |
|---|---|
| (a) | ensure that their high-risk AI systems are compliant with the requirements |
| | set out in Chapter 2 of this Title; |
| (b) | have a quality management system in place which complies with Article 17; |
| (c) | draw-up the technical documentation of the high-risk AI system; |
| (d) | when under their control, keep the logs automatically generated by their high- |
| | risk AI systems; |
| (e) | ensure that the high-risk AI system undergoes the relevant conformity |
| | assessment procedure, prior to its placing on the market or putting into |
| | service; |
| (f) | comply with the registration obligations referred to in Article 51; |
| (g) | take the necessary corrective actions, if the high-risk AI system is not in |
| | conformity with the requirements set out in Chapter 2 of this Title; |
| (h) | inform the national competent authorities of the Member States in which they |
| | made the AI system available or put it into service and, where applicable, |
| | the notified body of the non-compliance and of any corrective actions taken; |
| (i) | to affix the CE marking to their high-risk AI systems to indicate the |
| | conformity with this Regulation in accordance with Article 49; |
| (j) | upon request of a national competent authority, demonstrate the conformity of |
| | the high-risk AI system with the requirements set out in Chapter 2 of this |
| | Title. |

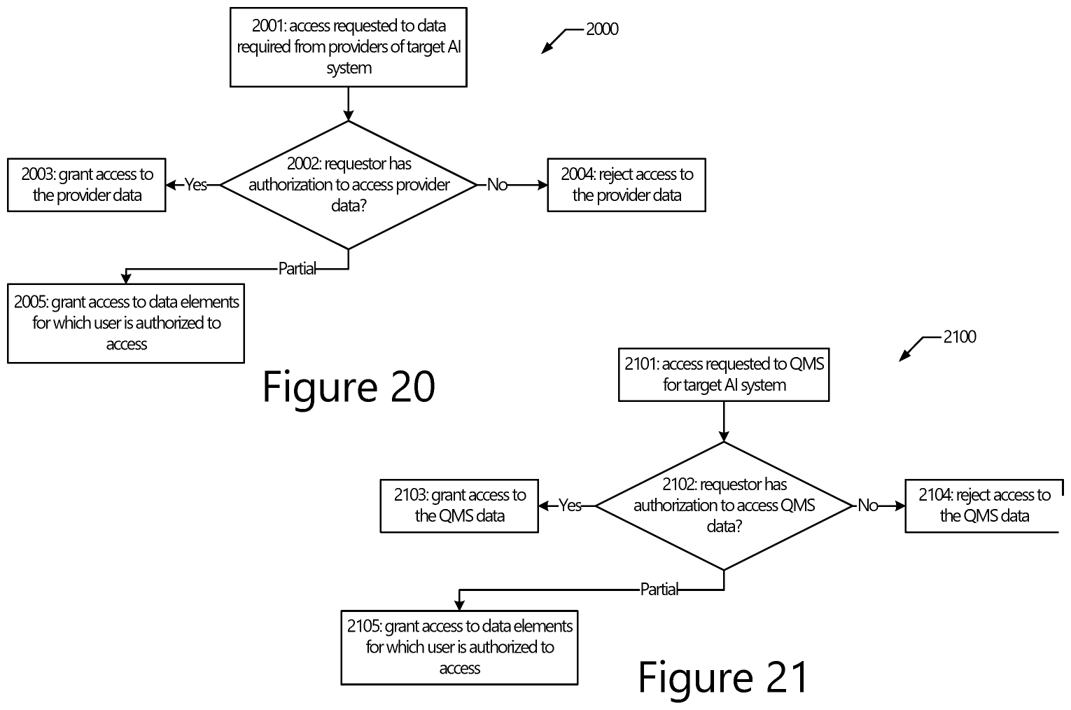

The data elements/IEs/containers containing the data in Table 2.12-2 is/are accessible to authorized personnel using the mechanism discussed infra w.r.t. FIG. 20. An entirety or a subset of the data elements/IEs/containers in Table 2.12-2 can be arranged in any order identical to or different from the order shown by Table 2.12-2. Furthermore, the data elements shown by Table 2.12-2 may be divided or combined in any way, and/or additional or alternative data elements may be used. Additionally, in Table 2.12-2, the Authorization Level IE indicates the required authorization level needed to access the described information, and the “required authorization level” may be the same or similar to those discussed previously w.r.t. Table 2.4-1, which may be defined depending on the use case or implementation. Furthermore, the “relevant metadata” may include, for example, a source of the data (ID, network address, etc.), timestamp when was the data created, validity limits (e.g., timestamp or amount of time until the data is valid), geographic restrictions, and/or any other metadata.

TABLE 2.12-2

| | Authorization | | |
|---|---|---|---|
| ID | Level | Related Metadata | Type of Information |
| 1 | Required | Relevant metadata | Information on how it is ensured that the high-risk AI systems |
| | authorization level | | are compliant with the requirements set out in Chapter 2 of |
| | | | [AIA]. |
| 2 | Required | Relevant metadata | Information related to the quality management system which |
| | authorization level | | is in place which complies with Article 17 of [AIA]. |
| 3 | Required | Relevant metadata | Technical documentation of the high-risk (and/or non-high- |
| | authorization level | | risk) AI system. |
| 4 | Required | Relevant metadata | If applicable, provide information on how the logs are kept |
| | authorization level | | automatically generated by their high-risk (and/or non-high- |
| | | | risk) AI systems. |
| 5 | Required | Relevant metadata | Information on how it is ensured that the high-risk AI system |
| | authorization level | | was undergoing the relevant conformity assessment |
| | | | procedure, prior to its placing on the market or putting into |
| | | | service. |
| 6 | Required | Relevant metadata | Information on how it is ensured that the high-risk and/or non- |
| | authorization level | | high-risk AI system complies with the registration obligations |
| | | | referred to in Article 51 of [AIA]. |
| 7 | Required | Relevant metadata | Information on how the necessary corrective actions are |
| | authorization level | | taken, if the high-risk AI system is not in conformity with the |
| | | | requirements set out in Chapter 2 of [AIA]. |
| 8 | Required | Relevant metadata | Details on the information made available to the national |
| | authorization level | | competent authorities of the Member States in which they |
| | | | made the AI system available or put it into service and, where |
| | | | applicable, the notified body of the non-compliance and of |
| | | | any corrective actions taken. |

FIG. 20 shows a process 2000 for access to data required from providers of HRAI systems and/or non-HRAI systems. Process 2000 begins at operation 2001 where access is requested to data from providers of a one or more AI systems (e.g., via AI system access 901 of FIG. 9 and/or the like). At operation 2002, the system (e.g., AI system 902 and/or target AI systems 1420, 1620, 1820, and/or 1920 discussed previously) determines whether the requestor (e.g., a user of AI system access 901 of FIG. 9) has authorization to the requested provider data. If the requestor does have adequate authorization, at operation 2003, the system grants access to the requested provider data. If the requestor does not have adequate authorization, at operation 2004, the system rejects the requested provider data. If the requestor has partial authorization (e.g., authorization for some but not all of the requested data), at operation 2005, the system grants access to records/data to which the requestor has adequate authorization. After operations 2003, 2004, or 2005, process 2000 may end or repeat as necessary.

### 2.13. Quality Management Systems Aspects

Article 17 of the [AIA] discusses aspects of quality management systems, and is reproduced in Table 2.13-1.

TABLE 2.13-1
Article 17
Quality management system

| 1. | Providers of high-risk AI systems shall put a quality management system in place | |
|---|---|---|
| | that ensures compliance with this Regulation. That system shall be documented in | |
| | a systematic and orderly manner in the form of written policies, procedures and | |
| | instructions, and shall include at least the following aspects: | |
| | (a) | a strategy for regulatory compliance, including compliance with conformity |
| | | assessment procedures and procedures for the management of modifications to |
| | | the high-risk AI system; |
| | (b) | techniques, procedures and systematic actions to be used for the design, |
| | | design control and design verification of the high-risk AI system; |
| | (c) | techniques, procedures and systematic actions to be used for the development, |
| | | quality control and quality assurance of the high-risk AI system; |
| | (d) | examination, test and validation procedures to be carried out before, during |
| | | and after the development of the high-risk AI system, and the frequency with |
| | | which they have to be carried out; |
| | (e) | technical specifications, including standards, to be applied and, where the |
| | | relevant harmonised standards are not applied in full, the means to be used |
| | | to ensure that the high-risk AI system complies with the requirements set |
| | | out in Chapter 2 of this Title; |
| | (f) | systems and procedures for data management, including data collection, data |
| | | analysis, data labelling, data storage, data filtration, data mining, data |
| | | aggregation, data retention and any other operation regarding the data that |
| | | is performed before and for the purposes of the placing on the market or |
| | | putting into service of high-risk AI systems; |
| | (g) | the risk management system referred to in Article 9; |
| | (h) | the setting-up, implementation and maintenance of a post-market monitoring |
| | | system, in accordance with Article 61; |
| | (i) | procedures related to the reporting of serious |
| | | malfunctioning in accordance with Article 62; incidents and of |
| | (j) | the handling of communication with national competent authorities, competent |
| | | authorities, including sectoral ones, providing or supporting the access to |
| | | data, notified bodies, other operators, customers or other interested |
| | | parties; |
| | (k) | systems and procedures for record keeping of all relevant documentation and |
| | | information; |
| | (l) | resource management, including security of supply related measures; |
| | (m) | an accountability framework setting out the responsibilities of the |
| | | management and other staff with regard to all aspects listed in this |
| | | paragraph. |

| | |
|---|---|
| 2. | The implementation of aspects referred to in paragraph 1 shall be proportionate |
| | to the size of the provider's organisation. |
| 3. | For providers that are credit institutions regulated by Directive 2013/36/ EU, |
| | the obligation to put a quality management system in place shall be deemed to be |
| | fulfilled by complying with the rules on internal governance arrangements, |
| | processes and mechanisms pursuant to Article 74 of that Directive. In that |
| | context, any harmonised standards referred to in Article 40 of this Regulation |
| | shall be taken into account. |

The data elements/IEs/containers containing the data in Table 2.13-2 is/are accessible to authorized personnel using the mechanism discussed infra w.r.t. FIG. 21. An entirety or a subset of the data elements/IEs/containers in Table 2.13-2 can be arranged in any order identical to or different from the order shown by Table 2.13-2. Furthermore, the data elements shown by Table 2.13-2 may be divided or combined in any way, and/or additional or alternative data elements may be used. Additionally, in Table 2.13-2, the Authorization Level IE indicates the required authorization level needed to access the described information, and the “required authorization level” may be the same or similar to those discussed previously w.r.t. Table 2.4-1, which may be defined depending on the use case or implementation. Furthermore, the “relevant metadata” may include, for example, a source of the data (ID, network address, etc.), timestamp when was the data created, validity limits (e.g., timestamp or amount of time until the data is valid), geographic restrictions, and/or any other metadata

TABLE 2.13-2

| | Authorization | | |
|---|---|---|---|
| ID | Level | Related Metadata | Type of Information |
| 1 | Required | Relevant metadata | Information on a strategy for regulatory compliance, including |
| | authorization level | | compliance with conformity assessment procedures and |
| | | | procedures for the management of modifications to the high- |
| | | | risk AI system. |
| 2 | Required | Relevant metadata | Information on techniques, procedures and systematic |
| | authorization level | | actions which are used for the design, design control and |
| | | | design verification of the high-risk AI system. |
| 3 | Required | Relevant metadata | techniques, procedures and systematic actions which are |
| | authorization level | | used for the development, quality control and quality |
| | | | assurance of the high-risk AI system. |
| 4 | Required | Relevant metadata | Information on examination, test and validation procedures |
| | authorization level | | which are carried out before, during and after the |
| | | | development of the high-risk AI system, and the frequency |
| | | | with which they have to be carried out. |
| 5 | Required | Relevant metadata | technical specifications, including standards, to be applied |
| | authorization level | | and, where the relevant harmonised standards are not |
| | | | applied in full, the means to be used to ensure that the high- |
| | | | risk AI system complies with the requirements set out in |
| | | | [AIA], Chapter 2. |
| 6 | Required | Relevant metadata | Information on systems and procedures for data |
| | authorization level | | management, including data collection, data analysis, data |
| | | | labelling, data storage, data filtration, data mining, data |
| | | | aggregation, data retention and any other operation |
| | | | regarding the data that is performed before and for the |
| | | | purposes of the placing on the market or putting into service |
| | | | of high-risk AI systems. |
| 7 | Required | Relevant metadata | Information on the implementation/specification of the risk |
| | authorization level | | management system referred to in [AIA], Article 9. |
| 8 | Required | Relevant metadata | Information on the setting-up, implementation and |
| | authorization level | | maintenance of a post-market monitoring system, in |
| | | | accordance with [AIA], Article 61. |
| 9 | Required | Relevant metadata | Information on procedures related to the reporting of serious |
| | authorization level | | incidents and of malfunctioning in accordance with [AIA], |
| | | | Article 62. |
| 10 | Required | Relevant metadata | Information on the handling of communication with national |
| | authorization level | | competent authorities, competent authorities, including |
| | | | sectoral ones, providing or supporting the access to data, |
| | | | notified bodies, other operators, customers or other |
| | | | interested parties. |
| 11 | Required | Relevant metadata | Information on systems and procedures for record keeping of |
| | authorization level | | all relevant documentation and information. |
| 12 | Required | Relevant metadata | Information for resource management, including security of |
| | authorization level | | supply related measures. |
| 13 | Required | Relevant metadata | Information on an accountability framework setting out the |
| | authorization level | | responsibilities of the management and other staff with |
| | | | regard to all aspects listed in this paragraph. |

FIG. 21 shows an example process 2100 for management of access to quality management system (QMS) information according to various embodiments. Process 2100 begins at operation 2101 where access is requested to QMS information/data of one or more AI systems (e.g., via AI system access 901 of FIG. 9). At operation 2102, the system (e.g., AI system 900 and/or target AI systems 1420, 1620, 1820, and/or 1920 discussed previously) determines whether the requestor (e.g., a user as discussed previously w.r.t. FIG. 9) has authorization to the requested QMS data. If the requestor does have adequate authorization, at operation 2103, the system grants access to the requested QMS data. If the requestor does not have adequate authorization, at operation 2104, the system rejects the requested QMS data. If the requestor has partial authorization (e.g., authorization for some but not all of the requested data), at operation 2105, the system grants access to QMS data elements to which the requestor has adequate authorization. After operations 2103, 2104, or 2105, process 2100 may end or repeat as necessary.

### 2.14. Obligation to Draw Up Technical Documentation Aspects

Article 18 of the [AIA] discusses obligations to draw up technical documentation, and is reproduces by Table 2.14-1.

TABLE 2.14-1
Article 18
Obligation to draw up technical documentation

| | |
|---|---|
| 1. | Providers of high-risk AI systems shall draw up the technical |
| | documentation referred to in Article 11 in accordance with |
| | Annex IV. |
| 2. | Providers that are credit institutions regulated by Directive |
| | 2013/36/EU shall maintain the technical documentation as part of |
| | the documentation concerning internal governance, arrangements, |
| | processes and mechanisms pursuant to Article 74 of that Directive. |

FIG. 22 shows a process 2200 for processing information on technical documentation for AI systems according to various embodiments. Process 2200 begins at operation 2201 where information/data on available technical information is supplied (e.g., via AI system access 901 of FIG. 9) to a target AI system (e.g., AI system 902 and/or target AI systems 1420, 1620, 1820, and/or 1920 discussed previously). At operation 2202, the system (e.g., AI system 900 and/or target AI systems 1420, 1620, 1820, and/or 1920 discussed previously) determines whether the technical info meets the requirements for the target AI system. If the technical info does meet the requirements, at operation 2203, the system grants access to the target AI system. If the technical info does not meet the requirements, at operation 2204, the system rejects access to the target AI system. After operations 2203 or 2204, process 2200 may end or repeat as necessary.

### 3. Aspects Related to Draft EU Standardization Request in Support of Artificial Intelligence Regulation

As mentioned previously, the [AIA] introduces a list of so-called HRAI systems and related requirements to be met for HRAI systems. The European Council is currently proposing to extend the list of HRAI systems and to include digital infrastructure (see e.g., COMMISSION IMPLEMENTING DECISION of XXX on a standardisation request to the European Standardisation Organisations in support of safe and trustworthy artificial intelligence, European Commission, Brussels, XXX (20 May 2022) (“[AIA-SR]”)). The [AIA-SR] is basically a draft standardization request (SR) to the multi-stakeholder platforms (MSPs) as well as to European Standardisation Organisations (ESOs). The [AIA-SR] implies the inclusion of network infrastructure, including cellular infrastructure, into the HRAI systems list by the [AIA], which would mean that network elements that incorporate AI systems or components would need to meet the requirements of the [AIA]. Since the [AIA] is not yet finalized and published, the [AIA-SR] will not require ESOs to develop harmonised European norms (HENs), but other types of deliverables, including non-harmonised European norms (ENs).

Current regulatory approaches that focus on AI systems holistically, and their testing, have been more limited. For example, manufacturers implement proprietary and/or other measures to address various requirements introduced by the [AIA] such as those related to mitigating bias (e.g., one group of users is disadvantaged versus another group of users) based on general frameworks and best practices, yet more detailed and technical prescribed holistic and testing requirements in European standards will now be introduced in the context of the [AIA].

The [AIA-SR] is likely to be the basis for developing future standards, including testing protocols, in order to verify the compliance to those requirements. The present disclosure provides solutions meeting the requirements of the [AIA-SR] in support of the [AIA]. The present disclosure builds on concepts of ['215] and sections 1-2 (supra), and includes solutions for meeting the specific requirements outlined in the [AIA-SR]. Section 1 (supra) and ['320] discuss the specific requirements originating from the assignment of the HRAI category. The discussion infra discusses a different set of requirements that are complementary to those in sections 1-2 (supra) and ['320], and those introduced by the [AIA-SR].

In particular, the following discussion addresses the specific requirements of the [AIA] and the related [AIA-SR] for (1) risk management systems for AI systems to ensure proper risk management on the level of the “overall product”—with the AI system being part of such an “overall product”; (2) data and data governance to ensure that datasets are only used if they are properly verified to meet all requirements of the AI regulation; (3) record keeping through built-in logging capabilities to ensure that AI system inputs/outputs and internal state information is suitably recorded and made available to an authorized supervisor/use R (4) transparency and information to the users to enable the authorized user to understand the operation of the AI system; (5) human oversight mechanisms to interact with the authorized user and enable the authorized user to supervise the AI system; (6) accuracy specifications for AI systems to determine the accuracy of the concerned AI system; (7) robustness specifications for AI systems to determine the robustness of the concerned AI system; (8) cybersecurity specifications for AI systems to protect the AI system against cyber-attacks, data breaches, and/or other vulnerabilities; (9) quality management systems for providers of AI systems, including post-market monitoring process to measure and evaluate the quality of the AI system; and (10) conformity assessment for AI systems to suitable assess the conformity of the AI system. The implementations discussed infra can be used to ensure that AI systems are in compliance to the requirements outlined in the [AIA] and refined through the related [AIA-SR]. The various example implementations discussed herein improve the functioning of the AI systems themselves and/or computing devices/systems that use or operate such AI systems by reducing the amount of time and/or computing resources needed to ensure compliance with the [AIA], as refined through the [AIA-SR] and/or future standardization efforts. Moreover, because the [AIA] addresses the various risks and benefits associated with AI, the various examples discussed herein allow AI systems to be developed in a secure, trustworthy, and ethical manner in ways that consume less time and computing resources than existing AI development techniques.

### 3.1. AI System Monitoring, Evaluation, and Reporting Arrangements

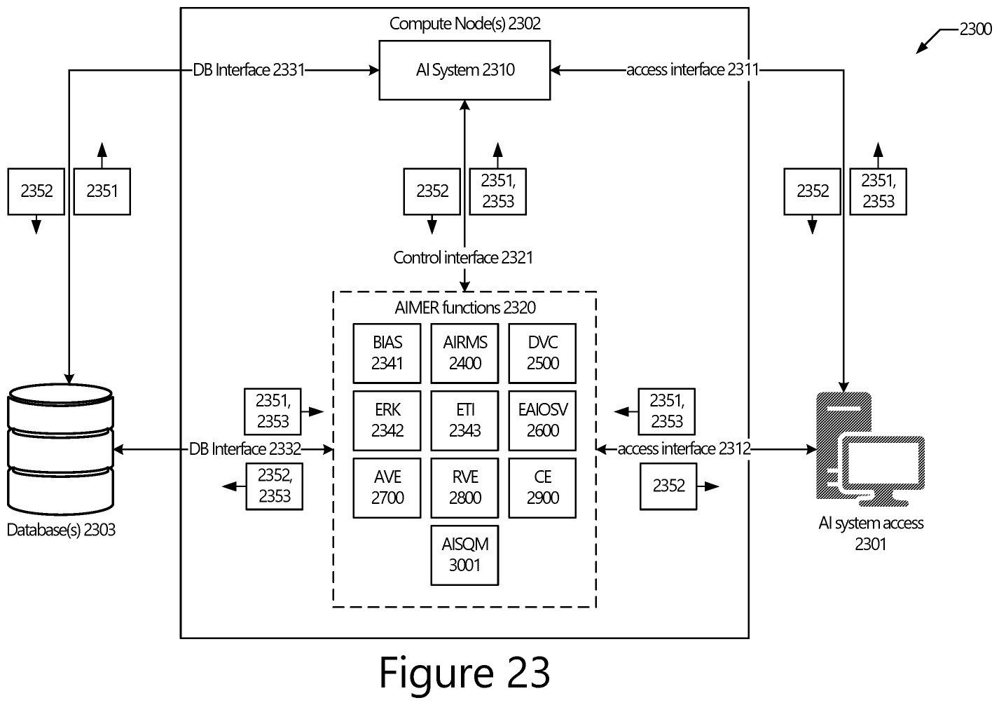

FIG. 23 shows an example AI system monitoring, evaluation, and reporting (AIMER) arrangement 2300, which includes one or more compute nodes 2302 that is communicatively coupled with the one or more DBs 2303 and the AI system access 2301. The compute node(s) 2302 can be any type of computing device or system such as, for example, one or more laptops, one or more desktop computers, one or more workstations, one or more gaming consoles, one or more virtual reality (VR) and/or augmented reality (AR) headsets, one or more head-up display devices, one or more servers in a data center, one or more edge compute nodes of an edge computing network, one or more cloud compute nodes of a cloud computing service, one or more NANs (e.g., one or more cellular base stations, WLAN access points, and/or the like), one or more network functions in a core network (e.g., a cellular core network), one or more virtual machines and/or virtualization containers, one or more sensors, one or more IoT devices, one or more (semi-)autonomous systems, one or more satellites, compute nodes of a management and/or orchestration system (e.g., management entities for digital infrastructure), any type of device or system that can be is considered to be high risk and/or any other risk level as defined by the [AIA] such as a biometric detection system, and/or any other device or system such as any of those discussed herein.

The compute node(s) 2302 include an AI system 2310 communicatively coupled with one or more AIMER functions 2320. In various implementations, the AI system 2310 is the same or similar as the AI system 902 and/or the target AI systems 1420, 1620, 1820, and/or 1920 discussed previously. The AI system 2310 contains input/output reference points and/or interfaces 2311, 2321, and 2331 as shown by FIG. 23. The inputs 2351 and outputs 2352 of the AI system 2310 are used to interact with other AIMER functions 2320 of the overall product (e.g., compute node(s) 2302).

The AI system access 2301 is a system or device that is authorized and/or capable of accessing the AI system 2310 to obtain AI services (e.g., provide inputs 2351 and/or obtain outputs 2352), perform human oversight (e.g., verify correct operation of the AI system 2310), and/or perform other tasks and/or obtain other services. The DB(s) 2303 store or otherwise include various data (e.g., some or all of the inputs 2351) such as, for example, reference training data, logs and/or logging data of user activities, logs and/or logging data of AI system behaviors, and/or other types of data. In various implementations, the AI system access 2301 and the DB(s) 2303 are the same or similar as the AI system access 901 and the DB(s) 903, respectively.

The AI system 2310 interacts with authorized users (e.g., using AI system access 2301) via an access interface 2311 and interacts with the DB(s) 4103 via a DB interface 2331. The AI system 2310 uses these interfaces 2311, 2331 to obtain inputs 2351 from the DB(s) 2303 and/or the AI system access 2301, obtain one or more actions 2353 from the AI system access 2301, and provide outputs 2352 to the DB(s) 2303 for storage and/or the AI system access 2301 for various purposes. The AI system 2310 can also interact with the one or more AIMER functions 2320 via a control interface 2321. The control interface 2321 (also referred to as a “configuration interface 2321”) allows the AI system 2310 to obtain inputs 2351 and/or actions 2353 from the AIMER function(s) 2320, and/or provide outputs 2352 to the AIMER function(s) 2320. Additionally or alternatively, the AIMER function(s) 2320 interact with the AI system access 2301 and the DB(s) 2303 via access interface 2311 and DB interface 2332, respectively. These interfaces 2312, 2332 to communicate inputs 2351, outputs 2352, and/or actions 2353 with the AI system access 2301 and the DB(s) 2303. Additionally or alternatively, the inputs 2351, outputs 2352, and/or actions 2353 can be obtained and/or provided to other components, devices, and/or systems other than those shown. Additionally or alternatively, the inputs 2351, outputs 2352, and/or actions 2353 can be conveyed in one or more data units, using a streaming mechanism, or using some other suitable communication means.

The inputs 2351 can include various data and/or datasets such as, for example, training data, validation data, testing data, input data, and/or inference data. These data and/or datasets may include various types of data (e.g., sensor data, video/image data, user data, text corpus, and/or other types of data). The data included in the inputs 2351 may depend on the AI/ML domain or AI/ML tasks to be performed by the AI system 2310 or otherwise related to the AI system 2310. An AI/ML task describes a desired problem to be solved (or a combination of a dataset with features and a target), an AI/ML domain describes a desired goal to be achieved, and an AI/Ml objective describes a metric that an AI/ML model or algorithm is attempting to optimize or solve. Examples of AI/ML tasks include clustering, classification, regression, anomaly detection, data cleaning, automated ML (autoML), association rules learning, reinforcement learning, structured prediction, feature engineering, feature learning, online learning, supervised learning, semi-supervised learning (SSL), unsupervised learning, machine learned ranking (MLR), grammar induction, and/or the like. Examples of AI/ML domains include, reasoning and problem solving, knowledge representation and/or ontology, automated planning, natural language processing (NLP), perception (e.g., computer vision, speech recognition, etc.), autonomous motion and manipulation (e.g., localization, robotic movement/travel, autonomous driving, and/or the like), and social intelligence.

The outputs 2352 include data based on processes, algorithms, and/or models operated or executed by the AI system 2310, and can include, for example, decisions, configuration information, actions, predictions, inferences, and/or the like. Additionally or alternatively, the outputs 2352 can include metrics, measurements, and/or other aspects related to the operation of the AI system 2310 including, for example, evaluation metrics, and/or the like.

The actions 2353 include triggers, commands, parameters, and/or data for operating and/or controlling the AI system 2310. The actions 2353 can be in the form of one or more triggers, commands, instructions, messages, data, metadata, parameters, variables, methods, functions, and/or some other suitable data structure. For purposes of the present disclosure, the term “actions 2353” or the like can refer to one or more specific actions to be performed, instructions or indications of one or more actions to be performed, and/or data associated with one or more actions to be performed. Examples of the actions 2353 can include start, stop, pause, or terminate execution or operation of one or more models of the AI system 2310; start, stop, pause, or terminate measurement, metric collection, and/or data collection; start, stop, pause, or terminate training of one or more models of the AI system 2310; configurations including operational parameters (e.g., tuning parameters for tuning model parameters and/or hyperparameters of the one or more models) and/or configuration aspects related to the AI system 2310; and/or other triggers, commands, parameters, and/or data; alerts, messages, indicators, and/or other data structures associated with the performance of one or more actions, tasks, events, and the like.

The AIMER function(s) 2320 include various functions or elements that monitor, evaluate, and report aspects of the AI system 2310, and can control the AI system 2310 to enforce compliance with the [AIA] and/or [AIA-SR]. In this example, one of the AIMER function(s) 2320 includes a bias detector 2341 (labeled “BIAS 2341” in FIG. 23). The bias detector 2341 performs one or more procedures for detecting biases in various data related to the operation of the AI system 2341. The bias detector 2341 can identify and/or detect biases, for example, through observing and analyzing various statistics, measurements, and/or metrics of AI decision, inference, and/or prediction generation across various HRAI classifications (see e.g., Table 1.2-1 supra) and/or one or more special categories of personal data referred to in Article 9(1) of Regulation (EU) 2016/679 (see e.g., Regulation (EU) 2016/679 of the European Parliament and of the Council of 27 Apr. 2016 on the protection of natural persons with regard to the processing of personal data and on the free movement of such data, and repealing Directive 95/46/EC (General Data Protection Regulation), Official Journal of the European Union, L 119, pp. 1-88 (4 May 2016), the contents of which are hereby incorporated by reference in its entirety), Article 10 of Directive (EU) 2016/680 (see e.g., Directive (EU) 2016/680 of the European Parliament and of the Council of 27 Apr. 2016 on the protection of natural persons with regard to the processing of personal data by competent authorities for the purposes of the prevention, investigation, detection or prosecution of criminal offences or the execution of criminal penalties, and on the free movement of such data, and repealing Council Framework Decision 2008/977/JHA, Official Journal of the European Union, L 119, pp. 89-131 (4 May 2016), the contents of which are hereby incorporated by reference in its entirety), and/or Article 10(1) of Regulation (EU) 2018/1725 (see e.g., Regulation (EU) 2018/1725 of the European Parliament and of the Council of 23 Oct. 2018 on the protection of natural persons with regard to the processing of personal data by the Union institutions, bodies, offices and agencies and on the free movement of such data, and repealing Regulation (EC) No 45/2001 and Decision No 1247/2002/EC (Text with EEA relevance), PE/31/2018/REV/1, Official Journal of the European Union, L 295, pp. 39-98 (21 Nov. 2018), the contents of which are hereby incorporated by reference in its entirety). In one example, the bias detector 2341 determines whether users or groups of users of different racial or ethnic origins, political opinions, religious or philosophical beliefs, trade union membership, and so forth are treated differently in identical or substantially similar circumstances and/or in a non-trivial or statistically significant manner. If the statistics, metrics, measurements, and the like indicated that different classes are being treated differently (while controlling for circumstances, features, or other parameters), then the AI system 2310 has indeed developed some biases, and corresponding remedial measures need to be taken to remove or otherwise correct the biases. For example, the AI system 2310 can be retrained using different training datasets, and/or the operation of the AI system 2310 needs to be interrupted or terminated.

Additionally or alternatively, as discussed in more detail infra, the AIMER function(s) 2320 can include an AI risk management system function (AIRMS) 2400, a data verification component (DVC) 2500, an entity for record keeping (ERK) 2342, an entity for transparency and information (ETI) 2343, an entity for AI output self-verification (EAIOSV) 2600, an accuracy verification entity (AVE) 2700, a robustness verification entity (RVE) 2800, cryptographic engine (CE) 2900, and an AI system quality manager (AISQM) 3000.

### 3.2. Risk Management System for AI Systems

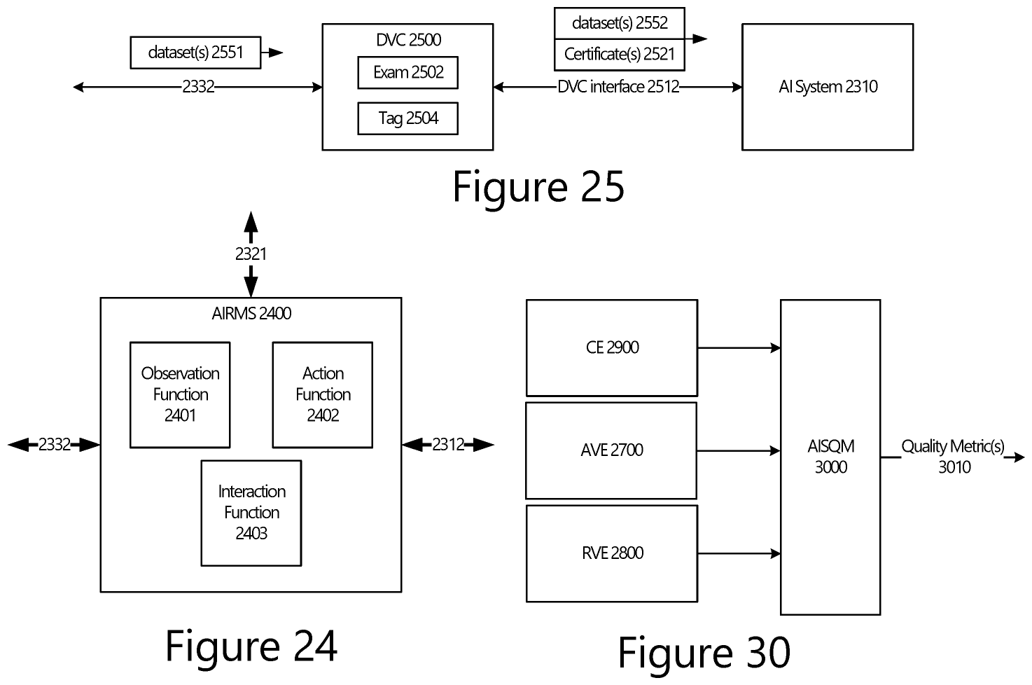

FIG. 24 shows an example AIRMS 2400, which is an example implementation solution to meet the risk management system requirements of the [AIA-SR] as shown by Table 3.2-1.

TABLE 3.2-1

| | |
|---|---|
| 2.1 | Risk management system for AI systems |
| | This (these) European standard(s) or European standardisation |
| | deliverable(s) shall set up specifications for a risk management |
| | system for AI systems. Risk management should be intended as a |
| | continuous iterative process run throughout the entire lifecycle |
| | of the AI system which is aimed at preventing or minimising the |
| | relevant risks to health, safety or fundamental rights. |
| | Specifications shall be drafted in such a way that, for AI systems |
| | which are safety components of products, the risk management |
| | system aspects related to the AI system may be integrated into |
| | the risk management system for the overall product. |

The AIRMS 2400 uses the control interface 2321 to interact with AI system 2310 including providing various inputs 2351 and/or actions (e.g., triggers and/or the like) 2353 to the AI system 2310, and can receive outputs 2352 from the AI system 2310. The DB interface 2332 acts as a verification interface (e.g., “verification interface 2332”) for verifying database entries in DB(s) 2303. The AIRMS 2400 can also send actions/triggers/commands 2352 to the DB(s) 2303 to change various database entries (e.g., erase erroneous training datasets, and/or the like). Additionally, the access interface 2312 allows for interaction with authorized users to, for example, monitor the AI system 2310, force actions 2352 upon the AI system 2310, and the like. In some implementations, the AIRMS 2400 can be complemented by a security feature that controls access to the AIRMS 2400, for example, through an appropriate authorization and/or authentication mechanism such that only authorized entities/users are able to interact with the AIRMS 2400 through, for example, the AI system access 2301.

In various implementations, the AIRMS 2400 can have the following functions: observation function 2401, an action function 2402, and an interaction functions 2403. The observation function 2401 observes, monitors, and/or collects inputs 2351 and/or outputs 2352 of the AI system 2310 (or individual components of the AI system 2310), which is part of the overall product (e.g., the compute node(s) 2302). In particular, the observation function 2401 of the AIRMS 2400 evaluates whether the AI system 2310 operates as intended and/or does not violate any of the [AIA] requirements, such as those related to the technical requirements of [AIA] Articles 9 through 19. For example, the observation function 2401 of the AIRMS 2400 verifies whether the AI system 2310 is properly trained such that the training data 2351 is completely or substantially free of errors and possibly biased outputs, and/or whether detected errors and/or biased outputs 2352 are duly addressed with one or more appropriate mitigation measures. In some implementations, the observation function 2401 performs this verification based on third party indicators collected by the AIRMS 2400 (or the observation function 2401) or via some other entity. In case the requirements are not met (e.g., biases are detected), it can be assumed that the AI system 2310 has indeed developed biases and corresponding measures should be taken to remediate the biases (e.g., the AI system 2310 should be retrained and/or the operation of the AI system 2310 needs to be interrupted). In some implementations, the observation function 2401 issues or otherwise generates an alarm, message, and/or other indication (e.g., as outputs 2352) to the AI system 2310, the AI system access 2301 and/or to DB(s) 2303. As examples, the alarm/indication can be or include any suitable visual, audible, haptic outputs 2352 such as textual and/or graphical messages, alarm sounds, flashing visual lights, and/or the like in order to communicate a detected violation of any of the [AIA] requirements. In some implementations, the alarm, message, and/or other indication (e.g., as outputs 2352) to the AI system 2310, the AI system access 2301 and/or to DB(s) 2303 can be generated and sent by the action function 2402 and/or the interaction function 2403. In some implementations, the observation function 2401 obtains bias indicators from the bias detector 2341. In other implementations, the bias detector 2341 is part of the observation function 2401.

The action function 2402 of AIRMS 2400 can force or otherwise instructing the AI system 2310 to perform one or more actions 2350, where action instructions 2353 are issued or otherwise conveyed through the control interface 2321 that allows for the configuration of the AI system 2310 and/or other interaction with the AI system 2310. Depending on the findings of the observation function 2401 and/or the bias detector 2341 (e.g., observations, metrics, measurements, and the like), the action function 2402 can determine actions 2353 to be taken by the AI system 2310 and can trigger the determined actions 2353 through the corresponding control interface 2321 for the AI system 2310. For example, in case that biases are detected, the action function 2402 can force or otherwise control the AI system 2310, through the configuration interface 2321, to retrain one or more AI/ML models, interrupt (e.g., stop, pause, or terminate) the operation of the AI system 2310, and/or cause any other suitable measure/action 2353 to be taken by sending an appropriate trigger, message, or other data structure to the AI system 2310. In some implementations, this process (e.g., triggering some action 2353) may become active during a critical high risk operation. In some cases, interrupting the operation of the AI system 2310 may be more harmful/dangerous than continuing in the short term, and in such a cases, one or more self learning and correction actions 2353 may first be applied, then a report or log can be generated, and then a series of different levels of other actions 2353 can be taken depending on the risk levels involved (e.g., a notification or alarm for lower risk activities versus shutting down the AI system 2310 and/or some other direct intervention for higher risk activities).

The interaction function 2403 can be used to interact with one or more users via the access interface 2312 and the AI system access 2301 (not shown by FIG. 24) to provide authorized users with information about the state of the AI system 2310 at various points in time. The interaction function 2403 can generate reports and/or other user interfaces, which can be provided to the AI system access 2301 (not shown by FIG. 24) as one or more outputs 2352. In various implementations, the interaction function 2403 can provide the following information to authorized users upon request: (i) historic input and/or historic output data received and/or generated by the AI system 2310, which may be available over the entire lifetime of the AI system 2310 or available for a predetermined duration (e.g., hourly, daily, weekly, monthly, annually, and/or the like); and (ii) statistics on the historic input and/or historic output data received and/or generated by the AI system 2310. In some implementations, the statistics can enable the user to identify whether there are any issues with the AI system 2310 (e.g., the AI system 2310 starts developing biases where different groups of individuals are treated differently in the same or similar circumstances, for example, users originating from one geographic region are treated differently compared to users originating from another geographic region). Additionally or alternatively, the user is able to trigger actions 2353 through the user interfaces provided by the interaction function 2403. Here, the interaction function 2403 forwards the actions 2353 (or indications of such actions 2353) to the AI system 2310 through the action function 2402 and the control interface 2321. For example, the user can indicate a desire to force a retraining of the AI system 2310 through the user interface, force the AI system 2310 to use different training datasets, force the AI system 2310 to terminate its operation, request the AI system 2310 to provide further metrics for verification, force the AI system 2310 to only operate for specific use cases/applications (e.g., non-safety critical use cases/applications, non-high risk use cases/applications, and/or the like) and to terminate operation for other use cases/applications (e.g., high risk use cases/applications).

### 3.3. Data and Data Governance

FIG. 25 shows an example DVC 2500, which is an example implementation solution to meet the data governance requirements of the [AIA-SR] as shown by Table 3.3-1.

TABLE 3.3-1

| 2.2 | Data and data governance | |
|---|---|---|
| | This (these) European standard(s) or European standardisation | |
| | deliverable(s) shall include: | |
| | (a) | Specifications for adequate data governance and data |
| | | management procedures to be implemented by providers of AI |
| | | systems (with specific focus on data generation and collection, |
| | | data preparation operations, design choices, procedures for |
| | | detecting and addressing biases or any other relevant |
| | | shortcomings in data), |
| | (b) | Specifications on quality aspects of datasets used to train, |
| | | validate and test AI systems (including representativeness, |
| | | relevance, completeness, correctness). |

FIG. 25 shows an example verification of datasets for the AI system 2310 using the DVC 2500. Here, new, raw, or otherwise unverified datasets 2551 are provided for usage by the AI system 2310, where the DVC 2500 obtains the datasets 2551 over the DB interface 2332. In other implementations, the datasets 2551 can be received over the access interface 2312. The DVC 2500 performs one or more verification and/or validation tests on the datasets 2551 to determine whether the datasets 2551 meet the [AIA] requirements. When the datasets 2551 are determined to be valid or are verified, the validated datasets 2552 is complemented by a digital certificate 2521 or any other type of validity information, which can be used by the AI system 2310 for training, testing, validation, and/or other actions or tasks. The DVC 2500 sends the verified/validated datasets 2552 to the AI system 2310 over a DVC interface 2512. In some implementations, the DVC interface 2512 may correspond to the control interface 2321 or some other interface.

As discussed previously, biases can be identified and/or detected (e.g., by the bias detector 2341 and/or the AIRMS 2400), for example, through observing and analyzing various statistics, measurements, and/or metrics of AI decision/inference/prediction generation across different HRAI classifications (see e.g., Table 1.2-1 supra) and/or special categories of personal data referred to in Article 9(1) of Regulation (EU) 2016/679, Article 10 of Directive (EU) 2016/680, and/or Article 10(1) of Regulation (EU) 2018/1725. The detected or identified biases may be based on quality issues of training data, testing data, validation data, and the like. The DVC 2500) is used to address quality issues of the datasets 2551 used to train, validate, and/or test AI system(s) 2310, including representativeness, relevance, completeness, correctness, and/or other aspects.

In some implementations, the DVC 2500 can include an examination component 2502 that examines incoming datasets 2551 and assesses whether those datasets 2551 are suitable to train, validate, and/or test the AI system 2310 (or individual components of the AI system 2310). This examination and/or verification can be done using various strategies. One strategy can involve training a copy or mirrored version of the AI system 2310 (or copies of the relevant components of the AI system 2310), which is only used for testing/verification purposes. This version of the AI system 2310 (or relevant components) can be sandboxed or operated within a virtualized environment (e.g., using one or more virtual machines and/or virtualization containers). Then, the AI system 2310 is fed with (random) input data (datasets), vectors, weights (ML biases), and/or other parameters to verify the outputs with the [AIA] requirements. The examination component 2502 can determine or identify biased outputs, for example, through observing statistics of the AI decision making, predictions, and/or inferences across different user groups and/or classifications.

In some implementations, the examination component 2502 obtains bias indicators from the bias detector 2341 for this purpose, while in other implementations, the bias detector 2341 is, or is part of, the examination component 2502.

In some implementations, verification data (datasets), vectors, weights (ML biases), and/or other parameters to can be specifically designed to test whether biases are present in the AI system 2310. In particular, the verification datasets, vectors, features, and/or parameters can have specific values and/or compositions of user groups or classifications that are defined a-priori. In one example, one or more user groups are defined according to ITU regions as shown by Table 3.3-2.

TABLE 3.3-2

| ITU Region | Description |
|---|---|
| Region 1 | Europe, Africa, the Commonwealth of Independent States, |
| | Mongolia, and the Middle East west of the Persian Gulf |
| | including Iraq |
| Region 2 | Americas, Greenland, some eastern Pacific Islands |
| Region 3 | Non-Former Soviet Union (FSU) Asian states east of and |
| | including Iran, and most of Oceania |

In case different user groups are treated differently in identical and/or similar circumstances, it can be assumed that the AI system 2310 has indeed developed biases and corresponding measures need to be taken as discussed previously. In case the dataset 2551 meets all applicable requirements, the certificate 2521 may be added to the dataset 2551 (e.g., producing dataset 2552) such that the AI system 2310 is able to use the verified and validated dataset 2552.

In some implementations, the DVC 2500 can include a tagging component 2504 that tags valid datasets 2552 with a suitable certificate 2521 before being passed to the AI system 2310. The tagging component 2504 may tag a valid dataset 2552 with a certificate 2521 using suitable mechanisms including, for example, adding the certificate 2521 or a suitable reference to the certificate 2521 to a header or metadata section of the dataset 2551, 2552 and/or the like. A valid dataset 2552 is a dataset that meets or fulfills some or all of the [AIA] requirements. When an AI system 2310 receives a dataset 2552, the AI system 2310 also verifies the validity of the certificate 2521 before implemented the dataset 2552. In some implementations, the verification is performed by a separate internal or external verification component. The AI system 2310 implements the dataset 2552 when the dataset 2552 is determined to be verified or otherwise approved (e.g., meeting some or all requirements of the [AIA] including representativeness, relevance, completeness, and/or correctness). Otherwise, the AI system 2310 rejects and/or discards the dataset 2552. In case of rejection, an authorized user may be informed (via the AI system access 2301) so that the user can take appropriate actions (e.g., provide another dataset 2551 with a corresponding certificate or the like).

The certificate 2521 contains some proof of validity of the dataset 2551, 2552. In some implementations, the certificate 2521 includes information about the dataset 2551, 2552, and can include a public key associated with the dataset 2551, 2552 which is then encrypted using a private key of an issuer of the certificate 2521. Additionally or alternatively, the certificate 2521 can include one or more of the following pieces of information: a subject of the certificate 2521, which is a party to which the certificate 2521 is issued and/or an owner of an associated public key (e.g., an ID and/or other information about the an owner, developer, and/or aggregator of the data in the dataset 2551, 2552); an issuer identity/identifier (ID), which identifies the issuer that has signed and issued the certificate 2521; a validity period, which is a time limit or TTL for the validity of the certificate 2521; subject public key information, which includes the public key owned by the subject of the certificate 2521 and/or indicates the algorithm with which the key is used; a usage ID, which indicates the intended use or purpose of the certificate 2521; an issuer signature, which is a digital signature of an entity that has verified the certificate's 2521 contents and/or the data in the dataset 2551, 2552; a public key owned by the issuer; a random value or nonce; information about the dataset 2551, 2552 itself; and/or other like information.

The certificate 2521 can be issued or otherwise provided by a suitable (“in-house” or third party) issuer such as, for example, a verification body, a notified body, certificate authority (CA) (e.g., a root CA or the like), an enrollment authority (EA), an authorization authority (AA), and/or the like. In various implementations, the AI system 2310 (or an internal/external verification component) is able to verify the certificate 2521 (or a signature included in the certificate 2521) through appropriate cryptographic mechanisms. If the certificate 2521 (or a signature included in the certificate 2521) is valid, and the AI system 2310 (or an internal/external verification component) examining the certificate trusts the issuer, then the AI system 2310 can use dataset 2551, 2552 and/or use the key to decrypt the dataset 2551, 2552. The digital certificates discussed herein may be in the X.509 format and/or some other suitable format, and may be signed using any suitable cryptographic mechanisms such as Elliptic Curve cryptography Digital Signature Algorithm (ECDSA) or some other suitable algorithm such as any of those discussed herein. Additionally or alternatively, the various key pairs discussed herein may be generated using an Elliptic Curve cryptography Key Agreement algorithm (ECKA) or some other suitable key generation algorithm such as any of those discussed herein. The certificates may include various certificates issued by the an issuer or CA as delineated by relevant Certificate Authority Security Council (CASC) standards, Common Computing Security Standards Forum (CCSF) standards, CA/Browser Forum standards, GSMA standards, ETSI standards, GlobalPlatform standards, and/or some other suitable standard.

In some implementations, the certificate 2521 may have a limited lifetime, validity period, or time-to-live (TTL). The validity period of the certificate 2521, and thus of the dataset 2552, may be chosen as appropriate, including an unlimited validity period, a validity period limited to minutes, hours, days, weeks, months, years, decades, centuries, and/or the like. After expiration of this limited lifetime, validity period, or TTL, the certificate 2521 is no longer valid and a new or updated certificate 2521 needs to be requested from the concerned issuer. When the new and valid certificate 2521 is made available, the AI system 2310 can use the dataset 2551, 2552, for example to train, validate, and/or test one or more AI/ML models and/or the AI system 2310 itself, among performing other actions or tasks on the dataset 2551, 2552.

### 3.4. Record Keeping Through Built-In Logging Capabilities

Referring back to FIG. 23, the AIMER function(s) 2320 includes an ERK 2342, which is an example implementation solution to meet the record keeping requirements of the [AIA-SR] as shown by Table 3.4-1.

TABLE 3.4-1

| | |
|---|---|
| 2.3 | Record keeping through built-in logging capabilities |
| | This European standard shall include specifications for automatic |
| | logging of events for AI systems. Those specifications shall enable |
| | the traceability of those systems throughout their lifecycle as |
| | well as the monitoring of their operations and shall facilitate |
| | the post-market monitoring of the AI systems by the providers. |

The ERK 2342 accesses or otherwise obtains inputs 2351, outputs 2352, and/or internal states of the AI system 2310. Here, the inputs 2351 and/or the outputs 2352 can include the actions 2353 discussed previously. In some examples, the inputs 2351 and/or the outputs 2352 include original (e.g., raw) data that is not processed and/or includes processed data (e.g., statistics, or data that is transformed, translated, transcoded, or otherwise manipulated in some way). The internal states of the AI system 2310 are related to the operational and/or system states of the AI processor or engine 910 and/or the self-assessment elements 921 (e.g., the RRI 911, the self-verification entity 917, the risk mitigation entity 912, the AI system management entity 913, the human oversight entity 915, the AI system redundancy entity 914, and/or the record keeping entity 916 discussed previously w.r.t. FIG. 9).

The inputs 2351, the outputs 2352, and/or the internal states of the AI system 2310 are recorded, logged, and/or stored by the ERK 2342 in one or more internal DB(s) or external or remote DB(s) 2303. The ERK 2342 can send the data to the external DB(s) 2303 over the DB interface 2332. Additionally or alternatively, the ERK 2342 can request records from the internal DB(s) and/or the external DB(s) 2302 over the DB interface 2332. Additionally or alternatively, historic and/or current records related to the operation of the AI system 2310 (e.g., raw data and/or processed data) can be made available by the ERK 2342 to an authorized user either directly over the access interface 2312 or through the human oversight entity 915.

The data can be stored without further processing (e.g., “as is”) and/or after some processing. The post-processing involves performing some transformations and/or analysis on the recorded/logged data for storage in the DB(s), which may require less memory than storing raw, unprocessed data (e.g., statistics and/or analytics associated with the inputs 2351, the outputs 2352, and/or the internal states) Also, the information on internal states of the AI system 2310 may include information on key behavior of the AI system 2310, for example, whether the AI system 2310 has, or is likely to develop one or more biases. This data can then be used to monitor for eventual development of biases. For example, statistics and/or analytics data may be defined on how the AI system 2310 decisions, inferences, and/or predictions relate to different user groups or other classifications. These statistics can be (quasi-)identical across various user groups or classifications.

The ERK 2342 can be implemented within the AI system 2310 (not shown by FIG. 23), within the same compute node(s) 2302 as the AI system 2310 but separate from the AI system 2310 (as shown by FIG. 23), or external or remote from the compute node(s) 2302 and the AI system 2310 (not shown by FIG. 23). When the ERK 2342 is implemented within the AI system 2310, the ERK 2342 accesses or otherwise obtains inputs 2351, outputs 2352, and/or internal states of the AI system 2310, for example, as they are provided to the AI system 2310 and/or generated by the AI system 2310 to be provided to external entities.

When the ERK 2342 is implemented by the same compute node(s) 2302 that implement the AI system 2310, but is implemented as a separate entity from the AI system 2310, the ERK 2342 accesses or otherwise obtains the inputs 2351, outputs 2352, actions 2353, and/or internal states of the AI system 2310 via the control interface 2321. Additionally or alternatively, the ERK 2342 can access the inputs 2351, outputs 2352, and/or actions 2353 via the DB interface 2332 and/or the access interface 2312. Additionally or alternatively, the ERK 2342 can use the control interface 2321 to interact with AI system 2310. For example, the ERK 2342 can send actions/triggers 2353 to the AI system 2310 to request or otherwise cause the AI system 2310 to provide internal state information, data of other external triggers, and/or other like data/information. When the ERK 2342 is implemented by an entity external to the compute node(s) 2302 and the AI system 2310, the ERK 2342 accesses or otherwise obtains the inputs 2351, outputs 2352, actions 2353, and/or internal states of the AI system 2310 via some combination of the control interface 2321, the access interface 2312, DB interface 2332, and/or some other interfaces.

### 3.5. Transparency and Information to the Users

Referring back to FIG. 23, the AIMER function(s) 2320 include an ETI 2343, which is an example implementation solution to meet the transparency requirements of the [AIA-SR] as shown by Table 3.5-1.

TABLE 3.5-1

| 2.4 | Transparency and information to the users | |
|---|---|---|
| | This (these) European standard(s) or European standardisation | |
| | deliverable(s) shall provide specifications related to: | |
| | (a) | design and development solutions which ensure transparency |
| | | of the operation of the AI system to enable users to understand |
| | | the system's output and use it appropriately |
| | (b) | instructions for use accompanying AI systems, including |
| | | instructions on the system's capabilities and limitations as |
| | | well as on maintenance and care measures, taking into particular |
| | | account: |

| | |
|---|---|
| (i) | The need to identify and appropriately distinguish |
| | information, which is relevant and comprehensible for |
| | different professional user profiles and lay users |
| (ii) | Without prejudice to point (i), the need to ensure that |
| | identified information is sufficient to enable users to |
| | interpret the system's output and use it appropriately |

In various implementations, based on a request by an authorized user, the ETI 2343 can provide various information and/or instructions (e.g., as outputs 2352) on the AI system's 2310 capabilities and/or limitations as well as information on the AI system's 2310 maintenance and care measures. In some implementations, this information (e.g., outputs 2352) can include explanatory text, audio, image, video, and/or other media/content, which can be read or otherwise understood or consumable by the authorized user. Additionally or alternatively, the information (e.g., outputs 2352) can be complemented by a machine-readable instructions or data that may also include definitions of the usage of the interface into ETI 2343 in order to request current status information for example, information related to capabilities of the AI system 2310, and information related to maintenance and care measures. Additionally or alternatively, the capability and maintenance information can be provided to different users at various levels of detail. In some implementations, the level of detail of the information provided to a user can be based on a role assigned to the user and/or permissions and/or authorization levels assigned to that user.

The information related to capabilities of the AI system 2310 (also referred to as “capability information” or the like) include or indicate various functionalities and/or capabilities of the AI system 2310 and/or individual components of the AI system 2310. The capability information can take current configurations and/or parameters of the AI system 2310 into account, for example, the functionalities and/or capabilities of the AI system 2310 can be reduced or extended depending on the configurations and/or parameters set by an authorized user. Also, the functionalities and capabilities of an AI system 2310 may change depending on the type of application, AI/Ml objectives, AI/ML tasks, and/or AI/ML domain of the AI system 2310. For example, for HRAI systems (as defined by the [AIA] and/or as discussed previously), certain surveillance functionalities may be activated, which are not required for non-HRAI systems. In this example, the risk mitigation entity 912 can be switched off in case a non-HRAI application is executed on or by the AI system 2310, and for HRAI application, the risk mitigation entity 912 can be switched on again.

The information related to maintenance and care measures (also referred to as “maintenance information”, “care information”, “M&C information”, or the like) includes data about maintaining [AIA] compliance of the AI system 2310. Here, “maintenance” may refer to processes, tasks, or actions that promote the continuity of physical and/or digital products, services, and/or infrastructure in order to ensure they continue to operate as designed or as intended. Maintenance and care measures can include monitoring the AI system 2310 and making relatively small changes over time to ensure equitable outcomes are achieved, maintaining up-to-date documentation that allows for audits and accountability, or otherwise maintaining [AIA] compliance. Examples of maintenance and care measures include the validation of the training status of the AI system 2310 (e.g., when a verification of whether the AI system 2310 has failed, when the AI system 2310 has been determined to have developed biases, and/or the like), one or more maintenance actions 2353 or tasks that have been trigger or are scheduled to take place, and/or other like information.

Additionally or alternatively, based on a request by an authorized user, the ETI 2343 can provide various information and/or instructions (e.g., as outputs 2352) to ensure transparency of the operation of the AI system 2310 to enable users to understand the AI system's 2310 output 2352 and use it appropriately. In some implementations, the operational transparency information can be provided to different users at various levels of detail. The level of detail of the information provided to a user can be based on a role assigned to the user and/or permissions and/or authorization levels assigned to that user. As examples, the operational transparency information can include self-assessment data, and raw historic data, and processed historic data.

The self-assessment data includes any data or information related to self-assessments performed by the AI system 2310. In various implementations, the AI system 2310 performs one or more self-assessments of its own operations. These self-assessments can include the various processes, methods, tasks, and/or actions performed by one or more AIMER function(s) 2320) and/or one or more of the self-assessment elements 921 as discussed in the present disclosure. For example, the AI system 2310 can identify whether any biases have been observed or detected, whether any erroneous decisions have been made based on the detected biases (e.g., possibly putting the user at risk), and/or the like. A result of the self-assessment can then be communicated to the requestor indicating whether or not the AI system 2310 is performing appropriately and/or in compliance with the [AIA]. In some implementations, the self-assessment is the most abstracted level of information. In case that the AI system 2310 is not performing appropriately and/or is not in [AIA] compliance, one or more actions 2353 can be triggered to remediate the issues. These actions 2353 can be automatically initiated or based on intervention by an authorized user.

The raw historic data includes information or data related to previously provided or generated inputs 2351, outputs 2352, actions 2353, configurations, statuses, and/or internal states of the AI system 2310. In some implementations, the raw historic data is the most detailed level of information. As alluded to previously, the ERK 2342 previously stored inputs/outputs/configuration/status of the AI system 2310 in DB(s) 2303. Upon the request by the authorized user, the ETI 2343 can recover or otherwise obtain the relevant transparency data from the DB(s) 2303, and transfer the transparency data to the authorized user.

The processed historic data includes processed or manipulated information or data related to previously provided or generated inputs 2351, outputs 2352, actions 2353, configurations, statuses, and/or internal states of the AI system 2310. In some implementations, the processed historic data is an intermediate level of information, which is less abstracted than the self-assessment data and more abstracted than the raw historic data. Additionally or alternatively, the processed historic data can be split or divided into multiple levels, which can provide options for multiple levels of detail to be provided to authorized users (e.g., in a same or similar manner as discussed previously) in order to understand the current operational status of the AI system 2310. Examples of processed historic data include one or more subsets of the raw historic data (e.g., samples of the raw historic data arranged according to different data types, time periods, and/or any other suitable classification, which may have the same or different sample sizes), statistics and/or other analytics information generated based on the raw historic data, and/or other transformation or manipulations of the raw historic data. Additionally or alternatively, the raw historic data can be processed as it is collected or generated (e.g., “on-the-fly” or using stream processing techniques), or the raw historic data may can be processed after the authorized user requests the transparency data.

In any of the aforementioned implementations, the various types of transparency information can be requested by authorized users (e.g., using a pull approach, an asynchronous API call, and/or the like), or authorized users can be automatically provided with such information (e.g., using a push approach or publish/subscribe approach) when (or shortly before) the transparency information is generated (e.g., when relevant maintenance and care measures are required, when self-assessment data is available, or the like) or on a cyclical or periodic basis. In the example of FIG. 23, the ETI 2343 uses the control interface 2321 to interact with AI system 2310, as well as to send inputs 2351 and/or actions/triggers 2353 to the AI system 2310. The ETI 2343 uses the DB interface 2332 to request historic data from the DB(s) 2303, and also uses the access interface 2312 to interact with authorized users (e.g., to provide the aforementioned transparency data to the authorized users).

### 3.6. Human Oversight

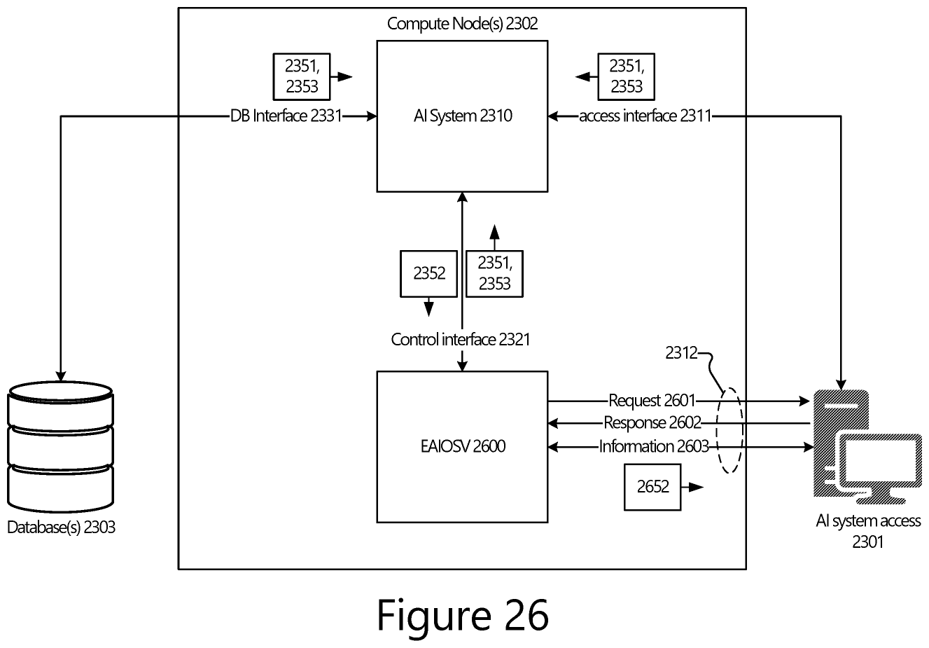

FIG. 26 shows an example operation of the EAIOSV 2600, which is an example implementation solution to meet the human oversight requirements of the [AIA-SR] as shown by Table 3.6-1.

TABLE 3.6-1

| 2.5 | Human oversight | |
|---|---|---|
| | This (these) European standard(s) or European standardisation | |
| | deliverable(s) shall specify measures and procedures for human | |
| | oversight of AI systems which are: | |
| | (a) | identified and built, when technically feasible, into |
| | | the high-risk AI system by the provider before it is |
| | | placed on the market or put into service; |
| | (b) | identified by the provider before placing the high- |
| | | risk AI system on the market or putting it into service |
| | | and that are appropriate to be implemented by the user. |

These shall include measures enabling users to understand, monitor,
interpret, assess and intervene in relevant aspects of the operation of
the high-risk AI system.
This (these) European standard(s) or European standardisation
deliverable(s) shall also define, where justified, appropriate
oversight measures which are specific to certain AI systems in
consideration of their intended purpose. With respect to AI systems
intended for remote biometric identification of persons, human
oversight measures shall inter alia ensure that no action or
decision is taken by the user on the basis of the identification
resulting from the system unless this has been separately verified
and confirmed by at least two natural persons.

In various implementations, the outputs 2352 of the AI system 2310 are double-checked and validated before they are used for any objective (e.g., as a decision to signaling an actuator to change the state of a system, as a prediction or inference to evaluate a human or object, as a decision to take an action, and/or the like). Because the AI/ML application, AI/Ml objectives, AI/ML tasks, and/or AI/ML domain of the AI system 2310 is likely to have an effect on the severity of the consequences of an inappropriate decision, prediction, or inference, the EAIOSV 2600 performs self-verification of the outputs 2352 (e.g., including predictions) before the outputs 2352 can be used to take an action.

In some implementations, the EAIOSV 2600 performs self-verification of the outputs 2352 of the AI system 2310. Here, the output 2352 of the AI system 2310 (e.g., a prediction) is fed into the EAIOSV 2600, and the EAIOSV 2600 verifies the plausibility of the prediction or otherwise evaluates the obtained prediction. In some examples, the EAIOSV 2600 verifies or otherwise evaluates the obtained prediction based on a comparison of the obtained prediction with one or more historical predictions retrieved from the internal/external DB(s) 2303. For example, the EAIOSV 2600 can determine that bias exists in the obtained prediction based on the amount that the obtained prediction diverges from the a historical prediction (or an average of historical predictions). Additionally or alternatively, the EAIOSV 2600 (or the bias detector 2341) can use an alternation function to alternate the values of one or more parameters and/or attributes of an AI/ML model and/or component of the AI system 2310, which creates two different predictions, and then the EAIOSV 2600 can evaluate the divergence or other differences between the predictions from the AI system 2310 with the swapped parameter/attribute values. In any of the aforementioned implementations, the divergence or difference between the predictions can be, or be based on, a Kullback-Leibler (KL) divergence, a contrastive divergence, confusion matrices, and/or the like. Additionally or alternatively, the EAIOSV 2600 can be an AI/ML model that is trained using counterfactual examples to predict whether the obtained prediction is biased w.r.t. historical predictions and/or predictions from alternation models. These training counterfactual examples can be based on known or hypothetical AI decision(s) that could potentially harm or cause damage to an individual human or object.

In case the verification leads to the assessment that the obtained prediction could potential cause harm or damage, then suitable counter measures/actions 2353 can be taken, for example, preventing outputs 2352 of the AI system 2310 from being fed to other devices or systems (e.g., actuators, or the like), and an authorized user can be informed about the possibly problematic decision of the AI system 2310 and/or the counter measures/actions 2353 via the access interface 2312. Additionally or alternatively, validated/authorized outputs 2652 of the AI system 2310 can be provided to authorized users over the access interface 2312.

Additionally or alternatively, authorized users can be required to validate the outputs 2352 of AI system 2310, or at least confirm or accept the verification provided by the EAIOSV 2600. In this case, some or all of the predictions provided by the AI system 2310 can be manually validated by one or multiple authorized users, which may be required for some HRAI systems such as biometric detection systems (see e.g., [AIA-SR] Annex II, section 2.5, as shown by Table 3.6-1). In these implementations, the EAIOSV 2600 is extended to include or provide an interface to communicate or convey the proposed decision or prediction together with accompanying information to better understand the context of proposed decision or prediction, including certain input data 2351, internal states, and/or configuration information of the AI system 2310 so the authorized user(s) can validate or reject the decision.

Receive a response includes (manual) validation or rejection of decisions (outputs) of AI system 2310|.

As an example, the EAIOSV 2600 can send a request 2601 to authorized user(s) over the access interface 2312 to request validation/confirmation of the potential predictions/decisions provided by the AI system 2310. Then, the authorized user(s) provide a response 2602 including validation or rejection of the potential predictions/decisions via the AI system access 2301 and the access interface 2312. If the potential predictions/decisions are accepted by the authorized user(s), then the EAIOSV 2600 can provide the predictions/decisions to the intended recipients. In case of rejection or inaction by the authorized user(s), the potential predictions/decisions are held back or discarded, and not forwarded to the related intended recipients. In some implementations, information can be forwarded to the intended recipients of the potential predictions/decisions indicating that the potential predictions/decisions was rejected and cannot be provided, and can include reasons why the potential predictions/decisions were rejected. Additionally or alternatively, the response 2602 can include a request for additional information about the potential predictions/decisions, and the EAIOSV 2600 provides additional information 2603 to the authorized user(s) via the access interface 2312 and the AI system access 2301. The information 2603 can include any of the various information, metrics, measurements, historical data, and/or other data discussed herein. Then, an additional response 2602 can then be provided by the AI system access 2301 to reject/accept the potential predictions/decisions as discussed previously.

### 3.7. Accuracy Specifications for AI Systems

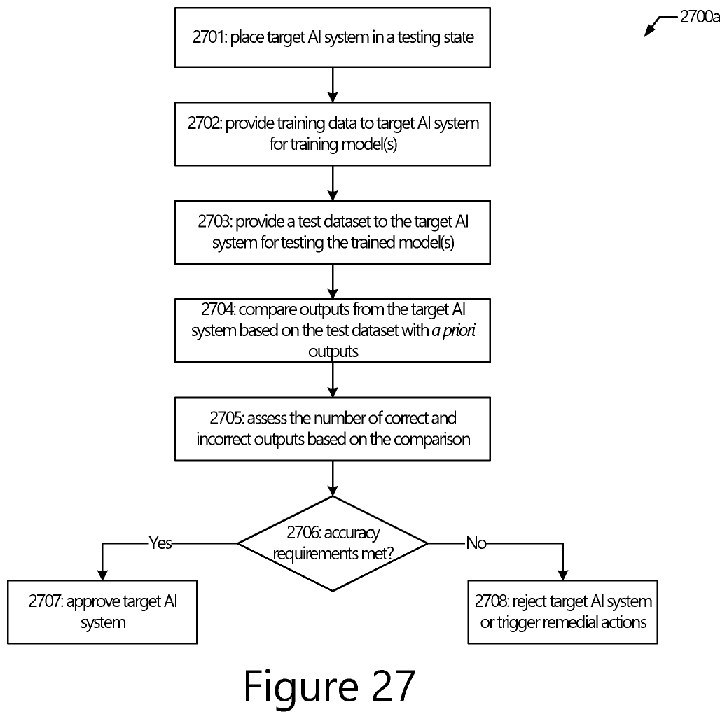

FIG. 27 shows an example accuracy verification process 2700a (performed by the AVE 2700), which is an example implementation solution to meet the accuracy requirements of the [AIA-SR] as shown by Table 3.7-1.

TABLE 3.7-1

| | |
|---|---|
| 2.6 | Accuracy specifications for AI systems |
| | This (these) European standard(s) or European standardisation |
| | deliverable(s) shall lay down specifications for ensuring an |
| | appropriate level of accuracy of AI systems and for allowing |
| | providers to declare the relevant accuracy metrics and levels. |
| | This (these) European standard(s) or European standardisation |
| | deliverable(s) shall also define, where justified, a set of |
| | appropriate and relevant tools and metrics to measure |
| | accuracy against suitably defined levels, which are specific to |
| | certain AI systems in consideration of their intended purpose. |

The accuracy verification process 2700a is an example methodology that can be used in order to assess the accuracy of an AI system 2310 for a specific AI/ML application, use case, AI/ML task, AI/ML domain, and/or AI/ML objective. The execution/operation of process 2700a is conducted through the AVE 2700. Process 2700a begins at operation 2701 where a target AI system 2310 is placed in a testing state (or test mode), which may prevent the target AI system 2310 from sending outputs 2352 to external entities/elements. At operation 2702, training data is provided to a target AI system 2310 to train one or more AI/ML models of the target AI system 2310 to meet the [AIA-SR] accuracy requirements for a specific AI/ML application, use case, AI/ML task. AI/ML domain, and/or AI/ML objective. In other implementations, an already-trained model can provided to the AI system 2310 at operation 2701. The one or more models are then trained using the provided training dataset. The AVE 2700 coordinates the provision of relevant training datasets (or trained AI/ML models) to the AI system 2310 for training the AI system 2310.

At operation 2703, a test dataset is given to the AI system 2310, which are used to test the trained AI/ML models. The test dataset can include set of pre-approved and/or validated test input vectors. The known or correct outputs (e.g., decisions, predictions, or inferences) of the AI system 2310 for the test dataset is known a priori. For example, the correct outputs can include a number of detectable objects and the types of objects that should be detected in a set of images or video data for a computer vision or object detection application. The AVE 2700 coordinates the provision of relevant test datasets to the AI system 2310 for testing the accuracy of the AI system 2310.

At operation 2704, the actual outputs 2352 of the AI system 2310 based on the test dataset are obtained and compared to the a priori known/correct outputs. In one example, the decisions (outputs) of the AI system 2310 for each of the inputs in the test dataset is compared to respective decisions (outputs) of the AI system 2310. In some cases, the test dataset may change over time based on the AI learnings, can be recalibrated automatically, or provided to an authorized user to update as desired.

At operation 2705, the number of correct decisions or predictions and/or a number incorrect decisions or predictions is determined based on the comparison at operation 2704. At operation 2706, the AVE 2700 determines whether the accuracy requirements are met based on the number of correct and/or incorrect predictions/decisions. In one example, the AVE 2700 declares that the accuracy requirements to not be met (e.g., the target AI system 2310 is considered to be inadequate for the concerned application, use case, task, domain, or objective) when a ratio of incorrect decisions to the total number of tests is above a predefined or configured threshold. In another example, the AVE 2700 declares that the accuracy requirements to not be met when a ratio of incorrect decisions to correct decisions is above a predefined or configured threshold. In another example, the AVE 2700 declares that the accuracy requirements to not be met when a number incorrect decisions is greater than a number correct decisions. The aforementioned thresholds may be defined individually for a specific application, use case, task, domain, or objective. For example, the threshold for very high risk AI applications, use cases, tasks, domains, or objectives (e.g., biometric detection) may be a relatively low number of incorrect decisions, whereas AI applications, use cases, tasks, domains, or objectives having lower risk tolerance may have threshold allowing for more incorrect decisions or predictions. Other metrics and/or accuracy evaluations may be used in other implementations.

If at operation 2706 the AVE 2700 determines that the decisions or predictions meet the accuracy requirements, then the AVE 2700 proceeds to operation 2707 to approve the target AI system 2310. In case that the target AI system 2310 is authorized to operate, a corresponding trigger/action 2353 can be sent to the target AI system 2310 through the control interface 2321 indicating or instructing the target AI system 2310 to exit the test state. When the approval action/trigger 2353 is received at the AI system 2310, the AI system 2310 may operate outside of a test mode or testing state to provide the decisions or predictions to the intended recipients. Additionally or alternatively, the AVE 2700 can provide the approved decisions or predictions to the intended recipients. In some implementations, the AVE 2700 can provide corresponding authorization codes/confirmations upon request (e.g., using pull mechanisms) or automatically or periodically after verification (e.g., using push mechanisms) to other relevant entities of the compute node(s) 2702 and/or other intended recipients to indicate that the AI system 2310 has met the accuracy requirements. Additionally or alternatively, the approval action/trigger 2353 may include a time limitation or TTL after which the accuracy verification (e.g., AVE process 2700a) would need to be repeated. Other actions/triggers 2353 can also be issued based on the application, use case, domain, task, and/or objective. If at operation 2705 the AVE 2700 determines that the decisions or predictions do not meet the accuracy requirements, then the AVE 2700 proceeds to operation 2707 to reject the target AI system 2310 and issues one or more remedial actions/triggers 2353 such as any of those discussed herein. After operation 2705 or 2706, process 2700a may end or repeat as necessary.

### 3.8. Robustness Specifications for AI Systems

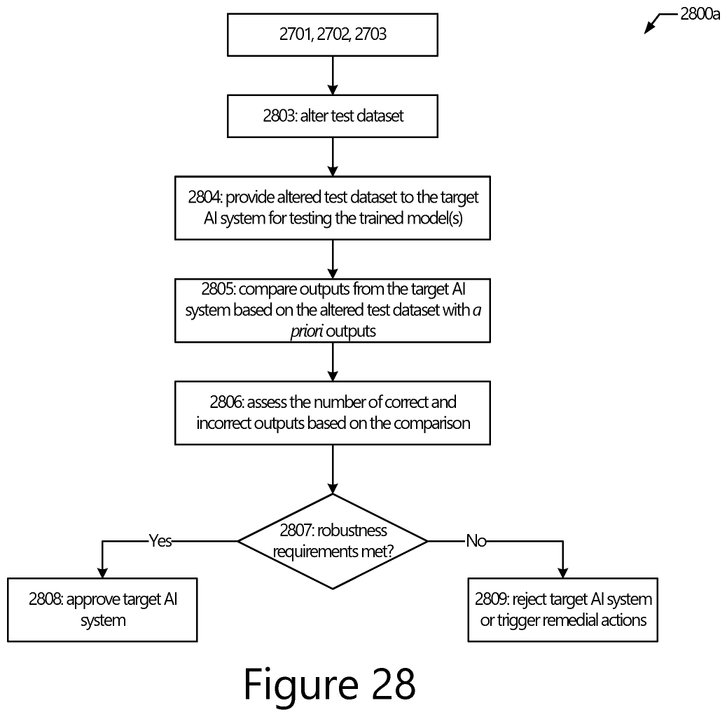

FIG. 28 shows an example robustness verification process 2800a (performed by the RVE 2800a), which is an example implementation solution to meet the robustness requirements of the [AIA-SR] as shown by Table 3.8-1.

TABLE 3.8-1

| | |
|---|---|
| 2.7 | Robustness specifications for AI systems |
| | This (these) European standard(s) or European standardisation |
| | deliverable(s) shall lay down specifications for the robustness |
| | of AI systems, taking into consideration relevant sources of |
| | errors, faults and inconsistencies, as well as the interactions |
| | of the AI system with the environment, including of those AI |
| | systems which continue to learn after being placed on the |
| | market or put into service, notably in respect to feedback loops. |

The robustness verification process 2800a is an example methodology that can be used in order to assess the robustness of an AI system 2310 for a specific AI/ML application, use case, AI/ML task, AI/ML domain, and/or AI/ML objective. The execution/operation of process 2800a is conducted through the RVE 2800. Process 2800a begins by performing operations 2701, 2702, and 2703 as discussed previously w.r.t. FIG. 27. At operation 2803, one or more values in the test dataset are altered such that a known incorrect decision or prediction should be generated from the altered values.

At operation 2804, the altered test dataset is given to the AI system 2310, which is used to test the trained AI/ML models. In some implementations, the test dataset can be modified by injecting errors into the test dataset, which can take place following a characterization of relevant sources of errors, faults and inconsistencies, as well as the interactions of the AI system 2310 for the specific AI/ML application, use case, AI/ML task, AI/ML domain, and/or AI/ML objective. Additionally or alternatively, some numerical noise can be added to the input vectors to create the altered test dataset. Additionally or alternatively, the altered test dataset can be created by replacing part of the input vectors with incorrect samples. Other mechanisms for altering the dataset can be used such as any of those discussed herein (e.g., using the alternation function discussed previously). The modified/falsified test dataset is given to the AI system 2310 for testing, and the correct decisions and/or predictions that should be output for any of the test input vectors is known a priori. Here, the “correct decisions and/or predictions” include the intentionally erroneous outputs based on the modified/falsified test data items in the altered test dataset. In some implementations, a new testing dataset of test input vectors with known errors can be generated rather than modifying the existing testing dataset.

At operation 2805, decisions and/or predictions of the AI system 2310 for each of the test data is compared to the a priori known correct decisions and/or predictions and/or with the outputs from the AI system 2310 using the unaltered test dataset. The comparison in operation 2805 may be performed in a same or similar manner as discussed previously w.r.t, operation 2704 of FIG. 27. In particular, the number of correct/incorrect decisions and/or predictions are determined or identified for this case where the approved input vectors are modified and errors are injected into the test dataset. This process may be repeated for various levels of modified input vectors, for example a first test may use a low level of added noise (or a small number of false sample is being injected), a second test may use a medium level of added noise (or a medium number of false sample is being injected) and a third test may use a high level of added noise (or a high number of false sample is being inject). This process can also be repeated using randomly generated errors injected into different versions of the test dataset.

At operation 2806, the overall number of correct/incorrect decisions is assessed for both of the aforementioned cases including a first assessment of tests relying on unmodified approved test vectors and a second assessment of tests relaying on modified test vectors. In case of multiple tests, each with different levels of modified test input vectors, each of the resulting performance metrics (e.g., number of correct vs incorrect decisions, and/or the like) are assessed. The same or different threshold discussed previously w.r.t, operation 2705 can be used for the assessment at operation 2806. In some implementations, the threshold(s) may be defined individually for a specific application/use case and typically depends on the level of modified input vectors (e.g., a higher number of incorrect decisions may be accepted in case that a higher level of modification is applied to the inputs to the AI system 2310). The tolerance and/or threshold may be more strict for very high risk AI applications, use cases, tasks, domains, or objectives (e.g., biometric detection) in comparison with the tolerance and/or threshold of lower risk AI applications, use cases, tasks, domains, or objectives.

The assessment(s) at operation 2806 are used for determining whether the robustness requirements have been met at operation 2807, and then approving the target AI system 2310 at operation 2808 or rejecting the target AI system 2310 at operation 2809. Operations 2807, 2808, and 2809 may be performed in a same or similar manner as operations 2706, 2707, and 2708, respectively. After performance of operation 2808 or 2809, process 2800a may end or repeat as necessary.

### 3.9. Cybersecurity Specifications for AI Systems

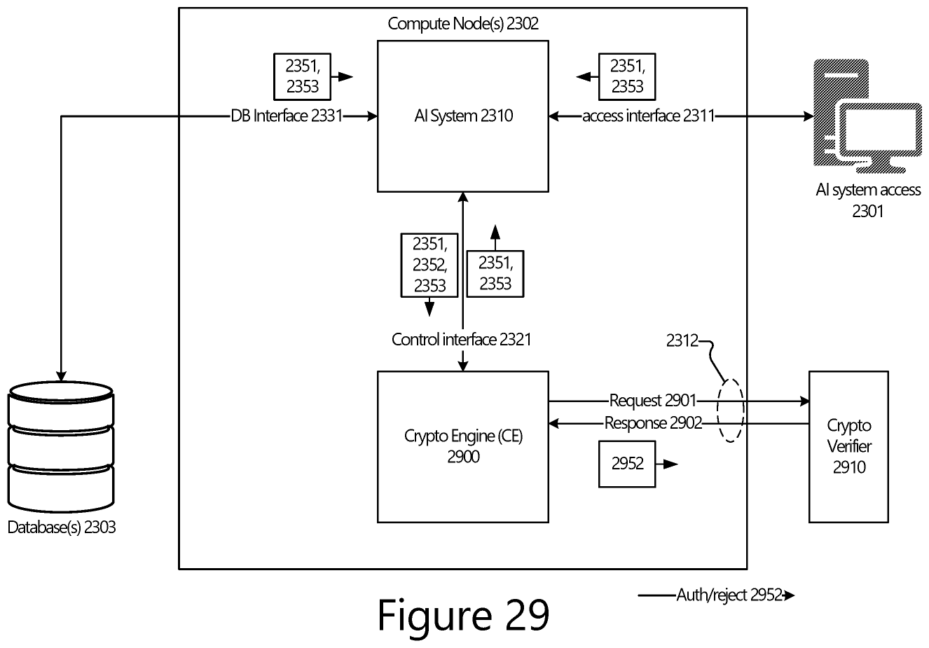

FIG. 29 shows an example verification of the AI system 2310 based on cryptographic (crypto) mechanisms, which is an example implementation solution to meet the cybersecurity requirements of the [AIA-SR] as shown by Table 3.9-1.

TABLE 3.9-1

| | |
|---|---|
| 2.8 | Cybersecurity specifications for AI systems |
| | This (these) European standard(s) or European standardisation |
| | deliverable(s) shall provide suitable organisational and technical |
| | solutions, to ensure that AI systems are resilient against attempts |
| | to alter their use, behaviour, performance or compromise their |
| | security properties by malicious third parties exploiting the AI |
| | systems' vulnerabilities. Organisational and technical solutions |
| | shall thus include, where appropriate, measures to prevent and |
| | control for cyberattacks trying to manipulate AI specific assets, |
| | such as training data sets (e.g. data poisoning) or trained models |
| | (e.g. adversarial attacks), or exploiting vulnerabilities in an AI |
| | system's digital assets or the underlying ICT infrastructure. |
| | Those technical solutions shall be appropriate to the relevant |
| | circumstances and risks. |

In the example of FIG. 29, cybersecurity aspects of the AI system 2310 are verified based on a crypto mechanisms. In this example, the crypto mechanisms are performed and/or calculated by the CE 2900. In some implementations, the CE 2900 is part of a secure execution environment (SEE), trusted platform module (TPM), trusted execution environment (TEE), UICC (sometimes referred to as a “universal integrated circuit card”) or SIM card, and/or the like). Additionally or alternatively, the CE 2900 can be implemented using secure enclaves or virtualization mechanisms.

One example implementation involves enforcing the usage of encrypted inputs 2351 to the AI system 2310 and the outputs 2352 of the AI system 2310. This may include, for example, encryption of the control interface 2321 (or encryption of the inputs 2351 and the outputs 2352 conveyed over the control interface 2321), including exchanges with the EAIOSV 2600 discussed previously. Additionally, relevant datasets (e.g., inputs 2351 from DB(s) 2303 and/or elsewhere) including training datasets (e.g., to prevent and control for cyberattacks trying to manipulate by way of data poisoning) or trained models (e.g., to prevent and control for cyberattacks trying to manipulate by way of adversarial attacks) may not only be encrypted but also combined with a digital signatures including proof of origin and/or the like. In these implementations, the relevant datasets can be used when the digital signature can be verified and the origin of the relevant datasets is/are validated or authenticated as an authorized entity/user.

Additionally, high risk datasets related to highly critical applications and/or HRAI applications (e.g., biometric detection and/or the like) can be stored in a secure area of the AI system 2310 and/or in a secure area of the compute node(s) 2302, such as in a shielded location, a secure memory of a TPM. UICC. SEE, and/or TEE (see e.g., TEE 3590 of FIG. 35). The high risk datasets can include personal data, sensitive data, and/or confidential data, or other data related to HRAI systems and/or applications. Additionally or alternatively, these high risk datasets can include training datasets (e.g., to prevent and control for cyberattacks trying to manipulate by way of data poisoning) and/or trained models (e.g., to prevent and control for cyberattacks trying to manipulate by way of adversarial attacks). In some implementations, after the original storage of the high risk datasets, a mechanical fuse may be broken which further allows for reading the data but makes it physically impossible to modify its content. For applications and/or datasets related to AI systems or applications of lower criticality (e.g., processing resumés/CVs of job applicants), some relaxed constraints may be applied, for example, the braking of a fuse may not be necessary, but related AI datasets may still be stored in a secure memory location of the system in order to protect against possible attacks.

In various implementations, the device or system fingerprinting is used for verifying, validation, authenticating, and/or authorizing the AI system 2310. In these implementations, the AI system 2310 cyclically or periodically performs a self-assessment wherein the AI system 2310 processes or otherwise determines its system state. The system state is then provided to the CE 2900 via the control interface 2321. The CE 2900 performs various cryptographic tasks/operations on the system state to calculate or otherwise create a value that is representative of the system state. This value is referred to as an “AI system fingerprint” or “fingerprint”.

The AI system fingerprint may be a fingerprint of the AI system 2310 and/or a device fingerprint (or machine fingerprint) of the compute node(s) 2302. The fingerprint can include, or be generated from any information collected about the software and hardware of a computing device for the purpose of identification, authentication, verification, and/or validation. In one example, the fingerprint may be based on one or more input datasets 2351 to the AI system 2310 and/or one or more outputs 2352 of the AI system 2310, which may or may not be combined with other data of the AI system 2310 and/or the compute node(s) 2302. Additionally or alternatively, any of the aforementioned types of data can be combined with one or more random values (or a nonce) when computing the fingerprint. Additionally or alternatively, the fingerprint can include the output of a physical unclonable function (PUF) implemented by a tamper-resistant chipset in the compute node(s) 2302 (e.g., as part of the CE 2900 and/or part of a separate TEE 3590). In these implementations, when a physical stimulus (e.g., electric impulse) is applied to the PUF, the PUF reacts in an unpredictable way due to the complex interaction of the stimulus with the physical microstructure of the PUF and/or elements of the compute node(s) 2302. This exact microstructure may depend on physical factors introduced during manufacture, which may be unpredictable. The PUF outputs a value, which may be used as the fingerprint, or the PUF outputs a value that may be combined with other data using known crypto mechanisms. Additionally or alternatively, the CE 2900 implements a hash function that hashes various types of data such as those discussed previously, and the calculated fingerprint may be a hash value. Any of the aforementioned implementations may be combined and/or used to generate the fingerprint.

The CE 2900 sends a request 2901 over the access interface 2312 to a crypto verifier 2910 to request verification of the AI system 2310. In this example, the crypto verifier 2910 is an external component. However, in some implementations the crypto verifier 2910 may be internal or part of the CE 2900, internal or part of the AI system 2310, or a separate, stand-alone entity within the compute node(s) 2302. The request 2901 can include the fingerprint of the AI system 2310 and a request for validation of the fingerprint. The crypto verifier 2910 performs various operations on the fingerprint to validate and/or verify the value of the fingerprint. For example, the crypto verifier 2910 can generate a verification value by performing the same crypto operations on the same data or values used to generate the fingerprint, and the resultant verification value is then compared to the fingerprint. If the values match, the AI system 2310 has not been altered. If the values do not match, the AI system 2310 has been corrupted or compromised. The crypto verifier 2910 provides a response 2902 indicating the validation or verification of the fingerprint, which may act as an implicit validation and/or verification of the system state of AI system 2310.

If the response 2902 includes or indicates that a potential alternation of the AI system 2310 is observed based on the comparison of the fingerprint with the verification value, corresponding counter measures/actions 2353 can be issued or implemented. In one example, an authorized user can be informed of the potentially compromised AI system 2310 in an authorization/rejection message 2952 conveyed over the access interface 2312. The message 2952 may ask the authorized user to take one or more remedial actions (e.g., force a reset of the AI system 2310 and/or compute node(s) 2302, retraining of one or more models of the AI system 2310, and/or other countermeasures such as those discussed herein). Additional or alternative examples of the counter measures/actions 2353 can include automatic retraining of one or more models of the AI system 2310, automatic reset of the AI system 2310 and/or compute node(s) 2302, re-installation of SW and/or firmware, and/or some other counter measures such as any of those discussed herein.

In some implementations, the various crypto operations performed by the CE 2900 and/or the crypto verifier 2910 may include various operations for calculating hash values, calculating integrity values, calculating cryptographic checksums, digitally signing data, generating nonces and keys including generating or obtaining random numbers, encrypting/decrypting data and/or other operations. In some implementations, the various crypto operations performed by the CE 2900 and/or the crypto verifier 2910 may be part of a crypto pipeline, which is a set of crypto operations or stages where each of the crypto operations/stages are connected or arranged in series, such that the output of one stage/operation is a required input to a subsequent operation/stage. The series of operations/stages may be defined by any suitable cryptographic algorithms, cryptographic standards, cryptographic libraries and/or digital random number generator (DRNG) libraries.

Examples of the cryptographic mechanisms used for any of the examples discussed herein include digital signature algorithms, key agreement algorithms, key generation and exchange algorithms, hash algorithms and/or hash functions, fingerprinting algorithms, and/or other cryptographic algorithms. The aforementioned algorithms may be implemented using any suitable cryptographic algorithm such as, for example, asymmetric (public key) encryption algorithms (e.g., digital signature algorithms (DSA), key generation and exchange algorithms, key agreement algorithms, elliptic curve cryptographic (ECC) algorithms. ECDSA. Rivest-Shamir-Adleman (RSA) cryptography, and/or the like), symmetric encryption or secret key encryption (e.g., advanced encryption system (AES), data encryption standard (DES)-X, triple DES (3DES or TDES) or triple data encryption algorithm (TDEA), twofish, threefish, and/or the like), hash functions (e.g., secure hash algorithms (SHA), message authentication code algorithms (MAC) (e.g., keyed MAC (KMAC), keyed-hash MAC (HMAC), parallelizable MAC (PMAC), and the like), BLAKE hash algorithms, MD6 Message-Digest Algorithm, fast syndrome-based hash functions (FSB), GOST hash functions, Grøstl, Whirlpool, and/or the like); lightweight cryptography (LWC); digital signature schemes (e.g., DSA. Schnorr signature scheme, and/or ElGamal signature scheme, and/or the like); and/or post-quantum cryptographic (PQC) algorithms.

### 3.10. Quality Management System for Providers of AI Systems, Including Post-Market Monitoring Process

FIG. 30 shows an example AISQM 3000, which is an example implementation solution to meet the quality management requirements of the [AIA-SR] as shown by Table 3.10-1.

TABLE 3.10-1

| | |
|---|---|
| 2.9 | Quality management system for providers of AI systems, including |
| | post-market monitoring process |
| | This (these) European standard(s) or European standardisation |
| | deliverable(s) shall lay down specification for a quality |
| | management system to be implemented by providers of AI systems |
| | within their organisations. Such quality management systems shall |
| | ensure inter alia continous compliance of an AI system with the |
| | aspects described under points 2.2. 2.3, 2.4, 2.5, 2.6, 2.7 and 2.8. |
| | Appropriate consideration shall be given to the implementation of |
| | quality management system measures by medium and small size |
| | organisations. |
| | Specifications shall be drafted such that, for AI systems which |
| | are safety components of products, the quality management system |
| | aspects related to the AI system may be integrated in the overall |
| | management system of the product manufacturer. |

The AISQM 3000 provides quality management to ensure, inter alia, compliance of an AI system 2310 with the aspects described under points 2.2, 2.3, 2.4, 2.5, 2.6, 2.7 and 2.8 of the [AIA-SR]. The AISQM 3000 calculates a quality metric 3010 based on various inputs including, for example, the fingerprint generated by the CE 2900, accuracy metrics generated by the AVE 2700, and/or robustness metrics generated by the RVE 2800. In one example, the quality metric 3010 may be set to a predefined or configured value, and the fingerprint, the accuracy metrics, and/or the robustness metrics are used to weight or scale the initial value of the quality metric 3010.

The quality metric 3010 generated by the AISQM 3000 indicates the level of observed quality of the AI system 2310. The quality metric 3010 can be a numerical value, for example, an integer in the range of 0 to 99 (or any other suitable range of values). In this example, a value of “0” may indicate a very low level of observed quality (e.g., the overall accuracy is low, the overall robustness is low, and/or the like), whereas a value of “99” may indicate a relatively very high level of observed quality (e.g., the overall accuracy is high, the overall robustness is high, and/or the like). Other implementations of the quality metric 3010 can be used in other examples,

In some implementations, an AI system 2310 for a particular application, use case, domain, task, and/or objective may have a minimum required quality metric 3010 in order to operate properly and/or to comply with the [AIA-SR]. Unless the predefined or configured quality metric 3010 level is achieved, the AI system 2310 is not authorized to operate for such an application, use case, domain, task, and/or objective. For example, sensitive applications and/or HRAI systems (e.g., biometric detection systems and/or the like) may require a very high minimum quality metric 3010 (e.g., a quality metric value of “90” or higher), whereas other less sensitive applications and/or non-HRAI system may require a lower minimum quality metric 3010.

As alluded to previously, the AISQM 3000 accesses the fingerprint value derived from the AI system 2310 state through the CE 2900. In some implementations, the AISQM 3000 verifies the validity of the fingerprint, possibly with the help of the crypto verification entity 2910, and suspicious or potentially compromised states of the AI system 2310 can be indicated through the quality metric 3010. For example, a high probability of a cyber-attack is detected and/or a specific alarm/trigger 2353 is issued, the AISQM 3000 may reduce the value of the quality metric 3010 or set the quality metric 3010 to 0. In some implementations, the AISQM 3000 can issue the alarm/trigger 2353 for the potential cyber-attack.

The AISQM 3000 also accesses the accuracy metrics generated by the AVE 2700. In some implementations, the AISQM 3000 uses the number of correct decisions/predictions and/or the number of incorrect decisions/predictions into account for calculating the quality metric 3010. For example, the value of the quality metric 3010 can be reduced, increased, or weighted in some way such that the value of the quality metric 3010 correlates to the number of incorrect decisions/predictions indicated by the accuracy metrics. In one example, the quality metric 3010 is set to 0 when the accuracy metrics indicate that all of the decisions/predictions are incorrect, and the quality metric 3010 is set to 99 when the accuracy metrics indicate that all of the decisions/predictions are correct.

The AISQM 3000 can also access the robustness metrics generated by the RVE 2800 In some implementations, the AISQM 3000 uses the number of correct and/or incorrect decisions/predictions (in the context of falsified input vectors provided to the AI system 2310) into account for calculating the quality metric 3010. Similar to the accuracy metrics discussed previously, the value of the quality metric 3010 can be reduced, increased, or weighted in some way such that the value of the quality metric 3010 correlates to the number of incorrect decisions/predictions indicated by the robustness metrics. In one example, the quality metric 3010 is set to 0 when the robustness metrics indicate that all of the decisions/predictions are incorrect, and the quality metric 3010 is set to 99 when the robustness metrics indicate that all of the decisions/predictions are correct.

### 3.11. Conformity Assessment for AI Systems

Referring back to FIG. 23, the AIMER function(s) 2320 can also include an example implementation solution to meet the conformity assessment requirements of the [AIA-SR] as shown by Table 3.11-1.

TABLE 3.11-1

| 2.10 | Conformity assessment for AI systems | |
|---|---|---|
| | This (these) European standard(s) or European standardisation deliverable(s) | |
| | shall provide verification and validation procedures and methodologies to | |
| | assess whether: | |
| | (a) | an AI system that is placed on the market or put into service is fit-for- |
| | | purpose, notably with regard to aspects described under points 2.1, 2.2. |
| | | 2.3, 2.4, 2.5, 2.6, 2.7 and 2.8. This (these) European standard(s) or |
| | | European standardisation deliverable(s) shall contain objectively |
| | | verifiable criteria and shall indicate not only the risks that they cover, |
| | | but also the major risks that they do not cover; |
| | (b) | the quality management system measures and processes, as described under |
| | | point 2.9, are appropriately implemented by a provider of an AI system |

This (these) European standard(s) or European standardisation deliverable(s)
shall consider both the scenarios whereby the conformity assessment is carried
out by the provider itself or with the involvement of a professional external
third-party organisation.
This (these) European standard(s) or European standardisation deliverable(s)
shall include specifications for the testing of AI systems in the context of
the conformity assessment.

The objectives of [AIA-SR], Annex II, point 2.10 (as shown by Table 3.11-1) can be met through the standardization of test scripts and training data from AI learnings. In some implementations, the AI system 2310 and/or the compute node(s) 2302 is/are equipped with a test interface that can be accessed by a testing entity. The testing entity will then provide test vectors for validating the correct implementation of all the functionalities required, including those introduced in the present document.

### 4. AI Regulation for In-Vehicle AI Processing

AI systems and/or components (e.g., AI system 902, 1420, 1620, 1820, 1920, and/or 2310 discussed previously) can be implemented as part of autonomous and/or semi-autonomous vehicles, drones, robots, and/or sensors (collectively referred to as “(semi-)autonomous systems”) as well as part of various infrastructure used to support such (semi-)autonomous systems (e.g., roadside infrastructure including road side units (RSUs), traffic control devices (e.g., traffic lights, electronic signage, gates, and the like), lamp posts, and so forth), as well as network infrastructure including edge compute nodes, network access nodes (NANs) (e.g., cellular base stations, WLAN access points, and the like). Some or all of the AI systems and/or components implemented in or by (semi-)autonomous systems will likely be considered to be HRAI systems following the categorization in the [AIA] and will be required to meet the requirements outlined previously and in the [AIA]. The following discussion provides additional functionalities for these AI systems and/or components in the (semi-)autonomous systems, in the support infrastructure, and/or other elements.

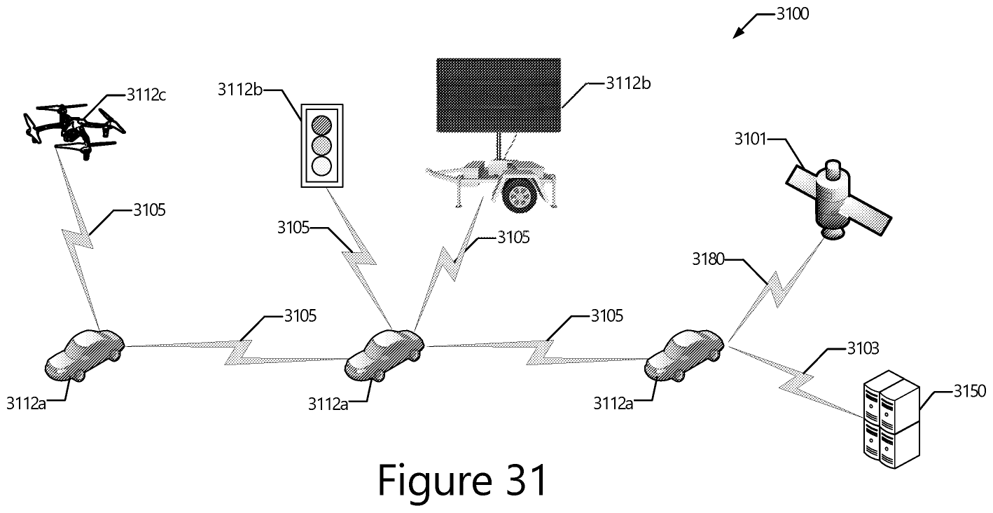

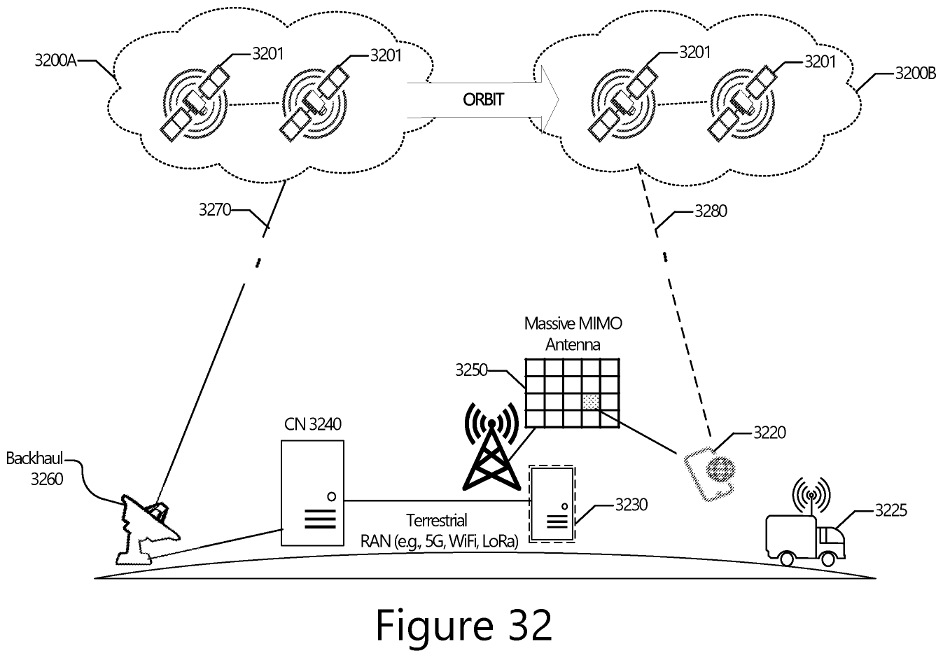

FIG. 31 shows an example vehicle network environment 3100 including (semi-)autonomous systems 3112 including vehicle systems 3112a, traffic control devices 3112b, and drone or unmanned aerial vehicle (UAV) 3112c, as well as a satellite vehicle (SV) 3101 and compute nodes 3150. The (semi-)autonomous systems 3112 can connect with, or otherwise communication with one another via links 3105, which can be implemented using one or more suitable RATs such as any of those discussed herein. Each of the links 3105 can be vehicle-to-vehicle (V2V) links 3105 (e.g., connecting two vehicles 3112a and/or a vehicle 3112a and drone 3112c) or vehicle-to-infrastructure (V2I) links 3105 (e.g., connecting a vehicle 3112a to one or more traffic control devices 3112b). The links 3105 can include any suitable RAT such as, for example, 3GPP sidelink channels including ProSe and/or respective PC5 interfaces; cellular links such as the 3GPP Uu interface; WiFi and/or PAN links, and/or the like. Additionally or alternatively, the direct links 3105 may be the same or similar as direct links 3305 and/or links 3303 of FIG. 33. The (semi-)autonomous systems 3112 can also connect with, or otherwise communication with SV 3101 via link 3180. Additionally, the (semi-)autonomous systems 3112 can also connect with, or otherwise communication with the compute nodes 3150 via link 3103, which can be implemented using one or more suitable RATs such as any of those discussed herein. The SV 3101 may be the same or similar as the SVs 3201 of FIG. 32, and the link 3180 may be the same or similar as links 3270 and/or 3280 of FIG. 32. Furthermore, the compute nodes 3150 may be the same or similar as the server(s) 3350 of FIG. 33, and the link 3103 may be the same or similar as links 3303 and/or links 3305 of FIG. 33. The compute nodes 3150 and/or SV 3101 may represent one or more available terrestrial networks (TNs) and/or non-TNs (NTNs), and link 3103 may include and/or represent one or more relays and/or network elements in the TNs and/or NTNs. In this example, an NTN may be based on satellite access (e.g., using SV 3101) and/or terrestrial NANs (not shown by FIG. 31). Additionally or alternatively. NTNs may be provided by drones (e.g., including drone 3112c), aircraft (e.g., hot air balloons, air ships, and the like), watercraft, and/or other non-terrestrial elements.

The usage of AI systems and/or components under consideration (e.g., any of the AI system 902, 1420, 1620, 1820, 1920, and/or 2310 discussed previously, components thereof, and/or other components of the compute node(s) 2302) relates to any type of data change, which can involve or other be used for feeding the AI systems and/or components either for training or decision making. This can include training and/or decision making related to the network access (e.g., the V2V, V2I, and/or TN/NTN access). In some examples, AI systems and/or components may be attached to or integrated within individual (semi-)autonomous systems 3112, compute nodes 3150. SVs 3101, and/or other equipment.

In one example implementation, an AI system (e.g., any of the AI system 902, 1420, 1620, 1820, 1920, and/or 2310 discussed previously) is trained using a training dataset to perform identification of vehicles and/or vulnerable road users. Additionally or alternatively, the training dataset can include image and/or video data of human features (e.g., facial features, finger print information, voice print data, and/or the like), which are exploited to identify a specific person.

Additionally or alternatively, the AI system includes the architecture of the AI system 902 of FIG. 9), including the AI processor/engine 910 and the set of self-assessment elements 921.

Additionally or alternatively, the AI system includes the architecture of the AI system 2310 and/or can be part of an in-vehicle computing system, which can have a same or similar architecture as the compute node(s) 2302 of FIG. 23. In these examples, the operator or passenger of a (semi-)autonomous vehicle 3112 can provide inputs to the various of the human oversight entity 915 to interrupt the operation of the AI system. In one example, the inputs to one or more self-assessment elements 921 and/or AIMER function(s) 2320 can be based on signals produced from an operator or passenger in the vehicle 3112 pressing one or more buttons on the vehicle's 3112 instrument panel or dashboard, by pressing the vehicle's 3112 brakes, signaling and/or data packets sent by a computing device (e.g., a smartphone, tablet, infotainment system. NAN, traffic control device 3112b, other vehicles 3112a, 3112c, 3101, and/or the like) via a wired or wireless signaling, signaling from one or more electronic control units (ECUs) and/or sensors within the vehicle 3112a, and/or any other component/device in the vehicle 3112a.

FIG. 32 illustrates an example of network connectivity in non-terrestrial (e.g., satellite) and terrestrial (e.g., mobile cellular network) settings. In FIG. 32, a satellite constellation 3200 (e.g., the constellation at orbital positions 3200A and 3200B in FIG. 32) include multiple satellite vehicles (SVs) 3201 (and numerous other SVs 3201 not shown by FIG. 32), which are connected to each other and to one or more terrestrial networks. Each SV 3201 in the constellation 3200 conducts an orbit around the earth, at an orbit speed that increases as the SV 3201 is closer to earth, low Earth orbit (LEO) constellations (e.g., constellation 3200) are generally considered to include SVs (e.g., SVs 3201) that orbit at an altitude between 160 and 1000 kilometers (km), and at this altitude each SV orbits the earth about every 90 to 120 minutes. The constellation 3200 uses one or multiple SVs 3201 to provide communications coverage to a geographic area on earth. The constellation 3200 may also coordinate with other satellite constellations (not shown), and with terrestrial-based networks, to selectively provide connectivity and services for individual devices (e.g., UEs 3220, 3225) or terrestrial network systems (e.g., network equipment).

In this example, the satellite constellation 3200 is connected via a satellite link 3270 to a backhaul network 3260, which is in turn connected to a CN 3240, which may be the same or similar as the CN 3342 discussed previously. The CN 3240 is used to support cellular (e.g., 5G and/or the like) communication operations with the satellite network (e.g., constellation 3200) and at a terrestrial RAN 3230, which may be the same or similar as a RAN including NANs 3330 discussed previously. In a first example, the CN 3240 is located in a remote location, and uses the satellite constellation 3200 as the exclusive mechanism to reach wide area networks (WANs) and/or the Internet. In a second example, the CN 3240) uses the satellite constellation 3200 as a redundant link to access the WANs and/or the Internet. In a third example, the CN 3240) uses the satellite constellation 3200 as an alternate path to access the WANs and/or the Internet (e.g., to communicate with networks on other continents and the like).

FIG. 32 also depicts a terrestrial RAN 3230) that provides radio connectivity to user equipment (UE) including user device 3220 or vehicle system 3225 on-ground via a massive multiple input multiple output (MIMO) antenna 3250. The UEs 3220, 3225 may be the same or similar as the UEs 3310 discussed previously. A variety of 5G and/or other network communication components and units are not depicted in FIG. 32 for purposes of simplicity/clarity. In some examples, each UE 3220, 3225 also may have its own satellite connectivity hardware (e.g., receiver circuitry and antenna), to directly connect with the satellite constellation 3200 via satellite link 3280. Although a cellular (e.g., 5G) network setting is depicted and discussed herein, other variations of 3GPP, O-RAN, WiFi, and other network specifications may also be applicable.

Other permutations (not shown) may involve a direct connection of the RAN 3230 to the satellite constellation 3200 (e.g., with the CN 3240) accessible over a satellite link 3270, 3280)); coordination with other wired (e.g., fiber), laser or optical, and wireless links and backhaul; multi-access radios among the UE, the RAN, and other UEs; and other permutations of terrestrial and non-terrestrial connectivity. Satellite network connections may be coordinated with 5G network equipment and user equipment based on satellite orbit coverage, available network services and equipment, cost and security, and geographic or geopolitical considerations, and the like. With these basic entities in mind, and with the changing compositions of mobile users and in-orbit satellites, the following techniques describe ways in which terrestrial and satellite networks can be extended for various edge computing scenarios.

Additionally or alternatively, the provision of a RAN 3230 from SVs 3201, and the significantly reduced latency from LEO vehicles, enables much more robust use cases, including the direct connection of devices (e.g., UEs 3220, 3225) using 5G satellite antennas at the device, and communication between an edge appliance (not shown) and the satellite constellation 3200 using standard and/or proprietary protocols. As an example, in some LEO settings, one 5G LEO satellite can cover a 500 km radius for 8 minutes, every 12 hours. Connectivity latency to LEO satellites may be as small as one ms. Further, connectivity between the satellite constellation and the UEs 3220, 3225 or the RAN 3230 depends on the number and capability of satellite ground stations. For example, one or more SVs 3201 can communicate with a ground station (e.g., satellite dish 3260 and/or a RAN node), which may host edge computing processing capabilities. The ground station in turn may be connected to a data center via CN 3240 (not shown) for additional processing. With the low latency offered by 5G communications, data processing, compute, and storage may be located at any number of locations (at edge, in satellite, on ground, at core network, at low-latency data center).

Additionally or alternatively, although not shown by FIG. 32, an edge appliance may be located at an SV 3201. Here, various edge compute operations may be directly performed using hardware located at the SV 3201, reducing the latency and transmission time that would have been otherwise needed to communicate with the ground station or data center. Likewise, in these scenarios, edge compute capabilities may be implemented or coordinated among specialized processing circuitry (e.g., acceleration circuitry 3564 of FIG. 35 such as FPGAs, ASICs, and the like) or general purpose processing circuitry (e.g., processor circuitry 3552 of FIG. 35 such as x86 CPUs, and/or the like) located at the SV 3201, the ground station. UEs/devices, and/or other edge appliances not shown, and/or combinations thereof. Additionally or alternatively, although not shown by FIG. 32, other types of orbit-based connectivity and edge computing may be involved with these architectures. These include connectivity and compute provided via balloons, drones, dirigibles, and similar types of non-terrestrial elements. Such systems encounter similar temporal limitations and connectivity challenges (like those encountered in a satellite orbit).

The need to deal with delayed hits (DHs) can be minimized by building meshes of intermediate processing that has local context. Hence, cache hits are localized thereby avoiding delayed hits. This applies to the satellite context by building an NF mesh at each satellite tier (e.g., terrestrial satellite 3260, near-Earth objects (NEO), LEO, medium Earth orbit (MEO), high Earth orbit (HEO), and/or Geostationary Earth Orbit (GEO) satellites 3201 in FIG. 32). Using the caching mechanisms discussed herein, a requested object that is at risk of receiving a delayed hit would migrate to an appropriate mesh layer with a function task that can be completed given available data. The workload may be blocked at a lower mesh layer for the upper layer mesh to complete. This is like a delayed hit scenario, but the workload blocks on task completion from another mesh layer. Hence, the cache can be cleared as the context remains in memory. Additionally or alternatively, the delayed hit cache algorithm opts to keep the function context in cache to avoid the context switch overhead. But this is likely to be uncommon given expected latencies between meshes (e.g., NEO, LEO, MEO, HEP, and/or GEO meshes and the like) versus context switch latency.

### 5. Edge Computing System Configurations and Arrangements

Edge computing refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership.

Individual compute platforms or other components that can perform edge computing operations (referred to as “edge compute nodes,” “edge nodes,” or the like) can reside in whatever location needed by the system architecture or ad hoc service. In many edge computing architectures, edge nodes are deployed at NANs, gateways, network routers, and/or other devices that are closer to endpoint devices (e.g., UEs, IoT devices, and the like) producing and consuming data. As examples, edge nodes may be implemented in a high performance compute data center or cloud installation; a designated edge node server, an enterprise server, a roadside server, a telecom central office; or a local or peer at-the-edge device being served consuming edge services.

Edge compute nodes may partition resources (e.g., memory, CPU, GPU, interrupt controller. I/O controller, memory controller, bus controller, network connections or sessions, and the like) where respective partitionings may contain security and/or integrity protection capabilities. Edge nodes may also provide orchestration of multiple applications through isolated user-space instances such as containers, partitions, virtual environments (VEs), virtual machines (VMs), Function-as-a-Service (FaaS) engines, Servlets, servers, and/or other like computation abstractions. Containers are contained, deployable units of software that provide code and needed dependencies. Various edge system arrangements/architecture treats VMs, containers, and functions equally in terms of application composition. The edge nodes are coordinated based on edge provisioning functions, while the operation of the various applications are coordinated with orchestration functions (e.g., VM or container engine, and the like). The orchestration functions may be used to deploy the isolated user-space instances, identifying and scheduling use of specific hardware, security related functions (e.g., key management, trust anchor management, and the like), and other tasks related to the provisioning and lifecycle of isolated user spaces.

Applications that have been adapted for edge computing include but are not limited to virtualization of traditional network functions including include, for example, Software-Defined Networking (SDN), Network Function Virtualization (NFV), distributed RAN units and/or RAN clouds, and the like. Additional example use cases for edge computing include computational offloading. Content Data Network (CDN) services (e.g., video on demand, content streaming, security surveillance, alarm system monitoring, building access, data/content caching, and the like), gaming services (e.g., AR/VR, and the like), accelerated browsing. IoT and industry applications (e.g., factory automation), media analytics, live streaming/transcoding, and V2X applications (e.g., driving assistance and/or autonomous driving applications).

The present disclosure provides specific examples relevant to various edge computing configurations provided within and various access/network implementations. Any suitable standards and network implementations are applicable to the edge computing concepts discussed herein. For example, many edge computing/networking technologies may be applicable to the present disclosure in various combinations and layouts of devices located at the edge of a network. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

FIG. 33 illustrates an example edge computing environment 3300 including different layers of communication, starting from an endpoint layer 3310a (also referred to as “sensor layer 3310a”, “things layer 3310a”, or the like) including one or more IoT devices 3311 (also referred to as “endpoints 3310a” or the like) (e.g., in an Internet of Things (IoT) network, wireless sensor network (WSN), fog, and/or mesh network topology); increasing in sophistication to intermediate layer 3310b (also referred to as “client layer 3310b”, “gateway layer 3310b”, or the like) including various user equipment (UEs) 3312a, 3312b, and 3312c (also referred to as “intermediate nodes 3310b” or the like), which may facilitate the collection and processing of data from endpoints 3310a; increasing in processing and connectivity sophistication to access layer 3330 including a set of network access nodes (NANs) 3331, 3332, and 3333 (collectively referred to as “NANs 3330” or the like); increasing in processing and connectivity sophistication to edge layer 3337 including a set of edge compute nodes 3336a-c (collectively referred to as “edge compute nodes 3336” or the like) within an edge computing framework 3335 (also referred to as “ECT 3335” or the like); and increasing in connectivity and processing sophistication to a backend layer 3340 including core network (CN) 3342, cloud 3344, and server(s) 3350. The processing at the backend layer 3340 may be enhanced by network services as performed by one or more remote servers 3350, which may be, or include, one or more CN functions, cloud compute nodes or clusters, application (app) servers, and/or other like systems and/or devices. Some or all of these elements may be equipped with or otherwise implement some or all features and/or functionality discussed herein.

The environment 3300 is shown to include end-user devices such as intermediate nodes 3310b and endpoint nodes 3310a (collectively referred to as “nodes 3310”, “UEs 3310”, or the like), which are configured to connect to (or communicatively couple with) one or more communication networks (also referred to as “access networks,” “radio access networks,” or the like) based on different access technologies (or “radio access technologies”) for accessing application, edge, and/or cloud services. These access networks may include one or more NANs 3330, which are arranged to provide network connectivity to the UEs 3310 via respective links 3303a and/or 3303b (collectively referred to as “channels 3303”, “links 3303”, “connections 3303”, and/or the like) between individual NANs 3330 and respective UEs 3310.

As examples, the communication networks and/or access technologies may include cellular technology such as LTE, MuLTEfire, and/or NR/5G (e.g., as provided by Radio Access Network (RAN) node 3331 and/or RAN nodes 3332), WiFi or wireless local area network (WLAN) technologies (e.g., as provided by access point (AP) 3333 and/or RAN nodes 3332), and/or the like. Different technologies exhibit benefits and limitations in different scenarios, and application performance in different scenarios becomes dependent on the choice of the access networks (e.g., WiFi, LTE, and the like) and the used network and transport protocols (e.g., Transfer Control Protocol (TCP), Virtual Private Network (VPN), Multi-Path TCP (MPTCP), Generic Routing Encapsulation (GRE), and the like).

The intermediate nodes 3310b include UE 3312a, UE 3312b, and UE 3312c (collectively referred to as “UE 3312” or “UEs 3312”). In this example, the UE 3312a is illustrated as a vehicle system (also referred to as a vehicle UE or vehicle station), UE 3312b is illustrated as a smartphone (e.g., handheld touchscreen mobile computing device connectable to one or more cellular networks), and UE 3312c is illustrated as a flying drone or unmanned aerial vehicle (UAV). However, the UEs 3312 may be any mobile or non-mobile computing device, such as desktop computers, workstations, laptop computers, tablets, wearable devices, PDAs, pagers, wireless handsets smart appliances, single-board computers (SBCs) (e.g., Raspberry Pi, Arduino, Intel Edison, and the like), plug computers, and/or any type of computing device such as any of those discussed herein.

The endpoints 3310 include UEs 3311, which may be IoT devices (also referred to as “IoT devices 3311”), which are uniquely identifiable embedded computing devices (e.g., within the Internet infrastructure) that comprise a network access layer designed for low-power IoT applications utilizing short-lived UE connections. The IoT devices 3311 are any physical or virtualized, devices, sensors, or “things” that are embedded with HW and/or SW components that enable the objects, devices, sensors, or “things” capable of capturing and/or recording data associated with an event, and capable of communicating such data with one or more other devices over a network with little or no user intervention. As examples, IoT devices 3311 may be abiotic devices such as autonomous sensors, gauges, meters, image capture devices, microphones, light emitting devices, audio emitting devices, audio and/or video playback devices, electro-mechanical devices (e.g., switch, actuator, and the like), EEMS, ECUs, ECMs, embedded systems, microcontrollers, control modules, networked or “smart” appliances, MTC devices, M2M devices, and/or the like. The IoT devices 3311 can utilize technologies such as M2M or MTC for exchanging data with an MTC server (e.g., a server 3350), an edge server 3336 and/or ECT 3335, or device via a PLMN. ProSe or D2D communication, sensor networks, or IoT networks. The M2M or MTC exchange of data may be a machine-initiated exchange of data.

The IoT devices 3311 may execute background applications (e.g., keep-alive messages, status updates, and the like) to facilitate the connections of the IoT network. Where the IoT devices 3311 are, or are embedded in, sensor devices, the IoT network may be a WSN. An IoT network describes an interconnecting IoT UEs, such as the IoT devices 3311 being connected to one another over respective direct links 3305. The IoT devices may include any number of different types of devices, grouped in various combinations (referred to as an “IoT group”) that may include IoT devices that provide one or more services for a particular user, customer, organizations, and the like. A service provider (e.g., an owner/operator of server(s) 3350, CN 3342, and/or cloud 3344) may deploy the IoT devices in the IoT group to a particular area (e.g., a geolocation, building, and the like) in order to provide the one or more services. In some implementations, the IoT network may be a mesh network of IoT devices 3311, which may be termed a fog device, fog system, or fog, operating at the edge of the cloud 3344. The fog involves mechanisms for bringing cloud computing functionality closer to data generators and consumers wherein various network devices run cloud application logic on their native architecture. Fog computing is a system-level horizontal architecture that distributes resources and services of computing, storage, control, and networking anywhere along the continuum from cloud 3344 to Things (e.g., IoT devices 3311). The fog may be established in accordance with specifications released by the OFC, the OCF, among others. Additionally or alternatively, the fog may be a tangle as defined by the IOTA foundation.

The fog may be used to perform low-latency computation/aggregation on the data while routing it to an edge cloud computing service (e.g., edge nodes 3330) and/or a central cloud computing service (e.g., cloud 3344) for performing heavy computations or computationally burdensome tasks. On the other hand, edge cloud computing consolidates human-operated, voluntary resources, as a cloud. These voluntary resource may include, inter-alia, intermediate nodes 3320) and/or endpoints 3310, desktop PCs, tablets, smartphones, nano data centers, and the like. In various implementations, resources in the edge cloud may be in one to two-hop proximity to the IoT devices 3311, which may result in reducing overhead related to processing data and may reduce network delay.

Additionally or alternatively, the fog may be a consolidation of IoT devices 3311 and/or networking devices, such as routers and switches, with high computing capabilities and the ability to run cloud application logic on their native architecture. Fog resources may be manufactured, managed, and deployed by cloud vendors, and may be interconnected with high speed, reliable links. Moreover, fog resources reside farther from the edge of the network when compared to edge systems but closer than a central cloud infrastructure. Fog devices are used to effectively handle computationally intensive tasks or workloads offloaded by edge resources.

Additionally or alternatively, the fog may operate at the edge of the cloud 3344. The fog operating at the edge of the cloud 3344 may overlap or be subsumed into an edge network 3330 of the cloud 3344. The edge network of the cloud 3344 may overlap with the fog, or become a part of the fog. Furthermore, the fog may be an edge-fog network that includes an edge layer and a fog layer. The edge layer of the edge-fog network includes a collection of loosely coupled, voluntary and human-operated resources (e.g., the aforementioned edge compute nodes 3336 or edge devices). The Fog layer resides on top of the edge layer and is a consolidation of networking devices such as the intermediate nodes 3320 and/or endpoints 3310 of FIG. 33.

Data may be captured, stored/recorded, and communicated among the IoT devices 3311 or, for example, among the intermediate nodes 3320 and/or endpoints 3310 that have direct links 3305 with one another as shown by FIG. 33. Analysis of the traffic flow and control schemes may be implemented by aggregators that are in communication with the IoT devices 3311 and each other through a mesh network. The aggregators may be a type of IoT device 3311 and/or network appliance. In the example of FIG. 33, the aggregators may be edge nodes 3330, or one or more designated intermediate nodes 3320 and/or endpoints 3310. Data may be uploaded to the cloud 3344 via the aggregator, and commands can be received from the cloud 3344 through gateway devices that are in communication with the IoT devices 3311 and the aggregators through the mesh network. Unlike the traditional cloud computing model, in some implementations, the cloud 3344 may have little or no computational capabilities and only serves as a repository for archiving data recorded and processed by the fog. In these implementations, the cloud 3344 centralized data storage system and provides reliability and access to data by the computing resources in the fog and/or edge devices. Being at the core of the architecture, the Data Store of the cloud 3344 is accessible by both Edge and Fog layers of the aforementioned edge-fog network.

As mentioned previously, the access networks provide network connectivity to the end-user devices 3320, 3310 via respective NANs 3330. The access networks may be Radio Access Networks (RANs) such as an NG RAN or a 5G RAN for a RAN that operates in a 5G/NR cellular network, an E-UTRAN for a RAN that operates in an LTE or 4G cellular network, or a legacy RAN such as a UTRAN or GERAN for GSM or CDMA cellular networks. The access network or RAN may be referred to as an Access Service Network for WiMAX implementations. Additionally or alternatively, all or parts of the RAN may be implemented as one or more software entities running on server computers as part of a virtual network, which may be referred to as a cloud RAN (CRAN), Cognitive Radio (CR), a virtual baseband unit pool (vBBUP), and/or the like. Additionally or alternatively, the CRAN, CR, or vBBUP may implement a RAN function split, wherein one or more communication protocol layers are operated by the CRAN/CR/vBBUP and other communication protocol entities are operated by individual RAN nodes 3331, 3332. This virtualized framework allows the freed-up processor cores of the NANs 3331, 3332 to perform other virtualized applications, such as virtualized applications for various elements discussed herein.

The UEs 3310 may utilize respective connections (or channels) 3303a, each of which comprises a physical communications interface or layer. The connections 3303a are illustrated as an air interface to enable communicative coupling consistent with cellular communications protocols, such as 3GPP LTE. 5G/NR. Push-to-Talk (PTT) and/or PTT over cellular (POC), UMTS. GSM. CDMA, and/or any of the other communications protocols discussed herein. Additionally or alternatively, the UEs 3310 and the NANs 3330 communicate data (e.g., transmit and receive) data over a licensed medium (also referred to as the “licensed spectrum” and/or the “licensed band”) and an unlicensed shared medium (also referred to as the “unlicensed spectrum” and/or the “unlicensed band”). To operate in the unlicensed spectrum, the UEs 3310 and NANs 3330 may operate using LAA, enhanced LAA (eLAA), and/or further eLAA (feLAA) mechanisms. The UEs 3310 may further directly exchange communication data via respective direct links 3305. Examples of the direct links 3305 include 3GPP LTE and/or NR sidelinks. Proximity Services (ProSe) links, and/or PC5 interfaces/links; WiFi based links and/or a personal area network (PAN) based links (e.g., [IEEE802154] based protocols including ZigBee, IPv6 over Low power Wireless Personal Area Networks (6LoWPAN), WirelessHART, MiWi, Thread, and the like; WiFi-direct; Bluetooth/Bluetooth Low Energy (BLE) protocols).

Additionally or alternatively, individual UEs 3310 provide radio information to one or more NANs 3330 and/or one or more edge compute nodes 3336 (e.g., edge servers/hosts, and the like). The radio information may be in the form of one or more measurement reports, and/or may include, for example, signal strength measurements, signal quality measurements, and/or the like. Each measurement report is tagged with a timestamp and the location of the measurement (e.g., the UEs 3310 current location). As examples, the measurements collected by the UEs 3310 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/N0), energy per chip to interference power density ratio (Ec/I0), energy per chip to noise power density ratio (Ec/N0), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal). GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP. RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon. Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v17.0.0 (2022 Mar. 31) (“[TS36214]”). 3GPP TS 38.215 v17.1.0 (2022 Apr. 1) (“[TS38215]”). 3GPP TS 38.314 v17.1.0 (2022 Jul. 17) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020. pp. 1-4379 (26 Feb. 2021) (“[IEEE80211]”), and/or the like. Additionally or alternatively, any of the aforementioned measurements (or combination of measurements) may be collected by one or more NANs 3330 and provided to the edge compute node(s) 3336.

Additionally or alternatively, the measurements can include one or more of the following measurements: measurements related to Data Radio Bearer (DRB) (e.g., number of DRBs attempted to setup, number of DRBs successfully setup, number of released active DRBs, in-session activity time for DRB, number of DRBs attempted to be resumed, number of DRBs successfully resumed, and the like); measurements related to Radio Resource Control (RRC) (e.g., mean number of RRC connections, maximum number of RRC connections, mean number of stored inactive RRC connections, maximum number of stored inactive RRC connections, number of attempted, successful, and/or failed RRC connection establishments, and the like); measurements related to UE Context (UECNTX); measurements related to Radio Resource Utilization (RRU) (e.g., DL total PRB usage, UL total PRB usage, distribution of DL total PRB usage, distribution of UL total PRB usage, DL PRB used for data traffic. UL PRB used for data traffic. DL total available PRBs, UL total available PRBs, and the like); measurements related to Registration Management (RM); measurements related to Session Management (SM) (e.g., number of PDU sessions requested to setup; number of PDU sessions successfully setup; number of PDU sessions failed to setup, and the like); measurements related to GTP Management (GTP); measurements related to IP Management (IP); measurements related to Policy Association (PA); measurements related to Mobility Management (MM) (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and the like); measurements related to Virtualized Resource(s) (VR); measurements related to Carrier (CARR); measurements related to QoS Flows (QF) (e.g., number of released active QoS flows, number of QOS flows attempted to release, in-session activity time for QoS flow, in-session activity time for a UE 3310, number of QoS flows attempted to setup, number of QoS flows successfully established, number of QOS flows failed to setup, number of initial QoS flows attempted to setup, number of initial QoS flows successfully established, number of initial QOS flows failed to setup, number of QoS flows attempted to modify, number of QoS flows successfully modified, number of QOS flows failed to modify, and the like); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (LIM); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v17.7.1 (2022 Jun. 17) (“[TS28552]”), 3GPP TS 32.425 v17.1.0 (2021 Jun. 24) (“[TS32425]”), and/or the like.

The radio information may be reported in response to a trigger event and/or on a periodic basis. Additionally or alternatively, individual UEs 3310 report radio information either at a low periodicity or a high periodicity depending on a data transfer that is to take place, and/or other information about the data transfer. Additionally or alternatively, the edge compute node(s) 3336 may request the measurements from the NANs 3330 at low or high periodicity, or the NANs 3330 may provide the measurements to the edge compute node(s) 3336 at low or high periodicity. Additionally or alternatively, the edge compute node(s) 3336 may obtain other relevant data from other edge compute node(s) 3336, core network functions (NFs), application functions (AFs), and/or other UEs 3310 such as Key Performance Indicators (KPIs), with the measurement reports or separately from the measurement reports.

Additionally or alternatively, in cases where is discrepancy in the observation data from one or more UEs, one or more RAN nodes, and/or core network NFs (e.g., missing reports, erroneous data, and the like) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

In any of the embodiments discussed herein, any suitable data collection and/or measurement mechanism(s) may be used to collect the observation data. For example, data marking (e.g., sequence numbering, and the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, and the like). Various configurations may be used to define any of the aforementioned data collection parameters. Such configurations may be defined by suitable specifications/standards, such as 3GPP (e.g., [SA6Edge]). ETSI (e.g., [MEC]). O-RAN (e.g., [O-RAN]). Intel® Smart Edge Open (formerly OpenNESS) (e.g., [ISEO]). IETF MAMS (e.g., [MAMS]. Kanugovi et al., Multi-Access Management Services (MAMS), INTERNET ENGINEERING TASK FORCE (IETF). REQUEST FOR COMMENTS (RFC) 8743 (March 2020) (“[RFC8743]”)), IEEE/WiFi (e.g., [IEEE80211], [WiMAX], [IEEE16090], and the like), and/or any other like standards such as those discussed herein.

The UE 3312b is shown as being capable of accessing access point (AP) 3333 via a connection 3303b. In this example, the AP 3333 is shown to be connected to the Internet without connecting to the CN 3342 of the wireless system. The connection 3303b can comprise a local wireless connection, such as a connection consistent with any IEEE 802.11 protocol (e.g., [IEEE80211] and variants thereof), wherein the AP 3333 would comprise a WiFi router. Additionally or alternatively, the UEs 3310 can be configured to communicate using suitable communication signals with each other or with any of the AP 3333 over a single or multicarrier communication channel in accordance with various communication techniques, such as, but not limited to, an OFDM communication technique, a single-carrier frequency division multiple access (SC-FDMA) communication technique, and/or the like, although the scope of the present disclosure is not limited in this respect. The communication technique may include a suitable modulation scheme such as Complementary Code Keying (CCK); Phase-Shift Keying (PSK) such as Binary PSK (BPSK), Quadrature PSK (QPSK), Differential PSK (DPSK), and the like; or Quadrature Amplitude Modulation (QAM) such as M-QAM; and/or the like.

The one or more NANs 3331 and 3332 that enable the connections 3303a may be referred to as “RAN nodes” or the like. The RAN nodes 3331, 3332 may comprise ground stations (e.g., terrestrial access points) or satellite stations providing coverage within a geographic area (e.g., a cell). The RAN nodes 3331, 3332 may be implemented as one or more of a dedicated physical device such as a macrocell base station, and/or a low power base station for providing femtocells, picocells or other like cells having smaller coverage areas, smaller user capacity, or higher bandwidth compared to macrocells. In this example, the RAN node 3331 is embodied as a NodeB, evolved NodeB (eNB), or a next generation NodeB (gNB), and the RAN nodes 3332 are embodied as relay nodes, distributed units, or Road Side Unites (RSUs). Any other type of NANs can be used.

Any of the RAN nodes 3331, 3332 can terminate the air interface protocol and can be the first point of contact for the UEs 3312 and IoT devices 3311. Additionally or alternatively, any of the RAN nodes 3331, 3332 can fulfill various logical functions for the RAN including, but not limited to, RAN function(s) (e.g., radio network controller (RNC) functions and/or NG-RAN functions) for radio resource management, admission control, UL and DL dynamic resource allocation, radio bearer management, data packet scheduling, and the like Additionally or alternatively, the UEs 3310 can be configured to communicate using OFDM communication signals with each other or with any of the NANs 3331, 3332 over a multicarrier communication channel in accordance with various communication techniques, such as, but not limited to, an OFDMA communication technique (e.g., for DL communications) and/or an SC-FDMA communication technique (e.g., for UL and ProSe or sidelink communications), although the scope of the present disclosure is not limited in this respect.

For most cellular communication systems, the RAN function(s) operated by a RAN or individual NANs 3331-3332 organize DL transmissions (e.g., from any of the RAN nodes 3331, 3332 to the UEs 3310) and UL transmissions (e.g., from the UEs 3310 to RAN nodes 3331, 3332) into radio frames (or simply “frames”) with 10 millisecond (ms) durations, where each frame includes ten 1 ms subframes. Each transmission direction has its own resource grid that indicate physical resource in each slot, where each column and each row of a resource grid corresponds to one symbol and one subcarrier, respectively. The duration of the resource grid in the time domain corresponds to one slot in a radio frame. The resource grids comprises a number of resource blocks (RBs), which describe the mapping of certain physical channels to resource elements (REs). Each RB may be a physical RB (PRB) or a virtual RB (VRB) and comprises a collection of REs. An RE is the smallest time-frequency unit in a resource grid. The RNC function(s) dynamically allocate resources (e.g., PRBs and modulation and coding schemes (MCS)) to each UE 3310 at each transmission time interval (TTI). A TTI is the duration of a transmission on a radio link 3303a. 3305, and is related to the size of the data blocks passed to the radio link layer from higher network layers.

The NANs 3331, 3332 may be configured to communicate with one another via respective interfaces or links (not shown), such as an X2 interface for LTE implementations (e.g., when CN 3342 is an Evolved Packet Core (EPC)), an Xn interface for 5G or NR implementations (e.g., when CN 3342 is an Fifth Generation Core (5GC)), or the like. The NANs 3331 and 3332 are also communicatively coupled to CN 3342. Additionally or alternatively, the CN 3342 may be an evolved packet core (EPC) network, a NextGen Packet Core (NPC) network, a 5G core (5GC), or some other type of CN. The CN 3342 is a network of network elements and/or network functions (NFs) relating to a part of a communications network that is independent of the connection technology used by a terminal or user device. The CN 3342 comprises a plurality of network elements/NFs configured to offer various data and telecommunications services to customers/subscribers (e.g., users of UEs 3312 and IoT devices 3311) who are connected to the CN 3342 via a RAN. The components of the CN 3342 may be implemented in one physical node or separate physical nodes including components to read and execute instructions from a machine-readable or computer-readable medium (e.g., a non-transitory machine-readable storage medium). Additionally or alternatively, Network Functions Virtualization (NFV) may be utilized to virtualize any or all of the above-described network node functions via executable instructions stored in one or more computer-readable storage mediums (described in further detail infra). A logical instantiation of the CN 3342 may be referred to as a network slice, and a logical instantiation of a portion of the CN 3342 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more CN 3342 components/functions.

The CN 3342 is shown to be communicatively coupled to an application server 3350 and a network 3350 via an IP communications interface 3355, the one or more server(s) 3350 comprise one or more physical and/or virtualized systems for providing functionality (or services) to one or more clients (e.g., UEs 3312 and IoT devices 3311) over a network. The server(s) 3350 may include various computer devices with rack computing architecture component(s), tower computing architecture component(s), blade computing architecture component(s), and/or the like. The server(s) 3350 may represent a cluster of servers, a server farm, a cloud computing service, or other grouping or pool of servers, which may be located in one or more datacenters. The server(s) 3350 may also be connected to, or otherwise associated with one or more data storage devices (not shown). Moreover, the server(s) 3350 may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art. Generally, the server(s) 3350 offer applications or services that use IP/network resources. As examples, the server(s) 3350 may provide traffic management services, cloud analytics, content streaming services, immersive gaming experiences, social networking and/or microblogging services, and/or other like services. In addition, the various services provided by the server(s) 3350 may include initiating and controlling software and/or firmware updates for applications or individual components implemented by the UEs 3312 and IoT devices 3311. The server(s) 3350 can also be configured to support one or more communication services (e.g., Voice-over-Internet Protocol (VOIP) sessions. PTT sessions, group communication sessions, social networking services, and the like) for the UEs 3312 and IoT devices 3311 via the CN 3342.

The Radio Access Technologies (RATs) employed by the NANs 3330, the UEs 3310, and the other elements in FIG. 33 may include, for example, any of the communication protocols and/or RATs discussed herein. Different technologies exhibit benefits and limitations in different scenarios, and application performance in different scenarios becomes dependent on the choice of the access networks (e.g., WiFi. LTE, and the like) and the used network and transport protocols (e.g., Transfer Control Protocol (TCP). Virtual Private Network (VPN). Multi-Path TCP (MPTCP). Generic Routing Encapsulation (GRE), and the like). These RATs may include one or more V2X RATs, which allow these elements to communicate directly with one another, with infrastructure equipment (e.g., NANs 3330), and other devices. In some implementations, at least two distinct V2X RATs may be used including WLAN V2X (W-V2X) RAT based on IEEE V2X technologies (e.g., DSRC for the U.S. and ITS-G5 for Europe) and 3GPP C-V2X RAT (e.g., LTE. 5G/NR, and beyond). In one example, the C-V2X RAT may utilize a C-V2X air interface and the WLAN V2X RAT may utilize an W-V2X air interface.

The W-V2X RATs include, for example, IEEE Guide for Wireless Access in Vehicular Environments (WAVE) Architecture, IEEE STANDARDS ASSOCIATION, IEEE 1609.0-2019 (10 Apr. 2019) (“[IEEE16090]”). V2X Communications Message Set Dictionary, SAE INT'L (23 Jul. 2020) (“[J2735_202007]”). Intelligent Transport Systems in the 5 GHz frequency band (ITS-G5), the [IEEE80211p] (which is the layer 1 (L1) and layer 2 (L2) part of WAVE, DSRC, and ITS-G5), and/or IEEE Standard for Air Interface for Broadband Wireless Access Systems, IEEE Std 802.16-2017, pp. 1-2726 (2 Mar. 2018) (“[WiMAX]”). The term “DSRC” refers to vehicular communications in the 5.9 GHZ frequency band that is generally used in the United States, while “ITS-G5” refers to vehicular communications in the 5.9 GHZ frequency band in Europe. Since any number of different RATs are applicable (including [IEEE80211p] RATs) that may be used in any geographic or political region, the terms “DSRC” (used, among other regions, in the U.S.) and “ITS-G5” (used, among other regions, in Europe) may be used interchangeably throughout this disclosure. The access layer for the ITS-G5 interface is outlined in ETSI EN 302 663 V1.3.1 (2020 January) (hereinafter “[EN302663]”) and describes the access layer of the ITS-S reference architecture. The ITS-G5 access layer comprises [IEEE80211] (which now incorporates [IEEE80211p]), as well as features for Decentralized Congestion Control (DCC) methods discussed in ETSI TS 102 687 V1.2.1 (2018 April) (“[TS102687]”). The access layer for 3GPP LTE-V2X based interface(s) is outlined in, inter alia. ETSI EN 303 613 V1.1.1 (2020 January). 3GPP TS 23.285 v16.2.0 (2019 December); and 3GPP 5G/NR-V2X is outlined in, inter alia. 3GPP TR 23.786 v16.1.0 (2019 June) and 3GPP TS 23.287 v16.2.0 (2020 March).

The cloud 3344 may represent a cloud computing architecture/platform that provides one or more cloud computing services. Cloud computing refers to a paradigm for enabling network access to a scalable and elastic pool of shareable computing resources with self-service provisioning and administration on-demand and without active management by users. Computing resources (or simply “resources”) are any physical or virtual component, or usage of such components, of limited availability within a computer system or network. Examples of resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/applications, computer files, and/or the like. Cloud computing provides cloud computing services (or cloud services), which are one or more capabilities offered via cloud computing that are invoked using a defined interface (e.g., an API or the like). Some capabilities of cloud 3344 include application capabilities type, infrastructure capabilities type, and platform capabilities type. A cloud capabilities type is a classification of the functionality provided by a cloud service to a cloud service customer (e.g., a user of cloud 3344), based on the resources used. The application capabilities type is a cloud capabilities type in which the cloud service customer can use the cloud service provider's applications; the infrastructure capabilities type is a cloud capabilities type in which the cloud service customer can provision and use processing, storage or networking resources; and platform capabilities type is a cloud capabilities type in which the cloud service customer can deploy, manage and run customer-created or customer-acquired applications using one or more programming languages and one or more execution environments supported by the cloud service provider. Cloud services may be grouped into categories that possess some common set of qualities. Some cloud service categories that the cloud 3344 may provide include, for example, Communications as a Service (CaaS), which is a cloud service category involving real-time interaction and collaboration services; Compute as a Service (CompaaS), which is a cloud service category involving the provision and use of processing resources needed to deploy and run software; Database as a Service (DaaS), which is a cloud service category involving the provision and use of database system management services; Data Storage as a Service (DSaaS), which is a cloud service category involving the provision and use of data storage and related capabilities; Firewall as a Service (FaaS), which is a cloud service category involving providing firewall and network traffic management services; Infrastructure as a Service (IaaS), which is a cloud service category involving infrastructure capabilities type; Network as a Service (NaaS), which is a cloud service category involving transport connectivity and related network capabilities; Platform as a Service (PaaS), which is a cloud service category involving the platform capabilities type; Software as a Service (Saas), which is a cloud service category involving the application capabilities type; Security as a Service, which is a cloud service category involving providing network and information security (infosec) services; and/or other like cloud services.

Additionally or alternatively, the cloud 3344 may represent one or more cloud servers, application servers, web servers, and/or some other remote infrastructure. The remote/cloud servers may include any one of a number of services and capabilities such as, for example, any of those discussed herein. Additionally or alternatively, the cloud 3344 may represent a network such as the Internet, a local area network (LAN), a wide area network (WAN), a wireless local area network (WLAN), or a wireless wide area network (WWAN) including proprietary and/or enterprise networks for a company or organization, or combinations thereof. The cloud 3344 may be a network that comprises computers, network connections among the computers, and software routines to enable communication between the computers over network connections. In this regard, the cloud 3344 comprises one or more network elements that may include one or more processors, communications systems (e.g., including network interface controllers, one or more transmitters/receivers connected to one or more antennas, and the like), and computer readable media. Examples of such network elements may include wireless access points (WAPs), home/business servers (with or without RF communications circuitry), routers, switches, hubs, radio beacons, base stations, picocell or small cell base stations, backbone gateways, and/or any other like network device. Connection to the cloud 3344 may be via a wired or a wireless connection using the various communication protocols discussed infra. More than one network may be involved in a communication session between the illustrated devices. Connection to the cloud 3344 may require that the computers execute software routines which enable, for example, the seven layers of the OSI model of computer networking or equivalent in a wireless (cellular) phone network. Cloud 3344 may be used to enable relatively long-range communication such as, for example, between the one or more server(s) 3350 and one or more UEs 3310. Additionally or alternatively, the cloud 3344 may represent the Internet, one or more cellular networks, local area networks, or wide area networks including proprietary and/or enterprise networks. TCP/Internet Protocol (IP)-based network, or combinations thereof. In these implementations, the cloud 3344 may be associated with network operator who owns or controls equipment and other elements necessary to provide network-related services, such as one or more base stations or access points, one or more servers for routing digital data or telephone calls (e.g., a core network or backbone network), and the like The backbone links 3355 may include any number of wired or wireless technologies, and may be part of a LAN, a WAN, or the Internet. In one example, the backbone links 3355 are fiber backbone links that couple lower levels of service providers to the Internet, such as the CN 3312 and cloud 3344.

As shown by FIG. 33, each of the NANs 3331, 3332, and 3333 are co-located with edge compute nodes (or “edge servers”) 3336a, 3336b, and 3336c, respectively. These implementations may be small-cell clouds (SCCs) where an edge compute node 3336 is co-located with a small cell (e.g., pico-cell, femto-cell, and the like), or may be mobile micro clouds (MCCs) where an edge compute node 3336 is co-located with a macro-cell (e.g., an eNB, gNB, and the like). The edge compute node 3336 may be deployed in a multitude of arrangements other than as shown by FIG. 33. In a first example, multiple NANs 3330 are co-located or otherwise communicatively coupled with one edge compute node 3336. In a second example, the edge servers 3336 may be co-located or operated by RNCs, which may be the case for legacy network deployments, such as 3G networks. In a third example, the edge servers 3336 may be deployed at cell aggregation sites or at multi-RAT aggregation points that can be located either within an enterprise or used in public coverage areas. In a fourth example, the edge servers 3336 may be deployed at the edge of CN 3342. These implementations may be used in follow-me clouds (FMC), where cloud services running at distributed data centers follow the UEs 3310 as they roam throughout the network.

In any of the implementations discussed herein, the edge servers 3336 provide a distributed computing environment for application and service hosting, and also provide storage and processing resources so that data and/or content can be processed in close proximity to subscribers (e.g., users of UEs 3310) for faster response times The edge servers 3336 also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge servers 3336 from the UEs 3310, CN 3342, cloud 3344, and/or server(s) 3350, or vice versa. For example, a device application or client application operating in a UE 3310 may offload application tasks or workloads to one or more edge servers 3336. In another example, an edge server 3336 may offload application tasks or workloads to one or more UE 3310 (e.g., for distributed ML computation or the like).

The edge compute nodes 3336 may include or be part of an edge system 3335 that employs one or more ECTs 3335. The edge compute nodes 3336 may also be referred to as “edge hosts 3336” or “edge servers 3336.” The edge system 3335 includes a collection of edge servers 3336 and edge management systems (not shown by FIG. 33) necessary to run edge computing applications within an operator network or a subset of an operator network. The edge servers 3336 are physical computer systems that may include an edge platform and/or virtualization infrastructure, and provide compute, storage, and network resources to edge computing applications. Each of the edge servers 3336 are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 3310. The VI of the edge servers 3336 provide virtualized environments and virtualized resources for the edge hosts, and the edge computing applications may run as VMs and/or application containers on top of the VI.

In one example implementation, the ECT 3335 is and/or operates according to the MEC framework, as discussed in ETSI GR MEC 001 v3.1.1 (2022 January), ETSI GS MEC 003 v3.1.1 (2022 March), ETSI GS MEC 009 v3.1.1 (2021 June), ETSI GS MEC 010-1 v1.1.1 (2017 December), ETSI GS MEC 010-2 v2.2.1 (2022 February), ETSI GS MEC 011 v2.2.1 (2020 December), ETSI GS MEC 012 V2.2.1 (2022 February), ETSI GS MEC 013 V2.2.1 (2022 January), ETSI GS MEC 014 v2.1.1 (2021 March), ETSI GS MEC 015 v2.1.1 (2020 June), ETSI GS MEC 016 v2.2.1 (2020 April), ETSI GS MEC 021 v2.2.1 (2022 February), ETSI GR MEC 024 v2.1.1 (2019 November), ETSI GS MEC 028 V2.2.1 (2021 July), ETSI GS MEC 029 v2.2.1 (2022 January), ETSI MEC GS 030 v2.1.1 (2020 April), ETSI GR MEC 031 v2.1.1 (2020 December), U.S. Provisional App. No. 63/003,834 filed Apr. 1, 2020 (“[US'834]”), and Int'l App. No. PCT/US2020/066969 filed on Dec. 23, 2020 (“[PCT'696]”) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (2021 March), ETSI GS NFV 002 V1.2.1 (2014 December), ETSI GR NFV 003 V1.6.1 (2021 March), ETSI GS NFV 006 V2.1.1 (2021 January), ETSI GS NFV-INF 001 V1.1.1 (2015 January), ETSI GS NFV-INF 003 V1.1.1 (2014 December), ETSI GS NFV-INF 004 V1.1.1 (2015 January), ETSI GS NFV-MAN 001 v1.1.1 (2014 December), and/or Israel et al., OSM Release FIVE Technical Overview, ETSI OPEN SOURCE MANO, OSM White Paper, 1st ed. (January 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used such as, for example, those discussed in E2E Network Slicing Architecture, GSMA, Official Doc. NG.127, v1.0 (3 Jun. 2021), https://www.gsma.com/newsroom/wp-content/uploads/NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.2.0 (2022 Mar. 22) (“[TS28533]”), the contents of each of which are hereby incorporated by reference in their entireties.

In another example implementation, the ECT 3335 is and/or operates according to the O-RAN framework. Typically, front-end and back-end device vendors and carriers have worked closely to ensure compatibility. The flip-side of such a working model is that it becomes quite difficult to plug-and-play with other devices and this can hamper innovation. To combat this, and to promote openness and inter-operability at every level, several key players interested in the wireless domain (e.g., carriers, device manufacturers, academic institutions, and/or the like) formed the Open RAN alliance (“O-RAN”) in 2018. The O-RAN network architecture is a building block for designing virtualized RAN on programmable hardware with radio access control powered by AI. Various aspects of the O-RAN architecture are described in O-RAN Architecture Description v05.00, O-RAN ALLIANCE WG1 (July 2021); O-RAN Operations and Maintenance Architecture Specification v04.00, O-RAN ALLIANCE WG1 (November 2020); O-RAN Operations and Maintenance Interface Specification v04.00, O-RAN ALLIANCE WG1 (November 2020); O-RAN Information Model and Data Models Specification v01.00, O-RAN ALLIANCE WG1 (November 2020); O-RAN Working Group 1 Slicing Architecture v05.00, O-RAN ALLIANCE WG1 (July 2021); O-RAN Working Group 2 (Non-RT RIC and A1 interface WG) A1 interface: Application Protocol v03.01, O-RAN ALLIANCE WG2 (March 2021); O-RAN Working Group 2 (Non-RT RIC and A1 interface WG) A1 interface: Type Definitions v02.00, O-RAN ALLIANCE WG2 (July 2021); O-RAN Working Group 2 (Non-RT RIC and A1 interface WG) A1 interface: Transport Protocol v01.01, O-RAN ALLIANCE WG2 (March 2021); O-RAN Working Group 2 AI/ML workflow description and requirements v01.03 O-RAN ALLIANCE WG2 (July 2021); O-RAN Working Group 2 Non-RT RIC: Functional Architecture v01.03 O-RAN ALLIANCE WG2 (July 2021); O-RAN Working Group 3, Near-Real-time Intelligent Controller, E2 Application Protocol (E2AP) v02.00, O-RAN ALLIANCE WG3 (July 2021); O-RAN Working Group 3 Near-Real-time Intelligent Controller Architecture & E2 General Aspects and Principles v02.00, O-RAN ALLIANCE WG3 (July 2021); O-RAN Working Group 3 Near-Real-time Intelligent Controller E2 Service Model (E2SM) v02.00, O-RAN ALLIANCE WG3 (July 2021); O-RAN Working Group 3 Near-Real-time Intelligent Controller E2 Service Model (E2SM) KPM v02.00, O-RAN ALLIANCE WG3 (July 2021); O-RAN Working Group 3 Near-Real-time Intelligent Controller E2 Service Model (E2SM) RAN Function Network Interface (NI) v01.00, O-RAN ALLIANCE WG3 (February 2020); O-RAN Working Group 3 Near-Real-time Intelligent Controller E2 Service Model (E2SM) RAN Control v01.00, O-RAN ALLIANCE WG3 (July 2021); O-RAN Working Group 3 Near-Real-time Intelligent Controller Near-RT RIC Architecture v02.00, O-RAN ALLIANCE WG3 (March 2021); O-RAN Fronthaul Working Group 4 Cooperative Transport Interface Transport Control Plane Specification v02.00, O-RAN ALLIANCE WG4 (March 2021); O-RAN Fronthaul Working Group 4 Cooperative Transport Interface Transport Management Plane Specification v02.00, O-RAN ALLIANCE WG4 (March 2021); O-RAN Fronthaul Working Group 4 Control. User, and Synchronization Plane Specification v07.00, O-RAN ALLIANCE WG4 (July 2021); O-RAN Fronthaul Working Group 4 Management Plane Specification v07.00, O-RAN ALLIANCE WG4 (July 2021); O-RAN Open F1/W1/E1/X2 Xn Interfaces Working Group Transport Specification v01.00, O-RAN ALLIANCE WG5 (April 2020); O-RAN Alliance Working Group 5 O1 Interface specification for O-DU v02.00, O-RAN ALLIANCE WGX (July 2021); Cloud Architecture and Deployment Scenarios for O-RAN Virtualized RAN v02.02, O-RAN ALLIANCE WG6 (July 2021); O-RAN Acceleration Abstraction Layer General Aspects and Principles v01.01, O-RAN ALLIANCE WG6 (July 2021); Cloud Platform Reference Designs v02.00, O-RAN ALLIANCE WG6 (November 2020); O-RAN O2 Interface General Aspects and Principles v01.01, O-RAN ALLIANCE WG6 (July 2021); O-RAN White Box Hardware Working Group Hardware Reference Design Specification for Indoor Pico Cell with Fronthaul Split Option 6 v02.00, O-RAN ALLIANCE WG7 (July 2021); O-RAN WG7 Hardware Reference Design Specification for Indoor Picocell (FR1) with Split Option 7-2 v03.00, O-RAN ALLIANCE WG7 (July 2021); O-RAN WG7 Hardware Reference Design Specification for Indoor Picocell (FR1) with Split Option 8 v03.00, O-RAN ALLIANCE WG7 (July 2021); O-RAN Open Transport Working Group 9 Xhaul Packet Switched Architectures and Solutions v02.00, O-RAN ALLIANCE WG9 (July 2021); O-RAN Open X-haul Transport Working Group Management interfaces for Transport Network Elements v02.00, O-RAN ALLIANCE WG9 (July 2021); O-RAN Open X-haul Transport WG9 WDM-based Fronthaul Transport v01.00, O-RAN ALLIANCE WG9 (November 2020); O-RAN Open X-haul Transport Working Group Synchronization Architecture and Solution Specification v01.00, O-RAN ALLIANCE WG9 (March 2021); O-RAN Operations and Maintenance Interface Specification v05.00, O-RAN ALLIANCE WG10 (July 2021); O-RAN Operations and Maintenance Architecture v05.00, O-RAN ALLIANCE WG10 (July 2021); O-RAN: Towards an Open and Smart RAN, O-RAN ALLIANCE, White Paper (October 2018), and U.S. application Ser. No. 17/484,743 filed on 24 Sep. 2021 (“[US'743]”) (collectively referred to as “[O-RAN]”); the contents of each of which are hereby incorporated by reference in their entireties.

In another example implementation, the ECT 3335 is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v17.2.0 (2021-12-31), 3GPP TS 23.501 v17.5.0 (2022 Jun. 15) (“[TS23501]”), 3GPP TS 28.538 v17.1.0 (2022 Jun. 16) (“[TS28538]”), and U.S. application Ser. No. 17/484,719 filed on 24 Sep. 2021 (“[US'719]”) (collectively referred to as “[SA6Edge]”), the contents of each of which are hereby incorporated by reference in their entireties.

In another example implementation, the ECT 3335 is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/ (“[ISEO]”), the contents of which is hereby incorporated by reference in its entirety.

In another example implementation, the ECT 3335 operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties. In these implementations, an edge compute node 3335 and/or one or more cloud computing nodes/clusters may be one or more MAMS servers that includes or operates a Network Connection Manager (NCM) for downstream/DL traffic, and the individual UEs 3310 include or operate a Client Connection Manager (CCM) for upstream/UL traffic. An NCM is a functional entity that handles MAMS control messages from clients (e.g., individual UEs 3310 configures the distribution of data packets over available access paths and (core) network paths, and manages user-plane treatment (e.g., tunneling, encryption, and/or the like) of the traffic flows (see e.g., [RFC8743]. [MAMS]). The CCM is the peer functional element in a client (e.g., individual UEs 3310 that handles MAMS control-plane procedures, exchanges MAMS signaling messages with the NCM, and configures the network paths at the client for the transport of user data (e.g., network packets, and/or the like) (see e.g., [RFC8743]. [MAMS]).

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure.

### 6. Software Distribution Systems

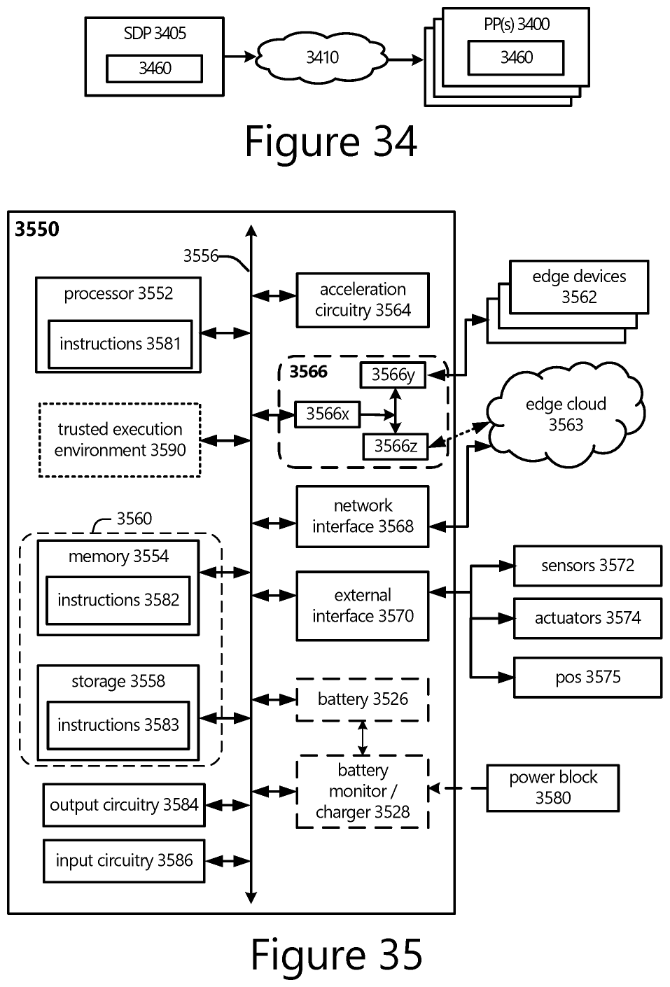

FIG. 34 illustrates an example software distribution platform 3405 to distribute software 3460, such as the example computer readable instructions 3560 of FIG. 35, to one or more devices, such as example processor platform(s) 3400 and/or example connected edge devices 3562 (see e.g., FIG. 35) and/or any of the other computing systems/devices discussed herein. The example software distribution platform 3405 may be implemented by any computer server, data facility, cloud service, and the like, capable of storing and transmitting software to other computing devices (e.g., third parties, the example connected edge devices 3562 of FIG. 35). Example connected edge devices may be customers, clients, managing devices (e.g., servers), third parties (e.g., customers of an entity owning and/or operating the software distribution platform 3405). Example connected edge devices may operate in commercial and/or home automation environments. In some examples, a third party is a developer, a seller, and/or a licensor of software such as the example computer readable instructions 3560 of FIG. 35. The third parties may be consumers, users, retailers, OEMs, and the like that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), and the like).

In the illustrated example of FIG. 34, the software distribution platform 3405 includes one or more servers and one or more storage devices. The storage devices store the computer readable instructions 3460, which may correspond to the example computer readable instructions 3560 of FIG. 35, as described above. The one or more servers of the example software distribution platform 3405 are in communication with a network 3410, which may correspond to any one or more of the Internet and/or any of the example networks as described herein. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 3460 from the software distribution platform 3405. For example, the software 3460, which may correspond to the example computer readable instructions 3560 of FIG. 35, may be downloaded to the example processor platform(s) 3400, which is/are to execute the computer readable instructions 3460 to implement Radio apps.

In some examples, one or more servers of the software distribution platform 3405 are communicatively connected to one or more security domains and/or security devices through which requests and transmissions of the example computer readable instructions 3460 must pass. In some examples, one or more servers of the software distribution platform 3405 periodically offer, transmit, and/or force updates to the software (e.g., the example computer readable instructions 3560 of FIG. 35) to ensure improvements, patches, updates, and the like are distributed and applied to the software at the end user devices.

In the illustrated example of FIG. 34, the computer readable instructions 3460 are stored on storage devices of the software distribution platform 3405 in a particular format. A format of computer readable instructions includes, but is not limited to a particular code language (e.g., Java, JavaScript, Python, C, C#, SQL, HTML, and the like), and/or a particular code state (e.g., uncompiled code (e.g., ASCII), interpreted code, linked code, executable code (e.g., a binary), and the like). In some examples, the computer readable instructions 3582 stored in the software distribution platform 3405 are in a first format when transmitted to the example processor platform(s) 3400. In some examples, the first format is an executable binary in which particular types of the processor platform(s) 3400 can execute. However, in some examples, the first format is uncompiled code that requires one or more preparation tasks to transform the first format to a second format to enable execution on the example processor platform(s) 3400. For instance, the receiving processor platform(s) 3400 may need to compile the computer readable instructions 3460 in the first format to generate executable code in a second format that is capable of being executed on the processor platform(s) 3400. In still other examples, the first format is interpreted code that, upon reaching the processor platform(s) 3400, is interpreted by an interpreter to facilitate execution of instructions.

### 7. Hardware Components

FIG. 35 illustrates an example of components that may be present in an compute node 3550) for implementing the techniques (e.g., operations, processes, methods, and methodologies) described herein. This compute node 3550 provides a closer view of the respective components of node 3550 when implemented as or as part of a computing device (e.g., as a mobile device, a base station, server, gateway, and/or the like). The compute node 3550) may include any combinations of the hardware or logical components referenced herein, and it may include or couple with any device usable with an edge communication network or a combination of such networks. The components may be implemented as ICs, portions thereof, discrete electronic devices, or other modules, instruction sets, programmable logic or algorithms, hardware, hardware accelerators, software, firmware, or a combination thereof adapted in the compute node 3550), or as components otherwise incorporated within a chassis of a larger system. The compute node 3550 may be embodied as a type of device, appliance, computer, or other “thing” capable of communicating with other edge, networking, or endpoint components. For example, compute node 3550 may be embodied as a smartphone, a mobile compute device, a smart appliance, an in-vehicle compute system (e.g., a navigation system), an edge compute node, a NAN, switch, router, bridge, hub, and/or other device or system capable of performing the described functions. In some examples, the compute node 3550 may correspond to requestor 110 and/or the ego component 120 of FIG. 1; controller 310 and/or component(s) 320 of FIGS. 3-5; producer 610 and/or consumer 610 of FIG. 6; HRAI system 710 and/or HRAI registration DB 720 of FIG. 7; external component 950 and/or any of the AI systems 902, 1420, 1620, 1820, 1920, and/or 2310 of FIGS. 9-23; compute node(s) 2302 of FIG. 23; SV 3101, (semi-)autonomous systems 3112, and/or compute nodes 3150 of FIG. 31; UEs 3310, NANs 3330, ECT 3335, edge compute nodes 3336, one or more network functions in CN 3342, one or more cloud compute nodes in cloud 3344, and/or server(s) 3350 of FIG. 33; SVs 3201, UEs 3220, 3225, RAN 3230, CN 3240, MIMO antenna 3250, and/or satellite dish 3260 in FIG. 32; software distribution platform 3405 and/or processor platform(s) 3400 of FIG. 34; and/or any other component, device, and/or system discussed herein.

The compute node 3550 includes processing circuitry in the form of one or more processors 3552. The processor circuitry 3552 includes circuitry such as, for example, one or more processor cores and one or more of cache memory, low drop-out voltage regulators (LDOs), interrupt controllers, serial interfaces such as SPI, I²C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 3552 may include one or more hardware accelerators (e.g., same or similar to acceleration circuitry 3564), which may be microprocessors, programmable processing devices (e.g., FPGA, ASIC, and/or the like), or the like. The one or more accelerators may include, for example, computer vision and/or deep learning accelerators. In some implementations, the processor circuitry 3552 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein. The processor circuitry 3552 includes a microarchitecture that is capable of executing the μenclave implementations and techniques discussed herein. The processors (or cores) 3552 may be coupled with or may include memory/storage and may be configured to execute instructions stored in the memory/storage to enable various applications or OSs to run on the platform 3550. The processors (or cores) 3552 is configured to operate application software to provide a specific service to a user of the platform 3550. Additionally or alternatively, the processor(s) 3552 may be a special-purpose processor(s)/controller(s) configured (or configurable) to operate according to the elements, features, and implementations discussed herein.

The processor circuitry 3552 may be or include, for example, one or more processor cores (CPUs), application processors, graphics processing units (GPUs), RISC processors, Acorn RISC Machine (ARM) processors, CISC processors, one or more DSPs, FPGAs, PLDs, one or more ASICs, baseband processors, radio-frequency integrated circuits (RFIC), microprocessors or controllers, multi-core processor, multithreaded processor, ultra-low voltage processor, embedded processor, an XPU, a data processing unit (DPU), an Infrastructure Processing Unit (IPU), a network processing unit (NPU), and/or any other known processing elements, or any suitable combination thereof.

As examples, the processor(s) 3552 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s). Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments. Inc.® Open Multimedia Applications Platform (OMAP)™ processor(s); a MIPS-based design from MIPS Technologies, Inc, such as MIPS Warrior M-class. Warrior I-class, and Warrior P-class processors; an ARM-based design licensed from ARM Holdings. Ltd., such as the ARM Cortex-A, Cortex-R, and Cortex-M family of processors; the ThunderX2® provided by Cavium™, Inc.; or the like. In some implementations, the processor(s) 3552 may be a part of a system on a chip (SoC), System-in-Package (SiP), a multi-chip package (MCP), and/or the like, in which the processor(s) 3552 and other components are formed into a single integrated circuit, or a single package, such as the Edison™ or Galileo™ SoC boards from Intel® Corporation. Other examples of the processor(s) 3552 are mentioned elsewhere in the present disclosure.

The processor(s) 3552 may communicate with system memory 3554 over an interconnect (IX) 3556. Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). Other types of RAM, such as static RAM (SRAM), dynamic RAM (DRAM), synchronous DRAM (SDRAM), and/or the like may also be included. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs. Additionally or alternatively, the memory circuitry 3554 is or includes block addressable memory device(s), such as those based on NAND or NOR technologies (e.g., single-level cell (“SLC”), Multi-Level Cell (“MLC”), Quad-Level Cell (“QLC”), Tri-Level Cell (“TLC”), or some other NAND).

To provide for persistent storage of information such as data, applications. OSs and so forth, a storage 3558 may also couple to the processor 3552 via the IX 3556. In an example, the storage 3558 may be implemented via a solid-state disk drive (SSDD) and/or high-speed electrically erasable memory (commonly referred to as “flash memory”). Other devices that may be used for the storage 3558 include flash memory cards, such as SD cards, microSD cards, extreme Digital (XD) picture cards, and the like, and USB flash drives. Additionally or alternatively, the memory circuitry 3554 and/or storage circuitry 3558 may be or may include memory devices that use chalcogenide glass, multi-threshold level NAND flash memory. NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, or a combination of any of the above, or other memory. Additionally or alternatively, the memory circuitry 3554 and/or storage circuitry 3558 can include resistor-based and/or transistor-less memory architectures. The memory circuitry 3554 and/or storage circuitry 3558 may also incorporate three-dimensional (3D) cross-point (XPOINT) memory devices (e.g., Intel® 3D XPoint™ memory), and/or other byte addressable write-in-place NVM. The memory circuitry 3554 and/or storage circuitry 3558 may refer to the die itself and/or to a packaged memory product.

In low power implementations, the storage 3558 may be on-die memory or registers associated with the processor 3552. However, in some examples, the storage 3558 may be implemented using a micro hard disk drive (HDD). Further, any number of new technologies may be used for the storage 3558 in addition to, or instead of, the technologies described, such resistance change memories, phase change memories, holographic memories, or chemical memories, among others.

Computer program code for carrying out operations of the present disclosure (e.g., computational logic and/or instructions 3581, 3582, 3583) may be written in any combination of one or more programming languages, including an object oriented programming language such as Python, Ruby, Scala, Smalltalk, Java™, C++, C #, or the like; a procedural programming languages, such as the “C” programming language, the Go (or “Golang”) programming language, or the like; a scripting language such as JavaScript, Server-Side JavaScript (SSJS), JQuery, PHP, Pearl, Python, Ruby on Rails, Accelerated Mobile Pages Script (AMPscript), Mustache Template Language, Handlebars Template Language, Guide Template Language (GTL), PHP, Java and/or Java Server Pages (JSP), Node.js, ASP.NET, JAMscript, and/or the like; a markup language such as Hypertext Markup Language (HTML). Extensible Markup Language (XML), Java Script Object Notion (JSON), Apex®, Cascading Stylesheets (CSS), JavaServer Pages (JSP), MessagePack™, Apache® Thrift, Abstract Syntax Notation One (ASN.1), Google® Protocol Buffers (protobuf), or the like; some other suitable programming languages including proprietary programming languages and/or development tools, or any other languages tools. The computer program code 3581, 3582, 3583 for carrying out operations of the present disclosure may also be written in any combination of the programming languages discussed herein. The program code may execute entirely on the system 3550, partly on the system 3550, as a stand-alone software package, partly on the system 3550) and partly on a remote computer or entirely on the remote computer or server. In the latter scenario, the remote computer may be connected to the system 3550) through any type of network, including a LAN or WAN, or the connection may be made to an external computer (e.g., through the Internet using an Internet Service Provider (ISP)).

In an example, the instructions 3581, 3582, 3583 on the processor circuitry 3552 (separately, or in combination with the instructions 3581, 3582, 3583) may configure execution or operation of a trusted execution environment (TEE) 3590. The TEE 3590 operates as a protected area accessible to the processor circuitry 3502 to enable secure access to data and secure execution of instructions. In some embodiments, the TEE 3590 may be a physical hardware device that is separate from other components of the system 3550) such as a secure-embedded controller, a dedicated SoC, or a tamper-resistant chipset or microcontroller with embedded processing devices and memory devices. Examples of such embodiments include a Desktop and mobile Architecture Hardware (DASH) compliant Network Interface Card (NIC). Intel® Management/Manageability Engine, Intel® Converged Security Engine (CSE) or a Converged Security Management/Manageability Engine (CSME), Trusted Execution Engine (TXE) provided by Intel® each of which may operate in conjunction with Intel® Active Management Technology (AMT) and/or Intel® vPro™ Technology; AMD® Platform Security coProcessor (PSP), AMD® PRO A-Series Accelerated Processing Unit (APU) with DASH manageability. Apple® Secure Enclave coprocessor; IBM® Crypto Express3 ®, IBM® 4807, 4808, 4809, and/or 4765 Cryptographic Coprocessors, IBM® Baseboard Management Controller (BMC) with Intelligent Platform Management Interface (IPMI), Dell™ Remote Assistant Card II (DRAC II), integrated Dell™ Remote Assistant Card (iDRAC), and the like.

Additionally or alternatively, the TEE 3590 may be implemented as secure enclaves (or “enclaves”), which are isolated regions of code and/or data within the processor and/or memory/storage circuitry of the compute node 3550. Only code executed within a secure enclave may access data within the same secure enclave, and the secure enclave may only be accessible using the secure application (which may be implemented by an application processor or a tamper-resistant microcontroller). Various implementations of the TEE 3590, and an accompanying secure area in the processor circuitry 3552 or the memory circuitry 3554 and/or storage circuitry 3558 may be provided, for instance, through use of Intel® Software Guard Extensions (SGX), ARM® TrustZone®, Keystone Enclaves. Open Enclave SDK, and/or the like. Other aspects of security hardening, hardware roots-of-trust, and trusted or protected operations may be implemented in the device 3500 through the TEE 3590 and the processor circuitry 3552. Additionally or alternatively, the memory circuitry 3554 and/or storage circuitry 3558 may be divided into isolated user-space instances such as virtualization/OS containers, partitions, virtual environments (VEs), and/or the like. The isolated user-space instances may be implemented using a suitable OS-level virtualization technology such as Docker® containers, Kubernetes® containers, Solaris® containers and/or zones, OpenVZ® virtual private servers, DragonFly BSD® virtual kernels and/or jails, chroot jails, and/or the like. Virtual machines could also be used in some implementations. In some embodiments, the memory circuitry 3504 and/or storage circuitry 3508 may be divided into one or more trusted memory regions for storing applications or software modules of the TEE 3590).

The OS stored by the memory circuitry 3554 and/or storage circuitry 3558 is software to control the compute node 3550. The OS may include one or more drivers that operate to control particular devices that are embedded in the compute node 3550, attached to the compute node 3550, and/or otherwise communicatively coupled with the compute node 3550. Example OSs include consumer-based operating systems (e.g., Microsoft® Windows® 10, Google® Android®, Apple® macOS®, Apple® IOS®, KaiOS™ provided by KaiOS Technologies Inc., Unix or a Unix-like OS such as Linux. Ubuntu, or the like), industry-focused OSs such as real-time OS (RTOS) (e.g., Apache® Mynewt, Windows® IoT® Android Things®, Micrium® MicroController OSs (“MicroC/OS” or “pC/OS”), VxWorks®, FreeRTOS, and/or the like), hypervisors (e.g., Xen® Hypervisor, Real-Time Systems® RTS Hypervisor, Wind River Hypervisor, VMWare® vSphere® Hypervisor, and/or the like), and/or the like. The OS can invoke alternate software to facilitate one or more functions and/or operations that are not native to the OS, such as particular communication protocols and/or interpreters. Additionally or alternatively, the OS instantiates various functionalities that are not native to the OS. In some examples, OSs include varying degrees of complexity and/or capabilities. In some examples, a first OS on a first compute node 3550 may be the same or different than a second OS on a second compute node 3550. For instance, the first OS may be an RTOS having particular performance expectations of responsivity to dynamic input conditions, and the second OS can include GUI capabilities to facilitate end-user I/O and the like.

The storage 3558 may include instructions 3583 in the form of software, firmware, or hardware commands to implement the techniques described herein. Although such instructions 3583 are shown as code blocks included in the memory 3554 and the storage 3558, any of the code blocks may be replaced with hardwired circuits, for example, built into an application specific integrated circuit (ASIC), FPGA memory blocks, and/or the like. In an example, the instructions 3581, 3582, 3583 provided via the memory 3554, the storage 3558, or the processor 3552 may be embodied as a non-transitory, machine-readable medium 3560) including code to direct the processor 3552 to perform electronic operations in the compute node 3550. The processor 3552 may access the non-transitory, machine-readable medium 3560 (also referred to as “computer readable medium 3560)” or “CRM 3560”) over the IX 3556. For instance, the non-transitory. CRM 3560 may be embodied by devices described for the storage 3558 or may include specific storage units such as storage devices and/or storage disks that include optical disks (e.g., digital versatile disk (DVD), compact disk (CD). CD-ROM. Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory. CRM 3560 may include instructions to direct the processor 3552 to perform a specific sequence or flow of actions, for example, as described with respect to the flowchart(s) and/or block diagram(s) of operations and functionality depicted herein.

The components of edge computing device 3550 may communicate over an interconnect (IX) 3556. The IX 3556 may represent any suitable type of connection or interface such as, for example, metal or metal alloys (e.g., copper, aluminum, and/or the like), fiber, and/or the like. The IX 3556 may include any number of IX, fabric, and/or interface technologies, including instruction set architecture (ISA), extended ISA (eISA). Inter-Integrated Circuit (I2C), serial peripheral interface (SPI), point-to-point interfaces, power management bus (PMBus), peripheral component interconnect (PCI), PCI express (PCIe), PCI extended (PCIx), Intel®; Ultra Path Interconnect (UPI), Intel® Accelerator Link, Intel® QuickPath Interconnect (QPI), Intel® Omni-Path Architecture (OPA), Compute Express Link™ (CXL™) IX technology, RapidIO™ IX, Coherent Accelerator Processor Interface (CAPI), OpenCAPI, cache coherent interconnect for accelerators (CCIX), Gen-Z Consortium IXs, HyperTransport IXs, NVLink provided by NVIDIA®, a Time-Trigger Protocol (TTP) system, a FlexRay system, PROFIBUS, ARM® Advanced extensible Interface (AXI), ARM® Advanced Microcontroller Bus Architecture (AMBA) IX, HyperTransport. Infinity Fabric (IF), and/or any number of other IX technologies. The IX 3556 may be a proprietary bus, for example, used in a SoC based system. Additionally or alternatively, the IX 3556 may be a suitable compute fabric.

The IX 3556 couples the processor 3552 to communication circuitry 3566 for communications with other devices, such as a remote server (not shown) and/or the connected edge devices 3562. The communication circuitry 3566 is a hardware element, or collection of hardware elements, used to communicate over one or more networks (e.g., cloud 3563) and/or with other devices (e.g., edge devices 3562). Communication circuitry 3566 includes modem circuitry 3566x may interface with application circuitry of compute node 3550 (e.g., a combination of processor circuitry 3502 and CRM 3560) for generation and processing of baseband signals and for controlling operations of the transceivers (TRx) 3566y and 3566z. The modem circuitry 3566x may handle various radio control functions that enable communication with one or more (R)ANs via the TRxs 3566y and 3566z according to one or more wireless communication protocols and/or RATs. The modem circuitry 3566x may include circuitry such as, but not limited to, one or more single-core or multi-core processors (e.g., one or more baseband processors) or control logic to process baseband signals received from a receive signal path of the TRxs 3566y, 3566, and to generate baseband signals to be provided to the TRxs 3566y, 3566z via a transmit signal path. The modem circuitry 3566x may implement a real-time OS (RTOS) to manage resources of the modem circuitry 3566x, schedule tasks, perform the various radio control functions, process the transmit/receive signal paths, and the like. In some implementations, the modem circuitry 3566x includes a parch that is capable of executing the μenclave implementations and techniques discussed herein.

The TRx 3566y may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 3562. For example, a wireless local area network (WLAN) unit may be used to implement Wi-Fi® communications in accordance with a also IEEE Standard for Local and Metropolitan Area Networks: Overview and Architecture, IEEE Std 802-2014, pp. 1-74 (30 Jun. 2014) (“[IEEE802]”) [IEEE802] standard (e.g., IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”) [IEEE80211] and/or the like). In addition, wireless wide area communications, e.g., according to a cellular or other wireless wide area protocol, may occur via a wireless wide area network (WWAN) unit.

The TRx 3566y (or multiple transceivers 3566y) may communicate using multiple standards or radios for communications at a different range. For example, the compute node 3550) may communicate with relatively close devices (e.g., within about 10 meters) using a local transceiver based on BLE, or another low power radio, to save power. More distant connected edge devices 3562 (e.g., within about 50 meters) may be reached over ZigBee® or other intermediate power radios. Both communications techniques may take place over a single radio at different power levels or may take place over separate transceivers, for example, a local transceiver using BLE and a separate mesh transceiver using ZigBee®.

A TRx 3566z (e.g., a radio transceiver) may be included to communicate with devices or services in the edge cloud 3563 via local or wide area network protocols. The TRx 3566z may be an LPWA transceiver that follows IEEE Standard for Low-Rate Wireless Networks, IEEE Std 802.15.4-2020, pp. 1-800 (23 Jul. 2020) (“[IEEE802154]”) [IEEE802154] or IEEE 802.15.4g standards, among others. The edge computing node 3563 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used. Any number of other radio communications and protocols may be used in addition to the systems mentioned for the TRx 3566z, as described herein. For example, the TRx 3566z may include a cellular transceiver that uses spread spectrum (SPA/SAS) communications for implementing high-speed communications. Further, any number of other protocols may be used, such as WiFi® networks for medium speed communications and provision of network communications. The TRx 3566z may include radios that are compatible with any number of 3GPP specifications, such as LTE and 5G/NR communication systems.

A network interface controller (NIC) 3568 may be included to provide a wired communication to nodes of the edge cloud 3563 or to other devices, such as the connected edge devices 3562 (e.g., operating in a mesh, fog, and/or the like). The wired communication may provide an Ethernet connection (see e.g., Ethernet (e.g., IEEE Standard for Ethernet, IEEE Std 802.3-2018, pp. 1-5600 (31 Aug. 2018) (“[IEEE8023]”)) or may be based on other types of networks, such as Controller Area Network (CAN). Local Interconnect Network (LIN), DeviceNet, ControlNet, Data Highway+, or PROFINET, among many others. In some implementations, the NIC 3568 may be an Ethernet controller (e.g., a Gigabit Ethernet Controller or the like), a SmartNIC, Intelligent Fabric Processor(s) (IFP(s)). An additional NIC 3568 may be included to enable connecting to a second network, for example, a first NIC 3568 providing communications to the cloud over Ethernet, and a second NIC 3568 providing communications to other devices over another type of network.

Given the variety of types of applicable communications from the device to another component or network, applicable communications circuitry used by the device may include or be embodied by any one or more of components 3564, 3566, 3568, or 3570. Accordingly, in various examples, applicable means for communicating (e.g., receiving, transmitting, and/or the like) may be embodied by such communications circuitry.

The compute node 3550 can include or be coupled to acceleration circuitry 3564, which may be embodied by one or more hardware accelerators, a neural compute stick, neuromorphic hardware, FPGAs, GPUs, SoCs (including programmable SoCs), vision processing units (VPUs), digital signal processors, dedicated ASICs, programmable ASICs, PLDs (e.g., CPLDs and/or HCPLDs), DPUs, IPUs, NPUs, and/or other forms of specialized processors or circuitry designed to accomplish one or more specialized tasks. Additionally or alternatively, the acceleration circuitry 3564 is embodied as one or more XPUs. In some implementations, an XPU is a multi-chip package including multiple chips stacked like tiles into an XPU, where the stack of chips includes any of the processor types discussed herein. Additionally or alternatively, an XPU is implemented by a heterogeneous computing system including multiple types of processor circuitry (e.g., one or more FPGAs, one or more CPUs, one or more GPUs, one or more DSPs, and/or the like, and/or a combination thereof) and application programming interface(s) (API(s)) that may assign computing task(s) to whichever one(s) of the multiple types of the processing circuitry is/are best suited to execute the computing task(s). In any of these implementations, the tasks may include AI/ML tasks (e.g., training, inferencing/prediction, classification, and the like), visual data processing, network data processing, infrastructure function management, object detection, rule analysis, or the like. In FPGA-based implementations, the acceleration circuitry 3564 may comprise logic blocks or logic fabric and other interconnected resources that may be programmed (configured) to perform various functions, such as the procedures, methods, functions, and/or the like discussed herein. In such implementations, the acceleration circuitry 3564 may also include memory cells (e.g., EPROM, EEPROM, flash memory, static memory (e.g., SRAM, anti-fuses, and/or the like) used to store logic blocks, logic fabric, data, and/or the like in LUTs and the like.

In some implementations, the acceleration circuitry 3564 and/or the processor circuitry 3552 can be or include may be a cluster of artificial intelligence (AI) GPUs, tensor processing units (TPUs) developed by Google® Inc., Real AI Processors (RAPS™) provided by AlphaICs®, Intel® Nervana™ Neural Network Processors (NNPs), Intel® Movidius™ Myriad™ X Vision Processing Units (VPUs), NVIDIA® PX™ based GPUs, the NM500 chip provided by General Vision®, Tesla® Hardware 3 processor, an Adaptevak; Epiphany™ based processor, and/or the like. Additionally or alternatively, the acceleration circuitry 3564 and/or the processor circuitry 3552 can be implemented as AI accelerating co-processor(s), such as the Hexagon 685 DSP provided by Qualcomm®, the PowerVR 2NX Neural Net Accelerator (NNA) provided by Imagination Technologies Limited®, the Apple® Neural Engine core, a Neural Processing Unit (NPU) within the HiSilicon Kirin 970 provided by Huawei®, and/or the like.

The IX 3556 also couples the processor 3552 to an external interface 3570) that is used to connect additional devices or subsystems. In some implementations, the interface 3570 can include one or more input/output (I/O) controllers. Examples of such I/O controllers include integrated memory controller (IMC), memory management unit (MMU), input-output MMU (IOMMU), sensor hub, General Purpose I/O (GPIO) controller, PCIe endpoint (EP) device, direct media interface (DMI) controller, Intel® Flexible Display Interface (FDI) controller(s), VGA interface controller(s), Peripheral Component Interconnect Express (PCIe) controller(s), universal serial bus (USB) controller(s), extensible Host Controller Interface (xHCI) controller(s), Enhanced Host Controller Interface (EHCI) controller(s), Serial Peripheral Interface (SPI) controller(s), Direct Memory Access (DMA) controller(s), hard drive controllers (e.g., Serial AT Attachment (SATA) host bus adapters/controllers. Intel® Rapid Storage Technology (RST), and/or the like), Advanced Host Controller Interface (AHCI), a Low Pin Count (LPC) interface (bridge function), Advanced Programmable Interrupt Controller(s) (APIC), audio controller(s), SMBus host interface controller(s). UART controller(s), and/or the like. Some of these controllers may be part of, or otherwise applicable to the memory circuitry 3554, storage circuitry 3558, and/or IX 3556 as well. The additional/external devices may include sensors 3572, actuators 3574, and positioning circuitry 3545.

The sensor circuitry 3572 includes devices, modules, or subsystems whose purpose is to detect events or changes in its environment and send the information (sensor data) about the detected events to some other a device, module, subsystem, and/or the like. Examples of such sensors 3572 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors, including sensors for measuring the temperature of internal components and sensors for measuring temperature external to the compute node 3550); pressure sensors; barometric pressure sensors; gravimeters; altimeters; image capture devices (e.g., cameras); light detection and ranging (LiDAR) sensors; proximity sensors (e.g., infrared radiation detector and the like); depth sensors, ambient light sensors; optical light sensors; ultrasonic transceivers; microphones; and the like.

The actuators 3574, allow platform 3550 to change its state, position, and/or orientation, or move or control a mechanism or system. The actuators 3574 comprise electrical and/or mechanical devices for moving or controlling a mechanism or system, and converts energy (e.g., electric current or moving air and/or liquid) into some kind of motion. The actuators 3574 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 3574 may include one or more electromechanical devices such as pneumatic actuators, hydraulic actuators, electromechanical switches including electromechanical relays (EMRs), motors (e.g., DC motors, stepper motors, servomechanisms, and/or the like), power switches, valve actuators, wheels, thrusters, propellers, claws, clamps, hooks, audible sound generators, visual warning devices, and/or other like electromechanical components. The platform 3550) may be configured to operate one or more actuators 3574 based on one or more captured events and/or instructions or control signals received from a service provider and/or various client systems.

The positioning circuitry 3545 includes circuitry to receive and decode signals transmitted/broadcasted by a positioning network of a global navigation satellite system (GNSS). Examples of navigation satellite constellations (or GNSS) include United States' Global Positioning System (GPS). Russia's Global Navigation System (GLONASS), the European Union's Galileo system. China's BeiDou Navigation Satellite System, a regional navigation system or GNSS augmentation system (e.g., Navigation with Indian Constellation (NAVIC), Japan's Quasi-Zenith Satellite System (QZSS). France's Doppler Orbitography and Radio-positioning Integrated by Satellite (DORIS), and/or the like), or the like. The positioning circuitry 3545 comprises various hardware elements (e.g., including hardware devices such as switches, filters, amplifiers, antenna elements, and the like to facilitate OTA communications) to communicate with components of a positioning network, such as navigation satellite constellation nodes. Additionally or alternatively, the positioning circuitry 3545 may include a Micro-Technology for Positioning. Navigation, and Timing (Micro-PNT) IC that uses a master timing clock to perform position tracking/estimation without GNSS assistance. The positioning circuitry 3545 may also be part of, or interact with, the communication circuitry 3566 to communicate with the nodes and components of the positioning network. The positioning circuitry 3545 may also provide position data and/or time data to the application circuitry, which may use the data to synchronize operations with various infrastructure (e.g., radio base stations), for turn-by-turn navigation, or the like. When a GNSS signal is not available or when GNSS position accuracy is not sufficient for a particular application or service, a positioning augmentation technology can be used to provide augmented positioning information and data to the application or service. Such a positioning augmentation technology may include, for example, satellite based positioning augmentation (e.g., EGNOS) and/or ground based positioning augmentation (e.g., DGPS). In some implementations, the positioning circuitry 3545 is, or includes an INS, which is a system or device that uses sensor circuitry 3572 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 3550 without the need for external references.

In some optional examples, various input/output (I/O) devices may be present within or connected to, the compute node 3550, which are referred to as input circuitry 3586 and output circuitry 3584 in FIG. 35. The input circuitry 3586 and output circuitry 3584 include one or more user interfaces designed to enable user interaction with the platform 3550 and/or peripheral component interfaces designed to enable peripheral component interaction with the platform 3550. Input circuitry 3586 may include any physical or virtual means for accepting an input including, inter alia, one or more physical or virtual buttons (e.g., a reset button), a physical key board, keypad, mouse, touchpad, touchscreen, microphones, scanner, headset, and/or the like. The output circuitry 3584 may be included to show information or otherwise convey information, such as sensor readings, actuator position(s), or other like information. Data and/or graphics may be displayed on one or more user interface components of the output circuitry 3584. Output circuitry 3584 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, and/or the like), with the output of characters, graphics, multimedia objects, and the like being generated or produced from the operation of the platform 3550. The output circuitry 3584 may also include speakers or other audio emitting devices, printer(s), and/or the like. Additionally or alternatively, the sensor circuitry 3572 may be used as the input circuitry 3584 (e.g., an image capture device, motion capture device, or the like) and one or more actuators 3574 may be used as the output device circuitry 3584 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and/or the like. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 3576 may power the compute node 3550, although, in examples in which the compute node 3550 is mounted in a fixed location, it may have a power supply coupled to an electrical grid, or the battery may be used as a backup or for temporary capabilities. The battery 3576 may be a lithium ion battery, or a metal-air battery, such as a zinc-air battery, an aluminum-air battery, a lithium-air battery, and the like.

A battery monitor/charger 3578 may be included in the compute node 3550 to track the state of charge (SoCh) of the battery 3576, if included. The battery monitor/charger 3578 may be used to monitor other parameters of the battery 3576 to provide failure predictions, such as the state of health (SoH) and the state of function (SoF) of the battery 3576. The battery monitor/charger 3578 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 3578 may communicate the information on the battery 3576 to the processor 3552 over the IX 3556. The battery monitor/charger 3578 may also include an analog-to-digital (ADC) converter that enables the processor 3552 to directly monitor the voltage of the battery 3576 or the current flow from the battery 3576. The battery parameters may be used to determine actions that the compute node 3550 may perform, such as transmission frequency, mesh network operation, sensing frequency, and the like.

A power block 3580, or other power supply coupled to a grid, may be coupled with the battery monitor/charger 3578 to charge the battery 3576. In some examples, the power block 3580 may be replaced with a wireless power receiver to obtain the power wirelessly, for example, through a loop antenna in the compute node 3550. A wireless battery charging circuit, such as an LTC4020 chip from Linear Technologies of Milpitas. California, among others, may be included in the battery monitor/charger 3578. The specific charging circuits may be selected based on the size of the battery 3576, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The example of FIG. 35 is intended to depict a high-level view of components of a varying device, subsystem, or arrangement of an edge computing node. However, in other implementations, some of the components shown may be omitted, additional components may be present, and a different arrangement of the components shown may occur in other implementations. Further, these arrangements are usable in a variety of use cases and environments, including those discussed below (e.g., a mobile device in industrial compute for smart city or smart factory, among many other examples).

### 8. Artificial Intelligence and Machine Learning Aspects

Machine learning (ML) involves programming computing systems to optimize a performance criterion using example (training) data and/or past experience. ML refers to the use and development of computer systems that are able to learn and adapt without following explicit instructions, by using algorithms and/or statistical models to analyze and draw inferences from patterns in data. ML involves using algorithms to perform specific task(s) without using explicit instructions to perform the specific task(s), but instead relying on learnt patterns and/or inferences. ML uses statistics to build mathematical model(s) (also referred to as “ML models” or simply “models”) in order to make predictions or decisions based on sample data (e.g., training data). The model is defined to have a set of parameters, and learning is the execution of a computer program to optimize the parameters of the model using the training data or past experience. The trained model may be a predictive model that makes predictions based on an input dataset, a descriptive model that gains knowledge from an input dataset, or both predictive and descriptive. Once the model is learned (trained), it can be used to make inferences (e.g., predictions).

ML algorithms perform a training process on a training dataset to estimate an underlying ML model. An ML algorithm is a computer program that learns from experience w.r.t, some task(s) and some performance measure(s)/metric(s), and an ML model is an object or data structure created after an ML algorithm is trained with training data. In other words, the term “ML model” or “model” may describe the output of an ML algorithm that is trained with training data. After training, an ML model may be used to make predictions on new datasets. Additionally, separately trained AI/ML models can be chained together in a AI/ML pipeline during inference or prediction generation. Although the term “ML algorithm” refers to different concepts than the term “ML model.” these terms may be used interchangeably for the purposes of the present disclosure. Any of the ML techniques discussed herein may be utilized, in whole or in part, and variants and/or combinations thereof, for any of the example embodiments discussed herein.

ML may require, among other things, obtaining and cleaning a dataset, performing feature selection, selecting an ML algorithm, dividing the dataset into training data and testing data, training a model (e.g., using the selected ML algorithm), testing the model, optimizing or tuning the model, and determining metrics for the model. Some of these tasks may be optional or omitted depending on the use case and/or the implementation used.

ML algorithms accept model parameters (or simply “parameters”) and/or hyperparameters that can be used to control certain properties of the training process and the resulting model. Model parameters are parameters, values, characteristics, configuration variables, and/or properties that are learnt during training. Model parameters are usually required by a model when making predictions, and their values define the skill of the model on a particular problem. Hyperparameters at least in some examples are characteristics, properties, and/or parameters for an ML process that cannot be learnt during a training process. Hyperparameter are usually set before training takes place, and may be used in processes to help estimate model parameters.

ML techniques generally fall into the following main types of learning problem categories: supervised learning, unsupervised learning, and reinforcement learning. Supervised learning involves building models from a set of data that contains both the inputs and the desired outputs. Unsupervised learning is an ML task that aims to learn a function to describe a hidden structure from unlabeled data. Unsupervised learning involves building models from a set of data that contains only inputs and no desired output labels. Reinforcement learning (RL) is a goal-oriented learning technique where an RL agent aims to optimize a long-term objective by interacting with an environment. Some implementations of AI and ML use data and neural networks (NNs) in a way that mimics the working of a biological brain. An example of such an implementation is shown by FIG. 36.

FIG. 36 illustrates an example NN 3600, which may be suitable for use by one or more of the computing systems (or subsystems) of the various implementations discussed herein, implemented in part by a HW accelerator, and/or the like. The NN 3600 may be deep neural network (DNN) used as an artificial brain of a compute node or network of compute nodes to handle very large and complicated observation spaces. Additionally or alternatively, the NN 3600 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or RL.

The NN 3600 may encompass a variety of ML techniques where a collection of connected artificial neurons 3610 that (loosely) model neurons in a biological brain that transmit signals to other neurons/nodes 3610. The neurons 3610 may also be referred to as nodes 3610, processing elements (PEs) 3610, or the like. The connections 3620 (or edges 3620) between the nodes 3610 are (loosely) modeled on synapses of a biological brain and convey the signals between nodes 3610. Note that not all neurons 3610 and edges 3620 are labeled in FIG. 36 for the sake of clarity.

Each neuron 3610 has one or more inputs and produces an output, which can be sent to one or more other neurons 3610 (the inputs and outputs may be referred to as “signals”). Inputs to the neurons 3610 of the input layer Lₓ can be feature values of a sample of external data (e.g., input variables xᵢ). The input variables xᵢ can be set as a vector containing relevant data (e.g., observations. ML features, and the like). The inputs to hidden units 3610 of the hidden layers Lₐ, L_{b}, and L_{c} may be based on the outputs of other neurons 3610. The outputs of the final output neurons 3610 of the output layer L_{y} (e.g., output variables yⱼ) include predictions, inferences, and/or accomplish a desired/configured task. The output variables yⱼ may be in the form of determinations, inferences, predictions, and/or assessments. Additionally or alternatively, the output variables yⱼ can be set as a vector containing the relevant data (e.g., determinations, inferences, predictions, assessments, and/or the like).

In the context of ML, an “ML feature” (or simply “feature”) is an individual measureable property or characteristic of a phenomenon being observed. Features are usually represented using numbers/numerals (e.g., integers), strings, variables, ordinals, real-values, categories, and/or the like. Additionally or alternatively. ML features are individual variables, which may be independent variables, based on observable phenomenon that can be quantified and recorded. ML models use one or more features to make predictions or inferences. In some implementations, new features can be derived from old features.

Neurons 3610 may have a threshold such that a signal is sent only if the aggregate signal crosses that threshold. A node 3610 may include an activation function, which defines the output of that node 3610 given an input or set of inputs. Additionally or alternatively, a node 3610 may include a propagation function that computes the input to a neuron 3610 from the outputs of its predecessor neurons 3610 and their connections 3620 as a weighted sum. A bias term can also be added to the result of the propagation function.

The NN 3600 also includes connections 3620, some of which provide the output of at least one neuron 3610 as an input to at least another neuron 3610. Each connection 3620 may be assigned a weight that represents its relative importance. The weights may also be adjusted as learning proceeds. The weight increases or decreases the strength of the signal at a connection 3620.

The neurons 3610 can be aggregated or grouped into one or more layers L where different layers L may perform different transformations on their inputs. In FIG. 36, the NN 3600 comprises an input layer Lₓ, one or more hidden layers Lₐ, L_{b}, and L_{c}, and an output layer L_{y} (where a, b, c, x, and y may be numbers), where each layer L comprises one or more neurons 3610. Signals travel from the first layer (e.g., the input layer L₁), to the last layer (e.g., the output layer L_{y}), possibly after traversing the hidden layers Lₐ, L_{b}, and L_{c} multiple times. In FIG. 36, the input layer Lₐ receives data of input variables xᵢ (where i=1, . . . , p, where p is a number). Hidden layers Lₐ, L_{b}, and L_{c} processes the inputs xᵢ, and eventually, output layer L_{y} provides output variables yⱼ (where j=1, . . . , p′, where p′ is a number that is the same or different than p). In the example of FIG. 36, for simplicity of illustration, there are only three hidden layers Lₐ, L_{b}, and L_{c} in the NN 3600, however, the NN 3600 may include many more (or fewer) hidden layers Lₐ, L_{b}, and L_{c} than are shown.

FIG. 37 shows an RL architecture 3700 comprising an agent 3710 and an environment 3720. The agent 3710 (e.g., software agent or AI agent) is the learner and decision maker, and the environment 3720 comprises everything outside the agent 3710 that the agent 3710 interacts with. The environment 3720 is typically stated in the form of a Markov decision process (MDP), which may be described using dynamic programming techniques. An MDP is a discrete-time stochastic control process that provides a mathematical framework for modeling decision making in situations where outcomes are partly random and partly under the control of a decision maker.

RL is a goal-oriented learning based on interaction with environment. RL is an ML paradigm concerned with how software agents (or AI agents) ought to take actions in an environment in order to maximize a numerical reward signal. In general, RL involves an agent taking actions in an environment that is/are interpreted into a reward and a representation of a state, which is then fed back into the agent. In RL, an agent aims to optimize a long-term objective by interacting with the environment based on a trial and error process. In many RL algorithms, the agent receives a reward in the next time step (or epoch) to evaluate its previous action. Examples of RL algorithms include Markov decision process (MDP) and Markov chains, associative RL, inverse RL, safe RL. Q-learning, multi-armed bandit learning, and deep RL.

The agent 3710 and environment 3720 continually interact with one another, wherein the agent 3710 selects actions A to be performed and the environment 3720 responds to these Actions and presents new situations (or states S) to the agent 3710. The action A comprises all possible actions, tasks, moves, etc., that the agent 3710 can take for a particular context. The state S is a current situation such as a complete description of a system, a unique configuration of information in a program or machine, a snapshot of a measure of various conditions in a system, and/or the like. In some implementations, the agent 3710 selects an action A to take based on a policy π. The policy π is a strategy that the agent 3710 employs to determine next action A based on the current state S. The environment 3720 also gives rise to rewards R, which are numerical values that the agent 3710 seeks to maximize over time through its choice of actions.

The environment 3720 starts by sending a state Sₜ to the agent 3710. In some implementations, the environment 3720 also sends an initial a reward Rₜ to the agent 3710 with the state Sₜ. The agent 3710, based on its knowledge, takes an action Aₜ in response to that state Sₜ, (and reward Rₜ, if any). The action Aₜ is fed back to the environment 3720, and the environment 3720 sends a state-reward pair including a next state Sₜ₊₁ and reward Rₜ₊₁ to the agent 3710 based on the action Aₜ. The agent 3710 will update its knowledge with the reward Rₜ₊₁ returned by the environment 3720 to evaluate its previous action(s). The process repeats until the environment 3720 sends a terminal state S, which ends the process or episode. Additionally or alternatively, the agent 3710 may take a particular action A to optimize a value V. The value V an expected long-term return with discount, as opposed to the short-term reward R. Vπ(S) is defined as the expected long-term return of the current state S under policy π.

Q-learning is a model-free RL algorithm that learns the value of an action in a particular state. Q-learning does not require a model of an environment 3720, and can handle problems with stochastic transitions and rewards without requiring adaptations. The “Q” in Q-learning refers to the function that the algorithm computes, which is the expected reward(s) for an action A taken in a given state S. In Q-learning, a Q-value is computed using the state Sₜ and the action Aₜ at time t using the function Q_{π}(Sₜ, Aₜ). Q_{π}(Sₜ, Aₜ) is the long-term return of a current state S taking action A under policy π. For any finite MDP (FMDP), Q-learning finds an optimal policy π in the sense of maximizing the expected value of the total reward over any and all successive steps, starting from the current state S. Additionally, examples of value-based deep RL include Deep Q-Network (DQN), Double DQN, and Dueling DQN. DQN is formed by substituting the Q-function of the Q-learning by an artificial neural network (ANN) such as a convolutional neural network (CNN).

### 9. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method of operation an artificial intelligence (AI) system, the method comprising: sending a request for AI authorization codes related to operation of a set of components of the AI system; and receiving a response including a set of AI authorization codes for corresponding components of the set of components.

Example 2 includes the method of example 1 and/or some other example(s) herein, wherein the response is a data packet that includes a header section, wherein the header section includes a set of data fields, and the set of data fields includes corresponding ones of the set of AI authorization codes.

Example 3 includes the method of example 2 and/or some other example(s) herein, wherein the data packet that includes a payload section, wherein the payload section includes data to be used for the operation of the AI system.

Example 4 includes the method of example 3 and/or some other example(s) herein, wherein

the method includes: using the data in the payload section when the AI authorization codes included in the header section indicate that the AI system is authorized to use the data in the payload section; and discarding the data in the payload section when the AI authorization codes included in the header section indicate that the AI system is not authorized to use the data in the payload section.

Example 5 includes the method of examples 2-4 and/or some other example(s) herein, wherein the header section includes, for each AI authorization code in the set of AI authorization codes, an AI system identifier and an AI system category.

Example 6 includes the method of examples 3-5 and/or some other example(s) herein, wherein the data section includes an indication of a risk level of a corresponding event, wherein the event is associated with an error, fault, or inconsistency of the operation of the AI system.

Example 7 includes the method of examples 1-6 and/or some other example(s) herein, wherein: the sending includes sending respective requests to the corresponding components; and the receiving includes receiving respective responses from the corresponding components, wherein each of the respective responses includes an a corresponding AI authorization code in the set of AI authorization codes.

Example 8 includes the method of examples 1-7 and/or some other example(s) herein, wherein the AI system is classified as belonging to a high risk AI (HRAI) category, and the method includes: operating the AI system when the set of AI authorization codes for the corresponding components indicate that the corresponding components are authorized to be used for the HRAI category to which the AI system belongs.

Example 9 includes the method of examples 1-8 and/or some other example(s) herein, wherein the method includes: deactivating a subset of components of the set of components when the set of AI authorization codes for the subset of components indicate that the subset of components are not authorized to be used for the HRAI category to which the AI system belongs.

Example 10 includes the method of examples 1-9 and/or some other example(s) herein, wherein the method includes: receiving respective acknowledge (ACK) messages from the corresponding components indicating whether the corresponding components are operational.

Example 11 includes the method of examples 1-4 and/or some other example(s) herein, wherein: the sending includes sending the request to an HRAI registration database (DB); and the response is a registration response received from the HRAI registration DB, wherein each of the respective responses includes an a corresponding AI authorization code in the set of AI authorization codes.

Example X includes the method of example 11 and/or some other example(s) herein, wherein the registration request includes one or more of an identifier of the AI system, a request for the identifier of the AI system, contact information of a developer or owner of the AI system, a description of an intended purpose of the AI system, a status of the AI system, a certificate belonging to the AI system, an expiration date of the certificate, jurisdictions in which the AI system is permitted to operate, a declaration of conformity, instructions or reference guide for operating the AI system, and a resource locator or pointer to additional information about the AI system.

Example 13 includes the method of examples 1-12 and/or some other example(s) herein, wherein the AI system includes an AI engine and a set of self-assessment entities.

Example 14 includes the method of example 13 and/or some other example(s) herein, wherein the set of self-assessment entities includes a risk-related information (RRI) processing entity, and the method includes operating the RRI processing entity to: process outputs generated by other ones of the self-assessment entities in a human-consumable format; and present the processed outputs to an authorized user.

Example 15 includes the method of examples 13-14 and/or some other example(s) herein, wherein the set of self-assessment entities includes a risk mitigation entity, and the method includes operating the risk mitigation entity to: determine trade-offs between risks of using the AI system versus functionality or efficiencies of operating the AI system.

Example 16 includes the method of examples 13-15 and/or some other example(s) herein, wherein the set of self-assessment entities includes an AI system management entity, wherein the AI system management entity is to orchestrate internal processes of the AI system and orchestrate interactions between individual components of the set of components.

Example 17 includes the method of examples 13-16 and/or some other example(s) herein, wherein the set of self-assessment entities includes an AI system redundancy entity, and the method includes operating the AI system redundancy entity to: detect, during the operation of the AI system, a malfunctioning component of the set of components; and replace the malfunctioning component with another component that fulfills a same or similar function as the malfunctioning component.

Example 18 includes the method of examples 13-17 and/or some other example(s) herein, wherein the set of self-assessment entities includes a human oversight entity, and the method includes operating the human oversight entity to: provide information about potential biases in predictions generated by the AI system to an authorized user via a user interface; receive an selected action based on the provided information; and issue the action to one or more components of the set of components to be executed by the one or more components.

Example 19 includes the method of examples 13-18 and/or some other example(s) herein, wherein the set of self-assessment entities includes a record keeping entity, and the method includes operating the record keeping entity to: track interactions with the AI system, wherein the interactions include one or more of user activity, behavior of the AI system, information on training or testing the AI system; and logging the tracked interactions in one or more records.

Example 20 includes the method of examples 13-19 and/or some other example(s) herein, wherein the set of self-assessment entities includes a self-verification entity, and the method includes operating the self-verification entity to: operate the AI system using a predefined test dataset; and stop or pause the operation of the AI system when biased predictions are generated by the AI system based on the predefined test dataset.

Example 21 includes the method of examples 13-20 and/or some other example(s) herein, wherein the AI engine is one or more of an inference engine, a recommendation engine, a reinforcement learning agent, a neural network engine, a neural co-processor, a hardware accelerator, a graphics processing unit, and a general-purpose processor.

Example 22 includes the method of examples 1-21 and/or some other example(s) herein, wherein the AI system is implemented by a compute node, and the compute node includes a set of AI system monitoring, evaluation, and reporting (AIMER) functions.

Example 23 includes the method of example 22 and/or some other example(s) herein, wherein the set of AIMER functions includes an AI risk management system function (AIRMS), and the method includes operating the AIRMS to: monitor outputs generated by the AI system; and issuing one or more corrective actions to the AI system when the monitored outputs include potential biases, wherein the one or more corrective actions include adjusting one or more parameters to reduce or eliminate the potential biases.

Example 24 includes the method of example 23 and/or some other example(s) herein, wherein the method includes operating the AIRMS to: monitor inputs provided to the AI system; and issuing one or more other corrective actions to the AI system when the monitored inputs include potential errors, wherein the one or more other corrective actions include adjusting one or more parameters of the inputs to correct the potential errors.

Example 25 includes the method of examples 22-24 and/or some other example(s) herein, wherein the set of AIMER functions includes a data verification component (DVC), and the method includes operating the DVC to: validate an input dataset before the input dataset is provided to the AI system; and tag the input dataset with a digital certificate when the input dataset is properly validated.

Example 26 includes the method of example 25 and/or some other example(s) herein, wherein the method includes: operating the AI system to verify the input dataset using the digital certificate; and generating a prediction using the input dataset when the input dataset is properly verified.

Example 27 includes the method of examples 22-26 and/or some other example(s) herein, wherein the set of AIMER functions includes an entity for record keeping (ERK), and the method includes operating the ERK to: obtain inputs to the AI system, outputs generated by the AI system, and internal states corresponding to the inputs or the outputs; and store the inputs, the outputs, and the internal states in a local or remote database.

Example 28 includes the method of example 27 and/or some other example(s) herein, wherein the method includes operating the ERK to: process the inputs, the outputs, and the internal states to generate statistics or metrics related to the inputs, the outputs, and the internal states; and store the statistics or metrics related to the inputs, the outputs, and the internal states in the local or remote database.

Example 29 includes the method of examples 22-28 and/or some other example(s) herein, wherein the set of AIMER functions includes an entity for transparency and information (ETI), and the method includes operating the ETI to: generate transparency data including one or more of capability information of the AI system, maintenance and care information related to the AI system, self-assessment information related to the AI system, and historic data related to the operation of the AI system; and generate user interface data to present the transparency data, wherein the user interface data includes one or more of text data, image data, audio data, and video data; and send the user interface data to an authorized user.

Example 30 includes the method of examples 22-29 and/or some other example(s) herein, wherein the set of AIMER functions includes an entity for AI output self-verification (EAIOSV), and the method includes operating the EAIOSV to: perform a self-verification process on a prediction generated by the AI system before the prediction is provided to an external entity.

Example 31 includes the method of example 30 and/or some other example(s) herein, wherein the self-verification process includes: comparing the generated prediction with one or more historical predictions; and determining biases in the generated prediction based on a divergence of the generated prediction from the one or more historical predictions.

Example 32 includes the method of example 30, 31, and/or some other example(s) herein, wherein the self-verification process includes: operating an alternation function to change one or more parameters of the AI system; obtaining a prediction from the AI system with the changed one or more parameters; comparing the generated prediction with obtained prediction; and determining biases in the generated prediction based on a divergence of the generated prediction from the obtained prediction.

Example 33 includes the method of examples 22-32 and/or some other example(s) herein, wherein the set of AIMER functions includes an accuracy verification entity (AVE), and the method includes operating the AVE to: place the AI system in a testing state; provide a test dataset to the AI system in the testing state; compare outputs generated by the AI system in the testing state with known outputs for the test dataset; and calculate an accuracy metric for the AI system in the testing state based on a number of correct predictions in the generated outputs or a number of incorrect predictions in the generated outputs.

Example 34 includes the method of example 33 and/or some other example(s) herein, wherein the set of AIMER functions includes a robustness verification entity (RVE), and the method includes operating the RVE to: modify the test dataset to include one or more erroneous data items; compare outputs generated by the AI system in the testing state with known outputs for the test dataset; and calculate robustness metric for the AI system in the testing state based on the number of correct predictions or the number of incorrect, wherein the number of correct predictions includes one or more correctly identified errors based on the one or more erroneous data items and the number of incorrect predictions includes one or more unidentified errors based on the one or more erroneous data items.

Example 35 includes the method of examples 22-34 and/or some other example(s) herein, wherein the set of AIMER functions includes cryptographic engine (CE), and the method includes operating the CE to: generate a fingerprint for the AI system based on one or more inputs to the AI system, outputs generated by the AI system, and one or more internal system states of the AI system.

Example 36 includes the method of example 35 and/or some other example(s) herein, wherein the method includes operating the CE to: encrypt data to be conveyed between the AI system and the set of AIMER functions or communicated to external devices.

Example 37 includes the method of examples 33-36 and/or some other example(s) herein, wherein the set of AIMER functions includes an AI system quality manager (AISQM), and the method includes operating the AISQM to: calculate a quality metric for the AI system based on the fingerprint, the accuracy metric, and the robustness metric; and issue one or more remedial actions to the AI system when the quality metric is below a threshold.

Example 38 includes one or more computer readable media comprising instructions, wherein execution of the instructions by processor circuitry is to cause the processor circuitry to perform the method of examples 1-37 and/or some other example(s) herein. Example 39 includes a computer program comprising the instructions of example 38 and/or some other example(s) herein. Example 40 includes an Application Programming Interface defining functions, methods, variables, data structures, and/or protocols for the computer program of example 39 and/or some other example(s) herein. Example 41 includes an apparatus comprising circuitry loaded with the instructions of example 38 and/or some other example(s) herein. Example 42 includes an apparatus comprising circuitry operable to run the instructions of example 38 and/or some other example(s) herein. Example 43 includes an integrated circuit comprising one or more of the processor circuitry and the one or more computer readable media of example 38 and/or some other example(s) herein. Example 44 includes a computing system comprising the one or more computer readable media and the processor circuitry of example 38 and/or some other example(s) herein. Example 45 includes an apparatus comprising means for executing the instructions of example 38 and/or some other example(s) herein. Example 46 includes a signal generated as a result of executing the instructions of example 38 and/or some other example(s) herein. Example 47 includes a data unit generated as a result of executing the instructions of example 38 and/or some other example(s) herein. Example 48 includes the data unit of example 47 and/or some other example(s) herein, the data unit is a datagram, network packet, data frame, data segment, a Protocol Data Unit (PDU), a Service Data Unit (SDU), a message, or a database object. Example 49 includes a signal encoded with the data unit of examples 47-48 and/or some other example(s) herein. Example 50 includes an electromagnetic signal carrying the instructions of example 38 and/or some other example(s) herein. Example 51 includes an apparatus comprising means for performing the method of examples 1-37 and/or some other example(s) herein.

### 10. Terminology

As used herein, the singular forms “a,” “an” and “the” are intended to include plural forms as well, unless the context clearly indicates otherwise. It will be further understood that the terms “comprises” and/or “comprising.” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment”, “in some embodiments,” and the like, each of which may refer to one or more of the same or different embodiments. The phrases “in an implementation” or “in some implementations,” and/or the like, may refer to one or more of the same or different embodiments. Furthermore, the terms “comprising.” “including.” “having.” and the like, as used w.r.t, the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and so forth, or combinations thereof.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value.

The term “metric” at least in some examples refers to a standard definition of a quantity, produced in an assessment of performance and/or reliability of the network, which has an intended utility and is carefully specified to convey the exact meaning of a measured value.

The term “action” at least in some examples refers to an attribute of the dynamics of a physical or virtual system and/or the manner in which a physical or virtual system changes over a period of time. Additionally or alternatively, the term “action” at least in some examples refers to the accomplishment of a thing, which can take place over a period of time, in stages, and/or with the possibility of repetition. Additionally or alternatively, the term “action” at least in some examples refers to the act of bringing about an alteration or operation. Additionally or alternatively, the term “action” at least in some examples refers to the an operating mechanism and/or the manner in which a mechanism or instrument operates.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period.

The term “identification” at least in some examples refers to a process of recognizing an identity as distinct from other identities in a particular scope or context, which may involve processing identifiers to reference an identity in an identity database.

The term “lightweight” or “lite” at least in some examples refers to an application or computer program designed to use a relatively small amount of resources such as having a relatively small memory footprint, low processor usage, and/or overall low usage of system resources. The term “lightweight protocol” at least in some examples refers to a communication protocol that is characterized by a relatively small overhead. Additionally or alternatively, the term “lightweight protocol” at least in some examples refers to a protocol that provides the same or enhanced services as a standard protocol, but performs faster than standard protocols, has lesser overall size in terms of memory footprint, uses data compression techniques for processing and/or transferring data, drops or eliminates data deemed to be nonessential or unnecessary, and/or uses other mechanisms to reduce overall overheard and/or footprint.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The terms “machine-readable medium” and “computer-readable medium” refers to tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP). A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, and/or the like), interpreting, loading, organizing (e.g., dynamically or statically linking), encoding, decoding, encrypting, unencrypting, packaging, unpackaging, or otherwise manipulating the information into the instructions. In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g., linked) if necessary, and compiled or interpreted (e.g., into a library, stand-alone executable, and/or the like) at a local machine, and executed by the local machine. The terms “machine-readable medium” and “computer-readable medium” may be interchangeable for purposes of the present disclosure. The term “non-transitory computer-readable medium at least in some examples refers to any type of memory, computer readable storage device, and/or storage disk and may exclude propagating signals and transmission media.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “SmartNIC” at least in some examples refers to a network interface controller (NIC), network adapter, or a programmable network adapter card with programmable hardware accelerators and network connectivity (e.g., Ethernet or the like) that can offload various tasks or workloads from other compute nodes or compute platforms such as servers, application processors, and/or the like and accelerate those tasks or workloads. A SmartNIC has similar networking and offload capabilities as an IPU, but remains under the control of the host as a peripheral device.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “device” at least in some examples refers to a physical entity embedded inside, or attached to, another physical entity in its vicinity, with capabilities to convey digital information from or to that physical entity.

The term “entity” at least in some examples refers to a distinct component of an architecture or device, or information transferred as a payload.

The term “controller” at least in some examples refers to an element or entity that has the capability to affect a physical entity, such as by changing its state or causing the physical entity to move.

The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “terminal” at least in some examples refers to point at which a conductor from a component, device, or network comes to an end. Additionally or alternatively, the term “terminal” at least in some examples refers to an electrical connector acting as an interface to a conductor and creating a point where external circuits can be connected. In some embodiments, terminals may include electrical leads, electrical connectors, electrical connectors, solder cups or buckets, and/or the like.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers may include an operating system (OS) that provides executable program instructions for the general administration and operation of the individual server computer devices, and may include a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “architecture” at least in some examples refers to a computer architecture or a network architecture. The term “computer architecture” at least in some examples refers to a physical and logical design or arrangement of software and/or hardware elements in a computing system or platform including technology standards for interacts therebetween. The term “network architecture” at least in some examples refers to a physical and logical design or arrangement of software and/or hardware elements in a network including communication protocols, interfaces, and media transmission.

The term “appliance.” “computer appliance.” and the like, at least in some examples refers to a computer device or computer system with program code (e.g., software or firmware) that is specifically designed to provide a specific computing resource. The term “virtual appliance” at least in some examples refers to a virtual machine image to be implemented by a hypervisor-equipped device that virtualizes or emulates a computer appliance or otherwise is dedicated to provide a specific computing resource. The term “security appliance”, “firewall”, and the like at least in some examples refers to a computer appliance designed to protect computer networks from unwanted traffic and/or malicious attacks. The term “policy appliance” at least in some examples refers to technical control and logging mechanisms to enforce or reconcile policy rules (information use rules) and to ensure accountability in information systems.

The term “gateway” at least in some examples refers to a network appliance that allows data to flow from one network to another network, or a computing system or application configured to perform such tasks. Examples of gateways include IP gateways. Internet-to-Orbit (120) gateways. IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” may include any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices. Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices.

The term “station” or “STA” at least in some examples refers to a logical entity that is a singly addressable instance of a medium access control (MAC) and physical layer (PHY) interface to the wireless medium (WM). The term “wireless medium” or WM” at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like.

The term “network controller” at least in some examples refers to a functional block that centralizes some or all of the control and management functionality of a network domain and may provide an abstract view of the network domain to other functional blocks via an interface.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware.

The term “access point” or “AP” at least in some examples refers to an entity that contains one station (STA) and provides access to the distribution services, via the wireless medium (WM) for associated STAs. An AP comprises a STA and a distribution system access function (DSAF).

The term “E-UTEAN NodeB”, “eNodeB”, or “eNB” at least in some examples refers to a RAN node providing E-UTRA user plane (PDCP/RLC/MAC/PHY) and control plane (RRC) protocol terminations towards a UE, and connected via an S1 interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.0.0 (2022 Apr. 15) (“[TS37340]”)). Two or more en-gNBs are interconnected with each other (and/or with one or more eNBs) by means of an X2 interface. The term “Next Generation RAN node” or “NG-RAN node” at least in some examples refers to either a gNB or an ng-eNB. The term “Transmission Reception Point” or “TRxP” at least in some examples refers to an antenna array with one or more antenna elements available to a network located at a specific geographical location for a specific area.

The term “edge computing” encompasses many implementations of distributed computing that move processing activities and resources (e.g., compute, storage, acceleration resources) towards the “edge” of the network, in an effort to reduce latency and increase throughput for endpoint users (client devices, user equipment, and the like). Such edge computing implementations typically involve the offering of such activities and resources in cloud-like services, functions, applications, and subsystems, from one or multiple locations accessible via wireless networks. Thus, the references to an “edge” of a network, cluster, domain, system or computing arrangement used herein are groups or groupings of functional distributed compute elements and, therefore, generally unrelated to “edges” (links or connections) as used in graph theory.

The term “colocated” or “co-located” at least in some examples refers to two or more elements being in the same place or location, or relatively close to one another (e.g., within some predetermined distance from one another). Additionally or alternatively, the term “colocated” or “co-located” at least in some examples refers to the placement or deployment of two or more compute elements or compute nodes together in a secure dedicated storage facility, or within a same enclosure or housing.

The term “central office” or “CO” at least in some examples refers to an aggregation point for telecommunications infrastructure within an accessible or defined geographical area, often where telecommunication service providers have traditionally located switching equipment for one or multiple types of access networks. In some examples, a CO can be physically designed to house telecommunications infrastructure equipment or compute, data storage, and network resources. The CO need not, however, be a designated location by a telecommunications service provider. The CO may host any number of compute devices for Edge applications and services, or even local implementations of cloud-like services.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “compute resource” or simply “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/applications, computer files, and/or the like. A “hardware resource” at least in some examples refers to compute, storage, and/or network resources provided by physical hardware element(s). A “virtualized resource” at least in some examples refers to compute, storage, and/or network resources provided by virtualization infrastructure to an application, device, system, and the like. The term “network resource” or “communication resource” at least in some examples refers to resources that are accessible by computer devices/systems via a communications network. The term “system resources” at least in some examples refers to any kind of shared entities to provide services, and may include computing and/or network resources. System resources may be considered as a set of coherent functions, network data objects or services, accessible through a server where such system resources reside on a single host or multiple hosts and are clearly identifiable.

The term “workload” at least in some examples refers to an amount of work performed by a computing system, device, entity, and the like, during a period of time or at a particular instant of time. A workload may be represented as a benchmark, such as a response time, throughput (e.g., how much work is accomplished over a period of time), and/or the like. Additionally or alternatively, the workload may be represented as a memory workload (e.g., an amount of memory space needed for program execution to store temporary or permanent data and to perform intermediate computations), processor workload (e.g., a number of instructions being executed by a processor during a given period of time or at a particular time instant), an I/O workload (e.g., a number of inputs and outputs or system accesses during a given period of time or at a particular time instant), database workloads (e.g., a number of database queries during a period of time), a network-related workload (e.g., a number of network attachments, a number of mobility updates, a number of radio link failures, a number of handovers, an amount of data to be transferred over an air interface, and the like), and/or the like. Various algorithms may be used to determine a workload and/or workload characteristics, which may be based on any of the aforementioned workload types.

The term “cloud service provider” or “CSP” at least in some examples refers to an organization which operates typically large-scale “cloud” resources comprised of centralized, regional, and Edge data centers (e.g., as used in the context of the public cloud). In other examples, a CSP may also be referred to as a “Cloud Service Operator” or “CSO”. References to “cloud computing” generally refer to computing resources and services offered by a CSP or a CSO, at remote locations with at least some increased latency, distance, or constraints relative to edge computing.

The term “data center” at least in some examples refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

The term “access edge layer” indicates the sub-layer of infrastructure edge closest to the end user or device. For example, such layer may be fulfilled by an edge data center deployed at a cellular network site. The access edge layer functions as the front line of the infrastructure Edge and may connect to an aggregation Edge layer higher in the hierarchy.

The term “aggregation edge layer” indicates the layer of infrastructure edge one hop away from the access edge layer. This layer can exist as either a medium-scale data center in a single location or may be formed from multiple interconnected micro data centers to form a hierarchical topology with the access Edge to allow for greater collaboration, workload failover, and scalability than access Edge alone.

The term “network function” or “NF” at least in some examples refers to a functional block within a network infrastructure that has one or more external interfaces and a defined functional behavior.

The term “network service” or “NS” at least in some examples refers to a composition of Network Function(s) and/or Network Service(s), defined by its functional and behavioral specification(s).

The term “RAN function” or “RANF” at least in some examples refers to a functional block within a RAN architecture that has one or more external interfaces and a defined behavior related to the operation of a RAN or RAN node. Additionally or alternatively, the term “RAN function” or “RANF” at least in some examples refers to a set of functions and/or NFs that are part of a RAN.

The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network.

The term “edge compute function” or “ECF” at least in some examples refers to an element or entity that performs an aspect of an edge computing technology (ECT), an aspect of edge networking technology (ENT), or performs an aspect of one or more edge computing services running over the ECT or ENT.

The term “management function” at least in some examples refers to a logical entity playing the roles of a service consumer and/or a service producer. The term “management service” at least in some examples refers to a set of offered management capabilities.

The term “network function virtualization” or “NFV” at least in some examples refers to the principle of separating network functions from the hardware they run on by using virtualization techniques and/or virtualization technologies.

The term “virtualized network function” or “VNF” at least in some examples refers to an implementation of an NF that can be deployed on a Network Function Virtualization Infrastructure (NFVI).

The term “Network Functions Virtualization Infrastructure Manager” or “NFVI” at least in some examples refers to a totality of all hardware and software components that build up the environment in which VNFs are deployed.

The term “slice” at least in some examples refers to a set of characteristics and behaviors that separate one instance, traffic, data flow, application, application instance, link or connection,

RAT, device, system, entity, element, and the like from another instance, traffic, data flow, application, application instance, link or connection, RAT, device, system, entity, element, and the like, or separate one type of instance, and the like, from another instance, and the like.

The term “network slice” at least in some examples refers to a logical network that provides specific network capabilities and network characteristics and/or supports various service properties for network slice service consumers. Additionally or alternatively, the term “network slice” at least in some examples refers to a logical network topology connecting a number of endpoints using a set of shared or dedicated network resources that are used to satisfy specific service level objectives (SLOs) and/or service level agreements (SLAs).

The term “network slicing” at least in some examples refers to methods, processes, techniques, and technologies used to create one or multiple unique logical and virtualized networks over a common multi-domain infrastructure.

The term “access network slice”, “radio access network slice”, or “RAN slice” at least in some examples refers to a part of a network slice that provides resources in a RAN to fulfill one or more application and/or service requirements (e.g., SLAs, and the like).

The term “network slice instance” at least in some examples refers to a set of Network Function instances and the required resources (e.g. compute, storage and networking resources) which form a deployed network slice. Additionally or alternatively, the term “network slice instance” at least in some examples refers to a representation of a service view of a network slice.

The term “network instance” at least in some examples refers to information identifying a domain.

The term “service consumer” at least in some examples refers to an entity that consumes one or more services.

The term “service producer” at least in some examples refers to an entity that offers, serves, or otherwise provides one or more services.

The term “service provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g., Application software service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like. At least in some examples, SLAs may specify, for example, particular aspects of the service to be provided including quality, availability, responsibilities, metrics by which service is measured, as well as remedies or penalties should agreed-on service levels not be achieved. The term “SAML service provider” at least in some examples refers to a system and/or entity that receives and accepts authentication assertions in conjunction with a single sign-on (SSO) profile of the Security Assertion Markup Language (SAML) and/or some other security mechanism(s).

The term “Virtualized Infrastructure Manager” or “VIM” at least in some examples refers to a functional block that is responsible for controlling and managing the NFVI compute, storage and network resources, usually within one operator's infrastructure domain.

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” generally refer to a distributed architecture, organization, or collection of multiple nodes and devices, and which is organized to accomplish or offer some aspect of services or resources in an edge computing setting. The term “cluster” at least in some examples refers to a set or grouping of entities as part of an Edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. The term “Edge IoT devices” at least in some examples refers to any kind of IoT devices deployed at a network's edge.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces).

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT, Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VOIP). Virtual Private Network (VPN). Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC). Generic Routing Encapsulation (GRE), GPRS Tunneling (GTP), Micro Transport Protocol (uTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC). Ethernet. RDMA over Converged Ethernet version 1 (RoCEv1), and/or the like.

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802]. 3GPP TS 38.321 v17.0.0 (2022 Apr. 14) and 3GPP TS 36.321 v17.0.0 (2022 Apr. 19) (collectively referred to as “[TSMAC]”)).

The term “physical layer”, “PHY layer”, or “PHY” at least in some examples refers to a protocol layer or sublayer that includes capabilities to transmit and receive modulated signals for communicating in a communications network (see e.g., [IEEE802]. 3GPP TS 38.201 v17.0.0 (2022-01-05) and 3GPP TS 36.201 v17.0.0 (2022 Mar. 31)).

The term “radio technology” at least in some examples refers to technology for wireless transmission and/or reception of electromagnetic radiation for information transfer. The term “radio access technology” or “RAT” at least in some examples refers to the technology used for the underlying physical connection to a radio based communication network. The term “RAT type” at least in some examples may identify a transmission technology and/or communication protocol used in an access network, for example, new radio (NR), Long Term Evolution (LTE), narrowband IoT (NB-IoT), untrusted non-3GPP, trusted non-3GPP, trusted Institute of Electrical and Electronics Engineers (IEEE) 802 (e.g., [IEEE80211]; see also IEEE Standard for Local and Metropolitan Area Networks: Overview and Architecture, IEEE Std 802-2014, pp. 1-74 (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) (and variants thereof such as HSPA Plus (HSPA+), and the like), Long Term Evolution (LTE) (and variants thereof such as LTE-Advanced (LTE-A), Evolved UTRA (E-UTRA), LTE Extra, LTE-A Pro, LTE LAA, MULTEfire, and the like), Fifth Generation (5G) or New Radio (NR), and the like; ETSI technologies such as High Performance Radio Metropolitan Area Network (HiperMAN) and the like; IEEE technologies such as [IEEE802] and/or WiFi (e.g., [IEEE80211] and variants thereof). Worldwide Interoperability for Microwave Access (WiMAX) (e.g., [WiMAX] and variants thereof). Mobile Broadband Wireless Access (MBWA)/iBurst (e.g., IEEE 802.20 and variants thereof), and the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHZ and above such as 3GPP 5G. Wireless Gigabit Alliance (WiGig) standards (e.g., IEEE 802.11ad, IEEE 802.11ay, and the like); short-range and/or wireless personal area network (WPAN) technologies/standards such as Bluetooth (and variants thereof such as Bluetooth 5.3. Bluetooth Low Energy (BLE), and the like). IEEE 802.15 technologies/standards (e.g., IEEE Standard for Low-Rate Wireless Networks, IEEE Std 802.15.4-2020, pp. 1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks—Part 15.7: Short-Range Optical Wireless Communications, IEEE Std 802.15.7-2018, pp. 1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-G5B, ITS-G5C, and the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “V2X” at least in some examples refers to vehicle to vehicle (V2V), vehicle to infrastructure (V2I), infrastructure to vehicle (12V), vehicle to network (V2N), and/or network to vehicle (N2V) communications and associated radio access technologies.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “local area network” or “LAN” at least in some examples refers to a network of devices, whether indoors or outdoors, covering a limited area or a relatively small geographic area (e.g., within a building or a campus). The term “wireless local area network”, “wireless LAN”, or “WLAN” at least in some examples refers to a LAN that involves wireless communications. The term “wide area network” or “WAN” at least in some examples refers to a network of devices that extends over a relatively large geographic area (e.g., a telecommunications network). Additionally or alternatively, the term “wide area network” or “WAN” at least in some examples refers to a computer network spanning regions, countries, or even an entire planet. The term “backbone network”, “backbone”, or “core network” at least in some examples refers to a computer network which interconnects networks, providing a path for the exchange of information between different subnetworks such as LANs or WANs. The term “interworking” at least in some examples refers to the use of interconnected stations in a network for the exchange of data, by means of protocols operating over one or more underlying data transmission paths.

The term “flow” at least in some examples refers to a sequence of data and/or data units (e.g., datagrams, packets, or the like) from a source entity/element to a destination entity/element. Additionally or alternatively, the terms “flow” or “traffic flow” at least in some examples refer to an artificial and/or logical equivalent to a call, connection, or link. Additionally or alternatively, the terms “flow” or “traffic flow” at least in some examples refer to a sequence of packets sent from a particular source to a particular unicast, anycast, or multicast destination that the source desires to label as a flow; from an upper-layer viewpoint, a flow may include of all packets in a specific transport connection or a media stream, however, a flow is not necessarily 1:1 mapped to a transport connection. Additionally or alternatively, the terms “flow” or “traffic flow” at least in some examples refer to a set of data and/or data units (e.g., datagrams, packets, or the like) passing an observation point in a network during a certain time interval. Additionally or alternatively, the term “flow” at least in some examples refers to a user plane data link that is attached to an association. Examples are circuit switched phone call, voice over IP call, reception of an SMS, sending of a contact card. PDP context for internet access, demultiplexing a TV channel from a channel multiplex, calculation of position coordinates from geopositioning satellite signals, and the like. For purposes of the present disclosure, the terms “traffic flow”, “data flow”, “dataflow”, “packet flow”, “network flow”, and/or “flow” may be used interchangeably even though these terms at least in some examples refers to different concepts.

The term “dataflow” or “data flow” at least in some examples refers to the movement of data through a system including software elements, hardware elements, or a combination of both software and hardware elements. Additionally or alternatively, the term “dataflow” or “data flow” at least in some examples refers to a path taken by a set of data from an origination or source to destination that includes all nodes through which the set of data travels.

The term “stream” at least in some examples refers to a sequence of data elements made available over time. At least in some examples, functions that operate on a stream, which may produce another stream, are referred to as “filters.” and can be connected in pipelines, analogously to function composition; filters may operate on one item of a stream at a time, or may base an item of output on multiple items of input, such as a moving average. Additionally or alternatively, the term “stream” or “streaming” at least in some examples refers to a manner of processing in which an object is not represented by a complete logical data structure of nodes occupying memory proportional to a size of that object, but are processed “on the fly” as a sequence of events.

The term “distributed computing” at least in some examples refers to computation resources that are geographically distributed within the vicinity of one or more localized networks' terminations. The term “distributed computations” at least in some examples refers to a model in which components located on networked computers communicate and coordinate their actions by passing messages interacting with each other in order to achieve a common goal.

The term “service” at least in some examples refers to the provision of a discrete function within a system and/or environment. Additionally or alternatively, the term “service” at least in some examples refers to a functionality or a set of functionalities that can be reused. The term “microservice” at least in some examples refers to one or more processes that communicate over a network to fulfil a goal using technology-agnostic protocols (e.g., HTTP or the like). Additionally or alternatively, the term “microservice” at least in some examples refers to services that are relatively small in size, messaging-enabled, bounded by contexts, autonomously developed, independently deployable, decentralized, and/or built and released with automated processes. Additionally or alternatively, the term “microservice” at least in some examples refers to a self-contained piece of functionality with clear interfaces, and may implement a layered architecture through its own internal components. Additionally or alternatively, the term “microservice architecture” at least in some examples refers to a variant of the service-oriented architecture (SOA) structural style wherein applications are arranged as a collection of loosely-coupled services (e.g., fine-grained services) and may use lightweight protocols.

The term “session” at least in some examples refers to a temporary and interactive information interchange between two or more communicating devices, two or more application instances, between a computer and user, and/or between any two or more entities or elements. Additionally or alternatively, the term “session” at least in some examples refers to a connectivity service or other service that provides or enables the exchange of data between two entities or elements. The term “network session” at least in some examples refers to a session between two or more communicating devices over a network. The term “web session” at least in some examples refers to session between two or more communicating devices over the Internet or some other network. The term “session identifier,” “session ID,” or “session token” at least in some examples refers to a piece of data that is used in network communications to identify a session and/or a series of message exchanges.

The term “quality” at least in some examples refers to a property, character, attribute, or feature of something as being affirmative or negative, and/or a degree of excellence of something. Additionally or alternatively, the term “quality” at least in some examples, in the context of data processing, refers to a state of qualitative and/or quantitative aspects of data, processes, and/or some other aspects of data processing systems. The term “Quality of Service” or “QoS’ at least in some examples refers to a description or measurement of the overall performance of a service (e.g., telephony and/or cellular service, network service, wireless communication/connectivity service, cloud computing service, and the like).

The term “queue” at least in some examples refers to a collection of entities (e.g., data, objects, events, and the like) are stored and held to be processed later, that are maintained in a sequence and can be modified by the addition of entities at one end of the sequence and the removal of entities from the other end of the sequence; the end of the sequence at which elements are added may be referred to as the “back”, “tail”, or “rear” of the queue, and the end at which elements are removed may be referred to as the “head” or “front” of the queue. Additionally, a queue may perform the function of a buffer, and the terms “queue” and “buffer” may be used interchangeably throughout the present disclosure. The term “enqueue” at least in some examples refers to one or more operations of adding an element to the rear of a queue. The term “dequeue” at least in some examples refers to one or more operations of removing an element from the front of a queue.

The term “network path” or “path” at least in some examples refers to a data communications feature of a communication system describing the sequence and identity of system components visited by one or more packets, where the components of the path may be either logical or physical. The term “network forwarding path” at least in some examples refers to an ordered list of connection points forming a chain of NFs and/or nodes, along with policies associated to the list.

The term “network address” at least in some examples refers to an identifier for a node or host in a computer network, and may be a unique identifier across a network and/or may be unique to a locally administered portion of the network. Examples of identifiers and/or network addresses include: application identifier (app ID), Bluetooth hardware device address (BD_ADDR), a cellular network address, Access Point Name (APN), AMF identifier (ID), AF-Service-Identifier, Edge Application Server (EAS) ID, Data Network Access Identifier (DNAI), Data Network Name (DNN), Local Area Data Network (LADN) DNN, EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, Radio Network Temporary Identifier (RNTI) (including any RNTI discussed in clause 8.1 of 3GPP TS 38.300 v17.0.0 (2022 Apr. 13) (“[TS38300]”)), a Closed Access Group Identifier (CAG-ID), Electronic Product Code (EPC) as defined by the EPCglobal Tag Data Standard, email address, Enterprise Application Server (EAS) ID, endpoint address, Fully Qualified Domain Name (FQDN), International Mobile Equipment Identity (IMEI), IMEI Type Allocation Code (IMEA/TAC), International Mobile Subscriber Identity (IMSI), IMSI software version (IMSISV), permanent equipment identifier (PEI), an internet protocol (IP) address in an IP network (e.g., IP version 4 (Ipv4), IP version 6 (IPv6), and the like), an internet packet exchange (IPX) address, Local Area Network (LAN) ID, media access control (MAC) address, Mobile Subscriber Identification Number (MSIN), Mobile Subscriber/Station ISDN Number (MSISDN), Network identifier (NID), Network Slice Instance (NSI) ID, Permanent Equipment Identifier (PEI), Public Land Mobile Network (PLMN) ID, personal area network (PAN) ID, a port number (e.g., Transmission Control Protocol (TCP) port number, User Datagram Protocol (UDP) port number), QoS Flow ID (QFI) and/or 5G QoS Identifier (5QI), QUIC connection ID, radio access network (RAN) ID, RFID tag, Routing Indicator, service set identifier (SSID) and variants thereof. SMS Function (SMSF) ID, Stand-alone Non-Public Network (SNPN) ID, Subscription Concealed Identifier (SUCI), Subscription Permanent Identifier (SUPI), Temporary Mobile Subscriber Identity (TMSI) and variants thereof, telephone numbers in a public switched telephone network (PTSN), a socket address, universally unique identifier (UUID) (e.g., as specified in ISO/IEC 11578: 1996), UE ID, UE Access Category and Identity, a Universal Resource Locator (URL) and/or Universal Resource Identifier (URI), Virtual LAN (VLAN) ID, an X.21 address, an X.25 address. Zigbee® ID, Zigbee® Device Network ID, and/or any other suitable network address and components thereof.

The term “universally unique identifier” or “UUID” at least in some examples refers to a number used to identify information in computer systems. In some examples, a UUID includes 128-bit numbers and/or are represented as 32 hexadecimal digits displayed in five groups separated by hyphens in the following format: “xxxxxxxx-xxxx-Mxxx-Nxxx-xxxxxxxxxxxx” where the four-bit M and the 1 to 3 bit N fields code the format of the UUID itself. Additionally or alternatively, the term “universally unique identifier” or “UUID” at least in some examples refers to a “globally unique identifier” and/or a “GUID”.

The term “application identifier”, “application ID”, or “app ID” at least in some examples refers to an identifier that can be mapped to a specific application or application instance; in the context of 3GPP 5G/NR systems, an “application identifier” at least in some examples refers to an identifier that can be mapped to a specific application traffic detection rule. Additionally or alternatively, the term “application identifier”, “application ID”, or “app ID” at least in some examples refers to a collection of entry points and/or data structures that an application program can access when translated into an application executable.

The term “endpoint address” at least in some examples refers to an address used to determine the host/authority part of a target URI, where the target URI is used to access an NF service (e.g., to invoke service operations) of an NF service producer or for notifications to an NF service consumer. The term “port” in the context of computer networks, at least in some examples refers to a communication endpoint, a virtual data connection between two or more entities, and/or a virtual point where network connections start and end. Additionally or alternatively, a “port” at least in some examples is associated with a specific process or service.

The term “artificial intelligence” or “AI” at least in some examples refers to any intelligence demonstrated by machines, in contrast to the natural intelligence displayed by humans and other animals. Additionally or alternatively, the term “artificial intelligence” or “AI” at least in some examples refers to the study of “intelligent agents” and/or any device that perceives its environment and takes actions that maximize its chance of successfully achieving a goal. Additionally or alternatively, the term “artificial intelligence” or “AI” at least in some examples refers to a non-human program or model that can solve tasks.

The term “artificial intelligence system” or “AI system” at least in some examples refers to software and/or a machine-based system that is developed with one or more of techniques and approaches listed in Annex I of the [AIA] and can, for a given set of human-defined objectives, generate outputs such as content, predictions, recommendations, and/or decisions influencing the environments they interact with. Additionally or alternatively, the term “artificial intelligence system” or “AI system” at least in some examples refers to software and/or a machine-based system that can, with varying levels of autonomy, for a given set of human-defined objectives, make predictions, content, recommendations, or decisions influencing real or virtual environments they interact with. The term “autonomy” at least in some examples refers to an AI system that can operate by interpreting certain input and by using a set of predetermined objectives, without being limited to such instructions, despite the system's behaviour being constrained by, and targeted at, fulfilling the goal it was given and other relevant design choices made by its developer.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and the like). Linear Dynamical System (LDS), Switching LDS (SLDS), Optical NNs (ONNs), an NN for reinforcement learning (RL) and/or deep RL (DRL), attention models, self-attention models, and/or the like.

The term “bias” at least in some examples refers to stereotyping, prejudice or favoritism towards some things, people, and/or groups over other things, people, and/or groups. In some examples, bias can affect the collection and interpretation of data, the design of a system, how users interact with a system, and/or or prejudiced hypotheses made when designing AI/ML models; examples of these types of bias include automation bias, confirmation bias, experimenter's bias, group attribution bias, implicit bias, in-group bias, and out-group homogeneity bias. In some examples, bias can be led by a systematic error in a sampling or reporting procedure; examples of these types of bias include coverage bias, non-response bias, participation bias, reporting bias, sampling bias, selection bias, and survivor bias. The term “prediction bias” at least in some examples refers to a value indicating how far apart an average of predictions is from an average of labels in a dataset. Additionally or alternatively, the term “bias” or “bias term” at least in some examples refers to an intercept or offset from an origin. Additionally or alternatively, the term “bias” at least in some examples refers to a weight in an ML model such as, for example, a coefficient for a feature in a linear model or an edge in a deep network.

The term “Bayesian optimization” at least in some examples refers to a sequential design strategy for global optimization of black-box functions that does not assume any functional forms. Additionally or alternatively, the term “Bayesian optimization” at least in some examples refers to an optimization technique based upon the minimization of an expected deviation from an extremum. At least in some examples, Bayesian optimization minimizes an objective function by building a probability model based on past evaluation results of the objective.

The term “classification” in the context of machine learning at least in some examples refers to an ML technique for determining the classes to which various data points belong. Here, the term “class” or “classes” at least in some examples refers to categories, and are sometimes called “targets” or “labels.” Classification is used when the outputs are restricted to a limited set of quantifiable properties. Classification algorithms may describe an individual (data) instance whose category is to be predicted using a feature vector. As an example, when the instance includes a collection (corpus) of text, each feature in a feature vector may be the frequency that specific words appear in the corpus of text. In ML classification, labels are assigned to instances, and models are trained to correctly predict the pre-assigned labels of from the training examples, ML algorithms for classification may be referred to as a “classifier.” Examples of classifiers include linear classifiers, k-nearest neighbor (kNN), decision trees, random forests, support vector machines (SVMs), Bayesian classifiers, convolutional neural networks (CNNs), among many others (note that some of these algorithms can be used for other ML tasks as well).

The term “clustering” at least in some examples refers to a process of grouping related examples without existing labels.

The term “computational graph” at least in some examples refers to a data structure that describes how an output is produced from one or more inputs.

The term “converge” or “convergence” at least in some examples refers to the stable point found at the end of a sequence of solutions via an iterative optimization algorithm. Additionally or alternatively, the term “converge” or “convergence” at least in some examples refers to the output of a function or algorithm getting closer to a specific value over multiple iterations of the function or algorithm.

The term “convolution” at least in some examples refers to a convolutional operation or a convolutional layer of a CNN.

The term “convolutional neural network” or “CNN” at least in some examples refers to a neural network including at least one convolutional layer. Additionally or alternatively, the term “convolutional neural network” or “CNN” at least in some examples refers to a DNN designed to process structured arrays of data such as images.

The term “deep learning” at least in some examples refers to a family of ML/AI methods or techniques based on artificial neural networks with representation learning, where the learning is supervised, semi-supervised, or unsupervised. Additionally or alternatively, the term “deep learning” at least in some examples refers to a class of ML/AI algorithms that use multiple layers to progressively extract higher-level features from input data. Additionally or alternatively, the term “deep learning” at least in some examples refers to a subset of ML/AI involving neural networks with three or more layers including an input layer, output layer, and at least one hidden level in between.

The term “ensemble averaging” at least in some examples refers to the process of creating multiple models and combining them to produce a desired output, as opposed to creating just one model.

The term “ensemble learning” or “ensemble method” at least in some examples refers to using multiple learning algorithms to obtain better predictive performance than could be obtained from any of the constituent learning algorithms alone.

The term “evaluation metrics” at least in some examples refers to metrics or measures of the quality of a statistical model or AI/ML model. Examples of evaluation metrics include classification accuracy, logarithmic loss, confusion matrixes, precision, recall, accuracy, false-positive rate, F-measure or F-score, P-value, among many others.

The term “event” at least in some examples refers to a set of outcomes of an experiment (e.g., a subset of a sample space) to which a probability is assigned. Additionally or alternatively, the term “event” at least in some examples refers to a software message indicating that something has happened. Additionally or alternatively, the term “event” at least in some examples refers to an object in time, or an instantiation of a property in an object. Additionally or alternatively, the term “event” at least in some examples refers to a point in space at an instant in time (e.g., a location in space-time). Additionally or alternatively, the term “event” at least in some examples refers to a notable occurrence at a particular point in time.

The term “feature” at least in some examples refers to an individual measureable property, quantifiable property, or characteristic of a phenomenon being observed. Additionally or alternatively, the term “feature” at least in some examples refers to an input variable used in making predictions. Additionally or alternatively, the term “feature” at least in some examples refers to individual independent variables that act as the input to an AI/ML model. At least in some examples, features may be represented using numbers/numerals (e.g., integers), strings, variables, ordinals, real-values, categories, and/or the like.

The term “feature extraction” at least in some examples refers to a process of dimensionality reduction by which an initial set of raw data is reduced to more manageable groups for processing. Additionally or alternatively, the term “feature extraction” at least in some examples refers to retrieving intermediate feature representations calculated by an unsupervised model or a pre-trained model for use in another model as an input. Feature extraction is sometimes used as a synonym of “feature engineering.”

The term “feature map” at least in some examples refers to a function that takes feature vectors (or feature tensors) in one space and transforms them into feature vectors (or feature tensors) in another space. Additionally or alternatively, the term “feature map” at least in some examples refers to a function that maps a data vector (or tensor) to feature space. Additionally or alternatively, the term “feature map” at least in some examples refers to a function that applies the output of one filter applied to a previous layer. In some embodiments, the term “feature map” may also be referred to as an “activation map”.

The term “feature vector” at least in some examples, in the context of ML, refers to a set of features and/or a list of feature values representing an example passed into a model. Additionally or alternatively, the term “feature vector” at least in some examples, in the context of ML, refers to a vector that includes a tuple of one or more features.

The term “hidden layer”, in the context of ML and NNs, at least in some examples refers to an internal layer of neurons in an ANN that is not dedicated to input or output. The term “hidden unit” refers to a neuron in a hidden layer in an ANN.

The term “hyperparameter” at least in some examples refers to characteristics, properties, and/or parameters for an ML process that cannot be learnt during a training process.

Hyperparameter are usually set before training takes place, and may be used in processes to help estimate model parameters. Additionally or alternatively, the term “hyperparameter” at least in some examples refers to a parameter set that controls a learning process, established by a model designer and not learned by the model itself. Examples of hyperparameters include model size (e.g., in terms of memory space, bytes, number of layers, and the like); training data shuffling (e.g., whether to do so and by how much); number of evaluation instances, iterations, epochs (e.g., a number of iterations or passes over the training data), or episodes; number of passes over training data; regularization; learning rate (e.g., the speed at which the algorithm reaches (converges to) optimal weights); learning rate decay (or weight decay); momentum; number of hidden layers; size of individual hidden layers; weight initialization scheme; dropout and gradient clipping thresholds; the C value and sigma value for SVMs; the k in k-nearest neighbors; number of branches in a decision tree; number of clusters in a clustering algorithm; vector size; word vector size for NLP and NLU; and/or the like.

The term “inference engine” at least in some examples refers to a component of a computing system that applies logical rules to a knowledge base to deduce new information.

The terms “instance-based learning” or “memory-based learning” in the context of ML at least in some examples refers to a family of learning algorithms that, instead of performing explicit generalization, compares new problem instances with instances seen in training, which have been stored in memory. Examples of instance-based algorithms include k-nearest neighbor, and the like), decision tree Algorithms (e.g., Classification And Regression Tree (CART), Iterative Dichotomiser 3 (ID3), C4.5, chi-square automatic interaction detection (CHAID), and the like), Fuzzy Decision Tree (FDT), and the like), Support Vector Machines (SVM), Bayesian Algorithms (e.g., Bayesian network (BN), a dynamic BN (DBN), Naive Bayes, and the like), and ensemble algorithms (e.g., Extreme Gradient Boosting, voting ensemble, bootstrap aggregating (“bagging”), Random Forest and the like.

The term “intelligent agent” at least in some examples refers to an a software agent or other autonomous entity which acts, directing its activity towards achieving goals upon an environment using observation through sensors and consequent actuators (i.e. it is intelligent). Intelligent agents may also learn or use knowledge to achieve their goals.

The term “iteration” at least in some examples refers to the repetition of a process in order to generate a sequence of outcomes, wherein each repetition of the process is a single iteration, and the outcome of each iteration is the starting point of the next iteration. Additionally or alternatively, the term “iteration” at least in some examples refers to a single update of a model's weights during training.

The term “Kullback-Leibler divergence” at least in some examples refers to a measure of how one probability distribution is different from a reference probability distribution. The “Kullback-Leibler divergence” may be a useful distance measure for continuous distributions and is often useful when performing direct regression over the space of (discretely sampled) continuous output distributions. The term “Kullback-Leibler divergence” may also be referred to as “relative entropy”.

The term “loss function” or “cost function” at least in some examples refers to an event or values of one or more variables onto a real number that represents some “cost” associated with the event. A value calculated by a loss function may be referred to as a “loss” or “error”. Additionally or alternatively, the term “loss function” or “cost function” at least in some examples refers to a function used to determine the error or loss between the output of an algorithm and a target value. Additionally or alternatively, the term “loss function” or “cost function” at least in some examples refers to a function are used in optimization problems with the goal of minimizing a loss or error.

The term “mathematical model” at least in some examples refers to a system of postulates, data, and inferences presented as a mathematical description of an entity or state of affairs including governing equations, assumptions, and constraints. The term “statistical model” at least in some examples refer to a mathematical model that embodies a set of statistical assumptions concerning the generation of sample data and/or similar data from a larger population. Additionally or alternatively, the term “statistical model” at least in some examples refers to a representation of a data generating process.

The term “machine learning” or “ML” at least in some examples refers to the use of computer systems to optimize a performance criterion using example (training) data and/or past experience. Additionally or alternatively, the term “machine learning” or “ML” at least in some examples refers a subset of AI, which builds (e.g., trains) a predictive model from input data. In some examples, ML involves using algorithms to perform specific task(s) without using explicit instructions to perform the specific task(s), and/or relying on patterns, predictions, and/or inferences. ML uses statistics to build mathematical model(s) and/or statistical model(s), referred to as “ML models” or simply “models”, in order to make predictions or decisions based on sample data (e.g., training data). Examples of ML techniques generally fall into the following main types of learning problem categories: supervised learning, unsupervised learning, and reinforcement learning.

The term “machine learning model”, “ML model”, or “model” at least in some examples refers to a mathematical model and/or statistical model that is trained on some training data and then can process additional data to make predictions. Additionally or alternatively, the term “machine learning model”, “ML model”, or “model” at least in some examples refers to a set of ML methods, techniques, and/or concepts used to address a use case. Additionally or alternatively, the term “machine learning model”, “ML model”, or “model” at least in some examples refers to program, application, or system that can detect, discover, or otherwise determine patterns and/or make decisions from a previously unseen data. An ML model is defined to have a set of parameters, and learning is the execution of a computer program to optimize the parameters of the model using the training data or past experience. The trained model may be a predictive model (or “predictor”) that makes predictions based on an input dataset, an inference model that makes inferences based on input dataset(s), a descriptive model that gains knowledge from an input dataset, or a combination thereof. Once the model is learned (trained), it can be used to make inferences, predictions, and/or decisions. Additionally, separately trained ML models can be chained together in an ML pipeline during inference or prediction generation.

The term “machine learning algorithm” or “ML algorithm” at least in some examples refers to a computer program that learns from experience with respect to some task(s) and some performance measure(s)/metric(s). Additionally or alternatively, the term “machine learning algorithm” or “ML algorithm” at least in some examples refers to a mathematical method to find patterns in a set of data. In some examples, an ML model is an object or data structure created after an ML algorithm is trained with training data. After training, an ML model may be used to make predictions on new datasets. Although the term “ML algorithm at least in some examples refers to different concepts than the term “ML model,” these terms may be used interchangeably for the purposes of the present disclosure.

The term “ML application” or “AI/ML application” at least in some examples refers to an application that contains some AI/ML models and application-level descriptions.

The term “matrix” at least in some examples refers to a rectangular array of numbers, symbols, or expressions, arranged in rows and columns, which may be used to represent an object or a property of such an object.

The term “model parameter” or “parameter” at least in some examples refers to values, characteristics, and/or properties that are learnt during training. Additionally or alternatively, the term “model parameter” and/or “parameter” at least in some examples refers to a configuration variable that is internal to the model and whose value can be estimated from the given data. Additionally or alternatively, the term “model parameter” and/or “parameter” at least in some examples refers to a variable of a model that an AI/ML system learns on its own. In some examples, model parameters are usually required by a model when making predictions, and their values define the skill of the model on a particular problem. Examples of such model parameters/parameters include weights (e.g., in an ANN); constraints; support vectors in a support vector machine (SVM); coefficients in a linear regression and/or logistic regression; word frequency, sentence length, noun or verb distribution per sentence, the number of specific character n-grams per word, lexical diversity, and the like, for natural language processing (NLP) and/or natural language understanding (NLU); and/or the like.

The term “objective function” at least in some examples refers to a function to be maximized or minimized for a specific optimization problem. In some cases, an objective function is defined by its decision variables and an objective. The objective is the value, target, or goal to be optimized, such as maximizing profit or minimizing usage of a particular resource. The specific objective function chosen depends on the specific problem to be solved and the objectives to be optimized. Constraints may also be defined to restrict the values the decision variables can assume thereby influencing the objective value (output) that can be achieved. During an optimization process, an objective function's decision variables are often changed or manipulated within the bounds of the constraints to improve the objective function's values. In general, the difficulty in solving an objective function increases as the number of decision variables included in that objective function increases. The term “decision variable” refers to a variable that represents a decision to be made.

The term “optimization” at least in some examples refers to an act, process, or methodology of making something (e.g., a design, system, or decision) as fully perfect, functional, or effective as possible. Optimization usually includes mathematical procedures such as finding the maximum or minimum of a function. The term “optimal” at least in some examples refers to a most desirable or satisfactory end, outcome, or output. The term “optimum” at least in some examples refers to an amount or degree of something that is most favorable to some end. The term “optima” at least in some examples refers to a condition, degree, amount, or compromise that produces a best possible result. Additionally or alternatively, the term “optima” at least in some examples refers to a most favorable or advantageous outcome or result.

The term “prediction” at least in some examples refers to an AI/ML model's output when provided with an input example. Additionally or alternatively, the term “prediction” at least in some examples refers to AI/ML model's guesses for a target value based on the given features.

The term “target” at least in some examples refers to the information an AI/ML model learns to predict.

The term “probability” at least in some examples refers to a numerical description of how likely an event is to occur and/or how likely it is that a proposition is true. The term “probability distribution” at least in some examples refers to a mathematical function that gives the probabilities of occurrence of different possible outcomes for an experiment or event. The term “probability distribution” at least in some examples refers to a function that gives the probabilities of occurrence of different possible outcomes for an experiment or event. Additionally or alternatively, the term “probability distribution” at least in some examples refers to a statistical function that describes all possible values and likelihoods that a random variable can take within a given range (e.g., a bound between minimum and maximum possible values). A probability distribution may have one or more factors or attributes such as, for example, a mean or average, mode, support, tail, head, median, variance, standard deviation, quantile, symmetry, skewness, kurtosis, and the like. A probability distribution may be a description of a random phenomenon in terms of a sample space and the probabilities of events (subsets of the sample space). Example probability distributions include discrete distributions (e.g., Bernoulli distribution, discrete uniform, binomial, Dirac measure, Gauss-Kuzmin distribution, geometric, hypergeometric, negative binomial, negative hypergeometric, Poisson, Poisson binomial, Rademacher distribution, Yule-Simon distribution, zeta distribution, Zipf distribution, and the like), continuous distributions (e.g., Bates distribution, beta, continuous uniform, normal distribution, Gaussian distribution, bell curve, joint normal, gamma, chi-squared, non-central chi-squared, exponential, Cauchy, lognormal, logit-normal, F distribution, t distribution, Dirac delta function, Pareto distribution, Lomax distribution, Wishart distribution, Weibull distribution, Gumbel distribution, Irwin-Hall distribution. Gompertz, distribution, inverse Gaussian distribution (or Wald distribution), Chernoff's distribution. Laplace distribution. Pólya-Gamma distribution, and the like), and/or joint distributions (e.g., Dirichlet distribution. Ewens's sampling formula, multinomial distribution, multivariate normal distribution, multivariate t-distribution, Wishart distribution, matrix normal distribution, matrix t distribution, and the like).

The term “production model” at least in some examples refers to an AI/ML model that has been launched into operation after being successfully trained and evaluated.

The term “regression algorithm”, “regression analysis”, or “regression” at least in some examples refers to a set of statistical processes for estimating the relationships between a dependent variable (often referred to as the “outcome variable”) and one or more independent variables (often referred to as “predictors”, “covariates”, or “features”). Additionally or alternatively, the term “regression algorithm”, “regression analysis”, or “regression” at least in some examples refers to a type of AI/ML model that outputs continuous values. Examples of regression algorithms/models include logistic regression, linear regression, gradient descent (GD), stochastic GD (SGD), and the like.

The term “reinforcement learning” or “RL” at least in some examples refers to a goal-oriented learning technique based on interaction with an environment. Additionally or alternatively, the term “reinforcement learning” or “RL” at least in some examples refers to a family of AI/ML algorithms that learn an optimal policy, whose goal is to maximize return when interacting with an environment. In some RL examples, an agent aims to optimize a long-term objective by interacting with the environment based on a trial and error process. Examples of RL algorithms include Markov decision process. Markov chain, Q-learning, multi-armed bandit learning, temporal difference learning, and deep RL, The term “multi-armed bandit problem”, “K-armed bandit problem”, “N-armed bandit problem”, or “contextual bandit” at least in some examples refers to a problem in which a fixed limited set of resources must be allocated between competing (alternative) choices in a way that maximizes their expected gain, when each choice's properties are only partially known at the time of allocation, and may become better understood as time passes or by allocating resources to the choice. The term “contextual multi-armed bandit problem” or “contextual bandit” at least in some examples refers to a version of multi-armed bandit where, in each iteration, an agent has to choose between arms; before making the choice, the agent sees a d-dimensional feature vector (context vector) associated with a current iteration, the learner uses these context vectors along with the rewards of the arms played in the past to make the choice of the arm to play in the current iteration, and over time the learner's aim is to collect enough information about how the context vectors and rewards relate to each other, so that it can predict the next best arm to play by looking at the feature vectors. The term “reward function”, in the context of RL, at least in some examples refers to a function that outputs a reward value based on one or more reward variables; the reward value provides feedback for an RL policy so that an RL agent can learn a desirable behavior. The term “reward shaping”, in the context of RL, at least in some examples refers to a adjusting or altering a reward function to output a positive reward for desirable behavior and a negative reward for undesirable behavior.

The term “sample space” in probability theory (also referred to as a “sample description space” or “possibility space”) of an experiment or random trial at least in some examples refers to a set of all possible outcomes or results of that experiment.

The term “search space”, in the context of optimization, at least in some examples refers to an a domain of a function to be optimized. Additionally or alternatively, the term “search space”, in the context of search algorithms, at least in some examples refers to a feasible region defining a set of all possible solutions. Additionally or alternatively, the term “search space” at least in some examples refers to a subset of all hypotheses that are consistent with the observed training examples, Additionally or alternatively, the term “search space” at least in some examples refers to a version space, which may be developed via machine learning.

The term “supervised learning” at least in some examples refers to an ML technique that aims to learn a function or generate an ML model that produces an output given a labeled dataset. Supervised learning algorithms build models from a set of data that contains both the inputs and the desired outputs. For example, supervised learning involves learning a function or model that maps an input to an output based on example input-output pairs or some other form of labeled training data including a set of training examples, Each input-output pair includes an input object (e.g., a vector) and a desired output object or value (referred to as a “supervisory signal”). Supervised learning can be grouped into classification algorithms, regression algorithms, and instance-based algorithms.

The term “training data” at least in some examples refers to data used for training an AI system through fitting its learnable parameters such as the weights of an ANN. Additionally or alternatively, the term “training data” at least in some examples refers to a set of examples or a dataset used to fit the parameters (e.g. weights of connections between neurons in an ANN) of an AL/ML model.

The term “validation data” at least in some examples refers to data used for providing an evaluation of the trained AI system and for tuning its non-learnable parameters and its learning process, among other things, in order to prevent overfitting; whereas the validation dataset can be a separate dataset or part of the training dataset, either as a fixed or variable split.

The term “testing data” at least in some examples refers to data used for providing an independent evaluation of the trained and validated AI system in order to confirm the expected performance of that system before its placing on the market or putting into service.

The term “input data” at least in some examples refers to data provided to or directly acquired by an AI system on the basis of which the system produces an output. The term “model inference information” or “inference data” at least in some examples refers to information needed as input for an ML model to produce or otherwise generate an inference or prediction.

The term “unsupervised learning” at least in some examples refers to an ML technique that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Examples of unsupervised learning are K-means clustering, principal component analysis (PCA), and topic modeling, among many others. The term “semi-supervised learning at least in some examples refers to ML algorithms that develop ML models from incomplete training data, where a portion of the sample input does not include labels.

The term “vector” at least in some examples refers to a one-dimensional array data structure. Additionally or alternatively, the term “vector” at least in some examples refers to a tuple of one or more values called scalars.

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment. Additionally or alternatively, the term “application” or “app” at least in some examples refers to a computer program that defines and implements a useful functionality. The term “application executable” or “executable” at least in some examples refers to a representation of an application as collection of executable code. The term “application executable” or “executable” at least in some examples refers to a representation of an application in a programming language such as, for example, assembly language, an object-oriented programming language, a declarative programming language, a markup language, a scripting language, and/or some other type of language.

The term “process” at least in some examples refers to an instance of a computer program that is being executed by one or more threads. In some implementations, a process may be made up of multiple threads of execution that execute instructions concurrently.

The term “algorithm” at least in some examples refers to an unambiguous specification of how to solve a problem or a class of problems by performing calculations, input/output operations, data processing, automated reasoning tasks, and/or the like.

The term “analytics” at least in some examples refers to the discovery, interpretation, and communication of meaningful patterns in data.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. Additionally or alternatively, the term “application programming interface” or “API” at least in some examples refers to a collection of entry points and/or data structures that an application program can access when translated into an application executable. In some examples,

an API may be defined or otherwise used for a web-based system, operating system, database system, computer hardware, software library, and/or the like.

The term “data processing” or “processing” at least in some examples refers to any operation or set of operations which is performed on data or on sets of data, whether or not by automated means, such as collection, recording, writing, organization, structuring, storing, adaptation, alteration, retrieval, consultation, use, disclosure by transmission, dissemination or otherwise making available, alignment or combination, restriction, erasure and/or destruction.

The term “data pipeline” or “pipeline” at least in some examples refers to a set of data processing elements (or data processors) connected in series and/or in parallel, where the output of one data processing element is the input of one or more other data processing elements in the pipeline; the elements of a pipeline may be executed in parallel or in time-sliced fashion and/or some amount of buffer storage can be inserted between elements.

The term “filter” at least in some examples refers to computer program, subroutine, or other software element capable of processing a stream, data flow, or other collection of data, and producing another stream. In some examples, multiple filters can be strung together or otherwise connected to form a pipeline.

The terms “instantiate,” “instantiation,” and the like at least in some examples refers to the creation of an instance. An “instance” also at least in some examples refers to a concrete occurrence of an object, which may occur, for example, during execution of program code.

The term “operating system” or “OS” at least in some examples refers to system software that manages hardware resources, software resources, and provides common services for computer programs. The term “kernel” at least in some examples refers to a portion of OS code that is resident in memory and facilitates interactions between hardware and software components.

The term “packet processor” at least in some examples refers to software and/or hardware element(s) that transform a stream of input packets into output packets (or transforms a stream of input data into output data); examples of the transformations include adding, removing, and modifying fields in a packet header, trailer, and/or payload.

The term “software agent” at least in some examples refers to a computer program that acts for a user or other program in a relationship of agency.

The term “use case” at least in some examples refers to a description of a system from a user's perspective. Use cases sometimes treat a system as a black box, and the interactions with the system, including system responses, are perceived as from outside the system. Use cases typically avoid technical jargon, preferring instead the language of the end user or domain expert. The term “user” at least in some examples refers to an abstract representation of any entity

issuing commands, requests, and/or data to a compute node or system, and/or otherwise consumes or uses services.

The term “datagram” at least in some examples at least in some examples refers to a basic transfer unit associated with a packet-switched network; a datagram may be structured to have header and payload sections. The term “datagram” at least in some examples may be synonymous with any of the following terms, even though they may refer to different aspects: “data unit”, a “protocol data unit” or “PDU”, a “service data unit” or “SDU”, “frame”, “packet”, a “network packet”, “segment”, “block”, “cell”, “chunk”, and/or the like. Examples of datagrams, network packets, and the like, include internet protocol (IP) packet. Internet Control Message Protocol (ICMP) packet, UDP packet. TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a [IEEE802] protocol/standard (e.g., [IEEE80211] or the like), and/or other like data structures.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information.

The term “field” at least in some examples refers to individual contents of an information element, or a data element that contains content. The term “data field” or “DF” at least in some examples refers to a data type that contains more than one data element in a predefined order.

The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, and the like), object instances, and/or other data elements. An “attribute” at least in some examples refers to a markup construct including a name-value pair that exists within a start tag or empty element tag. Attributes contain data related to its element and/or control the element's behavior.

The term “reference” at least in some examples refers to data useable to locate other data and may be implemented a variety of ways (e.g., a pointer, an index, a handle, a key, an identifier, a hyperlink, and/or the like).

The term “translation” at least in some examples refers to the process of converting or

otherwise changing data from a first form, shape, configuration, structure, arrangement, embodiment, description, or the like into a second form, shape, configuration, structure, arrangement, embodiment, description, or the like; at least in some examples there may be two different types of translation: transcoding and transformation. The term “transcoding” at least in some examples refers to taking information/data in one format (e.g., a packed binary format) and translating the same information/data into another format in the same sequence. Additionally or alternatively, the term “transcoding” at least in some examples refers to taking the same information, in the same sequence, and packaging the information (e.g., bits or bytes) differently. The term “transformation” at least in some examples refers to changing data from one format and writing it in another format, keeping the same order, sequence, and/or nesting of data items.

Additionally or alternatively, the term “transformation” at least in some examples involves the process of converting data from a first format or structure into a second format or structure, and involves reshaping the data into the second format to conform with a schema or other like specification. Transformation may include rearranging data items or data objects, which may involve changing the order, sequence, and/or nesting of the data items/objects. Additionally or alternatively, the term “transformation” at least in some examples refers to changing the schema of a data object to another schema.

The term “database” at least in some examples refers to an organized collection of data stored and accessed electronically. Databases at least in some examples can be implemented according to a variety of different database models, such as relational, non-relational (also referred to as “schema-less” and “NoSQL”), graph, columnar (also referred to as extensible record), object, tabular, tuple store, and multi-model. Examples of non-relational database models include key-value store and document store (also referred to as document-oriented as they store document-oriented information, which is also known as semi-structured data). A database may comprise one or more database objects that are managed by a database management system (DBMS).

The term “database object” at least in some examples refers to any representation of information that is in the form of an object, attribute-value pair (AVP), key-value pair (KVP), tuple, and the like, and may include variables, data structures, functions, methods, classes, database records, database fields, database entities, associations between data and/or database entities (also referred to as a “relation”), blocks in block chain implementations, and links between blocks in block chain implementations. Furthermore, a database object may include a number of records, and each record may include a set of fields. A database object can be unstructured or have a structure defined by a DBMS (a standard database object) and/or defined by a user (a custom database object). In some implementations, a record may take different forms based on the database model being used and/or the specific database object to which it belongs. For example, a record may be: 1) a row in a table of a relational database; 2) a JavaScript Object Notation (JSON) object; 3) an Extensible Markup Language (XML) document; 4) a KVP; and the like.

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like).

The term “authorization” at least in some examples refers to a prescription that a particular behaviour shall not be prevented.

The term “biometric data”, “biometrics”, and/or “biometric identifier” at least in some examples refers to any body measurement(s) and/or calculation(s) related to human characteristics. Additionally or alternatively, the term “biometric data”, “biometrics”, and/or “biometric identifier” at least in some embodiments refers to one or more distinctive, measurable characteristics used to label and describe an individual. The term “physiological biometrics” at least in some embodiments refers to biometrics and/or other characteristics related to physical aspects of an individual; examples include fingerprints, face image, facial features (e.g., including relative arrangement of facial features). DNA, palm print, body part geometry (e.g., hand geometry and/or the like), vein patterns (e.g., palm vein patterns, finger vein pattern, or vein patters of any other body part), eye features (e.g., retina and/or iris), odor/scent, voice features (e.g., pitch, tone, and other audio characteristics of an individual's voice), neural oscillations and/or brainwaves, pulse, electrocardiogram, pulse oximetry, and/or the like. The term “behavioral biometrics” or “behaviometrics” at least in some embodiments refers to biometrics and/or other characteristics related to an individual's behavioral pattern(s); examples include typing rhythm, gait, signature, behavioral profiling (e.g., including personality traits), and voice features

The term “certificate” or “digital certificate” at least in some examples refers to an information object (e.g., an electronic document or other data structure) used to prove the validity of a piece of data such as a public key in a public key infrastructure (PKI) system.

The term “authentication” at least in some embodiments refers to a process of proving or verifying an identity. Additionally or alternatively, the term “authentication” at least in some embodiments refers to a mechanism by which a computer system checks or verifies that a user or entity is really the user or entity being claimed.

The term “confidential data” at least in some examples refers to any form of information that a person or entity is obligated, by law or contract, to protect from unauthorized access, use, disclosure, modification, or destruction. Additionally or alternatively, “confidential data” at least in some examples refers to any data owned or licensed by a person or entity that is not intentionally shared with the general public or that is classified by the person or entity with a designation that precludes sharing with the general public.

The term “consent” at least in some examples refers to any freely given, specific, informed and unambiguous indication of a data subject's wishes by which he or she, by a statement or by a clear affirmative action, signifies agreement to the processing of personal data relating to the data subject.

The term “consistency check” at least in some examples refers to a test or assessment performed to determine if data has any internal conflicts, conflicts with other data, and/or whether any contradictions exist. In some examples, a “consistency check” may operate according to a “consistency model”, which at least in some examples refers to a set of operations for performing a consistency check and/or rules or policies used to determine if data is consistent (or predictable) or not.

The term “cryptographic mechanism” at least in some examples refers to any cryptographic protocol and/or cryptographic algorithm. Additionally or alternatively, the term “cryptographic protocol” at least in some examples refers to a sequence of steps precisely specifying the actions required of two or more entities to achieve specific security objectives (e.g., cryptographic protocol for key agreement). Additionally or alternatively, the term “cryptographic algorithm” at least in some examples refers to an algorithm specifying the steps followed by a single entity to achieve specific security objectives (e.g., cryptographic algorithm for symmetric key encryption).

The term “cryptographic hash function”, “hash function”, or “hash”) at least in some examples refers to a mathematical algorithm that maps data of arbitrary size (sometimes referred to as a “message”) to a bit array of a fixed size (sometimes referred to as a “hash value”, “hash”, or “message digest”). A cryptographic hash function is usually a one-way function, which is a function that is practically infeasible to invert.

The term “data breach” at least in some examples refers to a breach of security leading to the accidental or unlawful destruction, loss, alteration, unauthorised disclosure of, or access to, data (including personal, sensitive, and/or confidential data) transmitted, stored or otherwise processed.

The term “integrity” at least in some examples refers to a mechanism that assures that data has not been altered in an unapproved way. Examples of cryptographic mechanisms that can be used for integrity protection include digital signatures, message authentication codes (MAC), and secure hashes.

The term “information security” or “InfoSec” at least in some examples refers to any practice, technique, and technology for protecting information by mitigating information risks and typically involves preventing or reducing the probability of unauthorized/inappropriate access to data, or the unlawful use, disclosure, disruption, deletion, corruption, modification, inspection, recording, or devaluation of information; and the information to be protected may take any form including electronic information, physical or tangible (e.g., computer-readable media storing information, paperwork, and the like), or intangible (e.g., knowledge, intellectual property assets, and the like).

The term “personal data,” “personally identifiable information,” “PII,” at least in some examples refers to information that relates to an identified or identifiable individual (referred to as a “data subject”). Additionally or alternatively, “personal data,” “personally identifiable information,” “PII,” at least in some examples refers to information that can be used on its own or in combination with other information to identify, contact, or locate a data subject, or to identify a data subject in context.

The term “Personal Identity Verification” or “PIV” at least in some examples refers to a common identification standard for Federal employees and contractors as specified in National Institute of Standards and Technology (NIST), “Personal Identity Verification (PIV) of Federal Employees and Contractors”, Federal Information Processing Standards (FIPS) 201-3 (January 2022), which is hereby incorporated by reference in its entirety.

The term “Personal Identity Verification—Interoperable” or “PIV-I” at least in some examples refers to a credential standard for issuance to non-Federal entities to access U.S. Federal Government systems. Additionally or alternatively, the term “Personal Identity Verification-Interoperable” or “PIV-I” at least in some embodiments refers to a credential that is issued to non-Federal entities per the Chief Information Officers (CIO) Council, “Personal Identity Verification Interoperability for Issuers” v2.0.1 (27 Jul. 2017), which is hereby incorporated by reference in its entirety.

The term “plausibility check” at least in some examples refers to a test or assessment performed to determine whether data is, or can be, plausible. The term “plausible” at least in some examples refers to an amount or quality of being acceptable, reasonable, comprehensible, and/or probable.

The term “protected location” at least in some examples refers to a memory location outside of a hardware root of trust, protected against attacks on confidentiality, and in which from the perspective of the root of trust, integrity protection is limited to the detection of modifications.

The term “pseudonymization” at least in some examples refers to any means of processing personal data or sensitive data in such a manner that the personal/sensitive data can no longer be attributed to a specific data subject (e.g., person or entity) without the use of additional information. The additional information may be kept separately from the personal/sensitive data and may be subject to technical and organizational measures to ensure that the personal/sensitive data are not attributed to an identified or identifiable natural person.

The term “Secure Signature Creating Device” and/or “SSCD” at least in some examples refers to a device for creating a digital signature that is able to ensure that the signature-creation data involved in creating a signature is unique, protects against forgery and alteration after the signature has been created.

The term “security threat” at least in some examples refers to a potential violation of security. Examples of security threats include loss or disclosure of information, modification of assets, destruction of assets, and the like. In some examples, a security threat can be intentional like a deliberate attack or unintentional due to an internal failure or malfunctions. Alteration of data/assets may include insertion, deletion, and/or substitution breaches.

The term “sensitive data” at least in some examples refers to data related to racial or ethnic origin, political opinions, religious or philosophical beliefs, or trade union membership, genetic data, biometric data, data concerning health, and/or data concerning a natural person's sex life or sexual orientation.

The term “shielded location” at least in some examples refers to a memory location within the hardware root of trust, protected against attacks on confidentiality and manipulation attacks including deletion that impact the integrity of the memory, in which access is enforced by the hardware root of trust.

The term “signature” or “digital signature” at least in some examples refers to a mathematical scheme, process, or method for verifying the authenticity of a digital message or information object (e.g., an electronic document or other data structure).

The term “verification” at least in some examples refers to a process, method, function, or any other means of establishing the correctness of information or data.

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, and/or the like). Furthermore, various standards (e.g., 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-51. (canceled)

52. An apparatus of an artificial intelligence (AI) system, comprising:
AI engine circuitry to operate a machine learning (ML) model;
memory circuitry to store program code of a set of self-assessment entities including a self-verification entity; and
processor circuitry connected to the memory circuitry, wherein the processor circuitry is to operate the self-verification entity to:
cause the AI engine circuitry to operate the ML model using a predefined test dataset, and
stop or pause the operation of the AI engine circuitry when biased predictions are generated by the AI engine circuitry based on the predefined test dataset.

53. The apparatus of claim 52, wherein the set of self-assessment entities includes a risk-related information (RRI) processing entity, and the processor circuitry is to operate the RRI processing entity to:
process outputs generated by other ones of the self-assessment entities in a human-consumable format; and
present the processed outputs to an authorized user.

54. The apparatus of claim 52, wherein the set of self-assessment entities includes a risk mitigation entity, and the processor circuitry is to operate the risk mitigation entity to:
determine trade-offs between risks of using the ML model versus functionality or efficiencies of operating the ML model.

55. The apparatus of claim 52, wherein the set of self-assessment entities includes an AI system management entity, and the processor circuitry is to operate the AI system management entity to:
orchestrate internal processes of the AI system and orchestrate interactions between individual components of a set of components of the AI system or the ML model.

56. The apparatus of claim 55, wherein the set of self-assessment entities includes an AI system redundancy entity, and the processor circuitry is to operate the AI system redundancy entity to:
detect, during the operation of the AI system, a malfunctioning component of the set of components; and
replace the malfunctioning component with another component that fulfills a same or similar function as the malfunctioning component.

57. The apparatus of claim 55, wherein the set of self-assessment entities includes a human oversight entity, and the processor circuitry is to operate the human oversight entity to:
provide information about potential biases in predictions generated by the ML model to an authorized user via a user interface;
receive a selected action based on the provided information; and
issue the action to one or more components of the set of components to be executed by the one or more components.

58. The apparatus of claim 52, wherein the set of self-assessment entities includes a record keeping entity, and the processor circuitry is to operate the record keeping entity to:
track interactions with the AI system, wherein the interactions include one or more of user activity, behavior of the AI system or the ML model, and information on training or testing the ML model; and
logging the tracked interactions in one or more records.

59. The apparatus of claim 52, wherein the AI engine circuitry comprises one or more of an inference engine, a recommendation engine, a reinforcement learning agent, a neural network engine, a neural co-processor, a hardware accelerator, a graphics processing unit, or a general-purpose processor.

60. A non-transitory computer readable medium (NTCRM) comprising instructions for operating a set of artificial intelligence (AI) system monitoring, evaluation, and reporting (AIMER) functions including an AI risk management system function (AIRMS), wherein execution of the instructions by one or more processors is to cause a compute node to operate the AIRMS to:
monitor outputs generated by an AI system implemented by the compute node; and
issuing one or more corrective actions to the AI system when the monitored outputs include potential biases, wherein the one or more corrective actions include adjusting one or more parameters to reduce or eliminate the potential biases.

61. The NTCRM of claim 60, wherein execution of the instructions is to cause the compute node to operate the AIRMS to:
monitor inputs provided to the AI system; and
issuing one or more other corrective actions to the AI system when the monitored inputs include potential errors, wherein the one or more other corrective actions include adjusting one or more parameters of the inputs to correct the potential errors.

62. The NTCRM of claim 60, wherein the set of AIMER functions includes a data verification component (DVC), and execution of the instructions is to cause the compute node to operate the DVC to:
validate an input dataset before the input dataset is provided to the AI system; and
tag the input dataset with a digital certificate when the input dataset is properly validated, and wherein the AI system is to verify the input dataset using the digital certificate, and generate a prediction using the input dataset when the input dataset is properly verified.

63. The NTCRM of claim 60, wherein the set of AIMER functions includes an entity for record keeping (ERK), and execution of the instructions is to cause the compute node to operate the ERK to:
obtain inputs to the AI system, outputs generated by the AI system, and internal states corresponding to the inputs or the outputs;
process the inputs, the outputs, and the internal states to generate statistics or metrics related to the inputs, the outputs, and the internal states; and
store the inputs, the outputs, the internal states, and the statistics or metrics in a local or remote database.

64. The NTCRM of claim 60, wherein the set of AIMER functions includes an entity for transparency and information (ETI), and execution of the instructions is to cause the compute node to operate the ETI to:
generate transparency data including one or more of capability information of the AI system, maintenance and care information related to the AI system, self-assessment information related to the AI system, and historic data related to the operation of the AI system; and
generate user interface data to present the transparency data, wherein the user interface data includes one or more of text data, image data, audio data, and video data; and
send the user interface data to an authorized user.

65. The NTCRM of claim 60, wherein the set of AIMER functions includes an entity for AI output self-verification (EAIOSV), and execution of the instructions is to cause the compute node to operate the EAIOSV to:
perform a self-verification process on a prediction generated by the AI system before the prediction is provided to an external entity, wherein the self-verification process includes:
comparison of the generated prediction with one or more historical predictions; and
determination of biases in the generated prediction based on a divergence of the generated prediction from the one or more historical predictions.

66. The NTCRM of claim 65, wherein the self-verification process includes:
operation of an alternation function to change one or more parameters of the AI system;
obtaining a prediction from the AI system with the changed one or more parameters;
comparison of the generated prediction with obtained prediction; and
determination of biases in the generated prediction based on a divergence of the generated prediction from the obtained prediction.

67. The NTCRM of claim 60, wherein the set of AIMER functions includes an accuracy verification entity (AVE), and execution of the instructions is to cause the compute node to operate the AVE to:
place the AI system in a testing state;
provide a test dataset to the AI system in the testing state;
compare outputs generated by the AI system in the testing state with known outputs for the test dataset; and
calculate an accuracy metric for the AI system in the testing state based on a number of correct predictions in the generated outputs or a number of incorrect predictions in the generated outputs.

68. The NTCRM of claim 67, wherein the set of AIMER functions includes a robustness verification entity (RVE), and execution of the instructions is to cause the compute node to operate the RVE to:
modify the test dataset to include one or more erroneous data items;
compare outputs generated by the AI system in the testing state with known outputs for the test dataset; and
calculate robustness metric for the AI system in the testing state based on the number of correct predictions or the number of incorrect, wherein the number of correct predictions includes one or more correctly identified errors based on the one or more erroneous data items and the number of incorrect predictions includes one or more unidentified errors based on the one or more erroneous data items.

69. The NTCRM of claim 60, wherein the set of AIMER functions includes cryptographic engine (CE), and execution of the instructions is to cause the compute node to operate the CE to:
generate a fingerprint for the AI system based on one or more inputs to the AI system, outputs generated by the AI system, and one or more internal system states of the AI system; and
encrypt data to be conveyed between the AI system and the set of AIMER functions or communicated to external devices.

70. The NTCRM of claim 69, wherein the set of AIMER functions includes an AI system quality manager (AISQM), and execution of the instructions is to cause the compute node to operate the AISQM to:
calculate a quality metric for the AI system based on the fingerprint, the accuracy metric, and the robustness metric; and
issue one or more remedial actions to the AI system when the quality metric is below a threshold.

71. The NTCRM of claim 60, wherein the AI system comprises one or more of an inference engine, a recommendation engine, a reinforcement learning agent, a neural network engine, a neural co-processor, a hardware accelerator, a graphics processing unit, or a general-purpose processor.
